(19) United States
(12) Patent Application Publication
(10) Pub. No.: US 2003/0087761 A1
(43) Pub. Date: May 8, 2003

(54) Synergistic active compound combinations for controlling harmful plants

(76) Inventors: Hartmut Ahrens, Frankfurt (DE); Hansjorg Dietrich, Hofheim (DE); Lothar Willms, Hofheim (DE); Erwin Hacker, Hochheim (DE); Hermann Bieringer, Eppstein (DE)

Correspondence Address: FROMMER LAWRENCE & HAUG LLP, 745 Fifth Avenue, New York, NY, 10151, US

(21) Appl. No.: 10/116,361

(22) Filed: Apr. 4, 2002

(30) Foreign Application Priority Data
Apr. 7, 2001 (DE) 101 17 505.1

(51) Int. Cl. A01N 43/64

(52) U.S. Cl. 504/133

(57) ABSTRACT

The invention relates to synergistic herbicide combinations for controlling harmful plants in crops of plants. The combinations comprise active compounds (A) and (B), where

(A) are aminotriazines having a partial structure of the formula (I)

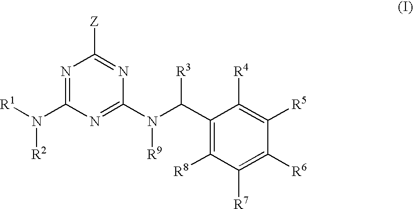

where Z and R¹ to R⁹ are as defined in claim 1 and at least one of the radicals R⁴ to R⁸ is different from hydrogen,

and

(B) is one or more herbicides selected from the group of compounds consisting of

(B1) foliar- and/or soil-acting herbicides which are active against monocotyledonous harmful plants,

(B2) herbicides which are active against predominantly dicotyledonous harmful plants,

(B3) herbicides which are active against monocotyledonous and dicotyledonous harmful plants and, if appropriate,

(B4) herbicides which are active against monocotyledonous and dicotyledonous harmful plants and which can be employed specifically in tolerant crops or on non-crop land.

The invention relates to the field of crop protection agents, in particular to the combination of groups of active compounds having different modes of action and types of activity, which are outstandingly suitable for use against harmful plants in crops of useful plants.

In many crops of useful plants, harmful plants are undesirable competitors which can be controlled only with considerable expense and at high cost. They germinate and grow in the soil over prolonged periods of time and can therefore only be effectively controlled with herbicides having foliar and soil action. Examples of economically important harmful plants which occur in crops of useful plants all over the world are: Alcopecurus myosuroides, Avena fatua and other forms of wild oat, Lolium spp., Phalaris spp., Setaria spp., Echinochloa spp., Poa spp., Bromus spp., Elymus repens, Sorghum spp. and others, such as Agrostis spp. and Panicum spp. Herbicides suitable for controlling such harmful plants are, for example, those of the group of some derivatives of 2,4-diamino-1,3,5-triazine substituted in the 6-position (short amino triazines), as described in WO-A 97/08156, WO-A-97/31904, DE-A-19826670, WO-A-98/15536, WO-A-98/15537, WO-A-98/15538, WO-A-98/15539 and also DE-A-19828519, WO-A-98/34925, WO-A-98142684, WO-A-99/18100, WO-A-99/19309, WO-A-99137627, WO-A-99144999, WO-A-99/46249, WO-A-99/65882 and WO-A-00100480, WO-A-00132580, WO-A-00/47579, WO-A-00/56722, WO-A-00/69854 and WO-A-01/10849.

The effectiveness of these herbicides against harmful plants in crops is at a high level; however, it depends in general on the application rate, the respective formulation, the harmful plants to be controlled in each case or the spectrum of harmful plants, the climatic and soil conditions, etc. A further criterion is the duration of action, or the rate of degradation of the herbicide. Also to be taken into account are, if appropriate, changes in the susceptibility of harmful plants toward an active compound which may occur within geographical limits or on prolonged use of the herbicides. Activity losses in individual plants can only be compensated to a certain extent by higher application rates of the herbicides, for example because this frequently decreases the selectivity of the herbicides, or an improvement in activity is not observed, even at higher application rates. In some cases, it is possible to improve the selectivity in crops by addition of safeners. In general, however, there is always a need for methods to achieve the herbicidal action with a lower application rate of active compounds. A lower application rate reduces not only the amount of an active compound which is required for the application, but generally also reduces the amount of formulation auxiliaries required. Both reduce the economic expense and improve the ecological compatibility of the herbicide treatment.

One possibility for improving the application profile of a herbicide may consist in the combination of the active compound with one or more other active compounds which contribute the desired additional properties. However, when two or more active compounds are applied in combination, it is not uncommon for phenomena of physical and biological incompatibility to occur, for example lack of stability of a coformulation, decomposition of an active compound or antagonism of the active compounds. In contrast, what is desired are combinations of active compounds having a favorable activity profile, high stability and, as far as possible, synergistically enhanced activity, which permits a reduction of the application rate, compared with the individual application of the active compounds to be combined.

In the publications cited above, it has already been proposed to combine the active compounds described with known herbicides, and an extensive list of possible combination partners has been given. However, indications of favorable, in particular synergistic, properties of specific combinations have not been given therein.

Some herbicide combinations comprising, as one component, herbicides from the group of the 2,4-diamino-1,3,5-triazines have already been disclosed, with, inter alia, synergistic effects being described; cf. WO-A-98/10654, JP-A-10025211, WO-A-97/35481, JP-A-08198712, EP-A-573897, EP-A-573898 and WO-A-00/16627.

Surprisingly, it has now been found that certain active compounds from the group of the aminotriazine herbicides mentioned interact in a particularly favorable manner in combination with certain structurally different herbicides when used in crops of plants which are suitable for the selective use of the herbicides.

The invention provides herbicide combinations which differ from the prior art or have technical advantages over the prior art, and which comprise a synergistically effective amount of components (A) and (B), where

component (A) is one or more herbicidally active aminotriazine compounds of the formula (I) or salts thereof,

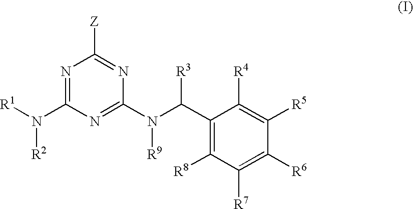

in which

Z is hydroxyl, halogen or

(C₁-C₁₀)alkyl, where the last-mentioned substituent is unsubstituted or substituted by one or more radicals selected from the group consisting of halogen, hydroxyl, amino, mercapto, cyano, nitro, thiocyanato, formyl, (C₁-C₄)alkoxy, mono(C₁-C₄)alkylamino, di(C₁-C₄)alkylamino, (C₁-C₄)haloalkoxy, (C₂-C₄)alkenyloxy, (C₂-C₄)haloalkenyloxy, (C₂-C₄)alkynyloxy, (C₂-C₄)haloalkynyloxy, (C₁-C₄)alkylthio, (C₁-C₄)alkylsulfinyl, (C₁-C₄)haloalkylsulfinyl, (C₁-C₄)alkylsulfonyl, (C₁-C₄)haloalkylsulfonyl, [(C₁-C₄)alkyl]carbonyl, [(C₁-C₄)haloalkyl]carbonyl, [(C₁-C₄)alkoxy]carbonyl, (C₃-C₉)cycloalkyl, (C₅-C₆)cycloalkenyl, phenyl and heterocyclyl, where each of the 4 last-mentioned radicals is unsubstituted or substituted, preferably unsubstituted or substituted by one or more radicals selected from the group consisting of halogen, cyano, hydroxyl, (C₁-C₄)alkyl, (C₁-C₄)haloalkyl, (C₂-C₄)alkenyl, (C₂-C₄)haloalkenyl, (C₂-C₄)alkynyl, (C₂-C₄)haloalkyl, (C₁-C₄)alkoxy, (C₁-C₄)haloalkoxy and (C₁-C₄)alkylthio and heterocycyl contains preferably in each case 3 to 9 ring atoms including 1 to 4 hetero ring atoms selected from the group consisting of N, O and S, or

[(C₁-C₆)alkyl]carbonyl, [(C₁-C₆)alkoxy]carbonyl, (C₁-C₆)alkylsulfinyl or (C₁-C₄)alkylsulfonyl, where each of the 4 last-mentioned radicals is unsubstituted or substituted, preferably unsubstituted or substituted by one or more radicals selected from the group consisting of halogen, (C₁-C₄)alkoxy, (C₁-C₄)haloalkoxy and (C₁-C₄)alkylthio, or

(C₃-C₆)cycloalkyl, (C₅-C₆)cycloalkenyl, where each of the two last-mentioned cyclic radicals is unsubstituted or substituted, preferably unsubstituted or substituted by one or more radicals selected from the group consisting of halogen, cyano, (C₁-C₄)alkyl, (C₁-C₄)haloalkyl, (C₂-C₄)alkenyl, C₂-C₄)alkynyl, (C₁-C₄)alkoxy, (C₁-C₄)haloalkoxy and (C₁-C₄)alkylthio, where the radical Z including substituents has preferably 1 to 30 carbon atoms, in particular from 1 to 20 carbon atoms

R¹ and R² independently of one another are

H, formyl, aminocarbonyl, aminothiocarbonyl, (C₁-C₁₀)alkyl, (C₂-C₁₀)alkenyl, (C₂-C₁₀)alkynyl, (C₁-C₁₀)alkylsulfinyl, (C₁-C₁₀)alkylsulfonyl, (C₁-C₁₀)alkoxy, [(C₁-C₁₀)alkyl]carbonyl, [(C₁-C₁₀)alkyl]thiocarbonyl, [(C₁-C₁₀)alkoxy]carbonyl, [(C₁-Cl o)alkoxy]thiocarbonyl, mono[(C₁-C₁₀)alkyl]aminocarbonyl, di[(C₁-C₁₀)alkyl]aminocarbonyl, mono[(C₁-C₁₀)alkyl]aminothiocarbonyl or di[(C₁-C₁₀)alkyl]aminothiocarbonyl, where each of the 14 last-mentioned radicals is unsubstituted or substituted, preferably unsubstituted or substituted by one or more radicals selected from the group consisting of halogen, (C₁-C₄)alkoxy, (C₁-C₄)haloalkoxy, (C₁-C₄)hydroxyalkoxy and (C₁-C₄)alkoxy-(C₁-C₄)alkoxy,

or (C₃-C₆)cycloalkyl, (C₅-C₆)cycloalkenyl, (C₃-C₆)cycloalkoxy, (C₅-C₆)cycloalkenyloxy, phenyl, phenoxy, phenylamino, phenylsulfonyl, phenylcarbonyl, naphthylcarbonyl, phenylthiocarbonyl, naphthylthiocarbonyl, heterocyclyl, heterocyclyloxy, heterocyclylamino, heterocyclylcarbonyl, heterocyclylsulfonyl, where each of the 13 last-mentioned radicals is unsubstituted or substituted, preferably unsubstituted or substituted by one or more radicals selected from the group consisting of halogen, cyano, hydroxyl, (C₁-C₄)alkyl, (C₁-C₄)haloalkyl, (C₁-C₄)hydroxyalkyl, (C₁-C₄)alkoxy, (C₁-C₄)alkyl, (C₁-C₄)alkoxy-(C₁-C₄)haloalkoxy, (C₁-C₄)hydroxyalkoxy and (C₁-C₄)alkoxy-(C₁-C₄)alkoxy and heterocyclyl in the radicals mentioned is in each case heterocyclyl having in each case 3 to 9 ring atoms including 1 to 4 hetero ring atoms selected from the group consisting of N, O and S, or one of the radicals R¹ and R² is as defined above and the other of the radicals

R¹ and R² is a group of the formula NR′R″, where R′ and R″ independently of one another are H or (C₁-C₆)alkyl,

or

R¹ and R² together are (C₁-C₁₀)alkylidene which is unsubstituted or substituted by one or more radicals selected from the group consisting of halogen, cyano, (C₁-C₄)alkoxy, (C₁-C₄)haloalkoxy, (C₁-C₄)monoalkylamino, (C₁-C₄)dialkylamino and (C₁-C₄)alkylthio,

or

NR¹R² together are a heterocyclyl radical which has 3 to 6 ring atoms, is attached at the nitrogen atom and, in addition to the nitrogen atom, optionally contains, as hetero ring atoms, 1 to 3 further hetero ring atoms selected from the group consisting of N. O and S, the heterocycle being unsubstituted or substituted, preferably unsubstituted or substituted by one or more radicals selected from the group consisting of halogen, cyano, hydroxyl, (C₁-C₄)alkyl, (C₁-C₄)haloalkyl, (C₁-C₄)hydroxyalkyl, (C₁-C₄)alkoxy, (C₁-C₄)haloalkoxy, (C₁-C₄)hydroxyalkoxy, (C₁-C₄)alkoxy-(C₁-C₄)alkoxy, (C₁-C₄)alkoxy-(C₁-C₄)alkyl and oxo,

R³ is halogen, CN, NO₂, SCN or a radical of the formula —X¹—A¹, where

X¹ is a direct bond or a divalent group of the formula —O—, —S(O)ₚ—, —S(O)ₚ—O—, —O—S(O)ₚ—, —CO—, —O—CO—, —CO—O—, —S—CO—, —CO—S—, —S—CS—, —CS—S—, —O—CO—O—, —NR^{O}—, —O—NR^{O—, —NR}^{O}—O—, —NR^{O}—CO—, —CO—NR^{O}—, —O—CO—NR^{O}— or —NR^{O}—CO—O—, where in each case p is the integer 0, 1 or 2 and R^{O} is hydrogen, (C₁-C₆)alkyl, (C₂-C₆)alkenyl, (C₂-C₆)alkynyl, phenyl, phenyl-(C₁-C₆)alkyl, (C₃-C₆)cycloalkyl or [(C₁-C₆)alkyl]carbonyl, and

A¹ is hydrogen, (C₁-C₁₀)alkyl, (C₂-C₁₀)alkenyl, (C₂-C₁₀)alkynyl, (C₃-C₆)cycloalkyl, (C₅-C₆)cycloalkenyl, phenyl or heterocyclyl having 3 to 9 ring atoms and 1 to 4 hetero ring atoms selected from the group consisting of N, O and S, where each of the 7 last-mentioned radicals is unsubstituted or substituted, preferably unsubstituted or substituted by one or more radicals selected from the group consisting of halogen, cyano, hydroxyl, (C₃-C₆)cycloalkyl, (C₁-C₄)alkoxy, (C₁-C₄)haloalkoxy and (C₁-C₄)hydroxyalkoxy and, in the case of cyclic radicals, also (C₁-C₄)alkyl, (C₁-C₄)haloalkyl, (C₁-C₄)alkoxy-(C₁-C₄)alkyl and (C₁-C₄)hydroxyalkyl and including substituents preferably has up to 20 carbon atoms,

R⁴, R⁵, R⁶, R⁷ and R⁸ in each case independently of one another are halogen, nitro, cyano, thiocyanato or a radical of the formula _X²—A², where

X² is a direct bond or a divalent group of the formula —O—, —S(O)_{q}—, —S(O)_{q}—O—, —O—S(O)_{q}—, —S(O)_{q}—NR^{r}—, —NR^{r}—S(O)_{q}—, —CO—, O—CO—, —CO—O—, —S—CO—, —CO—S—, —S—CS—, —CS—S—, —O—CO—O—, —NR^{r}—, —O—NR—, —NR^{r}—O—, —NR^{r}—CO—, —CO—NR^{r}—, —O—CO—NR^{r}— or —NR^{r}—CO—O— where in each case q is the integer 0, 1 or 2 and R^{r} is hydrogen, amino, substituted amino, (C₁-C₆)alkyl, (C₂-C₆)alkenyl, (C₂-C₆)alkynyl, phenyl, phenyl-(C₁-C₆)alkyl, phenylcarbonyl, (C₃-C₆)cycloalkyl, (C₅-C₆)cycloalkenyl, [(C₁-C₆)alkyl]carbonyl, (C₁-C₆)alkylsulfonyl or (C₁-C₆)alkylsulfinyl, phenylsulfonyl or phenylsulfinyl, where each of the 13 last-mentioned radicals is unsubstituted or substituted, preferably unsubstituted or substituted by one or more radicals selected from the group consisting of halogen, cyano, hydroxyl, (C₁-C₄)alkoxy, (C₁-C₄)haloalkoxy and (C₁-C₄)hydroxyalkoxy and, in the case of cyclic radicals, also (C₁-C₄)alkyl, (C₁-C₄)haloalkyl, (C₁-C₄)alkoxy-(C₁-C₄)alkyl and (C₁-C₄)hydroxyalkyl, and

A² is hydrogen, (C₁-C₁₀)alkyl, (C₂-C₁₀)alkenyl, (C₂-C₁₀)alkynyl, (C₃-C₆)cycloalkyl, (C₅-C₆)cycloalkenyl, phenyl or heterocyclyl, where each of the 7 last-mentioned radicals is unsubstituted or substituted, preferably unsubstituted or substituted by one or more radicals selected from the group consisting of halogen, cyano, hydroxyl, amino, aminocarbonyl, mono- and di-(C₁-C₆)alkylamino, mono- and diarylamino, N—(C₁-C₆)alkyl-N-arylamino, mono- and diacylamino, N—(C₁-C₆)alkyl-N-acylamino, N-aryl-N-acylamino, (C₁-C₆)alkoxy, (C₁-C₆)alkylthio, (C₁-C₆)alkylsulfonyl, (C₁-C₆)sulfinyl, [(C₁-C₅)alkyl]carbonyl, [(C₁-C₅)alkoxy]carbonyl, [(C₁-C₆)alkyl]carbonyloxy, (C₃-C₆)cycloalkyl, (C₃-C₆)cycloalkoxy, (C₃-C₆)cycloalkylcarbonyl, (C₃-C₆)cycloalkylcarbonyloxy, phenyl, phenoxy, phenylthio, phenylcarbonyl, phenylcarbonyloxy, heterocycyl, heterocycyloxy, heterocyclylthio, heterocyclylthiocarbonyl, heterocyclylcarbonyloxy and, in the case of cyclic radicals, also (C₁-C₆)alkyl, where each of the 31 last-mentioned radicals is unsubstituted or substituted, preferably unsubstituted or substituted by one or more radicals selected from the group consisting of halogen, cyano, hydroxyl, amino, mono- and di-(C₁-C₆)alkylamino, mono- and diarylamino, N—(C₁-C₆)alkyl-N-arylamino, mono- and di-(C₁-C₆) acylamino, N—(C₁-C₆)alkyl-N-acylamino, (C₁-C₆)alkoxy, (C₁-C₆)alkylthio, (C₃-C₆)cycloalkyl, (C₃-C₆)cycloalkoxy, (C₃-C₆)cycloalkylcarbonyl, (C₃-C₆)cycloalkylcarbonyloxy, phenyl, phenoxy, phenylthio and, in the case of cyclic radicals, also (C₁-C₆)alkyl, (C₁-C₆)haloalkyl and (C₁-C₄)alkoxy-(C₁-C₆)alkyl and where heterocyclyl in A² contains in each case 3 to 9 ring atoms and 1 to 4 hetero ring atoms selected from the group consisting of N, O and S,

and A² including substituents preferably has up to 20 carbon atoms

or

two adjacent radicals from the group consisting of R⁴, R⁵, R⁶, R⁷ and R⁸ together with the phenyl ring carbon atoms to which they are attached form a fused ring having 4 to 6 ring atoms which is carbocyclic or contains 1 to 3 hetero ring atoms selected from the group consisting of N, O and S and which is unsubstituted or substituted by one or more radicals selected from the group consisting of halogen, (C₁-C₆)alkyl, (C₁-C₆)haloalkyl, (C₂-C₆)alkenyl, (C₂-C₆)alkynyl, (C₁-C₆)alkoxy, (C₁-C₆)haloalkoxy, [(C₁-C₆)alkyl]carbonyl, [(C₁-C₆)alkoxy]carbonyl, (C₁-C₆)alkylsulfonyl and (C₁-C₆)alkylsulfinyl, and

R⁹ is H or formyl, (C₁-C₁₀)alkyl, (C₂-C₁₀)alkenyl, (C₂-C₁₀)alkynyl, (C₁-C₁₀)alkylsulfinyl, (C₁-C₁₀)alkylsulfonyl, (C₁-C₁₀)alkoxy, [(C₁-C₁₀)alkyl]carbonyl, [(C₁-C₁₀)alkoxy]carbonyl, where each of the 8 last-mentioned radicals is unsubstituted or substituted, preferably unsubstituted or substituted by one or more radicals selected from the group consisting of halogen (C₁-C₄)alkoxy, (C₁-C₄)haloalkoxy and (C₁-C₄)hydroxyalkoxy, or

(C₃-C₆)cycloalkyl, (C₅-C₆)cycloalkenyl, (C₃-C₆)cycloalkoxy, (C₅-C₆)cycloalkenyloxy, phenyl, phenoxy, phenylamino, phenylcarbonyl, phenylsulfonyl, heterocyclyl, heterocyclyloxy, heterocyclylamino, heterocyclylcarbonyl or heterocyclylsulfonyl, where each of the 14 last-mentioned radicals is unsubstituted or substituted, and heterocyclyl in the 5 last-mentioned radicals contains preferably in each case 3 to 9 ring atoms including 1 to 4 hetero ring atoms selected from the group consisting of N, O and S,

where preferably each of the 14 radicals mentioned is unsubstituted or substituted by one or more radicals selected from the group consisting of halogen, cyano, hydroxyl, (C₁-C₄)alkyl, (C₁-C₄)haloalkyl, (C₁-C₄)hydroxyalkyl, (C₁-C₄)alkoxy, (C₁-C₄)haloalkoxy and (C₁-C₄)hydroxyalkoxy, or a group of the formula NR^{a}R^{b},

where R^{a} and R^{b} independently of one another are H, formyl, (C₁-C₆)alkyl, (C₂-C₆)alkenyl, (C₂-C₆)alkynyl, (C₁-C₆)alkylsulfinyl, (C₁-C₆)alkylsulfonyl, (C₁-C₆)alkoxy, (C₁-C₆)alkylcarbonyl or [(C₁-C₆)alkoxy]carbonyl, where each of the 8 last-mentioned groups is unsubstituted or substituted, preferably unsubstituted or substituted by one or more radicals selected from the group consisting of halogen, hydroxyl, (C₁-C₄)alkoxy, (C₁-C₄)haloalkoxy, (C₁-C₄)hydroxyalkoxy and (C₁-C₄)alkoxy-(C₁-C₄)alkoxy, or

R^{a} and R^{b} together are straight-chain (C₂-C₅)alkylene which is unsubstituted or substituted by one or more radicals selected from the group consisting of (C₁-C₄)alkyl, (C₁-C₄)alkoxy, (C₁-C₄)alkoxy-(C₁-C₄)alkyl and oxo,

where

at least two radicals, preferably 2 to 3 radicals, from the group consisting of R⁴, R⁵, R⁶, R⁷ and R⁸ are different from hydrogen,

and

component (B) is one or more herbicides selected from the group of compounds consisting of

| | |
|---|---|
| (B1) | foliar- and/or soil-acting herbicides which are active against |
| | monocotyledonous harmful plants, |
| (B2) | herbicides which are active against predominantly dicotyledonous |
| | harmful plants, |
| (B3) | herbicides which are active against monocotyledonous and |
| | dicotyledonous harmful plants and |
| (B4) | herbicides which are active against monocotyledonous and |
| | dicotyledonous harmful plants and which can be employed speci- |
| | fically in tolerant crops or on non-crop land. |

The synergistic effects are observed when the active compounds (A) and (B) are applied jointly; however, they can also frequently be observed when the active compounds are applied at different times (splitting). It is also possible to apply the herbicides or the herbicide combinations in a plurality of portions (sequential application), for example after pre-emergence applications, followed by post-emergence applications or after early post-emergence applications, followed by medium or late post-emergence applications. Preference is given here to the joint or almost simultaneous application of the active compounds of the combination in question.

The synergistic effects permit a reduction of the application rates of the individual active compounds, a higher level of activity at the same application rate, the control of harmful plants which were as yet uncontrolled (gaps), an extension of the period of application and/or a reduction in the number of individual applications required and—as a result for the user—weed control systems which are more advantageous economically and ecologically.

The combinations according to the invention of (A)+(B) permit, for example, synergistic increases in activity which, in an unexpected manner, exceed the activities which are achieved with the individual active compounds (A) and (B).

The formula (I) mentioned embraces all stereoisomers and mixtures thereof, in particular also racemic mixtures and—if enantiomers are possible—in each case the biologically active enantiomer or the biologically active enantiomers.

The compounds of the formula (I) can form salts by addition of a suitable inorganic or organic acid, such as, for example, HCl, HBr, H₂SO₄ or HNO₃, but also oxalic acid or sulfonic acids, to a basic group, such as, for example, amino or alkylamino. Suitable substituents which are present in deprotonated form, such as, for example, sulfonic acids or carboxylic acids, can form inner salts with groups which for their part can be protonated, such as amino groups. Salts can also be formed by replacing the hydrogen of suitable substituents, such as, for example, sulfonic acids or carboxylic acids, by an agriculturally suitable cation. These salts are, for example, metal salts, in particular alkali metal salts or alkaline earth metal salts, in particular sodium salts and potassium salts, or else ammonium salts or salts with organic amines.

In the formula (I) and all the formulae hereinbelow, the radicals alkyl, alkoxy, haloalkyl, haloalkoxy, alkylamino and alkylthio and the corresponding unsaturated and/or substituted radicals can in each case be straight-chain or branched in the carbon skeleton. Unless specifically mentioned otherwise, the lower carbon skeletons, for example with 1 to 6 carbon atoms or, in the case of unsaturated groups, with 2 to 6 carbon atoms are preferred for these radicals. Alkyl radicals, also in the composed meanings, such as alkoxy, haloalkyl, and the like, are, for example, methyl, ethyl, n- or isopropyl, n-, i-, t- or 2-butyl, pentyls, hexyls, such as n-hexyl, isohexyl and 1,3-dimethylbutyl, heptyls, such as n-heptyl, 1-methylhexyl and 1,4-dimethylpentyl; alkenyl and alkynyl radicals have the meaning of the possible unsaturated radicals which correspond to the alkyl radicals; alkenyl is, for example, allyl, 1-methylprop-2-en-1-yl, 2-methylprop-2-en-1-yl, but-2-en-1-yl, but-3-en-1-yl, 1-methyl-but-3-en-1-yl and 1-methyl-but-2-en-1-yl; alkenyl also includes in particular straight-chain or branched hydrocarbon radicals having more than one double bond, such as 1,3-butadienyl and 1,4-pentadienyl, and also allenyl or cumulenyl radicals having one or more cumulated double bonds, such as, for example, allenyl (1,2-propadienyl), 1,2-butadienyl and 1,2,3-pentatrienyl; alkynyl is, for example, propargyl, but-2-yn-1-yl, but-3-yn-1-yl, 1-methylbut-3-yn-1-yl. Alkynyl also includes in particular straight-chain or branched hydrocarbon radicals having more than one triple bond or else having one or more triple bonds and one or more double bonds, such as, for example, 1,3-butatrienyl or 3-penten-1-yn-1-yl.

Alkylidene, for example in the form (C₁-C₁₀)alkylidene, is the radical of a straight-chain or branched alkane which is attached via a double bond, the position of the binding site not yet being fixed. In the case of a branched alkane, the only possible positions are, of course, those where two hydrogen atoms can be replaced by the double bond; examples of radicals are ═CH₂, ═CH—CH₃, ═C(CH₃)—CH₃, ═C(CH₃)—C₂H₅ or ═C(C₂H₅)—C₂H₅.

Cycloalkyl is a carbocyclic saturated ring system having preferably 3-8 carbon atoms, for example cyclopropyl, cyclobutyl, cyclopentyl or cyclohexyl. In the case of substituted cycloalkyl, this includes cyclic systems with substituents, including substituents attached to the cycloalkyl radical via a double bond, for example an alkylidene group such as methylidene. Substituted cycloalkyl also includes polycyclic aliphatic systems, such as, for example, bicyclo[1.1.0]butan-1-yl, bicyclo[1.1.0]butan-2-yl, bicyclo[2.1.0]pentan-1-yl, bicyclo[2.1.0]pentan-2-yl, bicyclo[2.1.0]pentan-5-yl, adamantan-1-yl and adamantan-2-yl.

Cycloalkenyl is a carbocyclic nonaromatic, partially unsaturated ring system having preferably 4-8 carbon atoms, for example 1-cyclobutenyl, 2-cyclobutenyl, 1-cyclopentenyl, 2-cyclopentenyl, 3-cyclopentenyl, or 1-cyclohexenyl; 2-cyclohexenyl, 3-cyclohexenyl, 1,3-cyclohexadienyl or 1,4-cyclohexadienyl. For substituted cycloalkenyl, the illustrations for substituted cycloalkyl apply correspondingly.

Halogen is, for example, fluorine, chlorine, bromine or iodine. Haloalkyl, -alkenyl and -alkynyl are alkyl, alkenyl and alkynyl, respectively, which are partially or fully substituted by halogen, preferably by fluorine, chlorine and/or bromine, in particular by fluorine or chlorine, for example, monohaloalkyl, perhaloalkyl, CF₃, CHF₂, CH₂F, CF₃CF₂, CH₂FCHCl, CCl₃, CHCl₂, CH₂CH₂Cl; haloalkoxy is, for example, OCF₃, OCHF₂, OCH₂F, CF₃CF₂O, OCH₂CF₃ and OCH₂CH₂Cl; this applies correspondingly to haloalkenyl and other halogen-substituted radicals.

Aryl is a mono-, bi- or polycyclic aromatic system, for example phenyl, naphthyl, tetrahydronaphthyl, indenyl, indanyl, pentalenyl, fluorenyl and the like, preferably phenyl.

A heterocyclic radical or ring (heterocyclyl) can be saturated, unsaturated or heteroaromatic; unless defined otherwise, it preferably contains one or more, in particular 1, 2 or 3, heteroatoms in the heterocyclic ring, preferably selected from the group consisting of N, O and S; it is preferably an aliphatic heterocyclyl radical having 3 to 7 ring atoms or a heteroaromatic radical having 5 or 6 ring atoms. The heterocyclic radical can, for example, be a heteroaromatic radical or ring (heteroaryl), such as, for example, a mono-, bi- or polycyclic aromatic system, in which at least 1 ring contains one or more heteroatoms. It is preferably a heteroaromatic ring having one heteroatom selected from the group consisting of N, O and S, for example pyridyl, pyrrolyl, thienyl or furyl; furthermore, preferably, it is a corresponding heteroaromatic ring having 2 or 3 heteroatoms, for example pyrimidinyl, pyridazinyl, pyrazinyl, triazinyl, thiazolyl, thiadiazolyl, oxazolyl, isoxazolyl, pyrazolyl, imidazolyl and triazolyl. Furthermore preferably, it is a partially or fully hydrogenated heterocyclic radical having one heteroatom selected from the group consisting of N, O and S, for example oxiranyl, oxetanyl, oxolanyl (=tetrahydrofuryl), oxanyl, pyrrolidyl or piperidyl.

Furthermore preferably, it is a partially or fully hydrogenated heterocyclic radical having 2 heteroatoms selected from the group consisting of N, O and S, for example piperazinyl, dioxolanyl, oxazolinyl, isoxazolinyl, oxazolidinyl, isoxazolidinyl and morpholinyl.

Possible substituents for a substituted heterocyclic radical are the substituents mentioned further below, and additionally also oxo. The oxo group can also be present at the hetero ring atoms which can exist in different oxidation states, for example at N and S.

Substituted radicals, such as a substituted alkyl, alkenyl, alkynyl, aryl, phenyl, benzyl, heterocyclyl and heteroaryl radical, are, for example, a substituted radical derived from the unsubstituted skeleton, where the substituents are, for example, one or more, preferably 1, 2 or 3, radicals selected from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkylsulfonyl, haloalkylsulfonyl and, in the case of cyclic radicals, also alkyl, haloalkyl, alkylthioalkyl, alkoxyalkyl, optionally substituted mono- and dialkylaminoalkyl and hydroxyalkyl; the term “substituted radicals”, such as substituted alkyl and the like, includes as substituents, in addition to the saturated hydrocarbon-containing radicals mentioned, the corresponding unsaturated aliphatic and aromatic radicals, such as unsubstituted or substituted alkenyl, alkynyl; alkenyloxy, alkynyloxy, phenyl, phenoxy etc. Substituted cyclic radicals having aliphatic moieties in the ring include cyclic systems having substituents which are attached to the ring via a double bond, for example those substituted by an alkylidene group, such as methylidene or ethylidene.

Among the radicals with carbon atoms, preference is given to those having 1 to 4 carbon atoms, in particular 1 or 2 carbon atoms. In general, preference is given to substituents selected from the group consisting of halogen, for example fluorine and chlorine, (C₁-C₄)alkyl, preferably methyl or ethyl, (C₁-C₄)haloalkyl, preferably trifluoromethyl, (C₁-C₄)alkoxy, preferably methoxy or ethoxy, (C₁-C₄)haloalkoxy, nitro and cyano. Particular preference is given here to the substituents methyl, methoxy, fluorine and chlorine.

Substituted amino, such as mono- or disubstituted amino, is a radical from the group of the substituted amino radicals which are N-substituted, for example, by one or two identical or different radicals selected from the group consisting of alkyl, alkoxy, acyl and aryl; preferably mono- and dialkylamino, mono- and diarylamino, acylamino, N-alkyl-N-arylamino, N-alkyl-N-acylamino and N-heterocycles; preference is given to alkyl radicals having 1 to 4 carbon atoms; aryl is preferably phenyl or substituted phenyl; for acyl, the definition mentioned further below applies, preferably (C₁-C₄)alkanoyl. This applies correspondingly to substituted hydroxylamino or hydrazino.

Unsubstituted or substituted phenyl is preferably phenyl which is unsubstituted or mono- or polysubstituted, preferably up to trisubstituted, by identical or different radicals selected from the group consisting of halogen, (C₁-C₄)alkyl, (C₁-C₄)alkoxy, (C₁-C₄)haloalkyl, (C₁-C₄)haloalkoxy and nitro, for example o-, m- and p-tolyl, dimethylphenyls, 2-, 3- and 4-chlorophenyl, 2-, 3- and 4-trifluoro- and -trichlorophenyl, 2,4-, 3,5-, 2,5- and 2,3-dichlorophenyl, o-, m- and p-methoxyphenyl.

Acyl is a radical of an organic acid which is formally formed by removing a hydroxyl group from the acid function, where the organic radical in the acid can also be attached to the acid function via a heteroatom. Examples of acyl are the radical —CO—R of a carboxylic acid HO—CO—R and radicals of acids derived therefrom, such as thiocarboxylic acid, unsubstituted or N-substituted iminocarboxylic acids or the radical of carbonic monoesters, N-substituted carbamic acid, sulfonic acids, sulfinic acids, N-substituted sulfonamide acids, phosphonic acids, phosphinic acids. Acyl is, for example, formyl, alkylcarbonyl, such as [(C₁-C₄)alkyl]carbonyl, phenylcarbonyl, alkyloxycarbonyl, phenyloxycarbonyl, benzyloxycarbonyl, alkylsulfonyl, alkylsulfinyl, N-alkyl-1-iminoalkyl and other radicals of organic acids. The radicals can in each case be further substituted in the alkyl or phenyl moiety, for example in the alkyl moiety by one or more radicals selected from the group consisting of halogen, alkoxy, phenyl and phenoxy; examples of substituents in the phenyl moiety are the substituents which have already been mentioned further above generally for substituted phenyl.

Acyl is preferably an acyl radical in the more restricted sense, i.e. a radical of an organic acid where the acid group is directly attached to the carbon atom of an organic radical, for example formyl, alkylcarbonyl, such as acetyl or [(C₁-C₄)alkyl]carbonyl, phenylcarbonyl, alkylsulfonyl, alkylsulfinyl and other radicals of organic acids.

In particular for reasons of better herbicidal activity, increased synergistic effects, of better selectivity and/or better stability in coformulations, those herbicide combinations according to the invention are of particular interest in which the components (A) and/or (B) mentioned below are used. Particular preference is given to those in which one of the components (A) and (B) is one of the preferred components mentioned, or in particular to those in which preferred components (A) and (B) are combined.

Of particular interest are herbicide combinations with one or more amino triazines of the formula (I) or salts thereof as component (A) in which

Z is (C₁-C₆)alkyl which is unsubstituted or substituted by one or more radicals selected from the group consisting of halogen, cyano, formyl, (C₁-C₄)alkoxy, mono(C₁-C₄)alkylamino, di(C₁-C₄)alkylamino, (C₁-C₄)haloalkoxy, (C₁-C₄)alkylsulfonyl, (C₁-C₄)haloalkylsulfonyl, [(C₁-C₄)alkyl]carbonyl, [(C₁-C₄)alkoxy]carbonyl, (C₃-C₆)cycloalkyl, (C₅-C₆)cycloalkenyl and phenyl, where each of the 3 last-mentioned radicals is unsubstituted or substituted by one or more radicals selected from the group consisting of halogen, cyano, (C₁-C₄)alkyl, (C₁-C₄)haloalkyl, (C₁-C₄)alkoxy, (C₁-C₄)haloalkoxy and (C₁-C₄)alkylthio, or

(C₃-C₆)cycloalkyl which is unsubstituted or substituted by one or more radicals selected from the group consisting of halogen, cyano, (C₁-C₄)alkyl, (C₁-C₄)haloalkyl, (C₁-C₄)alkoxy, (C₁-C₄)haloalkoxy and (C₁-C₄)alkylthio,

Z is preferably (C₁-C₆)alkyl which is unsubstituted or substituted by one or more radicals selected from the group consisting of halogen, (C₃-C₆)cycloalkyl and phenyl, where each of the two last-mentioned radicals is unsubstituted or substituted by one or more radicals selected from the group consisting of halogen, (C₁-C₄)alkyl, (C₁-C₄)haloalkyl, (C₁-C₄)alkoxy, (C₁-C₄)haloalkoxy and (C₁-C₄)alkylthio, or (C₃-C₆)cycloalkyl which is unsubstituted or substituted by one or more radicals selected from the group consisting of halogen, (C₁-C₄)alkyl, (C₁-C₄)haloalkyl, (C₁-C₄)alkoxy, (C₁-C₄)haloalkoxy and (C₁-C₄)alkylthio.

Z is in particular (C₁-C₄)alkyl, such as, for example, methyl, ethyl, n-propyl and isopropyl, or (C₁-C₄)haloalkyl, such as, for example, 1-fluoroisopropyl, 1-fluoroethyl, 1-fluoropropyl, CF₃ and CCl₃, or cyclopropyl, cyclobutyl, cyclopentyl, cyclohexyl, 1-methylcyclopropyl, 1-methylcyclobutyl, 1-methylcyclopentyl, 1-methylcyclohexyl or benzyl.

Of particular interest are herbicide combinations with one or more aminotriazines of the formula (I) or salts thereof as component (A) in which

R¹ is hydrogen or (C₁-C₄)alkyl, in particular H, and

R² is hydrogen, formyl, aminocarbonyl, aminothiocarbonyl, (C₁-C₄)alkyl, (C₁-C₄)alkylsulfonyl, [(C₁-C₄)alkyl]carbonyl, [(C₁-C₄)alkoxy]carbonyl, where each of the 4 last-mentioned radicals is unsubstituted or substituted by one or more radicals selected from the group consisting of halogen, and (C₁-C₄)alkoxy, or (C₃-C₆)cycloalkyl which is unsubstituted or substituted by one or more radicals selected from the group consisting of halogen, (C₁-C₄)alkyl and (C₁-C₄)haloalkyl, or

R¹ and R² together are (C₁-C₆)alkylidene which is unsubstituted or substituted by one or more radicals selected from the group consisting of halogen and cyano, in particular hydrogen.

Of particular interest are herbicide combinations with one or more amino triazines of the formula (I) or salts thereof as component (A) in which

R³ is halogen, CN, NO₂, SCN or a radical of the formula —X¹—A¹, where

X¹ is a direct bond or a divalent group of the formula —O—, —S(O)ₚ—, —S(O)ₚ-O—, —O—S(O)ₚ—, —CO—, —O—CO—, —CO—O—, —S—CO—, —CO—S—, —S—CS—, —CS—S—, —O—CO—O—, —NR^{O}—, —O—NR^{O}—, —NR^{O}—O—, —NR^{O}—CO—, —CO—NR^{O}—, —O—CO—NR^{O}— or —NR^{O}—CO—O—, preferably —O—, —S(O)ₚ—, —CO—, —O—CO—, —CO—O—, —S—CO—, —CO—S—, —NR^{O}—O—NR^{O}—, —NR^{O}—O—, —NR^{O}—CO—, —CO—NR^{O}—, —O—CO—NR^{O}— or —NR^{O}—CO—O— where in each case p is the integer 0, 1 or 2 and R^{O} s hydrogen, (C₁-C₄)alkyl, (C₂-C₄)alkenyl, (C₂-C₄)alkynyl, phenyl, phenyl-(C₁-C₂)alkyl, (C₃-C₆)cycloalkyl or [(C₁-C₄)alkyl]carbonyl, and

A¹ is hydrogen, (C₁-C₆)alkyl, (C₂-C₆)alkenyl, (C₂-C₆)alkynyl, (C₃-C₆)cycloalkyl, phenyl or heterocyclyl having 3 to 9 ring atoms and 1 to 3 hetero ring atoms selected from the group consisting of N, O and S, where each of the 6 last-mentioned radicals is unsubstituted or substituted, preferably unsubstituted or substituted by one or more radicals selected from the group consisting of halogen, cyano, (C₁-C₄)alkyl, (C₃-C₆)cycloalkyl, (C₁-C₄)alkoxy, (C₁-C₄)haloalkoxy, (C₁-C₄)alkylthio and, in the case of cyclic radicals, also (C₁-C₄)haloalkyl and (C₁-C₄)alkoxy-(CO—C₄)alkyl and including substituents preferably has up to 16 carbon atoms.

Preferably, R³═H, (C₁-C₄)alkyl, preferably methyl or ethyl, or cyclopropyl, cyclobutyl, cyclopentyl, cyclohexyl or phenyl, where each of the 8 last-mentioned radicals is unsubstituted or substituted by one or more radicals selected from the group consisting of halogen and (C₁-C₂)alkoxy and, in the case of cyclic radicals, also (C₁-C₂)alkyl, (C₁-C₂)haloalkyl and (C₁-C₄)alkoxy-(C₁-C₄)alkyl.

Of particular interest are herbicide combinations with one or more amino triazines of the formula (I) or salts thereof as component (A) in which

each of the radicals R⁴, R⁵, R⁶, R⁷ and R⁸ independently of one another is halogen, nitro, cyano, thiocyanato or a radical of the formula —X²—A², where

X² is a direct bond or a divalent group of the formula —O—, —S(O)_{q}—, —S(O)_{q}—O—, —O—S(O)_{q}, S(O)_{q}NR^{r}—, —NR^{r}—S(O)_{q}—, —CO—, —O—CO—, —CO—O—, —S—CO—, —CO—S—, S—CS—, —CS—S—, —O—CO—O—, —NR^{r}—, —O—NR^{r}—, —NR^{r}O—, —NR^{r}—CO—, —CO—NR^{r}—, —O—CO—NR^{r}— or —NR^{r}—CO—O—, preferably —O—, —S(O)_{q}—, —S(O)_{q}—O—, —S(O)_{q}—NR^{r}—, —NR^{r}—S(O)_{q}—, —CO—, —O—CO—, —CO—O—, —S—CO—, —CO—S—, —NR^{r}—, O—NR^{r}—, —NR^{r}—O—, —NR^{r}—CO—, —CO—NR^{r}—, —O—CO—NR^{r}— or —NR^{r}—CO—O—, where in each case q is the integer 0, 1 or 2 and R^{r} is in each case, independently of the others, hydrogen, amino, mono- or di-(C₁-C₄)alkylamino, mono- or di-(C₁-C₄)arylamino, N—(C₁-C₄)alkyl-N-arylamino, (C₁-C₄)alkyl, (C₂-C₄)alkenyl, (C₂-C₄)alkynyl, phenyl, phenyl(C₁-C₄)alkyl, phenylcarbonyl, (C₃-C₆)cycloalkyl, (C₅-C₆)cycloalkenyl, [(C₁-C₄)alkyl]carbonyl (C₁-C₄)alkylsulfonyl, (C₁-C₄)alkylsulfinyl, phenylsulfonyl or phenylsulfinyl, where each of the 18 last-mentioned radicals is unsubstituted or substituted, preferably unsubstituted or substituted by one or more radicals selected from the group consisting of halogen, cyano, (C₁-C₄)alkyl, (C₁-C₄)alkoxy, (C₁-C₄)haloalkoxy and, in the case of cyclic radicals, also (C₁-C₄)haloalkyl and (C₁-C₄)alkoxy-(C₁-C₄)alkyl, and

A² is hydrogen, (C₁-C₆)alkyl, (C₂-C₆)alkenyl, (C₂-C₆)alkynyl, (C₃-C₆)cycloalkyl, (C₅-C₆)cycloalkenyl, phenyl or heterocyclyl having 3 to 6 ring atoms and 1 to 3 hetero ring atoms selected from the group consisting of N, O and S, where each of the 7 last-mentioned radicals is unsubstituted or substituted, preferably unsubstituted or substituted by one or more radicals selected from the group consisting of halogen, cyano, hydroxyl, amino or else mercapto or aminocarbonyl, mono- and di-(C₁-C₄)alkylamino, mono- and diphenylamino, N—(C₁-C₄)alkyl-N-phenylamino, mono- and di-[(C₁-C₄)alkanoyl]amino, mono- and di-[(C₁-C₄)alkylsulfonyl]amino, N—(C₁-C₄)alkyl-N-[(C₁-C₄)alkanoyl]amino, (C₁-C₄)alkyl-N-[(C₁-C₄)alkylsulfonyl]amino, N-phenyl-N-((C₁-C₄)alkanoyl]amino, N-phenyl-N-[(C₁-C₄)alkylsulfonyl]amino, (C₁-C₄)alkoxy, (C₁-C₄)alkylthio, (C₁-C₄)alkylsulfonyl, (C₁-C₄)alkylsulfinyl, [(C₁-C₄)alkyl]-carbonyl, [(C₁-C₄)alkoxy]carbonyl, [(C₁-C₄)alkyl]carbonyloxy, (C₃-C₆)cycloalkyl, (C₃-C₆)cycloalkoxy, (C₃-C₆)cycloalkylcarbonyl, (C₃-C₆)cycloalkylcarbonyloxy, phenyl, phenoxy, phenylthio, phenylcarbonyl, phenylcarbonyloxy, heterocyclyl, heterocyclyloxy, heterocyclylthio, heterocyclylcarbonyl, heterocyclylcarbonyloxy and, in the case of cyclic radicals, also (C₁-C₆)alkyl,

where each of the 35 last-mentioned radicals is unsubstituted or substituted, preferably unsubstituted or substituted by one or more radicals selected from the group consisting of halogen, cyano, hydroxyl, amino, mono- and di-(C₁-C₄)alkylamino, mono- and diphenylamino, N—(C₁-C₄)alkyl-N-phenyl-amino, (C₁-C₄)alkoxy, (C₁-C₄)alkylthio, (C₃-C₆)cycloalkyl, (C₃-C₆)cycloalkoxy, phenyl, phenoxy and phenylthio and, in the case of cyclic radicals, also (C₁-C₄)alkyl, (C₁-C₄)haloalkyl and (C₁-C₄)alkoxy-(C₁-C₄)alkyl, and A² including substituents preferably has up to 16 carbon atoms,

or

two adjacent radicals from the group consisting of R⁴, R⁵, R⁶, R⁷ and R⁸ together with the phenyl ring carbon atoms to which they are attached form a fused ring having 4 to 6 ring atoms which is carbocyclic or which contains from 1 to 3 hetero ring atoms selected from the group consisting of N, O and S and which is unsubstituted or substituted by one or more radicals selected from the group consisting of halogen, (C₁-C₄)alkyl, (C₂-C₄)alkenyl, (C₂-C₄)alkynyl, [(C₁-C₄)alkyl]carbonyl, (C₁-C₆)alkoxy, [(C₁-C₄)alkoxy]carbonyl, (C₁-C₄)alkylsulfonyl and (C₁-C₄)alkylsulfinyl,

where at least two radicals, preferably 2 to 3 radicals, in particular 2 radicals, of the group consisting of R⁴, R⁵, R⁶, R⁷ and R⁸ are different from hydrogen.

Preferably, each of the radicals R⁴, R⁵, R⁶, R⁷ and R⁸ independently of one another is hydrogen, halogen, hydroxyl, amino, nitro, formyl, aminocarbonyl, carboxyl, cyano, thiocyanato or else aminosulfonyl or (C₁-C₆)alkyl, (C₁-C₆)alkoxy, (C₁-C₆)alkylthio, (C₁-C₄)alkylsulfonyl, (C₁-C₄)alkylsulfinyl, (C₂-C₆)alkenyl, (C₂-C₆)alkynyl, (C₁-C₆)alkylcarbonyl, (C₁-C₆)alkoxycarbonyl, (C₁-C₆)alkylcarbonyloxy, mono- or di-[(C₁-C₄)alkyl]amino, mono- and diphenylamino, N—(C₁-C₄)alkyl-N-phenylamino or also mono or di-[(C₁-C₄)alkylamino-sulfonyl, mono- or di-[(C₁-C₆)alkanoyl]amino, N-[(C₁-C₆)alkanoyl]-N-[(C₁-C₄)alkyl]amino, N-phenyl-N-[(C₁-C₄)alkanoyl]amino, mono- or di-[(C₁-C₆)alkylsulfonyl]amino, N-[(C₁-C₆)alkylsulfonyl]-N-[(C₁-C₄)alkyl]amino, N-phenyl-N-[(C₁-C₄)alkylsulfonyl]amino,

where each of the 24 last-mentioned radicals is substituted by one or more radicals selected from the group consisting of halogen, nitro, amino, mono- and di-[(C₁-C₄)alkyl]amino, mono- and diphenylamino, N—(C₁-C₄)alkyl-N-phenylamino, hydroxyl, cyano, (C₁-C₄)alkoxy or mercapto or (C₁-C₄)alkylthio, (C₁-C₄)haloalkoxy, (C₁-C₄)alkylcarbonyl, (C₁-C₄)alkoxycarbonyl, (C₃-C₆)-cycloalkyl. (C₃-C₆)cycloalkylcarbonyl, (C₃-C₆)cycloalkylcarbonyloxy, phenyl, phenoxy, phenylthio, phenylcarbonyl, phenoxycarbonyl, phenylcarbonyloxy, phenylsulfonyl, where the 7 last-mentioned radicals are unsubstituted or optionally substituted in the phenyl radical, or

(C₃-C₆)cycloalkyl, (C₃-C₆)cycloalkoxy, (C₃-C₆)cycloalkylcarbonyl, phenyl, phenoxy, phenylthio, phenylcarbonyl, phenoxycarbonyl, phenylcarbonyloxy or phenylsulfonyl, heterocyclyl, heterocyclyloxy, heterocyclylthio, heterocyclylcarbonyl, heterocyclylcarbonyloxy, where each of the 14 last-mentioned radicals is unsubstituted or substituted by one or more radicals selected from the group consisting of halogen, nitro, amino, (C₁-C₄)alkyl, mono- and di-[(C₁-C₄)alkyl]amino, mono- and diphenylamino, N—(C₁-C₄)alkyl-N-phenylamino, hydroxyl, cyano, (C₁-C₄)alkoxy, (C₁-C₄)alkylthio, (C₁-C₄)haloalkoxy, (C₁-C₄)alkylcarbonyl, (C₁-C₄)alkoxycarbonyl.

Furthermore, each of the radicals R⁴, R⁵, R⁶, R⁷ and R⁸, independently of one another, is preferably hydrogen, halogen, hydroxyl, amino, nitro, formyl, carboxyl, cyano, (C₁-C₆)alkyl, (C₁-C₄)alkoxy, halo-(C₁-C₄)alkyl, halo-(C₁-C₄)alkoxy, hydroxyl-(C₁-C₄)alkyl, hydroxyl-(C₁-C₄)alkoxy, (C₁-C₄)alkoxy-(C₁-C₄)alkyl, halo-(C₁-C₄)alkoxy-(C₁-C₄)alkyl, halo-(C₁-C₄)alkoxy-(C₁-C₄)-alkoxy, (C₁-C₄)alkoxy-(C₁-C₄)alkoxy, (C₃-C₆)cycloalkyl, halo-(C₃-C₆)cycloalkyl, (C₂-C₄)alkenyl, halo-(C₂-C₄)alkenyl, (C₂-C₄)alkynyl, halo-(C₂-C₄)alkynyl, (C₁-C₄)alkylcarbonyl, (C₁-C₄)alkoxycarbonyl or else (C₁-C₄)alkylsulfonyl or else (C₁-C₄)alkylsulfinyl or else (C₁-C₄)alkylamino-sulfonyl or else di-[(C₁-C₄)alkyl]aminosulfonyl or (C₁-C₄)alkylcarbonyl-(C₁-C₄)alkyl, (C₁-C₄)alkylcarbonyloxy, (C₁-C₄)alkylthio-(C₁-C₄)alkyl, Mercapto-(C₁-C₄)alkyl, amino-(C₁-C₄)alkyl, (C₁-C₄)alkylamino, (C₁-C₄)alkylamino-(C₁-C₄)alkyl, di-[(C₁-C₄)-alkyl]amino, di-[(C₁-C₄)-alkyl]amino-(C₁-C₄)alkyl, (C₁-C₄)alkanoylamino, (C₁-C₄)alkylsulfonylamino, di[(C₁-C₄)alkanoyl]amino, di-[(C₁-C₄)alkylsulfonyl]amino or

phenyl, phenoxy, phenylcarbonyl, phenoxycarbonyl, phenylcarbonyloxy, phenoxy-(C₁-C₄)alkyl, phenylcarbonyl-(C₁-C₄)alkyl, phenyl-(C₁-C₄)alkyl or one of the 8 last-mentioned radicals which is substituted in the phenyl moiety by one or more radicals selected from the group consisting of halogen, (C₁-C₄)alkyl, (C₁-C₄)alkoxy, (C₁-C₄)haloalkyl and (C₁-C₄)haloalkoxy and also hydroxyl.

Furthermore, each of the radicals R⁴, R⁵, R⁶, R⁷ and R⁸ independently of one another is preferably hydrogen, hydroxyl, amino, nitro, formyl, carboxyl, cyano, fluorine, chlorine, bromine, iodine, methyl, ethyl, n-propyl, isopropyl, n-butyl, isobutyl, tert-butyl, sec-butyl, methoxy, ethoxy, n-propoxy, isopropoxy, CF₃, CHF₂, CH₂F, CCl₃, OCHF₂, OCF₃, OCH₂F, CH₂NH₂, CH₂CH₂NH₂, CH₂OH, CH₂CH₂OH, CH₂SH, CH₂CH₂SH, OCH₂CH₂OH, OCH(CH₃)OH, CH₂OCH₃, CH₂OC₂H₅, CH₂CH₂OCH₃, CH₂CH₂OC₂H₅, OCH₂OCH₃, OCH₂OC₂H₅, OCH₂CH₂OCH₃, OCH₂CH₂OC₂H₅, cyclopropyl, cyclobutyl, cyclopentyl, cyclohexyl, 1-fluorocyclopropyl, vinyl, allyl, 1-propenyl, 1-methyl-1-propenyl, 1-ethyl-1-propenyl, but-1-enyl, but-2-en-1-yl, but-3-en-1-yl, ethynyl, propargyl, prop-1-yn-1-yl, but-1-yn-1-yl, but-2-yn-1-yl, but-3-yn-1-yl, 1-methyl-prop-1-in-1-yl, acetyl, propionyl, propylcarbonyl, methylsulfonyl, ethylsulfonyl, methylsulfinyl, ethylsulfinyl, aminosulfonyl, methylaminosulfonyl, ethylaminosulfonyl, propylaminosulfonyl, isopropylaminosulfonyl, dimethylaminosulfonyl, diethylaminosulfonyl, methoxycarbonyl, ethoxycarbonyl, methoxycarbonyloxy, ethoxycarbonyloxy, methoxycarbonylmethyl, ethoxycarbonylmethyl, methoxycarbonyloxymethyl, ethoxycarbonyloxymethyl, methylthio, ethylthio, propylthio, methylthiomethyl, ethylthiomethyl, methylthioethyl, ethylthioethyl, methylamino, ethylamino, propylamino, isopropylamino, dimethylamino, diethylamino, methylaminomethyl, ethylaminomethyl, dimethylaminomethyl, diethylaminoethyl, formylamino, acetylamino, formylaminomethyl, formylaminoethyl, methylsulfonylamino, ethylsulfonylamino, dimethylsulfonylamino, diethylsulfonylamino, methylsulfonylaminomethyl, ethylsulfonylaminomethyl, dimethylsulfonylaminomethyl, diethylsulfonylaminomethyl, phenyl, phenoxy, phenylcarbonyl, phenoxycarbonyl, phenylcarbonyloxy, phenoxymethyl, phenoxyethyl, phenylcarbonylmethyl, phenylcarbonylethyl, phenylmethyl (benzyl), phenylethyl (phenethyl) or one of the 11 last-mentioned radicals which is substituted in the phenyl moiety by one or more radicals selected from the group consisting of halogen, (C₁-C₄)alkyl, (C₁-C₄)alkoxy, (C₁-C₄)haloalkyl, (C₁-C₄)haloalkoxy and hydroxyl.

R⁹ is preferably H or formyl, (C₁-C₆)alkyl, (C₂-C₆)alkenyl, (C₂-C₆)alkynyl, (C₁-C₆)alkylsulfinyl, (C₁-C₆)alkylsulfonyl, (C₁-C₆)alkoxy, [(C₁-C₆)alkyl]carbonyl, [(C₁-C₆)alkoxy]carbonyl, where each of the 8 last-mentioned radicals is unsubstituted or substituted by one or more radicals selected from the group consisting of halogen, (C₁-C₄)alkoxy, (C₁-C₄)haloalkoxy and (C₁-C₄)hydroxyalkoxy, or

a group of the formula NR^{a}R^{b}, where R^{a} and R^{b} independently of one another are H, or (C₁-C₄)alkyl. R⁹ is in particular hydrogen.

Particularly preferred compounds of the formula (I) are compounds of the formula (Ia) according to the invention and salts thereof,

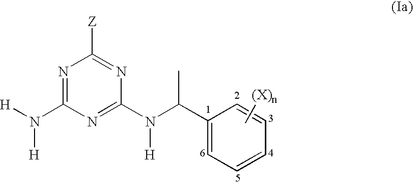

in which

Z is (C₁-C₄)alkyl or (C₁-C₄)haloalkyl,

(X)ₙ are n radicals X, each of which, independently of the others, is in the 2-, 3-, 4- or 5-position, preferably in the 3-, 4- or 5-position, on the phenyl ring and is halogen, preferably fluorine or chlorine, methyl, ethyl, methoxy, ethoxy, or CF₃, and

n is 2 or 3.

Preference is given to the compounds of the formula (Ia) from Table 1 below and salts thereof (note: the numbers at the phenyl ring in the formula (Ia) denote the numbers of the substituent position for the radicals X different from hydrogen):

TABLE 1
Compounds of the formula (Ia)

(Ia)

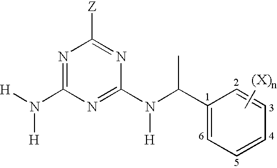

in which

| No. | Z | (X)ₙ |
|---|---|---|
| (A1) | CHFCH₃ | 3-Cl-4-CH₃ |
| (A2) | CF(CH₃)₂ | 3-Cl-4-CH₃ |
| (A3) | CH(CH₃)₂ | 3-Cl-4-CH₃ |
| (A4) | CH₂CH₃ | 3-Cl-4-CH₃ |
| (A5) | CHFCH₂CH₃ | 3-Cl-4-CH₃ |
| (A6) | CHFCH₃ | 3-F-4-CH₃ |
| (A7) | CF(CH₃)₂ | 3-F-4-CH₃ |
| (A8) | CH(CH₃)₂ | 3-F-4-CH₃ |
| (A9) | CH₂CH₃ | 3-F-4-CH₃ |
| (A10) | CHFCH₂CH₃ | 3-F-4-CH₃ |
| (A11) | CHFCH₃ | 3,4-F₂ |
| (A12) | CF(CH₃)₂ | 3,4-F₂ |
| (A13) | CH(CH₃)₂ | 3,4-F₂ |
| (A14) | CH₂CH₃ | 3,4-F₂ |
| (A15) | CHFCH₂CH₃ | 3,4-F₂ |
| (A16) | CHFCH₃ | 3-CH₃-4-F |
| (A17) | CF(CH₃)₂ | 3-CH₃-4-F |
| (A18) | CH(CH₃)₂ | 3-CH₃-4-F |
| (A19) | CH₂CH₃ | 3-CH₃-4-F |
| (A20) | CHFCH₂CH₃ | 3-CH₃-4-F |
| (A21) | CHFCH₃ | 3,4,5-F₃ |
| (A22) | CF(CH₃)₂ | 3,4,5-F₃ |
| (A23) | CH(CH₃)₂ | 3,4,5-F₃ |
| (A24) | CH₂CH₃ | 3,4,5-F₃ |
| (A25) | CHFCH₂CH₃ | 3,4,5-F₃ |
| (A26) | CHFCH₃ | 3-CF₃-4-F |
| (A27) | CF(CH₃)₂ | 3-CF₃-4-F |
| (A28) | CH(CH₃)₂ | 3-CF₃-4-F |
| (A29) | CH₂CH₃ | 3-CF₃-4-F |
| (A30) | CHFCH₂CH₃ | 3-CF₃-4-F |
| (A31) | CHFCH₃ | 3-F-4-OCH₃ |
| (A32) | CF(CH₃)₂ | 3-F-4-OCH₃ |
| (A33) | CH(CH₃)₂ | 3-F-4-OCH₃ |
| (A34) | CH₂CH₃ | 3-F-4-OCH₃ |
| (A35) | CHFCH₂CH₃ | 3-F-4-OCH₃ |
| (A36) | CHFCH₃ | 2,4-F₂ |
| (A37) | CF(CH₃)₂ | 2,4-F₂ |
| (A38) | CH(CH₃)₂ | 2,4-F₂ |
| (A39) | CH₂CH₃ | 2,4-F₂ |
| (A40) | CHFCH₂CH₃ | 2,4-F₂ |
| (A41) | CHFCH₃ | 2,4-Cl₂ |
| (A42) | CF(CH₃)₂ | 2,4-Cl₂ |
| (A43) | CH(CH₃)₂ | 2,4-Cl₂ |
| (A44) | CH₂CH₃ | 2,4-Cl₂ |
| (A45) | CHFCH₂CH₃ | 2,4-Cl₂ |
| (A46) | CHFCH₃ | 3-Cl-4-F |
| (A47) | CF(CH₃)₂ | 3-Cl-4-F |
| (A48) | CH(CH₃)₂ | 3-Cl-4-F |
| (A49) | CH₂CH₃ | 3-Cl-4-F |
| (A50) | CHFCH₂CH₃ | 3-Cl-4-F |
| (A51) | CHFCH₃ | 3-Br-4-F |
| (A52) | CF(CH₃)₂ | 3-Br-4-F |
| (A53) | CH(CH₃)₂ | 3-Br-4-F |
| (A54) | CH₂CH₃ | 3-Br-4-F |
| (A55) | CHFCH₂CH₃ | 3-Br-4-F |
| (A56) | CHFCH₃ | 3,5-F₂ |
| (A57) | CF(CH₃)₂ | 3,5-F₂ |
| (A58) | CH(CH₃)₂ | 3,5-F₂ |
| (A59) | CH₂CH₃ | 3,5-F₂ |
| (A60) | CHFCH₂CH₃ | 3,5-F₂ |

Aminotriazines of the formula (I) and salts thereof (hereinbelow together also referred to in short as “compounds (I) according to the invention” or “compounds (I)”) have already been proposed in the International Application No. PCT/EP00/09419 (WO-A-01/27093). The compounds (I) can be prepared by the methods described therein or by similar known methods, as described in the patent applications also mentioned further above, and in the literature cited therein.

For the preferred compounds, their preparation and general conditions for their use and in particular for specific example compounds, reference is made to the descriptions of the publications mentioned, and these descriptions are inasmuch part of the present invention.

The active compounds (A) are suitable for controlling weeds in a number of crops, for example in crops of economical importance, such as cereals (wheat, barley, rye, rice, corn), sugar beet, sugar cane, oilseed rape, cotton and soybean. Of particular interest is the use in cereals such as wheat and corn, in particular corn. These crops are also preferred for the combinations (A)+(B).

Suitable combination partners (B) are, for example, one or more of the following compounds of subgroups (B1) to (B4) (in most cases, the herbicides are referred to by the common name, in accordance with the reference “The Pesticide Manual” 12th Ed., British Crop Protection Council 2000, abbreviated “PM”.

| | |
|---|---|
| (B1) | foliar- and/or soil-acting herbicides which are active against |
| | monocotyledonous harmful plants, preferably |
| (B1.1) | ureas which are predominantly soil-acting, such as |
| (B1.1.1) | isoproturon (PM, pp. 559-560), i.e. 3-(4-isopropylphenyl)-1,1- |
| | dimethylurea and/or |
| (B1.1.2) | chlorotoluron (PM, pp. 142-169), i.e. 3-(3-chloro-p-tolyl)-1,1- |
| | dimethylurea and/or |
| (B1.2) | compounds of various structures, which are predominantly soil-acting, |
| | such as |
| (B1.2.1) | flufenacet (= fluthiamide, see PM, pp. 434-435), i.e. 4′-fluoro-N- |
| | isopropyl-2-(5-trifluoromethyl-1,3,4-thiadiazol-2-yloxy)acetanilide and/or |
| (B1.2.2) | pendimethalin (PM, pp. 714-715), i.e. N-(1-ethylpropyl)-2,6-dinitro-3,4- |
| | xylidine and/or |
| (B1.2.3) | prosulfocarb (PM, pp. 786-787), i.e. s-benzyl dipropylthiocarbamate |
| | and/or |
| (B1.3) | 2-(4-heteroaryl- or 4-aryloxyphenoxy)propionic acids which are |
| | predominantly foliar-acting, such as |
| (B1.3.1) | clodinafop-propargyl (PM, pp. 186-187), i.e. prop-2-ynyl (R)-2-[4-[(5- |
| | chloro-3-fluoro-2-pyridinyl)oxy]phenoxy]propanoate and/or |
| (B1.3.2) | diclofop-methyl (PM, pp. 279-280), i.e. methyl (RS)-2-[4-(2,4- |
| | dichlorophenoxy)phenoxy]propanoate and/or |
| (B1.3.3) | fenoxaprop-P-ethyl (PM, pp. 393-394), i.e. ethyl (R)-2-[4-[(6-chloro-2- |
| | benzoxazolyl)oxy]phenoxy]propanoate, also in the form of the mixtures |
| | of the optical isomers, for example the racemic mixture fenoxaprop- |
| | ethyl (B1.3.3-RS) and/or |
| (B1.3.4) | quizalofop-P and its esters, such as the ethyl or tefuryl ester (PM, pp. |
| | 822-824), also in the form of the mixtures of the optical isomers, for |
| | example the racemic mixture quizalofop and its esters and/or |
| (B1.3.5) | fluazifop-P and its esters, such as the butyl ester (PM, pp. 423-424), |
| | also in the form of the mixtures of the optical isomers, for example the |
| | racemic mixture fluazifop-butyl (B1.3.5-RS) and/or |
| (B1.3.6) | haloxyfop and haloxyfop-P (R1.3.6-R) and their esters, such as the |
| | methyl or the etotyl ester (PM, pp. 499-501) and/or |
| (B1.3.7) | propaquizafop (PM, pp. 773-774) and/or |
| (B1.3.8) | cyhalofop and its esters, such as the butyl ester (PM, pp. 223-224) |
| | (= (R)-2-[4-(4-cyano-2-fluorophenoxy)phenoxy]propionic acid or butyl |
| | (R)-2-[4-(4-cyano-2-fluorophenoxy)phenoxy]propanoate) and/or |
| (B1.4) | cyclohexanedione oximes which are predominantly foliar-acting, such |
| | as |
| (B1.4.1) | sethoxydim (PM, pp. 832-833), i.e. (E,Z)-2-(1-ethoxyiminobutyl)-5-[2- |
| | (ethylthio)propyl]-3-hydroxycyclohex-2-enone, and/or |
| (B1.4.2) | cycloxydim (PM, pp. 218-219), i.e. 2-(1-ethoxyiminobutyl)-3-hydroxy-5- |
| | thian-3-ylcyclohex-2-enone, and/or |
| (B1.4.3) | clethodim (PM, pp. 185-186), i.e. 2-{(E)-1-[(E)-3-chloroallyloxy- |
| | imino]propyl}-5[-2-(ethylthio)propyl]-3-hydroxycyclohex-2-enone and/or |
| (B1.4.4) | Profoxydim or “BAS 625 H” (= clefoxidim) (see PM, pp. 61-62), i.e. 2- |
| | [1-(2-(4-chlorophenoxy)propoxyimino)butyl]-3-oxo-5-thion-3-ylcyclohex- |
| | 1-enol, |
| (B1.4.5) | tralkoxidim (PM, pp. 914-915), i.e. 2-[1-(ethoxyimino)propyl]-3-hydroxy- |
| | 5-mesitylcyclohex-2-enone, and/or |
| (B1.5) | chloroacetamides which are predominantly soil-acting, such as |
| (B1.5.1) | dimethenamid (PM, pp. 305-306), i.e. 2-chloro-N-(2,4-dimethyl-3- |
| | thienyl)-N-(2-methoxy-1-methylethyl)acetamide, and/or |
| (B1.5.2) | penthoxamid, i.e. 2-chloro-N-(2-ethoxyethyl)-N-(2-methyl-1-phenyl-1- |
| | propenyl)acetamide (TKC-94, known from AG Chem New Compound, |
| | Review Vol. 17 (1999), EP-A-206 251), and/or |
| (B1.5.3) | butachlor (PM, pp. 117-118), i.e. N-(butoxymethyl)-2-chloro-N-(2,6- |
| | diethylphenyl)acetamide, and/or |
| (B1.5.4) | pretilachlor (PM, pp. 755-756), i.e. 2-chloro-N-(2,6-diethylphenyl)-N- |
| | (propoxyethyl)acetamide, and/or |
| (B1.6) | foliar and/or soil acting compounds having various structures, such as |
| (B1.6.1) | imazamethabenz-methyl (PM, pp. 526-527), i.e. methyl (±)-2-(4- |
| | isopropyl-4-methyl-5-oxo-2-imidazolin-2-yl)-para- and -meta-toluate, |
| | and/or |
| (B1.6.2) | simazin (PM, pp. 836-837), i.e. 6-chloro-N,N′-diethyl-2,4-diamino-1,3,5- |
| | triazine, and/or |
| (B1.6.3) | molinate (PM, pp. 652-653), i.e. S-ethyl azepane-1-thiocarboxylate, |
| | and/or |
| (B1.6.4) | thiobencarb (benthiocarb) (PM, pp. 901-902), i.e. S-4-chlorobenzyl |
| | diethylthiocarbamate, and/or |
| (B1.6.5) | oxaziclomefone (MY 100) (PM, p. 696) i.e. 3-[1-(3,5-dichlorophenyl)-1, |
| | methylethyl]-3,4-dihydro-6-methyl-5-phenyl-2H-1,3-oxazin-4-one and/or |
| (B1.6.6) | anilofos (PM, p. 38), i.e. S-4-chloro-N-isopropylcarbaniloylmethyl-O,O- |
| | dimethyl dithiophosphate, and/or |
| (B1.6.7) | cafenstrole (CH 900) (PM, pp. 128-129), i.e. N,N-diethyl-3- |
| | mesitylsulfonyl-1H-1,2,4-triazole-1-carboxamide, and/or |
| (B1.6.8) | mefenacet (PM, pp. 593-594), i.e. 2-(1,3-benzothiazol-2-yloxy)-N- |
| | methylacetanilide, and/or |
| (B1.6.9) | fentrazamid (NBA 061), (PM, pp. 406-407), i.e. N-cyclohexyl-N-ethyl-4- |
| | (2-chlorophenyl)-5-oxo-4,5-dihydrotetrazole-1-carboxamide, and/or |
| (B1.6.10) | thiazopyr (PM, pp. 897-898), i.e. methyl 2-difluoromethyl-5-(4,5- |
| | dihydro-1,3-thiazol-2-yl)-4-isobutyl-6-trifluoromethylnicotinate, and/or |
| (B1.6.11) | oxadiazon (PM. pp. 691-692), i.e. 3-tert-butyl-3-(2,4-dichloro-5- |
| | isopropoxyphenyl)-1,3,4-oxadiazol-2(3H)-one, and/or |
| (B1.6.12) | esprocarb (PM, pp. 354-355), i.e. S-benzyl 1,2-dimethylpropyl- |
| | (ethyl)thiocarbamate, and/or |
| (B1.6.13) | pyributicarb (PM, p. 802), i.e. O-3-tert-butylphenyl 6-(methoxy-2- |
| | pyridyl(methyl)thiocarbamate, and/or |
| (B1.6.14) | azimsulfuron (PM, pp. 48-50), i.e. 1-(4,6-dimethoxypyrimidin-2-yl)-3-[1- |
| | methyl-4-(2-methyl-2H-tetrazol-5-yl)pyrazol-5-ylsulfonyl]urea, and/or |
| (B1.6.15) | thenylchlor (PM, pp. 893-894), i.e. 2-chloro-N-(2,6-dimethylphenyl)-N- |
| | (3-methoxy-2-thienyl)methyl]acetamide, and/or |
| (B1.6.16) | pentoxazone (KPP 314) (PM, pp. 718-719), i.e. 3-(4-chloro-5- |
| | cyclopentyloxy-2-fluorophenyl)-5-isopropylidene-1,3-oxazolidine-2,4- |
| | dione, and/or |
| (B1.6.17) | pyriminobac, pyriminobac-methyl (KIH 6127) (PM, pp. 810-811), i.e. 2- |
| | (4,6-dimethoxy-2-pyrimidinyloxy)-6-(1-methoxyiminoethyl)benzoic acid, |
| | and its salts and esters, such as the methyl ester, and/or |
| (B1.6.18) | flucarbazone and its salts, such as flucarbazone sodium salt (BAY |
| | MKH 6562) (PM, pp. 427-425), i.e. IH-1,2,4-triazole-1-carboxamide- |
| | 4,5-dihydro-3-methoxy-4-methyl-5-oxo-N-[[2-(trifluoromethoxy)- |
| | phenyl]sulfonyl] sodium salt, preferably in amounts of 5-100, in |
| | particular 10-80 g of a.s./ha, and/or |
| (B1.6.19) | procarbazone (BAY MKH 6561, known from AG Chem New |
| | Compound, Review Vol. 17 (1999), page 27 and EP-A-507171), i.e. |
| | methyl 2-[[[(4,5-dihydro-4-methyl-5-oxo-3-propoxy-1H-1,2,4-triazol-1- |
| | yl)carbonyl]amino]sulfonyl]benzoate, and its salts, preferably in |
| | amounts of 10-150, in particular 20-120 g of a.s./ha and/or |
| (B2) | herbicides which are predominantly active against dicotyledonous |
| | plants, preferably |
| (B2.1) | sulfonylureas, such as |
| (B2.1.1) | tribenuron-methyl (PM, pp. 928-929), i.e. methyl 2-[4-methoxy-6- |
| | methyl-1,3,5-triazin-2-yl(methyl)carbamoylsulfamoyl]benzoate, and/or |
| (B2.1.2) | thifensulfuron and its esters, preferably the methyl ester (PM, pp. 899- |
| | 900), i.e. 3-[[[(4-methoxy-6-methyl-1,3,5-triazin-2-yl)amino]carbonyl]- |
| | amino]sulfonyl]-2-thiophenecarboxylic acid or methyl 3-[[[(4-methoxy-6- |
| | methyl-1,3,5-triazin-2-yl)amino]carbonyl]amino]sulfonyl]-2- |
| | thiophenecarboxylate and its salts, and/or |
| (B2.1.3) | prosulfuron (PM, pp. 787-788), i.e. 1-(4-methoxy-6-methyl-1,3,5-triazin- |
| | 2-yl)-3-[2-(3,3,3-trifluoropropyl)phenylsulfonyl]urea and its salts, and/or |
| (B2.1.4) | amidosulfuron (PM, pp. 29-30), i.e. 1-(4,6-dimethoxypyrimidin-2-yl)-3- |
| | mesyl(methyl)sulfamoylurea and its salts, and/or |
| (B2.1.5) | chlorimuron and its esters, such as chlorimuron-ethyl (PM, pp. 161- |
| | 162) (= 2-(4-chloro-2-methoxypyrimidin-2-ylcarbamoysulfamoyl)- |
| | benzoic acid and its esters, such as the ethyl ester) and/or |
| (B2.1.6) | halosulfuron and its esters, such as the methyl ester (PM, pp. 497- |
| | 499), i.e. methyl 3-chloro-5-(4,6-dimethoxypyrimidin-2- |
| | ylcarbamoylsulfamoyl)-1-methylpyrazolecarboxylate, also in its salt |
| | form, and/or |
| (B2.1.7) | LAB271272, (= tritosulfuron, CAS Reg. No. 142469-14-5; see AG |
| | Chem New Compound Review, Vol. 17, 1999, p. 24, published by |
| | AGRANOVA), i.e. N-[[[4-methoxy-6-(trifluoromethyl)-1,3,5-triazin-2- |
| | yl)amino]carbonyl]-2-(trifluoromethyl)benzenesulfonamide), preferably |
| | in an amount of 2-250, in particular 10-150 g of a.s./ha, and/or |
| (B2.1.8) | bensulfuron-methyl (PM, pp. 76-77), i.e. methyl 2-[[[[[(4,6-dimethoxy-2- |
| | pyrimidinyl)amino]carbonyl]amino]sulfonyl]methyl]benzoate, and/or |
| (B2.1.9) | ethoxysulfuron (PM, pp. 367-368), i.e. 1-(4,6-dimethoxypyrimidin-2-yl)- |
| | 3-(2-ethoxyphenoxysulfonyl)urea, and/or |
| (B2.1.10) | cinosulfuron (PM, pp. 183-184), i.e. 1-(4,6-dimethoxy-1,3,5-triazin-2-yl)- |
| | 3-[2-(2-methoxyethoxy)phenylsulfonyl)urea, and/or |
| (B2.1.11) | pyrazosulfuron and its esters, such as pyrazosulfuron-ethyl (PM, pp. |
| | 1795-797) (= 5-(4,6-dimethoxypyrimidin-2-ylcarbamoylsulfamoyl)-1- |
| | methylpyrazole-4-carboxylic acid and its salts and esters, such as the |
| | ethyl ester), and/or |
| (B2.1.12) | imazosulfuron (PM, pp. 534-535), i.e. 1-(2-chloroimidazo[1,2-a]pyridin- |
| | 3-ylsulfonyl)-3-(4,6-dimethoxypyrimidin-2-yl)urea, and/or |
| (B2.1.13) | cyclosulfamuron (PM, pp. 217-218), i.e. 1-(2-(cyclopropylcarbonyl)- |
| | phenylsulfamoyl]-3-(4,6-dimethoxypyrimidin-2-yl)urea, and/or |
| (B2.2) | growth regulators (of the auxin type), such as |
| (B2.2.1) | MCPA (PM, pp. 583-585), i.e. (4-chloro-2-methylphenoxy)acetic acid |
| | and its salts and esters, and/or |
| (B2.2.2) | 2,4-D (PM, pp. 243-246), i.e. 2,4-dichlorophenoxyacetic acid and its |
| | salts and esters, and/or |
| (B2.2.3) | dichlorprop-P (PM, pp. 275-276), i.e. (R)-2-(2,4-dichloro- |
| | phenoxy)propionic acid, also in the racemic form dichlorprop (PM, pp. |
| | 273-275) (B2.2.3-RS), and their salts and esters, and/or |
| (B2.2.4) | mecoprop-P (PM, pp. 591-592), i.e. (R)-2-(4-chloro-o-tolyloxy)propionic |
| | acid, also in the racemic form mecoprop (PM, pp. 590-591) (B2.2.4- |
| | RS), and their respective salts and esters, and/or |
| (B2.2.5) | fluoroxypyr (PM, pp. 455-457), i.e. 4-amino-3,5-dichloro-6-fluoro-2- |
| | pyridyloxyacetic acid, and its salts and esters, and/or |
| (B2.2.6) | dicamba (PM, pp. 265-267), i.e. 3,6-dichloro-o-anisic acid and its salts |
| | and esters, and/or |
| (B2.2.7) | clopyralid (PM, pp. 193-194), i.e. 3,6-dichloro-2-pyridinecarboxylic acid, |
| | and its salts and esters, preferably in an amount of 10-2000, in |
| | particular 20-1000 g a.s./ha and/or |
| (B2.2.8) | picloram (PM, pp. 740-742), i.e. 4-amino-3,5,6-trichloropicolinic acid |
| | and its salts and esters, and/or |
| (B2.3) | hydroxybenzonitriles, such as |
| (B.2.3.1) | bromoxynil (PM, pp. 110-112), i.e. 3,5-dibromo-4-hydroxybenzonitrile |
| | and its salts and esters, and/or |
| (B.2.3.2) | ioxynil (PM, pp. 548-550), i.e. 4-hydroxy-3,5-diiodobenzonitrile and its |
| | salts and esters, and/or |
| (B2.4) | diphenyl ethers, such as |
| (B2.4.1) | fluoroglycofen-ethyl (PM, pp. 444-445), i.e. ethyl O-[5-(2-chloro-α,α,α- |
| | trifluoro-p-tolyloxy)-2-nitrobenzoyl]glycolate, and/or |
| (B2.4.2) | aclonifen (PM, pp. 14-15), i.e. 2-chloro-6-nitro-3-phenoxyaniline, |
| | preferably in an amount of 10-5000, in particular 20-3000 g of a.s./ha, |
| | and/or |
| (B2.4.3) | acifluorfen (PM, pp. 12-14) and its salts, such as the sodium salt (= 5- |
| | [2-chloro-4-(trifluoromethyl)phenoxy]-2-nitrobenzoic acid and its salts, |
| | such as the Na salt), and/or |
| (B2.5) | [1,2,4]-triazolopyrimidinesulfonamides, such as |
| (B2.5.1) | cloransulam and preferably the methyl ester (PM, pp. 196-197), i.e. 3- |
| | chloro-2-(5-ethoxy-7-fluoro-[1,2,4]triazolo-[1,5-c]pyrimidin-2- |
| | ylsulfonamido)benzoic acid or methyl 3-chloro-2-(5-ethoxy-7-fluoro- |
| | [1,2,4]triazolo-[1,5-c]pyrimidin-2-ylsulfonamido)benzoate, and/or |
| (B2.5.2) | florasulam, i.e. N-(2,6-difluorophenyl)-8-fluoro-5-methoxy-1,2,4- |
| | triazolo[1,5-c]pyrimidine-2-sulfonamide (PM, pp. 420-421), and/or |
| (B2.6) | compounds of various structures, such as |
| (B2.6.1) | bentazone (PM, pp. 80-81), i.e. 3-isopropyl-1H-2,1,3-benzothiadiazin- |
| | 4(3H)-one 2,2-dioxide, and/or |
| (B2.6.2) | bifenox (PM, pp. 87-88), i.e. methyl 5-(2,4-dichlorophenoxy)-2- |
| | nitrobenzoate, and/or |
| (B2.6.3) | carfentrazone-ethyl (PM, pp. 141-142), i.e. ethyl (RS)-2-chloro-3-[2- |
| | chloro-4-(4-difluoromethyl-4,5-dihydro-3-methyl-5-oxo-1H-1,2,4-triazol- |
| | 1-yl)-4-fluorophenyl]propionate, and/or |
| (B2.6.4) | pyraflufen (PM, pp. 792-793), i.e. 2-chloro-5-(4-chloro-5- |
| | difluoromethoxy-1-methylpyrazol-3-yl)-4-fluorophenoxyacetic acid, |
| | and/or |
| (B2.6.5) | pyridate (PM, pp. 805-806), i.e. O-(6-chloro-3-phenylpyridazin-4-yl) S- |
| | (octyl) thioformate, and/or |
| (B2.6.6) | linuron (PM, pp. 572-573), i.e. 3-(3,4-dichlorophenyl)-1-methoxy-1- |
| | methylurea, and/or |
| (B2.6.7) | diflufenzopyr (BASF 654 00 H) (PM, pp. 297-298), i.e. 2-{1-[4-(3,5- |
| | difluorophenyl)semicarbazone]ethyl}nicotinic acid, and its salts, |
| (B2.6.8) | cinidon-ethyl (PM, pp. 181-182), i.e. ethyl (z)-2-chloro-3[2-chloro-5- |
| | (1,2-cyclohex-1-enedicarboximide)phenyl]acrylate preferably in an |
| | amount of 5-500, in particular 10-400 g of a.s./ha, and/or |
| (B2.6.9) | metribuzin (PM, pp. 642-644), preferably in an amount of 50-3000, in |
| | particular 60-2000 g of a.s./ha, and/or |
| (B2.6.10) | picolinafen (PM, pp. 742-743), i.e. N-4-fluorophenyl-6-(3- |
| | trifluoromethylphenoxy)pyridine-2-carboxamide (AC 900001), |
| | preferably in an amount of 1-90, in particular 2-80 g of a.s./ha, and/or |
| (B2.6.11) | clomazone (PM, pp. 190-191), preferably in an amount of 50-5000, in |
| | particular 100-3000 g of a.s./ha, and/or |
| (B2.6.12) | bromobutide (PM, p. 108), i.e. 2-bromo-3,3-dimethyl-N-(1-methyl-1- |
| | phenylethyl)butyramide, and/or |
| (B2.6.13) | benfuresate (PM, pp. 71-72), i.e. 2,3-dihydro-3,3-dimethylbenzofuran- |
| | 5-yl ethanesulfonate, and/or |
| (B2.6.14) | dithiopyr (PM, p. 330) (= S,S′-dimethyl 2-difluoromethyl-4-isobutyl-6- |
| | trifluoromethylpyridine-3,5-di(thiocarboxylate)), and/or |
| (B2.6.15) | triclopyr (PM, pp. 933-934), i.e. 3,5,6-trichloro-2-pyridyloxyacetic acid, |
| | and its salts and esters, and/or |
| (B3) | herbicides which are active against monocotyledonous and |
| | dicotyledonous harmful plants, preferably |
| (B3.1) | sulfonylureas, such as |
| (B3.1.1) | metsulfuron-methyl (PM, pp. 644-645), i.e. methyl 2-[(4-methoxy-6- |
| | methyl-1,3,5-triazin-2-yl)carbamoylsulfamoyl]benzoic acid, and/or |
| B3.1.2) | triasulfuron (PM, pp. 922-923), i.e. 1-[2-(2-chloroethoxy)- |
| | phenylsulfonyl]-3-(4-methoxy-6-methyl-1,3,5-triazin-2-yl)urea, and/or |
| (B3.1.3) | chlorsulfuron (PM, pp. 175-176), i.e. 1-(2-chlorosulfonyl)-3-(4-methoxy- |
| | 6-methyl-1,3,5-triazin-2-yl)urea, and/or |
| (B3.1.4) | iodosulfuron-methyl and preferably its sodium salt (PM, pp. 547-548), |
| | i.e. methyl 4-iodo-2-(4-methoxy-6-methyl-1,3,5-triazin-2-ylcarbamoyl- |
| | sulfamoyl)benzoate and/or the corresponding sodium salt, and/or |
| (B3.1.5) | mesosulfuron, i.e. methyl 4-methylsulfonylamino-2-(4,6-dimethoxy- |
| | pyrimidin-2-ylcarbamoylsulfamoyl)benzoate, known from WO-A- |
| | 95/10507, and/or |
| (B3.1.6) | sulfosulfuron (PM, pp. 853-854), i.e. 1-(4,6-dimethoxypyrimidin-2-yl)-3- |
| | (2-ethylsulfonylimidazole[1,2-a]pyridin-3-yl)sulfonylurea, and/or |
| (B3.1.7) | flupyrsulfuron (PM, pp. 447-448), i.e. 2-(4,6-dimethoxypyrimidin-2- |
| | ylcarbamoylsulfamoyl)-6-trifluoromethylnicotinic acid, preferably the |
| | sodium salt of the methyl ester, and/or |
| (B3.1.8) | nicosulfuron (PM, pp. 672-673), i.e. 2-(4,6-dimethoxypyrimidin-2-yl)-3- |
| | (3-dimethylcarbamoyl-2-pyridylsulfonyl)urea, and/or |
| (B3.1.9) | rimsulfuron (PM, pp. 826-827), i.e. 1-(4,6-dimethoxypyrimidin-2-yl)-3- |
| | (3-ethylsulfonyl-2-pyridylsulfonyl)urea, and/or |
| (B3.1.10) | primisulfuron-methyl (PM, pp. 756-758), i.e. methyl 2-[4,6- |
| | bis(difluoromethoxy)pyrimidin-2-ylcarbamoylsulfamoyl]benzoate, and/or |
| (B3.1.11) | foramsulfuron, i.e. 4-formylamino-2-[[(4,6-dimethoxypyrimidin-2-yl)- |
| | carbamoyl]sulfamoyl]-N,N-dimethylbenzamide, known from |
| | EP-A-0757679, and/or |
| (B3.2) | triazine derivatives, such as |
| (B3.2.1) | cyanazine (PM, pp. 211-212), i.e. 2-(4-chloro-6-ethylamino-1,3,5- |
| | triazin-2-ylamino)-2-methylpropionitrile, and/or |
| (B3.2.2) | atrazin (PM, pp. 42-43), i.e. N-ethyl-N′-isopropyl-6-chloro-2,4-diamino- |
| | 1,3,5-triazine, and/or |
| (B3.2.3) | terbuthylazine (PM, pp. 881-882), i.e. N-ethyl-N′-tert-butyl-6-chloro-2,4- |
| | diamino-1,3,5-triazine, and/or |
| (B3.2.4) | terbutryn (PM, pp. 883-884), i.e. N-(1,1-dimethylethyl)-N′-ethyl-6- |
| | methylthio-2,4-diamino-1,3,5-triazine, and/or |
| (B3.3) | chloroacetamides, such as |
| (B3.3.1) | acetochlor (PM, pp. 10-11), i.e. 2-chloro-N-(ethoxymethyl)-N-(2-ethyl-6- |
| | methylphenyl)acetamide, and/or |
| (B3.3.2) | S-metolachlor (PM, pp. 637-638), i.e. (aRS, 1-R)-2-chloro-N-(2-ethyl-6- |
| | methylphenyl)-N-(2-methoxy-1-methylethyl)acetamide also in the form |
| | of racemic metolachlor (B3.3.2-RS) (PM, pp. 635-636), and/or |
| (B3.3.3) | alachlor (PM, pp. 19-20), i.e. 2-chloro-N-(2,6-diethylphenyl)-N- |
| | (methoxymethyl)acetamide, and/or |
| (B3.4) | compounds of various structures, such as |
| (B3.4.1) | diflufenican (PM, pp. 397-399), i.e. 2′,4′-difluoro-2-(α,α,α-trifluoro-m- |
| | tolyloxy)nicotinanilide, and/or |
| (B3.4.2) | flumetsulam (PM, pp. 573-574), i.e. 2′,6′-difluoro-5- |
| | methyl[1,2,4]triazolo[1,5-a]pyrimidine-2-sulfoanilide, and/or |
| (B3.4.3) | flurtamone (PM, pp. 602-603), i.e. (RS)-5-methylamino-2-phenyl-4- |
| | (α,α,α-trifluoro-m-tolyl)furan-3(2H)-one, and/or |
| (B3.4.4) | isoxaflutole (PM, pp. 737-739), i.e. 5-cyclopropyl-1,2-oxazol-4-yl α,α,α- |
| | trifluoro-2-mesyl-p-tolyl ketone, and/or |
| (B3.4.5) | metosulam (PM, pp. 640-641), i.e. 2′,6′-dichloro-5,7-dimethoxy-3′- |
| | methyl[1,2,4]triazole[1,5-a]pyrimidine-2-sulfoanilide, and/or |
| (B3.4.6) | paraquat (salts), for example the dichloride (PM, pp. 705-706), i.e. 1,1′- |
| | (dimethyl)-4,4′-bipyridinium dichloride or other salts, and/or |
| (B3.4.7) | benoxacor (PM, pp. 74-75), i.e. 4-dichloroacetyl-3,4-dihydro-3-methyl- |
| | 2H-1,4-benzoxazine, and/or |
| (B3.4.8) | sulcotrione (PM, pp. 848-849), i.e. 2-(2-chloro-4-mesylbenzoyl)- |
| | cyclohexane-1,3-dione, and/or |
| (B3.4.9) | mesotrione (PM, p. 602), i.e. 2-(4-mesyl-2-nitrobenzoyl)cyclohexane- |
| | 1,3-dione, and/or |
| (B3.4.10) | quinclorac (PM, pp. 815-816), i.e. 3,7-dichloroquinoline-8-carboxylic |
| | acid, and/or |
| (B3.4.11) | propanil (PM, pp. 771-772), i.e. N-(3,4-dichlorophenyl)propanamide |
| | and/or |
| (B3.4.12) | bispyribac, bispyribac-Na (KIH 2023) (PM, pp. 97-98), i.e. sodium 2,6- |
| | bis-(4,6-dimethoxy-2-pyrimidin-2-yloxy)benzoate, and/or |
| (B3.4.13) | pyribenzoxim (LGC 40863) (PM, p. 801), i.e. 2,6-bis-(4,6-dimethoxy- |
| | pyridin-2-yl)-1-[N-(diphenylmethyl)iminooxycarbonyl]benzene, and/or |
| (B3.4.14) | oxadiargyl (PM, pp. 690-691), i.e. 5-tert-butyl-3-[2,4-dichloro-5-(prop-2 |
| | ynyloxy)phenyl]-1,3,4-oxadiazol-2(3H)-one, and/or |
| (B3.4.15) | norflurazon (PM, pp. 678-679), i.e. 4-chloro-5-(methylamino)-2-[3- |
| | (trifluoromethyl)phenyl]-3-(2H)-pyridazinone, and/or |
| (B3.4.16) | fluometuron (PM, pp. 442-443), i.e. N,N-dimethyl-N′-[3- |
| | trifluoromethyl)phenyl]urea; and/or |
| (B3.4.17) | methylarsonic acid of the formula CH₃AS(=O)(OH)₂ and its salts, such |
| | as DSMA = disodium salt or MSMA = monosodium salt of |
| | methylarsonic acid (PM, pp. 625-626), and/or |
| (B3.4.18) | prometryn (promethyrin) (PM, pp. 766-767), i.e. N,N′-bis(1- |
| | methylethyl)-6-methylthio-2,4-diamino-1,3,5-triazine, and/or |
| (B3.4.19) | trifluralin (PM, pp. 942-943), i.e. 2,6-dinitro-N,N-dipropyl-4- |
| | trifluoromethylaniline, and/or |
| (B4) | herbicides which are active against monocotyledonous and |
| | dicotyledonous harmful plants and which can be employed specifically |
| | in tolerant crops and on non-crop land, preferably |
| (B4.1) | compounds of the glufosinate or phosphinothricin (= L-glufosinate) type |
| | and their salts and derivatives, such as |
| (B4.1.1) | glufosinate in a narrow sense (PM, pp. 486-487), i.e. D,L-2-amino-4- |
| | [hydroxy(methyl)phosphinyl]butanoic acid or its active I-enantiomer and |
| | their salts, preferably the racemic glufosinate monoammonium salt, |
| (B4.1.2) | bilanafos (or bialaphos) (PM, pp. 90-91), i.e. L-2-amino-4- |
| | [hydroxy(methyl)phosphinyl]butanoyl-L-alanyl-L-alanine, in particular its |
| | sodium salt. |
| (B4.2) | compounds of the phosphonomethylglycine type and its salts, such as |
| (B4.2.1) | glyphosate (PM, pp. 488-491), i.e. N-(phosphonomethyl)glycine or its |
| | salts, preferably the glyphosate monoisopropylammonium salt or the |
| | sodium salt, and/or |
| (B4.2.2) | sulfosate, i.e. N-(phosphonomethyl)glycine trimesium salt = |
| | N-(phosphonomethyl)glycine trimethylsulfoxonium salt (PM, pp. 488- |
| | 491), and/or |
| (B4.3) | imidazolinones, such as |
| (B4.3.1) | imazapyr (PM, pp. 530-531) and its salts and esters, and/or |
| (B4.3.2) | imazethapyr (PM, pp. 533-534) and its salts and esters; and/or |
| (B4.3.3) | imazamethabenz (PM, pp. 526-527) and its salts and esters such as |
| | methyl ester:, and/or |
| (B4.3.4) | imazamox (PM, p. 528) and its salts and esters, and/or |
| (B4.3.5) | imazaquin (PM, pp. 531-533) and its salts and esters, for example the |
| | ammonium salt, and/or |
| (B4.3.6) | imazapic (AC 263,222) (PM, p. 529) and its salts and esters, for |
| | example the ammonium salt, and/or |
| (B4.4) | compounds of various structural types, such as |
| (B4.4.1) | WC9717 or CGA276854 = 1-allyloxycarbonyl-1-methylethyl 2-chloro-5- |
| | (3-methyl-2,6-dioxo-4-trifluoromethyl-3,6-dihydro-2H-pyrimidin-1- |
| | yl)benzoate (known from US-A-5183492) |
| (B4.4.2) | azafenidin (PM, pp. 46-47), i.e. 2-(2-dichloro-5-prop-2-ynyloxyphenyl)- |
| | 5,6,7,8-tetrahydro-1,2,4-triazolo[4,3-a]pyridin-3(2H)-one, and/or |
| (B4.4.3) | diuron (PM, pp. 331-332), i.e. 3-(3,4-dichlorophenyl)-1,1-dimethylurea, |
| | and/or |
| (B4.4.4) | oxyfluorfen (PM, pp. 702-703), i.e. 2-chloro-1-(3-ethoxy-4- |
| | nitrophenoxy)-4-(trifluoromethyl)benzene. |

When the short form of the common name is used, this includes all customary derivatives, such as esters and salts, in particular the commercially available form or forms. In the case of sulfonylureas, salts include those which are formed by exchanging a hydrogen atom at the sulfonamide group for a cation.

Preference is given to herbicide combinations of one or more compounds (A) with one or more compounds of group (B1) or (B2) or (B3) or (B4).

Preference is furthermore given to combinations of compounds (A) with one or more compounds (B) according to the scheme:

(A)+(B1)+(B2), (A)+(B1)+(B3), (A)+(B1)+(B4) or (A)+(B2)+(B3), (A)+(B2)+(B4), (A)+(B3)+(B4) or (A)+(B1)+(B2)+(B3), (A)+(B1)+(B2)+(B4), (A)+(B4)+(B2)+(B3), (A)+(B1)+(B3)+(B4) or (A)+(B1)+(B2)+(B3)+(B4).

Also according to the invention are combinations in which one or more further active compounds of a different structure [active compounds (C)] are added, such as

(A)+(B1)+(C), (A)+(B2)+(C) or (A)+(B3)+(C), (A)+(B4)+(C), (A)+(B1)+(B2)+(C), (A)+(B1)+(B3)+(C), (A)+(B1)+(B4)+(C) or (A)+(B2)+(B3)+(C), (A)+(B2)+(B4)+(C), (A)+(83)+(B4)+(C) or (A)+(B1)+(B2)+(B3)+(C), (A)+(B1)+(B2)+(B4)+(C), (A)+(B4)+(B2)+(B3)+(C), (A)+(B1)+(B3)+(B4)+(C) or (A)+(B1)+(B2)+(B3)+(B4)+(C).

For combinations of the last-mentioned kind with three or more active compounds, the preferred conditions explained below in particular for two-compound combinations according to the invention primarily apply likewise if they comprise the two-compound combinations according to the invention.

The application rate of the herbicides (A) can be varied within wide limits; the optimum rate depends on the herbicide in question, on the spectrum of harmful plants and on the crop plants. In general, the application rate is in the range from 10 to 1200, preferably 15 to 800, very particularly preferably from 10 to 150 g of active compound (a.s.)/ha.

The application rates of the herbicides (B) can vary considerably from herbicide to herbicide. As a rule of thumb, for preferred application rates, the following details can apply, it also being possible in the combinations according to the invention for amounts below the lowest amount to be useful (a.s.=active substance). Compounds of groups (B1.1) and (B1.2): 0.5 to 5000, in particular 50-5000 g of a.s./ha, predominantly against weed grasses by the post-emergence method, but also by the pre-emergence method;

compounds of groups (B1.3) and (B1.4): 0.5 to 5000, in particular 10-1500 g of a.s./ha, mainly against weed grasses by the post-emergence method, if appropriate in combination with safeners;

compounds of groups (B1.5): 10 to 5000, in particular 20 to 4000 g of a.s./ha, mainly against weed grasses by the post-emergence and pre-emergence method;

compounds of groups (B1.6): 0.5 to 2000, in particular 10 to 1500 g of a.s./ha, mainly against weed grasses by the post-emergence and pre-emergence method;

compounds of group (B2.1): 0.5 to 500, in particular 2.5-80 g of a.s./ha, predominantly against broad-leaved weeds by the post-emergence method;

compounds of group (B2.2): 20 to 5000, in particular 50-2000 g of a.s./ha, predominantly against broad-leaved weeds and Cyperaceae by the post-emergence method;

compounds of group (B2.3): 1-3000, in particular 5-2000 g of a.s./ha predominantly against broad-leaved weeds by the post-emergence method;

compounds of group (B2.4): 1 to 3000, in particular 2 to 1500 g of a.s./ha predominantly against broad-leaved weeds by the post-emergence method;

compounds of group (B2.5): 1 to 1000, in particular 2 to 200 g of a.s./ha against broad-leaved weeds by the pre- and post-emergence method;

compounds of group (B2.6): 0.5 to 5000, in particular 10 to 1500 g of a.s./ha against broad-leaved weeds by the pre- and/or post-emergence method;

compounds of group (B3.1): 0.5 to 2000, in particular 1 to 500 g of a.s./ha predominantly against broad-leaved weeds and weed grasses by the post-emergence, but also by the pre-emergence method;

compounds of group (B3.2): 10 to 5000, in particular 100 to 4000, very particularly preferably 300-3000 g of a.s./ha against broad-leaved weeds and weed grasses by the post-emergence and/or pre-emergence method;

compounds of group (B3.3): 10 to 5000, in particular 100 to 4000, very particularly preferably 200-3000 g of a.s./ha against broad-leaved weeds and weed grasses by the post-emergence and/or pre-emergence method;

compounds of group (B3.4): 0.5 to 5000, in particular 10 to 1500 g of a.s./ha against broad-leaved weeds and weed grasses by the post-emergence and/or pre-emergence method;

compounds of group (B4.1): 10 to 1000, in particular 20 to 600;

compounds of group (B4.2): 20 to 1000, in particular 20 to 800;

compounds of group (B4.3): 1 to 1000, in particular 10 to 200;

compounds of group (B4.4): 10 to 8000, in particular 10 to 6000.

Ranges of suitable ratios of compounds (A) and (B) result from the above-mentioned application rates for the individual substances. In the combinations according to the invention, it is generally possible to reduce the application rates.

Preferred mixing ratios (based on weight) for the combinations are listed below:

| | |
|---|---|
| (A):(B1) | in the range from 2000:1 to 1:500, preferably from 500:1 to |
| | 1:150, in particular from 75:1 to 1:80; |
| (A):(B2) | in the range from 1600:1 to 1:500, preferably from 600:1 to |
| | 1:150, in particular from 40:1 to 1:60; |
| (A):(B3) | in the range from 9000:1 to 1:600, preferably from 700:1 to |
| | 1:250, in particular from 100:1 to 1:150; |
| (A):(B4) | in the range from 120:1 to 1:400, preferably from 40:1 to |
| | 1:250, in particular from 20:1 to 1:150. |

Certain combinations of compounds (A) and (B) are particularly suitable for use in the following crops:

Suitable for use in cereals (wheat, barley, etc.) are combinations of compounds (A) with the compounds (B1.1.1) to (B1.3.3), (B1.4.5), (B1.6.1), (B1.6.18)/(B1.6.19), (B2.1.1)/(B2.1.2), (B2.1.4), (B2.1.7), (B2.2.1)−(B2.2.5), (B2.3.1)/(B2.3.2), (B2.4.1), (B2.5.2), (B2.6.2), (B2.6.3)/(B2.6.4), (B2.6.8), (B2.6.10), (B3.1.1)−(B3.1.5), (B3.1.7), (B3.4.1)−(B3.4.3), (B4.3.3).

Suitable for use in corn are combinations of compounds (A) with the compounds (B1.5.1), (B1.6.2), (B2.1.3), (B2.1.6), (B2.1.8)−(B2.1.13), (B2.2.6), (B2.4.2), (B2.6.5), (B2.6.7), (B3.1.8)−(B3.1.11), (B3.2.1)−(B3.2.4), (B3.3.1)−(B3.3.3), (B3.4.2)/(B3.4.4)/(B3.4.5), (B3.4.8)/(B3.4.9).

Suitable for use in rice are combinations of combinations (A) with the compounds (B1.3.8), (B1.4.4), (B1.5.2)−(B1.5.4), (B1.6.3)−(B1.6.17), (B2.1.5), (B2.1.6), (B2.6.11)−(B2.6.15), (B3.4.10(B3.4.14).

Suitable for nonselective use in perennial crops are combinations of combinations (A) and the compounds (B2.2.8), (B3.4.6), (B4.2.1), (B4.2.2), (B4.3.5), (B4.4.1)−(B4.4.4).

Suitable for use in dicotyledonous crops such as oilseed rape, sugar beet and soybeana bean are combinations of compounds (A) with the compounds (B1.3.4)−(B1.3.7), (B1.4.1), (B1.4.2), (B1.4.3), (B2.2.7), (B2.4.3), (B2.5.1), (B2.6.6), (B2.6.9), (B3.4.7), (B3.4.15)−(B3.4.19), (B4.3.1), (B4.3.2), (B4.3.4), (B4.3.6).

Of particular interest is the use of herbicidal compositions having a synergistically effective content of one or more of the following combinations of two compounds (A)+(B):

(A1)+(B1.1.1), (A1)+(B1.1.2.); (A1)+(B1.2.1), (A1)+(B1.2.2.), (A1)+(B1.2.3); (A1)+(B1.3.1), (A1)+(B1.3.2.), (A1)+(B1.3.3), (A1)+(B1.3.4), (A1)+(B1.3.5), (A1)+(B1.3.6), (A1)+(B1.3.7), (A1)+(B1.3.8); (A1)+(B1.4.1), (A1)+(B1.4.2), (A1)+(B1.4.3), (A1)+(B1.4.4), (A1)+(B1.4.5); (A1)+(B1.5.1), (A1)+(B1.5.2), (A1)+(B1.5.3), (A1)+(B1.5.4); (A1)+(B1.6.1), (A1)+(B1.6.2), (A1)+(B1.6.3), (A1)+(B1.6.4), (A1)+(B1.6.5), (A1)+(B1.6.6), (A1)+(B1.6.7), (A1)+(B1.6.8), (A1)+(B1.6.9), (A1)+(B1.6.10), (A1)+(B1.6.11), (A1)+(B1.6.12), (A1)+(B1.6.13), (A1)+(B1.6.14), (A1)+(B1.6.15), (A1)+(B1.6.16), (A1)+(B1.6.17), (A1)+(B1.6.18), (A1)+(B1.6.19); (A1)+(B2.1.1), (A1)+(B2.1.2), (A1)+(B2.1.3), (A1)+(B2.1.4), (A1)+(B2.1.6), (A1)+(B2.1.7), (A1)+(B2.1.8), (A1)+(B2.1.9), (A1)+(B2.1.10), (A1)+(B2.11.11), (A1)+(B2.1.12), (A1)+(B2.1.13), (A1)+(B2.1.13); (A1)+(B2.2.1), (A1)+(B2.2.2), (A1)+(B2.2.3), (A1)+(B2.2.3−RS), (A1)+(B2.2.4), (A1)+(B2.2.4−RS) (A1)+(B2.2.5), (A1)+(B2.2.6), (A1)+(B2.2.7), (A1)+(B2.2.8), (A1)+(B2.3.1), (A1)+(B2.3.2); (A1)+(B2.4.1), (A1)+(B2.4.2.), (A1)+(B2.4.3); (A1)+(B2.5.1), (A1)+(B2.5.2); (A1)+(B2.6.1), (A1)+(B2.6.2), (A1)+(B2.6.3), (A1)+(B2.6.4), (A1)+(B2.6.5), (A1)+(B2.6.6), (A1)+(B2.6.7), (A1)+(B2.6.8), (A1)+(B2.6.9), (A1)+(B2.6.10), (A1)+(B2.6.11), (A1)+(B2.6.12), (A1)+(B2.6.13), (A1)+(B2.6.14), (A1)+(B2.6.15); (A1)+(B3.1.1), (A1)+(B3.1.2), (A1)+(B3.1.3), (A1)+(B3.1.4), (A1)+(B3.1.5), (A1)+(B3.1.6), (A1)+(B3.1.7), (A1)+(B3.1.8), (A1)+(B3.1.9), (A1)+(B3.1.10), (A1)+(B3.1.11); (A1)+(B3.2.1), (A1)+(B3.2.2), (A1)+(B3.2.3); (A1)+(B3.3.1), (A1)+(B3.3.2), (A1)+(B3.3.2−RS), (A1)+(B3.3.3); (A1)+(B3.4.1), (A1)+(B3.4.2), (A1)+(B3.4.3), (A1)+(B3.4.4), (A1)+(B3.4.5), (A1)+(B3.4.6), (A1)+(B3.4.7), (A1)+(B3.4.8), (A1)+(B3.4.9), (A1)+(B3.4.10), (A1)+(B3.4.11), (A1)+(B3.4.12), (A1)+(B3.4.13), (A1)+(B3.4.14), (A1)+(B3.4.15), (A1)+(B3.4.16), (A1)+(B3.4.17), (A1)+(B3.4.18); (A1)+(B3.4.19); (A1)+(B4.1.1), (A1)+(B4.1.2); (A1)+(B4.2.1), (A1)+(B4.2.2); (A1)+(B4.3.1), (A1)+(B4.3.2), (A1)+(B4.3.3), (A1)+(B4.3.4), (A1)+(B4.3.5), (A1)+(B4.3.6); (A1)+(B4.4.1), (A1)+(B4.4.2), (A1)+(B4.4.3), (A1)+(B4.4.4);

(A2)+(B1.1.1), (A2)+(B1.1.2.); (A2)+(B1.2.1), (A2)+(B1.2.2.), (A2)+(B1.2.3); (A2)+(B1.3.1), (A2)+(B1.3.2.), (A2)+(B1.3.3), (A2)+(B1.3.4), (A2)+(B1.3.5), (A2)+(B 1.3.6), (A2)+(B1.3.7), (A2)+(B1.3.8); (A2)+(B1.4.1), (A2)+(B1.4.2), (A2)+(B1.4.3), (A2)+(B1.4.4), (A2)+(B1.4.5); (A2)+(B1.5.1), (A2)+(B1.5.2), (A2)+(B1.5.3), (A2)+(B1.5.4); (A2)+(B1.6.1), (A2)+(B1.6.2), (A2)+(B1.6.3), (A2)+(B1.6.4), (A2)+(B1.6.5), (A2)+(B1.6.6), (A2)+(B1.6.7), (A2)+(B1.6.8), (A2)+(B1.6.9), (A2)+(B1.6.10), (A2)+(B1.6.11), (A2)+(B1.6.12), (A2)+(B1.6.13), (A2)+(B1.6.14), (A2)+(B1.6.15), (A2)+(B1.6.16), (A2)+(B1.6.17), (A2)+(B1.6.18); (A2)+(B1.6.19); (A2)+(B2.1.1), (A2)+(B2.1.2), (A2)+(B2.1.3), (A2)+(B2.1.4), (A2)+(B2.1.6), (A2)+(B2.1.7), (A2)+(B2.1.8), (A2)+(B2.1.9), (A2)+(B2.1.10), (A2)+(B2.1.11), (A2)+(B2.1.12), (A2)+(B2.1.13), (A2)+(B2.1.13); (A2)+(B2.2.1), (A2)+(B2.2.2), (A2)+(B2.2.3), (A2)+(B2.2.3−RS), (A2)+(B2.2.4), (A2)+(B2.2.4−RS) (A2)+(B2.2.5), (A2)+(B2.2.6), (A2)+(B2.2.7), (A2)+(B2.2.8), (A2)+(B2.3.1), (A2)+(B2.3.2); (A2)+(B2.4.1), (A2)+(B2.4.2.), (A2)+(B2.4.3); (A2)+(B2.5.1), (A2)+(B2.5.2); (A2)+(B2.6.1), (A2)+(B2.6.2), (A2)+(B2.6.3), (A2)+(B2.6.4), (A2)+(B2.6.5), (A2)+(B2.6.6), (A2)+(B2.6.7), (A2)+(B2.6.8), (A2)+(B2.6.9), (A2)+(B2.6.10), (A2)+(B2.6.11), (A2)+(B2.6.12), (A2)+(B2.6.13), (A2)+(B2.6.14), (A2)+(B2.6.15); (A2)+(B3.1.1), (A2)+(B3.1.2), (A2)+(B3.1.3), (A2)+(B3.1.4), (A2)+(B3.1.5), (A2)+(B3.1.6), (A2)+(B3.1.7), (A2)+(B3.1.8), (A2)+(B3.1.9), (A2)+(B3.1.10), (A2)+(B3.1.11); (A2)+(B3.2.1), (A2)+(B3.2.2), (A2)+(B3.2.3); (A2)+(B3.3.1), (A2)+(B3.3.2), (A2)+(B3.3.2−RS), (A2)+(B3.3.3); (A2)+(B3.4.1), (A2)+(B3.4.2), (A2)+(B3.4.3), (A2)+(B3.4.4), (A2)+(B3.4.5), (A)+(B3.4.6), (A2)+(B3.4.7), (A2)+(B3.4.8), (A2)+(B3.4.9), (A2)+(B3.4.10), (A2)+(B3.4.11), (A2)+(B3.4.12), (A2)+(B3.4.13), (A2)+(B3.4.14), (A2)+(B3.4.15), (A2)+(B3.4.16), (A2)+(B3.4.17), (A2)+(B3.4.18); (A2)+(B3.4.19); (A2)+(B4.1.1), (A2)+(B4.1.2); (A2)+(B4.2.1), (A2)+(B4.2.2); (A2)+(B4.3.1), (A2)+(B4.3.2), (A2)+(B4.3.3), (A2)+(B4.3.4), (A2)+(B4.3.5), (A2)+(B4.3.6); (A2)+(B4.4.1), (A2)+(B4.4.2), (A2)+(B4.4.3), (A2)+(B4.4.4);

(A3)+(B1.1.1), (A3)+(B1.1.2.); (A3)+(B1.2.1), (A3)+(B1.2.2.), (A3)+(B1.2.3); (A3)+(B1.3.1), (A3)+(B1.3.2.), (A3)+(B1.3.3), (A3)+(B1.3.4), (A3)+(B1.3.5), (A3)+(B1.3.6), (A3)+(B1.3.7), (A3)+(B1.3.8); (A3)+(B1.4.1), (A3)+(B1.4.2), (A3)+(B1.4.3), (A3)+(B1.4.4), (A3)+(B1.4.5); (A3)+(B1.5.1), (A3)+(B1.5.2), (A3)+(B1.5.3), (A3)+(B1.5.4); (A3)+(B1.6.1), (A3)+(B1.6.2), (A3)+(B1.6.3), (A3)+(B1.6.4), (A3)+(B1.6.5), (A3)+(B1.6.6), (A3)+(B1.6.7), (A3)+(B1.6.8), (A3)+(B1.6.9), (A3)+(B1.6.10), (A3)+(B1.6.11), (A3)+(B1.6.12), (A3)+(B1.6.13), (A3)+(B1.6.14), (A3)+(B1.6.15), (A3)+(B1.6.16), (A3)+(B1.6.17), (A3)+(B1.6.18); (A3)+(B1.6.19); (A3)+(B2.1.1), (A3)+(B2.1.2), (A3)+(B2.1.3),,(A3)+(B2.1.4), (A3)+(B2.1.6), (A3)+(B2.1.7), (A3)+(B2.1.8), (A3)+(B2.1.9), (A3)+(B2.1.10), (A3)+(B2.1.11), (A3)+(B2.1.12), (A3)+(B2.1.13), (A3)+(B2.1.13); (A3)+(B2.2.1), (A3)+(B2.2.2), (A3)+(B2.2.3), (A3)+(B2.2.3−RS), (A3)+(B2.2.4), (A3)+(B2.2.4−RS) (A3)+(B2.2.5), (A3)+(B2.2.6), (A3)+(B2.2.7), (A3)+(B2.2.8), (A3)+(B2.3.1), (A3)+(B2.3.2); (A3)+(B2.4.1), (A3)+(B2.4.2.), (A3)+(B2.4.3); (A3)+(B2.5.1), (A3)+(B2.5.2); (A3)+(B2.6.1), (A3)+(B2.6.2), (A3)+(B2.6.3), (A3)+(B2.6.4), (A3)+(B2.6.5), (A3)+(B2.6.6), (A3)+(B2.6.7), (A3)+(B2.6.8), (A3)+(B2.6.9), (A3)+(B2.6.10), (A3)+(B2.6.11), (A3)+(B2.6.12), (A3)+(B2.6.13), (A3)+(B2.6.14), (A3)+(B2.6.15); (A3)+(B3.1.1), (A3)+(B3.1.2), (A3)+(B3.1.3), (A3)+(B3.1.4), (A3)+(B3.1.5), (A3)+(B3.1.6), (A3)+(B3.1.7), (A3)+(B3.1.8), (A3)+(B3.1.9), (A3)+(B3.1.10), (A3)+(B3.1.11); (A3)+(B3.2.1), (A3)+(B3.2.2), (A3)+(B3.2.3); (A3)+(B3.3.1), (A3)+(B3.3.2), (A3)+(B3.3.2−RS), (A3)+(B3.3.3); (A3)+(B3.4.1), (A3)+(B3.4.2), (A3)+(B3.4.3), (A3)+(B3.4.4), (A3)+(B3.4.5), (A3)+(B3.4.6), (A3)+(B3.4.7), (A3)+(B3.4.8), (A3)+(B3.4.9), (A3)+(B3.4.10), (A3)+(B3.4.11), (A3)+(B3.4.12), (A3)+(B3.4.13), (A3)+(B3.4.14), (A3)+(B3.4.15), (A3)+(B3.4.16), (A3)+(B3.4.17), (A3)+(B3.4.18);(A3)+(B3.4.19); (A3)+(B4.1.1), (A3)+(B4.1.2); (A3)+(B4.2.1), (A3)+(B4.2.2); (A3)+(B4.3.1), (A3)+(B4.3.2), (A3)+(B4.3.3), (A3)+(B4.3.4), (A3)+(B4.3.5), (A3)+(B4.3.6); (A3)+(B4.4.1), (A3)+(B4.4.2), (A3)+(B4.4.3), (A3)+(B4.4.4);

(A4)+(B1.1.1), (A4)+(B1.1.2.); (A4)+(B1.2.1), (A4)+(B1.2.2.),(A4)+(B1.2.3); (A4)+(B1.3.1), (A4)+(B1.3.2.), (A4)+(B1.3.3), (A4)+(B1.3.4), (A4)+(B1.3.5), (A4)+(B1.3.6), (A4)+(B1.3.7), (A4)+(B1.3.8); (A4)+(B1.4.1), (A4)+(B1.4.2), (A4)+(B1.4.3), (A4)+(B1.4.4), (A4)+(B1.4.5); (A4)+(B1.5.1), (A4)+(B1.5.2), (A4)+(B1.5.3), (A4)+(B1.5.4); (A4)+(B1.6.1), (A4)+(B1.6.2), (A4)+(B1.6.3), (A4)+(B1.6.4), (A4)+(B1.6.5), (A4)+(B1.6.6), (A4)+(B1.6.7), (A4)+(B1.6.8), (A4)+(B1.6.9), (A4)+(B1.6.10), (A4)+(B1.6.11), (A4)+(B1.6.12), (A4)+(B1.6.13), (A4)+(B1.6.14), (A4)+(B1.6.15), (A4)+(B1.6.16), (A4)+(B1.6.17), (A4)+(B1.6.18); (A4)+(B1.6.19); (A4)+(B2.1.1), (A4)+(B2.1.2), (A4)+(B2.1.3), (A4)+(B2.1.4), (A4)+(B2.1.6), (A4)+(B2.1.7), (A4)+(B2.1.8), (A4)+(B2.1.9), (A4)+(B2.1.10), (A4)+(B2.1.11), (A4)+(B2.1.12), (A4)+(B2.1.13), (A4)+(B2.1.13); (A4)+(B2.2.1), (A4)+(B2.2.2), (A4)+(B2.2.3), (A4)+(B2.2.3−RS), (A4)+(B2.2.4), (A4)+(B2.2.4−RS) (A4)+(B2.2.5), (A4)+(B2.2.6), (A4)+(B2.2.7), (A4)+(B2.2.8), (A4)+(B2.3.1), (A4)+(B2.3.2); (A4)+(B2.4.1), (A4)+(B2.4.2.), (A4)+(B2.4.3); (A4)+(B2.5.1), (A4)+(B2.5.2); (A4)+(B2.6.1), (A4)+(B2.6.2), (A4)+(B2.6.3), (A4)+(B2.6.4), (A4)+(B2.6.5), (A4)+(B2.6.6), (A4)+(B2.6.7), (A4)+(B2.6.8), (A4)+(B2.6.9), (A4)+(B2.6.10), (A4)+(B2.6.11), (A4)+(B2.6.12), (A4)+(B2.6.13), (A4)+(B2.6.14), (A4)+(B2.6.15); (A4)+(B3.1.1), (A4)+(B3.1.2), (A4)+(B3.1.3), (A4)+(B3.1.4), (A4)+(63.1.5), (A4)+(B3.1.6), (A4)+(B3.1.7), (A4)+(B3.1.8), (A4)+(B3.1.9), (A4)+(B3.1.10), (A4)+(B3.1.11); (A4)+(B3.2.1), (A4)+(B3.2.2), (A4)+(B3.2.3); (A4)+(B3.3.1), (A4)+(B3.3.2), (A4)+(B3.3.2−RS), (A4)+(B3.3.3); (A4)+(B3.4.1), (A4)+(B3.4.2), (A4)+(B3.4.3), (A4)+(B3.4.4), (A4)+(B3.4.5), (A4)+(B3.4.6), (A4)+(B3.4.7), (A4)+(B3.4.8), (A4)+(B3.4.9), (A4)+(B3.4.10), (A4)+(B3.4.11), (A4)+(B3.4.12), (A4)+(B3.4.13), (A4)+(B3.4.14), (A4)+(B3.4.15), (A4)+(B3.4.16), (A4)+(B3.4.17), (A4)+(B3.4.18); (A4)+(B3.4.19); (A4)+(B4.1.1), (A4)+(B4.1.2); (A4)+(B4.2.1), (A4)+(B4.2.2); (A4)+(B4.3.1), (A4)+(B4.3.2), (A4)+(B4.3.3), (A4)+(B4.3.4), (A4)+(B4.3.5), (A4)+(B4.3.6); (A4)+(B4.4.1), (A4)+(B4.4.2), (A4)+(B4.4.3), (A4)+(B4.4.4);

(A5)+(B1.1.1), (A5)+(B1.1.2.); (A5)+(B1.2.1), (A5)+(B1.2.2.), (A5)+(B1.2.3); (A5)+(B1.3.1), (A5)+(B1.3.2.), (A5)+(B1.3.3), (A5)+(B1.3.4), (A5)+(B1.3.5), (A5)+(B1.3.6), (A5)+(B1.3.7), (A5)+(B1.3.8); (A5)+(B1.4.1), (A5)+(B1.4.2), (A5)+(B1.4.3), (A5)+(B1.4.4), (A5)+(B1.4.5); (A5)+(B1.5.1), (A5)+(B1.5.2), (A5)+(B1.5.3), (A5)+(B1.5.4); (A5)+(B1.6.1), (A5)+(B1.6.2), (A5)+(B1.6.3), (A5)+(B1.6.4), (A5)+(B1.6.5), (A5)+(B1.6.6), (A5)+(B1.6.7), (A5)+(B1.6.8), (A5)+(B1.6.9),(A5)+(B1.6.10),(A5)+(B1.6.11),(A5)+(B1.6.12),(A5)+(B1.6.13), (A5)+(B1.6.14), (A5)+(B1.6.15), (A5)+(B1.6.16), (A5)+(B1.6.17), (A5)+(B1.6.18); (A5)+(B1.6.19); (A5)+(B2.1.1), (A5)+(B2.1.2), (A5)+(B2.1.3),;(A5)+(B2.1.4), (A5)+(B2.1.6), (A5)+(B2.1.7), (A5)+(B2.1.8), (A5)+(B2.1.9), (A5)+(B2.1.10), (A5)+(B2.1.11), (A5)+(B2.1.12), (A5)+(B2.1.13), (A5)+(B2.1.13); (A5)+(B2.2.1), (A5)+(B2.2.2), (A5)+(B2.2.3), (A5)+(B2.2.3−RS), (A5)+(B2.2.4), (A5)₄(B2.2.4−RS) (A5)+(B2.2.5), (A5)+(B2.2.6), (A5)+(B2.2.7), (A5)+(B2.2.8), (A5)+(B2.3.1), (A5)+(B2.3.2); (A5)+(B2.4.1), (A5)+(B2.4.2.), (A5)+(B2.4.3); (A5)+(B2.5.1), (A5)+(B2.5.2); (A5)+(B2.6.1), (A5)+(B2.6.2), (A5)+(B2.6.3), (A5)+(B2.6.4), (A5)+(B2.6.5), (A5)+(B2.6.6), (A5)+(B2.6.7), (A5)+(B2.6.8), (A5)+(B2.6.9), (A5)+(B2.6.10), (A5)+(B2.6.11), (A5)+(B2.6.12), (A5)+(B2.6.13), (A5)+(B2.6.14), (A5)+(B2.6.15); (A5)+(B3.1.1), (A5)+(B3.1.2), (A5)+(B3.1.3), (A5)+(B3.1.4), (A5)+(B3.1.5), (A5)+(B3.1.6), (A5)+(B3.1.7), (A5)+(B3.1.8), (A5)+(B3.1.9), (A5)+(B3.1.10), (A5)+(B3.1.11); (A5)+(B3.2.1), (A5)+(B3.2.2), (A5)+(B3.2.3); (A5)+(B3.3.1), (A5)+(B3.3.2), (A5)+(B3.3.2−RS), (A5)+(B3.3.3); (A5)+(B3.4.1), (A5)+(B3.4.2), (A:)+(B3.4.3), (A5)+(B3.4.4), (A5)+(B3.4.5), (A5)+(B3.4.6), (A5)+(B3.4.7), (A5)+(B3.4.8), (A5)+(B3.4.9), (A5)+(B3.4.10), (A5)+(B3.4.11), (A5)+(B3.4.12), (A5)+(B3.4.13), (A5)+(B3.4.14), (A5)+(B3.4.15), (A5)+(B3.4.16), (A5)+(B3.4.17), (A5)+(B3.4.18); (A5)+(B3.4.19); (A5)+(B4.1.1), (A5)+(B4.1.2); (A5)+(B4.2.1), (A5)+(B4.2.2); (A5)+(B4.3.1), (A5)+(B4.3.2), (A5)+(B4.3.3), (A5)+(B4.3.4), (A5)+(B4.3.5), (A5)+(B4.3.6); (A5)+(B4.4.1), (A5)+(B4.4.2), (A5)+(B4.4.3), (A5)+(B4.4.4);

(A6)+(B1.1.1), (A6)+(B1.1.2.); (A6)+(B1.2.1), (A6)+(B1.2.2.), (A6)+(B1.2.3); (A6)+(B1.3.1), (A6)+(B1.3.2.), (A6)+(B1.3.3), (A6)+(B1.3.4), (A6)+(B1.3.5), (A6)+(B1.3.6), (A6)+(B1.3.7), (A6)+(B1.3.8); (A6)+(B1.4.1), (A6)+(B1.4.2), (A6)+(B1.4.3), (A6)+(B1.4.4), (A6)+(B1.4.5); (A6)+(B1.5.1), (A6)+(B1.5.2), (A6)+(B1.5.3), (A6)+(B1.5.4); (A6)+(B1.6.1), (A6)+(B1.6.2), (A6)+(B1.6.3), (A6)+(B1.6.4), (A6)+(B1.6.5), (A6)+(B1.6.6), (A6)+(B1.6.7), (A6)+(B1.6.8), (A6)+(B1.6.9), (A6)+(B1.6.10), (A6)+(B1.6.11), (A6)+(B1.6.12), (A6)+(B1.6.13), (A6)+(B1.6.14), (A6)+(B1.6.15), (A6)+(B1.6.16), (A6)+(B1.6.17), (A6)+(B1.6.18); (A6)+(B1.6.19); (A6)+(B2.1.1), (A6)+(B2.1.2), (A6)+(B2.1.3), (A6)+(B2.1.4), (A6)+(B2.1.6), (A6)+(B2.1.7), (A6)+(B2.1.8), (A6)+(B2.1.9), (A6)+(B2.1.10), (A6)+(B2.1.11), (A6)+(B2.1.12), (A6)+(B2.1.13), (A6)+(B2.1.13); (A6)+(B2.2.1), (A6)+(B2.2.2), (A6)+(B2.2.3), (A6)+(B2.2.3−RS), (A6)+(B2.2.4), (A6)+(B2.2.4−RS) (A6)+(B2.2.5), (A6)+(B2.2.6), (A6)+(B2.2.7), (A6)+(B2.2.8), (A6)+(B2.3.1), (A6)+(B2.3.2); (A6)+(B2.4.1), (A6)+(B2.4.2.), (A6)+(B2.4.3); (A6)+(B2.5.1), (A6)+(B2.5.2); (A6)+(B2.6.1), (A6)+(B2.6.2), (A6)+(B2.6.3), (A6)+(B2.6.4), (A6)+(B2.6.5), (A6)+(B2.6.6), (A6)+(B2.6.7), (A6)+(B2.6.8), (A6)+(B2.6.9), (A6)+(B2.6.10), (A6)+(B2.6.11), (A6)+(B2.6.12), (A6)+(B2.6.13), (A6)+(B2.6.14), (A6)+(B2.6.15); (A6)+(B3.1.1), (A6)+(B3.1.2), (A6)+(B3.1.3), (A6)+(B3.1.4), (A6)+(B3.1.5), (A6)+(B3.1.6), (A6)+(B3.1.7), (A6)+(B3.1.8), (A6)+(B3.1.9), (A6)+(B3.1.10), (A6)+(B3.1.11); (A6)+(B3.2.1), (A6)+(B3.2.2), (A6)+(B3.2.3); (A6)+(B3.3.1), (A6)+(B3.3.2), (A6)+(B3.3.2−RS), (A6)+(B3.3.3); (A6)+(B3.4.1), (A6)+(B3.4.2), (A6)+(B3.4.3), (A6)+(B3.4.4), (A6)+(B3.4.5), (A6)+(B3.4.6), (A6)+(B3.4.7), (A6)+(B3.4.8), (A6)+(B3.4.9), (A6)+(B3.4.10), (A6)+(B3.4.11), (A6)+(B3.4.12), (A6)+(B3.4.13), (A6)+(B3.4.14), (A6)+(B3.4.15), (A6)+(B3.4.16), (A6)+(B3.4.17), (A6)+(B3.4.18); (A6)+(B3.4.19); (A6)+(B4.1.1), (A6)+(B4.1.2); (A6)+(B4.2.1), (A6)+(B4.2.2); (A6)+(B4.3.1), (A6)+(B4.3.2), (A6)+(B4.3.3), (A6)+(B4.3.4), (A6)+(B4.3.5), (A6)+(B4.3.6); (A6)+(B4.4.1), (A6)+(B4.4.2), (A6)+(B4.4.3), (A6)+(B4.4.4);

(A7)+(B1.1.1), (A7)+(B1.1.2.); (A7)+(B1.2.1), (A7)+(B1.2.2.), (A7)+(B1.2.3); (A7)+(B1.3.1), (A7)+(B1.3.2.), (A7)+(B1.3.3), (A7)+(B1.3.4), (A7)+(B1.3.5), (A7)+(B1.3.6), (A7)+(B1.3.7), (A7)+(B1.3.8); (A7)+(B1.4.1), (A7)+(B1.4.2), (A7)+(B1.4.3), (A7)+(B1.4.4), (A7)+(B1.4.5); (A7)+(B1.5.1), (A7)+(B1.5.2), (A7)+(B1.5.3), (A7)+(B1.5.4); (A7)+(B1.6.1), (A7)+(B1.6.2), (A7)+(B1.6.3), (A7)+(B1.6.4), (A7)+(B1.6.5), (A7)+(B1.6.6), (A7)+(B1.6.7), (A7)+(B1.6.8), (A7)+(B1.6.9), (A7)+(B1.6.10), (A7)+(B1.6.11), (A7)+(B1.6.12), (A7)+(B1.6.13), (A7)+(B1.6.14), (A7)+(B1.6.15), (A7)+(B1.6.16), (A7)+(B1.6.17), (A7)+(B1.6.18); (A7)+(B1.6.19); (A7)+(B2.1.1), (A7)+(B2.1.2), (A7)+(B2.1.3), (A7)+(B2.1.4), (A7)+(B2.1.6), (A7)+(B2.1.7), (A7)+(B2.1.8), (A7)+(B2.1.9), (A7)+(B2.1.10), (A7)+(B2.1.11), (A7)+(B2.1.12), (A7)+(B2.1.13), (A7)+(B2.1.13); (A7)+(B2.2.1), (A7)+(B2.2.2), (A7)+(B2.2.3), (A7)+(B2.2.3−RS), (A7)+(B2.2.4), (A7)+(B2.2.4−RS) (A7)+(B2.2.5), (A7)+(B2.2.6), (A7)+(B2.2.7), (A7)+(B2.2.8), (A7)+(B2.3.1), (A7)+(B2.3.2); (A7)+(B2.4.1), (A7)+(B2.4.2.), (A7)+(B2.4.3); (A7)+(B2.5.1), (A7)+(B2.5.2); (A7)+(B2.6.1), (A7)+(B2.6.2), (A7)+(B2.6.3), (A7)+(B2.6.4), (A7)+(B2.6.5), (A7)+(B2.6.6), (A7)+(B2.6.7), (A7)+(B2.6.8), (A7)+(B2.6.9), (A7)+(B2.6.10), (A7)+(B2.6.11), (A7)+(B2.6.12), (A7)+(B2.6.13), (A7)+(B2.6.14), (A7)+(B2.6.15); (A7)+(B3.1.1), (A7)+(B3.1.2), (A7)+(B3.1.3), (A7)+(B3.1.4), (A7)+(B3.1.5), (A7)+(B3.1.6), (A7)+(B3.1.7), (A7)+(B3.1.8), (A7)+(B3.1.9), (A7)+(B3.1.10), (A7)+(B3.1.11); (A7)+(B3.2.1), (A7)+(B3.2.2), (A7)+(B3.2.3); (A7)+(B3.3.1), (A7)+(B3.3.2), (A7)+(B3.3.2−RS), (A7)+(B3.3.3); (A7)+(B3.4.1), (A7)+(B3.4.2), (A7)+(B3.4.3), (A7)+(B3.4.4), (A7)+(B3.4.5), (A7)+(B3.4.6), (A7)+(B3.4.7), (A7)+(B3.4.8), (A7)+(B3.4.9), (A7)+(B3.4.10), (A7)+(B3.4.11), (A7)+(B3.4.12), (A7)+(B3.4.13), (A7)+(B3.4.14), (A7)+(B3.4.15), (A7)+(B3.4.16), (A7)+(B3.4.17), (A7)+(B3.4.18); (A7)+(B3.4.19); (A7)+(B4.1.1), (A7)+(B4.1.2); (A7)+(B4.2.1), (A7)+(B4.2.2); (A7)+(B4.3.1), (A7)+(B4.3.2), (A7)+(B4.3.3), (A7)+(B4.3.4), (A7)+(B4.3.5), (A7)+(B4.3.6); (A7)+(B4.4.1), (A7)+(B4.4.2), (A7)+(B4.4.3), (A7)+(B4.4.4);

(A8)+(B1.1.1), (A8)+(B1.1.2.); (A8)+(B1.2.1), (A8)+(B1.2.2.), (A8)+(B1.2.3); (A8)+(B1.3.1), (A8)+(B1.3.2.), (A8)+(B1.3.3), (A8)+(B1.3.4), (A8)+(B1.3.5), (A8)+(B1.3.6), (A8)+(B1.3.7), (A8)+(B1.3.8); (A8)+(B1.4.1), (A8)+(B1.4.2), (A8)+(B1.4.3), (A8)+(B1.4.4), (A8)+(B1.4.5); (A8)+(B1.5.1), (A8)+(B1.5.2), (A8)+(B1.5.3), (A8)+(B1.5.4); (A8)+(B1.6.1), (A8)+(B1.6.2), (A8)+(B1.6.3), (A8)+(B1.6.4), (A8)+(B1.6.5), (A8)+(B1.6.6), (A8)+(B1.6.7), (A8)+(B1.6.8), (A8)+(B1.6.9), (A8)+(B1.6.10), (A8)+(B1.6.11), (A8)+(B1.6.12), (A8)+(B1.6.13), (A8)+(B1.6.14), (A8)+(B1.6.15), (A8)+(B1.6.16), (A8)+(B1.6.17), (A8)+(B1.6.18); (A8)+(B1.6.19); (A8)+(B2.1.1), (A8)+(B2.1.2), (A8)+(B2.1.3), (A8)+(B2.1.4), (A8)+(B2.1.6), (A8)+(B2.1.7), (A8)+(B2.1.8), (A8)+(B2.1.9), (A8)+(B2.1.10), (A8)+(B2.1.11), (A8)+(B2.1.12), (A8)+(B2.1.13), (A8)+(B2.1.13); (A8)+(B2.2.1), (A8)+(B2.2.2), (A8)+(B2.2.3), (A8)+(B2.2.3−RS), (A8)+(B2.2.4), (A8)+(B2.2.4−RS) (A8)+(B2.2.5), (A8)+(B2.2.6), (A8)+(B2.2.7), (A8)+(B2.2.8), (A8)+(B2.3.1), (A8)+(B2.3.2); (A8)+(B2.4.1), (A8)+(B2.4.2.), (A8)+(B2.4.3); (A8)+(B2.5.1), (A8)+(B2.5.2); (A8)+(B2.6.1), (A8)+(B2.6.2), (A8)+(B2.6.3), (A8)+(B2.6.4), (A8)+(B2.6.5), (A8)+(B2.6.6), (A8)+(B2.6.7), (A8)+(B2.6.8), (A8)+(B2.6.9), (A8)+(B2.6.10), (A8)+(B2.6.11), (A8)+(B2.6.12), (A8)+(B2.6.13), (A8)+(B2.6.14), (A8)+(B2.6.15); (A8)+(B3.1.1), (A8)+(B3.1.2), (A8)+(B3.1.3),(A8)+(B3.1.4), (A8)+(B3.1.5), (A8)+(B3.1.6), (A8)+(B3.1.7), (A8)+(B3.1.8), (A8)+(B3.1.9), (A8)+(B3.1.10), (A8)+(B3.1.11); (A8)+(B3.2.1), (A8)+(B3.2.2), (A8)+(B3.2.3); (A8)+(B3.3.1), (A8)+(B3.3.2), (A8)+(B3.3.2−RS), (A8)+(B3.3.3); (A8)+(B3.4.1), (A8)+(B3.4.2), (A8)+(B3.4.3), (A8)+(B3.4.4), (A8)+(B3.4.5), (A8)+(B3.4.6), (A8)+(B3.4.7), (A8)+(B3.4.8), (A8)+(B3.4.9), (A8)+(B3.4.10), (A8)+(B3.4.11), (A8)+(B3.4.12), (A8)+(B3.4.13), (A8)+(B3.4.14), (A8)+(B3.4.15), (A8)+(B3.4.16), (A8)+(B3.4.17), (A8)+(B3.4.18); (A8)+(B3.4.19); (A8)+(B4.1.1), (A8)+(B4.1.2); (A8)+(B4.2.1), (A8)+(B4.2.2); (A8)+(B4.3.1), (A8)+(B4.3.2), (A8)+(B4.3.3), (A8)+(B4.3.4), (A8)+(B4.3.5), (A8)+(B4.3.6); (A8)+(B4.4.1), (A8)+(B4.4.2), (A8)+(B4.4.3), (A8)+(B4.4.4);

(A9)+(B1.1.1), (A9)+(B1.1.2.); (A9)+(B1.2.1), (A9)+(B1.2.2.), (A9)+(B1.2.3); (A9)+(B1.3.1), (A9)+(B1.3.2.), (A9)+(B1.3.3), (A9)+(B1.3.4), (A9)+(B1.3.5), (A9)+(B1.3.6), (A9)+(B1.3.7), (A9)+(B1.3.8); (A9)+(B1.4.1), (A9)+(B1.4.2), (A9)+(B1.4.3), (A9)+(B1.4.4), (A9)+(B1.4.5); (A9)+(B1.5.1), (A9)+(B1.5.2), (A9)+(B1.5.3), (A9)+(B1.5.4); (A9)+(B1.6.1), (A9)+(B1.6.2), (A9)+(B1.6.3), (A9)+(B1.6.4), (A9)+(B1.6.5), (A9)+(B1.6.6), (A9)+(B1.6.7), (A9)+(B1.6.8), (A9)+(B1.6.9), (A9)+(B1.6.10), (A9)+(B1.6.11), (A9)+(B1.6.12), (A9)+(B1.6.13), (A9)+(B1.6.14), (A9)+(B1.6.15), (A9)+(B1.6.16), (A9)+(B1.6.17), (A9)+(B1.6.18); (A9)+(B1.6.19); (A9)+(B2.1.1), (A9)+(B2.1.2), (A9)+(B2.1.3), (A9)+(B2.1.4), (A9)+(B2.1.6), (A9)+(B2.1.7), (A9)+(B2.1.8), (A9)+(B2.1.9), (A9)+(B2.1.10), (A9)+(B2.1.11), (A9)+(B2.1.12), (A9)+(B2.1.13), (A9)+(B2.1.13); (A9)+(B2.2.1), (A9)+(B2.2.2), (A9)+(B2.2.3), (A9)+(B2.2.3−RS), (A9)+(B2.2.4), (A9)+(B2.2.4−RS) (A9)+(B2.2.5), (A9)+(B2.2.6), (A9)+(B2.2.7), (A9)+(B2.2.8), (A9)+(B28.3.1), (A9)+(B2.3.2); (A9)+(B2.4.1), (A9)+(B2.4.2.), (A9)+(B2.4.3); (A9)+(B2.5.1), (A9)+(B2.5.2); (A9)+(B2.6.1), (A9)+(B2.6.2), (A9)+(B2.6.3), (A9)+(B2.6.4), (A9)+(B2.6.5), (A9)+(B2.6.6), (A9)+(B2.6.7), (A9)+(B2.6.8), (A9)+(B2.6.9), (A9)+(B2.6.10), (A9)+(B2.6.11), (A9)+(B2.6.12), (A9)+(B2.6.3), (A9)+(B2.6.14), (A9)+(B2.6.15); (A9)+(B3.1.1), (A9)+(B3.1.2), (A9)+(B3.1.3),(A9)+(B3.1.4), (A9)+(B3.1.5), (A9)+(B3.1.6), (A9)+(B3.1.7), (A9)+(B3.1.8), (A9)+(B3.1.9), (A9)+(B3.1.10), (A9)+(B3.1.11); (A9)+(B3.2.1), (A9)+(B3.2.2), (A9)+(B3.2.3); (A9)+(B3.3.1), (A9)+(B3.3.2), (A9)+(B3.3.2−RS), (A9)+(B3.3.3); (A9)+(B3.4.1), (A9)+(B3.4.2), (A9)+(B3.4.3), (A9)+(B3.4.4), (A9)+(B3.4.5), (A9)+(B3.4.6), (A9)+(B3.4.7), (A9)+(B3.4.8), (A9)+(B3.4.9), (A9)+(B3.4.10), (A9)+(B3.4.11), (A9)+(B3.4.12), (A9)+(B3.4.13), (A9)+(B3.4.14), (A9)+(B3.4.15), (A9)+(B3.4.16), (A9)+(B3.4.17), (A9)+(B3.4.18); (A9)+(B3.4.19); (A9)+(B4.1.1), (A9)+(B4.1.2); (A9)+(B4.2.1), (A9)+(B4.2.2); (A9)+(B4.3.1), (A9)+(B4.3.2), (A9)+(B4.3.3), (A9)+(B4.3.4), (A9)+(B4.3.5), (A9)+(B4.3.6); (A9)+(B4.4.1), (A9)+(B4.4.2), (A9)+(B4.4.3), (A9)+(B4.4.4);

(A10)+(B1.1.1), (A10)+(B1.1.2.); (A10)+(B1.2.1), (A10)+(B1.2.2.), (A10)+(B1.2.3); (A10)+(B1.3.1), (A10)+(B1.3.2.), (A10)+(B1.3.3), (A10)+(B1.3.4), (A10)+(B1.3.5), (A10)+(B1.3.6), (A10)+(B1.3.7), (A10)+(B1.3.8); (A10)+(B1.4.1), (A10)+(B1.4.2), (A10)+(B1.4.3), (A10)+(B1.4.4), (A10)+(B1.4.5); (A10)+(B1.5L1), (A10)+(B1.5.2), (A10)+(B1.5.3), (A10)+(B1.5.4); (A10)+(B1.6.1), (A10)+(B1.6.2), (A10)+(B1.6.3), (A10)+(B1.6.4), (A10)+(B1.6.5), (A10)+(B1.6.6), (A10)+(B1.6.7), (A10)+(B1.6.8), (A10)+(B1.6.9), (A10)+(B1.6.10), (A10)+(B1.6.11), (A10)+(B1.6.12), (A10)+(B1.6.13), (A10)+(B1.6.14), (A10)+(B1.6.15), (A10)+(B1.6.16), (A10)+(B1.6.17), (A10)+(B1.6.18); (A10)+(B1.6.19); (A10)+(B2.1.1), (A10)+(B2.1.2), (A10)+(B2.1.3), (A10)+(B2.1.4), (A10)+(B2.1.6), (A10)+(B2.1.7), (A10)+(B2.1.8), (A10)+(B2.1.9), (A10)+(B2.1.10), (A10)+(B2.1.11), (A10)+(B2.1.12), (A10)+(B2.1.13), (A10)+(B2.1.13); (A10)+(B2.2.1), (A10)+(B2.2.2), (A10)+(B2.2.3), (A10)+(B2.2.3−RS), (A10)+(B2.2.4), (A10)+(B2.2.4−RS) (A10)+(B2.2.5), (A10)+(B2.2.6), (A10)+(B2.2.7), (A10)+(B2.2.8), (A10)+(B2.3.1), (A10)+(B2.3.2); (A10)+(B2.4.1), (A10)+(B2.4.2.), (A10)+(B2.4.3); (A10)+(B2.5.1), (A10)+(B2.5.2); (A10)+(B2.6.1), (A10)+(B2.6.2), (A10)+(B2.6.3), (A10)+(B2.6.4), (A10)+(B2.6.5), (A10)+(B2.6.6), (A10)+(B2.6.7), (A10)+(B2.6.8), (A10)+(B2.6.9), (A10)+(B2.6.10), (A10)+(B2.6.11), (A10)+(B2.6.12), (A10)+(B2.6.13), (A10)+(B2.6.14), (A10)+(B2.6.15); (A10)+(B3.1.1), (A10)+(B3.1.2), (A10)+(B3.1.3), (A10)+(B3.1.4), (A10)+(B3.1.5), (A10)+(B3.1.6), (A10)+(B3.1.7), (A10)+(B3.1.8), (A10)+(B3.1.9), (A10)+(B3.11.10), (A10)+(B3.1.11); (A10)+(B3.2.1), (A10)+(B3.2.2), (A10)+(B3.2.3); (A10)+(B3.3.1), (A10)+(B3.3.2), (A10)+(B3.3.2−RS), (A10)+(B3.3.3); (A10)+(B3.4.1), (A10)+(B3.4.2), (A10)+(B3.4.3), (A10)+(B3.4.4), (A10)+(B3.4.5), (A10)+(B3.4.6), (A10)+(B3.4.7), (A10)+(B3.4.8), (A10)+(B3.4.9), (A10)+(B3.4.10), (A10)+(B3.4.11), (A10)+(B3.4.12), (A10)+(B3.4.13), (A10)+(B3.4.14), (A10)+(B3.4.15), (A10)+(B3.4.16), (A10)+(B3.4.17), (A10)+(B3.4.18); (A10)+(B3.4.19); (A10)+(B4.1.1), (A10)+(B4.1.2); (A10)+(B4.2.1), (A10)+(B4.2.2); (A10)+(B4.3.1), (A10)+(B4.3.2), (A10)+(B4.3.3), (A10)+(B4.3.4), (A10)+(B4.3-0.5), (A10)+(B4.3.6); (A10)+(B4.4.1), (A10)+(B4.4.2), (A10)+(B4.4.3), (A10)+(B4.4.4);

(A11)+(B1.1.1), (A11)+(B1.1.2.); (A11)+(B1.2.1), (A11)+(B1.2.2.), (A11)+(B1.2.3); (A11)+(B1.3.1), (A11)+(B1.3.2.), (A11)+(B1.3.3), (A11)+(B1.3.4), (A11)+(B1.3.5), (A11)+(B1.3.6), (A11)+(B1.3.7), (A11)+(B1.3.8); (A11)+(B1.4.1), (A11)+(B1.4.2), (A11)+(B1.4.3), (A11)+(B1.4.4), (A11)+(B1.4.5); (A11)+(B1.5.1), (A11)+(B1.5.2), (A11)+(B1.5.3), (A11)+(B1.5.4); (A11)+(B1.6.1), (A11)+(B1.6.2), (A11)+(B1.6.3), (A11)+(B1.6.4), (A11)+(B1.6.5), (A11)+(B1.6.6), (A11)+(B1.6.7), (A11)+(B1.6.8), (A11)+(B1.6.9), (A11)+(B1.6.10), (A11)+(B1.6.11), (A11)+(B1.6.12), (A11)+(B1.6.13), (A11)+(B1.6.14), (A11)+(B1.6.15), (A11)+(B1.6.16), (A11)+(B1.6.17), (A11)+(B1.6.18); (A11)+(B1.6.19); (A11)+(B2.1.1), (A11)+(B2.1.2), (A11)+(B2.1.3), (A11)+(B2.1.4), (A11)+(B2.1.6), (A11)+(B2.1.7), (A11)+(B2.1.8), (A11)+(B2.1.9), (A11)+(B2.1.10), (A11)+(B2.11.11), (A11)+(B2.1.12), (A11)+(B2.1.13), (A11)+(B2.1.13); (A11)+(B2.2.1), (A11)+(B2.2.2), (A11)+(B2.2.3), (A11)+(B2.2.3−RS), (A11)+(B2.2.4), (A11)+(B2.2.4−RS) (A11)+(B2.2.5), (A11)+(B2.2.6), (A11)+(B2.2.7), (A11)+(B2.2.8), (A11)+(B2.3.1), (A11)+(B2.3.2); (A11)+(B2.4.1), (A11)+(B2.4.2.), (A11)+(B2.4.3); (A11)+(B2.5.1), (A11)+(B2.5.2); (A11)+(B2.6.1), (A11)+(B2.6.2), (A11)+(B2.6.3), (A11)+(B2.6.4), (A11)+(B2.6.5), (A11)+(B2.6.6), (A11)+(B2.6.7), (A11)+(B2.6.8), (A11)+(B2.6.9), (A11)+(B2.6.10), (A11)+(B2.6.11), (A11)+(B2.6.12), (A11)+(B2.6.13), (A11)+(B2.6.14), (A11)+(B2.6.15); (A11)+(B3.1.1), (A11)+(B3.1.2), (A11)+(B3.1.3), (A11)+(B3.1.4), (A11)+(B3.1.5), (A11)+(B3.1.6), (A11)+(B3.1.7), (A11)+(B3.1.8), (A11)+(B3.1.9), (A11)+(B3.11.10), (A11)+(B3.1.11); (A11)+(B3.2.1), (A11)+(B3.2.2), (A11)+(B3.2.3); (A11)+(B3.3.1), (A11)+(B3.3.2), (A11)+(B3.3.2−RS), (A11)+(B3.3.3); (A11)+(B3.4.1), (A11)+(B3.4.2), (A11)+(B3.4.3), (A11)+(B3.4.4), (A11)+(B3.4:.5), (A11)+(B3.4.6), (A11)+(B3.4.7), (A11)+(B3.4.8), (A11)+(B3.4.9), (A11)+(B3.4.10), (A11)+(B3.4.11), (A11)+(B3.4.12), (A11)+(B3.4.13), (A11)+(B3.4.14), (A11)+(B3.4.15), (A11)+(B3.4.16), (A11)+(B3.4.17), (A11)+(B3.4.18); (A11)+(B3.4.19); (A11)+(B4.1.1), (A11)+(B4.1.2); (A11)+(B4.2.1), (A11)+(B4.2.2); (A11)+(B4.3.1), (A11)+(B4.3.2), (A11)+(B4.3.3), (A11)+(B4.3.4), (A11)+(B4.3.5), (A11)+(B4.3.6); (A11)+(B4.4.1), (A11)+(B4.4.2), (A11)+(B4.4.3), (A11)+(B4.4.4);

(A12)+(B1.1.1), (A12)+(B1.1.2.); (A12)+(B1.2.1), (A12)+(B1.2.2.), (A12)+(B1.2.3); (A12)+(B1.3.1), (A12)+(B1.3.2.), (A12)+(B1.3.3), (A12)+(B1.3.4), (A12)+(B1.3.5), (A12)+(B1.3.6), (A12)+(B1.3.7), (A12)+(B1.3.8); (A12)+(B1.4.1), (A12)+(B1.4.2), (A12)+(B1.4.3), (A12)+(B1.4.4), (A12)+(B1.4.5); (A12)+(B1.5.1), (A12)+(B1.5.2), (A12)+(B1.5.3), (A12)+(B1.5.4); (A12)+(B1.6.1), (A12)+(B1.6.2), (A12)+(B1.6.3), (A12)+(B1.6.4), (A12)+(B1.6.5), (A12)+(B1.6.6), (A12)+(B1.6.7), (A12)+(B1.6.8), (A12)+(B1.6.9), (A12)+(B1.6.10), (A12)+(B1.6.11), (A12)+(B1.6.12), (A12)+(B1.6.13), (A12)+(B1.6.14), (A12)+(B1.6.15), (A12)+(B1.6.16), (A12)+(B1.6.17), (A12)+(B1.6.18); (A12)+(B1.6.19); (A12)+(B2.1.1), (A12)+(B2.1.2), (A12)+(B2.1.3), (A12)+(B2.1.4), (A12)+(B2.1.6), (A12)+(B2.1.7), (A12)+(B2.1.8), (A12)+(B2.1.9), (A12)+(B2.1.10), (A12)+(B2.11.11), (A12)+(B2.1.12), (A12)+(B2.1.13), (A12)+(B2.1.13); (A12)+(B2.2.1), (A12)+(B2.2.2), (A12)+(B2.2.3), (A12)+(B2.2.3−RS), (A12)+(B2.2.4), (A12)+(B2.2.4−RS) (A12)+(B2.2.5), (A12)+(B2.2.6), (A12)+(B2.2.7), (A12)+(B2.2.8), (A12)+(B2.3.1), (A12)+(B2.3.2); (A12)+(B2.4.1), (A12)+(B2.4.2.), (A12)+(B2.4.3); (A12)+(B2.5.1), (A12)+(B2.5.2); (A12)+(B2.6.1), (A12)+(B2.6.2), (A12)+(B2.6.3), (A12)+(B2.6.4), (A12)+(B2.6.5), (A12)+(B2.6.6), (A12)+(B2.6.7), (A12)+(B2.6.8), (A12)+(B2.6.9), (A12)+(B2.6.10), (A12)+(B2.6.11), (A12)+(B2.6.12), (A12)+(B2.6.13), (A12)+(B2.6.14), (A12)+(B2.6.15); (A12)+(B3.1.1), (A12)+(B3.1.2), (A12)+(B3.1.3), (A12)+(B3.1.4), (A12)+(B3.1.5), (A12)+(B3.1.6), (A12)+(B3.1.7), (A12)+(B3.1-0.8), (A12)+(B3.1.9), (A12)+(B3.1.10), (A12)+(B3.1.11); (A12)+(B3.2.1), (A12)+(B3.2.2), (A12)+(B3.2.3); (A12)+(B3.3.1), (A12)+(B3.3.2), (A12)+(B3.3.2−RS), (A12)+(B3.3.3); (A12)+(B3.4.1), (A12)+(B3.4.2), (A12)+(B3.4.3), (A12)+(B3.4.4), (A12)+(B3.4.5), (A12)+(B3.4.6), (A12)+(B3.4.7), (A12)+(B3.4.8), (A12)+(B3.4.9), (A12)+(B3.4.10), (A12)+(B3.4.111), (A12)+(B3.4.12), (A12)+(B3.4.13), (A12)+(B3.4.14), (A12)+(B3.4.15), (A12)+(B3.4.16), (A12)+(B3.4.17), (A12)+(B3.4.18); (A12)+(B3.4.19); (A12)+(B4.1.1), (A12)+(B4.1.2); (A12)+(B4.2.1), (A12)+(B4.2.2); (A12)+(B4.3.1), (A12)+(B4.3.2), (A12)+(B4.3.3), (A12)+(B4.3.4), (A12)+(B4.3.5), (A12)+(B4.3.6); (A12)+(B4.4.1), (A12)+(B4.4.2), (A12)+(B4.4.3), (A12)+(B4.4.4);

(A13)+(B1.1.1), (A13)+(B1.1.2.); (A13)+(B1.2.1), (A13)+(B1.2.2.), (A13)+(B1.2.3); (A13)+(B1.3.1), (A13)+(B1.3.2.), (A13)+(B1.3.3), (A13)+(B1.3.4), (A13)+(B1.3.5), (A13)+(B1.3.6), (A13)+(B1.3.7), (A13)+(B1.3.8); (A13)+(B1.4.1), (A13)+(B1.4.2), (A13)+(B1.4.3), (A13)+(B1.4.4), (A13)+(B1.4.5); (A13)+(B1.5.1), (A13)+(B1.5.2), (A13)+(B1.5.3), (A13)+(B1.5.4); (A13)+(B1.6.1), (A13)+(B1.6.2), (A13)+(B1.6.3), (A13)+(B1.6.4), (A13)+(B1.6.5), (A13)+(B1.6.6), (A13)+(B1.6.7), (A13)+(B1.6.8), (A13)+(B1.6.9), (A13)+(B1.6.10), (A13)+(B1.6.11), (A13)+(B1.6.12), (A13)+(B1.6.13), (A13)+(B1.6.14), (A13)+(B1.6.15), (A13)+(B1.6.16), (A13)+(B1.6.17), (A13)+(B1.6.18); (A13)+(B1.6.19); (A13)+(B2.1.1), (A13)+(B2.1.2), (A13)+(B2.1.3), (A13)+(B2.1.4), (A13)+(B2.1.6), (A13)+(B2.1.7), (A13)+(B2.1.8), (A13)+(B2.1.9), (A13)+(B2.1.10), (A13)+(B2.1.11), (A13)+(B2.1.12), (A13)+(B2.1.13), (A13)+(B2.1.13); (A13)+(B2.2.1), (A13)+(B2.2.2), (A13)+(B2.2.3), (A13)+(B2.2.3−RS), (A13)+(B2.2.4), (A13)+(B2.2.4−RS) (A13)+(B2.2.5), (A13)+(B2.2.6), (A13)+(B2.2.7), (A13)+(B2.2.8), (A13)+(B2.3.1), (A13)+(B2.3.2); (A13)+(B2.4.1), (A13)+(B2.4.2.), (A13)+(B2.4.3); (A13)+(B2.5.1), (A13)+(B2.5.2); (A13)+(B2.6.1), (A13)+(B2.6.2), (A13)+(B2.6.3), (A13)+(B2.6.4), (A13)+(B2.6.5), (A13)+(B2.6.6), (A13)+(B2.6.7), (A13)+(B2.6.8), (A13)+(B2.6.9), (A13)+(B2.6.10), (A13)+(B2.6.11), (A13)+(B2.6.12), (A13)+(B2.6.13), (A13)+(B2.6.14), (A13)+(B2.6.15); (A13)+(B3.1.1), (A13)+(B3.1.2), (A13)+(B3.1.3), (A13)+(B3.1.4), (A13)+(B3.1.5), (A13)+(B3.1.6), (A13)+(B3.1.7), (A13)+(B3.1.8), (A13)+(B3.1.9), (A13)+(B3.11.10), (A13)+(B3.11.11); (A13)+(B3.2.1), (A13)+(B3.2.2), (A13)+(B3.2.3); (A13)+(B3.3.1), (A13)+(B3.3.2), (A13)+(B3.3.2−RS), (A13)+(B3.3.3); (A13)+(B3.4.1), (A13)+(B3.4.2), (A13)+(B3.4.3), (A13)+(B3.4.4), (A13)+(B3.4.5), (A13)+(B3.4.6), (A13)+(B3.4.7), (A13)+(B3.4.8), (A13)+(B3.4.9), (A13)+(B3.4.10), (A13)+(B3.4.11), (A13)+(B3.4.12), (A13)+(B3.4.13), (A13)+(B3.4.14), (A13)+(B3.4.15), (A13)+(B3.4.16), (A13)+(B3.4.17), (A13)+(B3.4.18); (A13)+(B3.4.19); (A13)+(B4.1.1), (A13)+(B4.1.2); (A13)+(B4.2.1), (A13)+(B4.2.2); (A13)+(B4.3.1), (A13)+(B4.3.2), (A13)+(B4.3.3), (A13)+(B4.3.4), (A13)+(B4.3.5), (A13)+(B4.3.6); (A13)+(B4.4.1), (A13)+(B4.4.2), (A13)+(B4.4.3), (A13)+(B4.4.4);

(A14)+(B1.1.1), (A14)+(B1.1.2.); (A14)+(B1.2.1), (A14)+(B1.2.2.), (A14)+(B1.2.3); (A14)+(B1.3.1), (A14)+(B1.3.2.), (A14)+(B1.3.3), (A14)+(B1.3.4), (A14)+(B1.3.5), (A14)+(B1.3.6), (A14)+(B1.3.7), (A14)+(B1.3.8); (A14)+(B1.4.1), (A14)+(B1.4.2), (A14)+(B1.4.3), (A14)+(B1.4.4), (A14)+(B1.4.5); (A14)+(B1.5.1), (A14)+(B1.5.2), (A14)+(B1.5.3), (A14)+(B1.5.4); (A14)+(B1.6.1), (A14)+(B1.6.2), (A14)+(B1.6.3), (A14)+(B1.6.4), (A14)+(B1.6.5), (A14)+(B1.6.6), (A14)+(B1.6.7), (A14)+(B1.6.8), (A14)+(B1.6.9), (A14)+(B1.6.10), (A14)+(B1.6.11), (A14)+(B1.6.12), (A14)+(B1.6.13), (A14)+(B1.6.14), (A14)+(B1.6.15), (A14)+(B1.6.16), (A14)+(B1.6.17), (A14)+(B1.6.18); (A14)+(B1.6.19); (A14)+(B2.1.1), (A14)+(B2.1.2), (A14)+(B2.1.3), (A14)+(B2.1.4), (A14)+(B2.1.6), (A14)+(B2.1.7), (A14)+(B2.1.8), (A14)+(B2.1.9), (A14)+(B2.1.10), (A14)+(B2.1.11), (A14)+(B2.1.12), (A14)+(B2.1.13), (A14)+(B2.1.13); (A14)+(B2.2.1), (A14)+(B2.2.2), (A14)+(B2.2.3), (A14)+(B2.2.3−RS), (A14)+(B2.2.4), (A14)+(B2.2.4−RS) (A14)+(B2.2.5), (A14)+(B2.2.6), (A14)+(B2.2.7), (A14)+(B2.2.8), (A14)+(B2.3.1), (A14)+(B2.3.2); (A14)+(B2.4.1), (A14)+(B2.4.2.), (A14)+(B2.4.3); (A14)+(B2.5.1), (A14)+(B2.5.2); (A14)+(B2.6.1),(A14)+(B2.6.2), (A14)+(B2.6.3), (A14)+(B2.6.4), (A14)+(B2.6.5), (A14)+(B2.6.6), (A14)+(B2.6.7), (A14)+(B2.6.8), (A14)+(B2.6.9), (A14)+(B2.6.10), (A14)+(B2.6.1.1), (A14)+(B2.6.12), (A14)+(B2.6.13), (A14)+(B2.6.14), (A14)+(B2.6.15); (A14)+(B3.1.1), (A14)+(B3.1.2), (A14)+(B3.1.3), (A14)+(B3.1.4), (A14)+(B3.1.5), (A14)+(B3.1.6), (A14)+(B3.1.7), (A14)+(B3.1.8), (A14)+(B3.1.9), (A14)+(B3.11.10), (A14)+(B3.1.11); (A14)+(B3.2.1), (A14)+(B3.2.2), (A14)+(B3.2.3); (A14)+(B3.3.1), (A14)+(B3.3.2), (A14)+(B3.3.2−RS), (A14)+(B3.3.3); (A14)+(B3.4.1), (A14)+(B3.4.2), (A14)+(B3.4.3), (A14)+(B3.4.4), (A14)+(B3.4.5), (A14)+(B3.4.6), (A14)+(B3.4.7), (A14)+(B3.4.8), (A14)+(B3.4.9), (A14)+(B3.4.10), (A14)+(B3.4.111), (A14)+(B3.4.12), (A14)+(B3.4.13), (A14)+(B3.4.14), (A14)+(B3.4.15), (A14)+(B3.4.16), (A14)+(B3.4.17), (A14)+(B3.4.18); (A14)+(B3.4.19); (A14)+(B4.1.1), (A14)+(B4.1.2); (A14)+(B4.2.1), (A14)+(B4.2.2); (A14)+(B4.3.1), (A14)+(B4.3.2), (A14)+(B4.3.3), (A14)+(B4.3.4), (A14)+(B4.3.5), (A14)+(B4.3.6); (A14)+(B4.4.1), (A14)+(B4.4.2), (A14)+(B4.4.3), (A14)+(B4.4.4);

(A15)+(B1.1.1), (A15)+(B1.1.2.); (A15)+(B1.2.1), (A15)+(B1.2.2.), (A15)+(B1.2.3); (A15)+(B1.3.1), (A15)+(B1.3.2.), (A15)+(B1.3.3), (A15)+(B1.3.4), (A15)+(B1.3.5), (A15)+(B1.3.6), (A15)+(B1.3.7), (A15)+(B1.3.8); (A15)+(B1.4.1), (A15)+(B1.4.2), (A15)+(B1.4.3), (A15)+(B1.4.4), (A15)+(B1.4.5); (A15)+(B1.5.1), (A15)+(B1.5.2), (A15)+(B1.5.3), (A15)+(B1.5.4); (A15)+(B1.6.1), (A15)+(B1.6.2), (A15)+(B1.6.3), (A15)+(B1.6.4), (A15)+(B1.6.5), (A15)+(B1.6.6), (A15)+(B1.6.7), (A15)+(B1.6.8), (A15)+(B1.6.9), (A15)+(B1.6.10), (A15)+(B1.6.11), (A15)+(B1.6.12), (A15)+(B1.6.13), (A15)+(B1.6.14), (A15)+(B1.6.15), (A15)+(B1.6.16), (A15)+(B1.6.17), (A15)+(B1.6.18); (A15)+(B1.6.19); (A15)+(B2.1.1), (A15)+(B2.1.2), (A15)+(B2.1.3), (A15)+(B2.1.4), (A15)+(B2.1.6), (A15)+(B2.1.7), (A15)+(B2.1.8), (A15)+(B2.1.9), (A15)+(B2.1.10), (A15)+(B2.1.11), (A15)+(B2.1.12), (A15)+(B2.1.13), (A15)+(B2.1.13); (A15)+(B2.2.1), (A15)+(B2.2.2), (A15)+(B2.2.3), (A15)+(B2.2.3−RS), (A15)+(B2.2.4), (A15)+(B2.2.4−RS) (A15)+(B2.2.5), (A15)+(B2.2.6), (A15)+(B2.2.7), (A15)+(B2.2.8), (A15)+(B2.3.1), (A15)+(B2.3.2); (A15)+(B2.4.1), (A15)+(B2.4.2.), (A15)+(B2.4.3); (A15)+(B2.5.1), (A15)+(B2.5.2); (A15)+(B2.6.1), (A15)+(B2.6.2), (A15)+(B2.6.3), (A15)+(B2.6.4), (A15)+(B2.6.5), (A15)+(B2.6.6), (A15)+(B2.6.7), (A15)+(B2.6.8), (A15)+(B2.6.9), (A15)+(B2.6.10), (A15)+(B2.6.11), (A15)+(B2.6.12), (A15)+(B2.6.13), (A15)+(B2.6.14), (A15)+(B2.6.15); (A15)+(B3.1.1), (A15)+(B3.1.2), (A15)+(B3.1.3), (A15)+(B3.1.4), (A15)+(B3.1.5), (A15)+(B3.1.6), (A15)+(B3.1.7), (A15)+(B3.1.8), (A15)+(B3.1.9), (A15)+(B3.11.10), (A15)+(B3.11.11); (A15)+(B3.2.1), (A15)+(B3.2.2), (A15)+(B3.2.3); (A15)+(B3.3.1), (A15)+(B3.3.2), (A15)+(B3.3.2−RS), (A15)+(B3.3.3); (A15)+(B3.4.1), (A15)+(B3.4.2), (A15)+(B3.4.3), (A15)+(B3.4.4), (A15)+(B3.4.5), (A15)+(B3.4.6), (A15)+(B3.4.7), (A15)+(B3.4.8), (A15)+(B3.4.9), (A15)+(B3.4.10), (A15)+(B3.4.111), (A15)+(B3.4.12), (A15)+(B3.4.13), (A15)+(B3.4.14), (A15)+(B3.4.15),; (A15)+(B3.4.16), (A15)+(B3.4.17), (A15)+(B3.4.18); (A15)+(B3.4.19); (A15)+(B4.1.1), (A15)+(B4.1.2); (A15)+(B4.2.1), (A15)+(B4.2.2); (A15)+(B4.3.1), (A15)+(B4.3.2), (A15)+(B4.3.3), (A15)+(B4.3.4), (A15)+(B4.3.5), (A15)+(B4.3.6); (A15)+(B4.4.1), (A15)+(B4.4.2), (A15)+(B4.4.3), (A15)+(B4.4.4);

(A16)+(B1.1.1), (A16)+(B1.1.2.); (A16)+(B1.2.1), (A16)+(B1.2.2.), (A16)+(B1.2.3); (A16)+(B1.3.1), (A16)+(B1.3.2.), (A16)+(B1.3.3), (A16)+(B1.3.4), (A16)+(B1.3.5), (A16)+(B1.3.6), (A16)+(B1.3.7), (A16)+(B1.3.8); (A16)+(B1.4.1), (A16)+(B1.4.2), (A16)+(B1.4.3), (A16)+(B1.4.4), (A16)+(B1.4.5); (A16)+(B1.5.1), (A16)+(B1.5.2), (A16)+(B1.5.3), (A16)+(B1.5.4); (A16)+(B1.6.1), (A16)+(B1.6.2), (A16)+(B1.6.3), (A16)+(B1.6.4), (A16)+(B1.6.5), (A16)+(B1.6.6), (A16)+(B1.6.7), (A16)+(B1.6.8), (A16)+(B1.6.9),(A16)+(B1.6.10),(A16)+(B1.6.11),(A16)+(B1.6.12), (A16)+(B1.6.13), (A16)+(B1.6.14), (A16)+(B1.6.15), (A16)+(B1.6.16), (A16)+(B1.6.17), (A16)+(B1.6.18); (A16)+(B1.6.19); (A16)+(B2.1.1), (A16)+(B2.1.2), (A16)+(B2.1.3), (A16)+(B2.1.4), (A16)+(B2.1.6), (A16)+(B2.1.7), (A16)+(B2.1.8), (A16)+(B2.1.9), (A16)+(B2.1.10), (A16)+(B2.1.11), (A16)+(B2.1.12), (A16)+(B2.1.13), (A16)+(B2.1.13); (A16)+(B2.2.1), (A16)+(B2.2.2), (A16)+(B2.2.3), (A16)+(B2.2.3−RS), (A16)+(B2.2.4), (A16)+(B2.2.4−RS) (A16)+(B2.2.5), (A16)+(B2.2.6), (A16)+(B2.2.7), (A16)+(B2.2.8), (A16)+(B2.3.1), (A16)+(B2.3.2); (A16)+(B2.4.1), (A16)+(B2.4.2.), (A16)+(B2.4.3); (A16)+(B2.5.1), (A16)+(B2.5.2); (A16)+(B2.6.1), (A16)+(B2.6.2), (A16)+(B2.6.3), (A16)+(B2.6.4), (A16)+(B2.6.5), is (A16)+(B2.6.6), (A16)+(B2.6.7), (A16)+(B2.6.8), (A16)+(B2.6.9), (A16)+(B2.6.10), (A16)+(B2.6.11), (A16)+(B2.6.12), (A16)+(B2.6.13), (A16)+(B2.6.14), (A16)+(B2.6.15); (A16)+(B3.1.1), (A16)+(B3.1.2), (A16)+(B3.1.3), (A16)+(B3.1.4), (A16)+(B3.1.5), (A16)+(B3.1.6), (A16)+(B3.1.7), (A16)+(B3.1.8), (A16)+(B3.1.9), (A16)+(B3.1.10), (A16)+(B3.1.11); (A16)+(B3.2.11), (A16)+(B3.2.2), (A16)+(B3.2.3); (A16)+(B3.3.1), (A16)+(B3.3.2), (A16)+(B3.3.2−RS), (A16)+(B3.3.3); (A16)+(B3.4.l), (A16)+(B3.4.2), (A16)+(B3.4.3), (A16)+(B3.4.4), (A16)+(B3.4.5), (A16)+(B3.4.6), (A16)+(B3.4.7), (A16)+(B3.4.8), (A16)+(B3.4.9), (A16)+(B3.4.10), (A16)+(B3.4.11), (A16)+(B3.4.12), (A16)+(B3.4.13), (A16)+(B3.4.14), (A16)+(B3.4.15), (A16)+(B3.4.16), (A16)+(B3.4.17), (A16)+(B3.4.18); (A16)+(B3.4.19); (A16)+(B4.1.1), (A16)+(B4.1.2); (A16)+(B4.2.1), (A16)+(B4.2.2); (A16)+(B4.3.1), (A16)+(B4.3.2), (A16)+(B4.3.3), (A16)+(B4.3.4), (A16)+(B4.3.5), (A16)+(B4.3.6); (A16)+(B4.4.1), (A16)+(B4.4.2), (A16)+(B4.4.3), (A16)+(B4.4.4);

(A17)+(B1.1.1), (A17)+(B1.1.2.); (A17)+(B1.2.1), (A17)+(B1.2.2.), (A17)+(B1.2.3); (A17)+(B1.3.1), (A17)+(B1.3.2.), (A17)+(B1.3.3), (A17)+(B1.3.4), (A17)+(B1.3.5), (A17)+(B1.3.6), (A17)+(B1.3.7), (A17)+(B1.3.8); (A17)+(B1.4.1), (A17)+(B1.4.2), (A17)+(B1.4.3), (A17)+(B1.4.4), (A17)+(B1.4.5); (A17)+(B1.5.1), (A17)+(B1.5.2), (A17)+(B1.5.3), (A17)+(B1.5.4); (A17)+(B1.6.1), (A17)+(B1.6.2), (A17)+(B1.6.3), (A17)+(B1.6.4), (A17)+(B1.6.5), (A17)+(B1.6.6), (A17)+(B1.6.7), (A17)+(B1.6.8), (A17)+(B1.6.9), (A17)+(B1.6.10), (A17)+(B1.6.11), (A17)+(B1.6.12), (A17)+(B1.6.13), (A17)+(B1.6.14), (A17)+(B1.6.15), (A17)+(B1.6.16), (A17)+(B1.6.17), (A17)+(B1.6.18); (A17)+(B1.6.19); (A17)+(B2.1.1), (A17)+(B2.1.2), (A17)+(B2.1.3), (A17)+(B2.1.4), (A17)+(B2.1.6), (A17)+(B2.1.7), (A17)+(B2.1.8), (A17)+(B2.1.9), (A17)+(B2.1.10), (A17)+(B2.1.11), (A17)+(B2.1.12), (A17)+(B2.1.13), (A17)+(B2.1.13); (A17)+(B2.2.1), (A17)+(B2.2.2), (A17)+(B2.2.3), (A17)+(B2.2.3−RS), (A17)+(B2.2.4), (A17)+(B2.2.4−RS) (A17)+(B2.2.5), (A17)+(B2.2.6), (A17)+(B2.2.7), (A17)+(B2.2.8), (A17)+(B2.3.1), (A17)+(B2.3.2); (A17)+(B2.4.1), (A17)+(B2.4.2.), (A17)+(B2.4.3); (A17)+(B2.5.1), (A17)+(B2.5.2); (A17)+(B2.6.1), (A17)+(B2.6.2), (A17)+(B2.6.3), (A17)+(B2.6.4), (A17)+(B2.6.5), (A17)+(B2.6.6), (A17)+(B2.6.7), (A17)+(B2.6.8), (A17)+(B2.6.9), (A17)+(B2.6.l 0), (A17)+(B2.6.11), (A17)+(B2.6.12), (A17)+(B2.6.13), (A17)+(B2.6.14), (A17)+(B2.6.15); (A17)+(B3.1.1), (A17)+(B3.1.2), (A17)+(B3.1.3), (A17)+(B3.1.4), (A17)+(B3.1.5), (A17)+(B3.1.6), (A17)+(B3.1.7), (A17)+(B3.1.8), (A17)+(B3.1.9), (A17)+(B3.1.10), (A17)+(B3.1.11); (A17)+(B3.2.1), (A17)+(B3.2.2), (A17)+(B3.2.3); (A17)+(B3.3.1), (A17)+(B3.3.2), (A17)+(B3.3.2−RS), (A17)+(B3.3.3); (A17)+(B3.4.1), (A17)+(B3.4.2), (A17)+(B3.4.3), (A17)+(B3.4.4), (A17)+(B3.4.5), (A17)+(B3.4.6), (A17)+(B3.4.7), (A17)+(B3.4.8), (A17)+(B3.4.9), (A17)+(B3.4.10), (A17)+(B3.4.111), (A17)+(B3.4.12), (A17)+(B3.4.13), (A17)+(B3.4.14), (A17)+(B3.4.15), (A17)+(B3.4.16), (A17)+(B3.4.17), (A17)+(B3.4.18); (A17)+(B3.4.19); (A17)+(B4.1.1), (A17)+(B4.1.2); (A17)+(B4.2.1), (A17)+(B4.2.2); (A17)+(B4.3.1), (A17)+(B4.3.2), (A17)+(B4.3.3), (A17)+(B4.3.4), (A17)+(B4.3.5), (A17)+(B4.3.6); (A17)+(B4.4.1), (A17)+(B4.4.2), (A17)+(B4.4.3), (A17)+(B4.4.4);

(A18)+(B1.1.1), (A18)+(B1.1.2.); (A18)+(B1.2.1), (A18)+(B1.2.2.), (A18)+(B1.2.3); (A18)+(B1.3.1), (A18)+(B1.3.2.), (A18)+(B1.3.3), (A18)+(B1.3.4), (A18)+(B1.3.5), (A18)+(B1.3.6), (A18)+(B1.3.7), (A18)+(B1.3.8); (A18)+(B1.4.1), (A18)+(B1.4.2), (A18)+(B1.4.3), (A18)+(B1.4.4), (A18)+(B1.4.5); (A18)+(B1.5.1), (A18)+(B1.5.2), (A18)+(B1.5.3), (A18)+(B1.5.4); (A18)+(B1.6.1), (A18)+(B1.6.2), (A18)+(B1.6.3), (A18)+(B1.6.4), (A18)+(B1.6.5), (A18)+(B1.6.6), (A18)+(B1.6.7), (A18)+(B1.6.8), (A18)+(B1.6.9), (A18)+(B1.6.10), (A18)+(B1.6.11), (A18)+(B1.6.12), (A18)+(B1.6.13), (A18)+(B1.6.14), (A18)+(B1.6.15), (A18)+(B1.6.16), (A18)+(B1.6.17), (A18)+(B1.6.18); (A18)+(B1.6.19); (A18)+(B2.1.1), (A18)+(B2.1.2), (A18)+(B2.1.3), (A18)+(B2.1.4), (A18)+(B2.1.6), (A18)+(B2.1.7), (A18)+(B2.1.8), (A18)+(B2.1.9), (A18)+(B2.1.10), (A18)+(B2.1.11), (A18)+(B2.1.12), (A18)+(B2.1.13), (A18)+(B2.1.13); (A18)+(B2.2.1), (A18)+(B2.2.2), (A18)+(B2.2.3), (A18)+(B2.2.3−RS), (A18)+(B2.2.4), (A18)+(B2.2.4−RS) (A18)+(B2.2.5), (A18)+(B2.2.6), (A18)+(B2.2.7), (A18)+(B2.2.8), (A18)+(B2.3.1), (A18)+(B2.3.2); (A18)+(B2.4.1), (A18)+(B2.4.2.), (A18)+(B2.4.3); (A18)+(B2.5.1), (A18)+(B2.5.2); (A18)+(B2.6.1), (A18)+(B2.6.2), (A18)+(B2.6.3), (A18)+(B2.6.4), (A18)+(B2.6.5), (A18)+(B2.6.6), (A18)+(B2.6.7), (A18)+(B2.6.8), (A18)+(B2.6.9), (A18)+(B2.6.10), (A18)+(B2.6.11), (A18)+(B2.6.12), (A18)+(B2.6.13), (A18)+(B2.6.14), (A18)+(B2.6.15); (A18)+(B3.1.1), (A18)+(B3.1.2), (A18)+(B3.1.3), (A18)+(B3.1.4), (A18)+(B3.1.5), (A18)+(B3.1.6), (A18)+(B3.1.7), (A18)+(B3.1.8), (A18)+(B3.1.9), (A18)+(B3.11.10), (A18)+(B3.1.11); (A18)+(B3.2.1), (A18)+(B3.2.2), (A18)+(B3.2.3); (A18)+(B3.3.1), (A18)+(B3.3.2), (A18)+(B3.3.2−RS), (A18)+(B3.3.3); (A18)+(B3.4.1), (A18)+(B3.4.2), (A18)+(B3.4.3), (A18)+(B3.4.4), (A18)+(B3.43.5), (A18)+(B3.4.6), (A18)+(B3.4.7), (A18)+(B3.4.8), (A18)+(B3.4.9), (A18)+(B3.4.10), (A18)+(B3.4.11), (A18)+(B3.4.12), (A18)+(B3.4.13), (A18)+(B3.4.14), (A18)+(B3.4.15), (A18)+(B3.4.16), (A18)+(B3.4.17), (A18)+(B3.4.18); (A18)+(B3.4.19); (A18)+(B4.1.1), (A18)+(B4.1.2); (A18)+(B4.2.1), (A18)+(B4.2.2); (A18)+(B4.3.1), (A18)+(B4.3.2), (A18)+(B4.3.3), (A18)+(B4.3.4), (A18)+(B4.3.5), (A18)+(B4.3.6); (A18)+(B4.4.1), (A18)+(B4.4.2), (A18)+(B4.4.3), (A18)+(B4.4.4);

(A19)+(B1.1.1), (A19)+(B1.1.2.); (A19)+(B1.2.1), (A19)+(B1.2.2.), (A19)+(B1.2.3); (A19)+(B1.3.1), (A19)+(B1.3.2.), (A19)+(B1.3.3), (A19)+(B1.3.4), (A19)+(B1.3.5), (A19)+(B1.3.6), (A19)+(B1.3.7), (A19)+(B1.3.8); (A19)+(B1.4-0.1), (A19)+(B1.4.2), (A19)+(B1.4.3), (A19)+(B1.4.4), (A19)+(B1.4.5); (A19)+(B1.5.1), (A19)₄(B1.5.2), (A19)+(B1.5.3), (A19)+(B1.5.4); (A19)+(B1.6.1), (A19)+(B1.6.2), (A19)+(B1.6.3), (A19)+(B1.6.4), (A19)+(B1.6.5), (A19)+(B1.6.6), (A19)+(B1.6.7), (A19)+(B1.6.8), (A19)+(B1.6.9), (A19)+(B1.6.10), (A19)+(B1.6.11), (A19)+(B1.6.12), (A19)+(B1.6.13), (A19)+(B1.6.14), (A19)+(B1.6.15), (A19)+(B1.6.16), (A19)+(B1.6.17), (A19)+(B1.6.18); (A19)+(B1.6.19); (A19)+(B2.1.1), (A19)+(B2.1.2), (A19)+(B2.1.3), (A19)+(B2.1.4), (A19)+(B2.1.6), (A19)+(B2.1.7), (A19)+(B2.1.8), (A19)+(B2.1.9), (A19)+(B2.1.10), (A19)+(B2.1.11), (A19)+(B2.1.12), (A19)+(B2.1.13), (A19)+(B2.1.13); (A19)+(B2.2.1), (A19)+(B2.2.2), (A19)+(B2.2.3), (A19)+(B2.2.3−RS), (A19)+(B2.2.4), (A19)+(B2.2.4−RS) (A19)+(B2.2.5), (A19)+(B2.2.6), (A19)+(B2.2.7), (A19)+(B2.2.8), (A19)+(B2.3-. 1), (A19)+(B2.3.2); (A19)+(B2.4.1), (A19)+(B2.4.2.), (A19)+(B2.4.3); (A19)+(B2.5.1), (A19)+(B2.5.2); (A19)+(B2.6.1), (A19)+(B2.6.2), (A19)+(B2.6.3), (A19)+(B2.6.4), (A19)+(B2.6.5), (A19)+(B2.6.6), (A19)+(B2.6.7), (A19)+(B2.6.8), (A19)+(B2.6.9), (A19)+(B2.6.10), (A19)+(B2.6.11), (A19)+(B2.6.12), (A19)+(B2.6.13), (A19)+(B2.6.14), (A19)+(B2.6.15); (A19)+(B3.1.1), (A19)+(B3.1.2), (A19)+(B3.1.3), (A19)+(B3.1.4), (A19)+(B3.1.5), (A19)+(B3.1.6), (A19)+(B3.1.7), (A19)+(B3.1.8), (A19)+(B3.1.9), (A19)+(B3.1.10), (A19)+(B3.1.11); (A19)+(B3.2.1), (A19)+(B3.2.2), (A19)+(B3.2.3); (A19)+(B3.3.1), (A19)+(B3.3.2), (A19)+(B3.3.2−RS), (A19)+(B3.3.3); (A19)+(B3.4.1), (A19)+(B3.4.2), (A19)+(B3.4.3), (A19)+(B3.4.4), (A19)+(B3.4.5), (A19)+(B3.4.6), (A19)+(B3.4.7), (A19)+(B3.4.8), (A19)+(B3.4.9), (A19)+(B3.4.10), (A19)+(B3.4.11), (A19)+(B3.4.12), (A19)+(B3.4.13), (A19)+(B3.4.1), (A19)+(B3.4.15), (A19)+(B3.4.16), (A19)+(B3.4.17), (A19)+(B3.4.18); (A19)+(B3.4.19); (A19)+(B4.1.1), (A19)+(B4.1.2); (A19)+(B4.2.1), (A19)+(B4.2.2); (A19)+(B4.3.1), (A19)+(B4.3.2), (A19)+(B4.3.3), (A19)+(B4.3.4), (A19)+(B4.3.5), (A19)+(B4.3.6); (A19)+(B4.4.1), (A19)+(B4.4.2), (A19)+(B4.4.3), (A19)+(B4.4.4);

(A20)+(B1.1.1), (A20)+(B1.1.2.); (A20)+(B1.2.1), (A20)+(B1.2.2.), (A20)+(B1.2.3); (A20)+(B1.3.1), (A20)+(B1.3.2.), (A20)+(B1.3.3), (A20)+(B1.3.4), (A20)+(B1.3.5), (A20)+(B1.3.6), (A20)+(B1.3.7), (A20)+(B1.3.8); (A20)+(B1.4.1), (A20)+(B1.4.2), (A20)+(B1.4.3), (A20)+(B1.4.4), (A20)+(B1.4.5); (A20)+(B1.5.1), (A20)+(B1.5.2), (A20)+(B1.5.3), (A20)+(B1.5.4); (A20)+(B1.6.1), (A20)+(B1.6.2), (A20)+(B1.6.3), (A20)+(B1.6.4), (A20)+(B1.6.5), (A20)+(B1.6.6), (A20)+(B1.6.7), (A20)+(B1.6.8), (A-20)+(B1.6.9), (A20)+(B1.6.10), (A20)+(B1.6.11), (A20)+(B1.6.12), (A20)+(B1.6.13), (A20)+(B1.6.14), (A20)+(B1.6.15), (A20)+(B1.6.16), (A20)+(B1.6.17), (A20)+(B1.6.18); (A20)+(B1.6.19); (A20)+(B2.1.1), (A20)+(B2.1.2), (A20)+(B2.1.3), (A20)+(B2.1.4), (A20)+(B2.1.6), (A20)+(B2.1.7), (A20)+(B2.1.8), (A20)+(B2.1.9), (A20)+(B2.1.10), (A20)+(B2.1.11), (A20)+(B2.1.12), (A20)+(B2.1.13), (A20)+(B2.1.13); (A20)+(B2.2.1), (A20)+(B2.2.2), (A20)+(B2.2.3), (A20)+(B2.2.3−RS), (A20)+(B2.2.4), (A20)+(B2.2.4−RS) (A20)+(B2.2.5), (A20)+(B2.2.6), (A20)+(B2.2.7), (A20)+(B2.2.8), (A20)+(B2.3.1), (A20)+(B2.3.2); (A20)+(B2.4.1), (A20)+(B2.4.2.), (A20)+(B2.4.3); (A20)+(B2.5.1), (A20)+(B2.5.2); (A20)+(B2.6.1), (A20)+(B2.6.2), (A20)+(B2.6.3), (A20)+(B2.6.4), (A20)+(B2.6.5), (A20)+(B2.6.6), (A20)+(B2.6.7), (A20)+(B2.6.8), (A20)+(B2.6.9), (A20)+(B2.6.10), (A20)+(B2.6.11), (A20)+(B2.6.12), (A20)+(B2.6.13), (A20)+(B2.6.14), (A20)+(B2.6.15); (A20)+(B3.1.1), (A20)+(B3.1.2), (A20)+(B3.1.3), (A20)+(B3.1.4), (A20)+(B3.1.5), (A20)+(B3.1.6), (A20)+(B3.1.7), (A20)+(B3.1.8), (A20)+(B3.1.9), (A20)+(B3.1.10), (A20)+(B3.1.11); (A20)+(B3.2.1), (A20)+(B3.2.2), (A20)+(B3.2.3); (A20)+(B3.3.1), (A20)+(B3.3.2), (A20)+(B3.3.2−RS), (A20)+(B3.3.3); (A20)+(B3.4.1), (A20)+(B3.4.2), (A20)+(B3.4.3), (A20)+(B3.4.4), (A20)+(B3.4.5), (A20)+(B3.4.6), (A20)+(B3.4.7), (A20)+(B3.4.8), (A20)+(B3.4.9), (A20)+(B3.4.10), (A20)+(B3.4.11), (A20)+(B3.4.12), (A20)+(B3.4.13), (A20)+(B3.4.14), (A20)+(B3.4.15), (A20)+(B3.4.16), (A20)+(B3.4.17), (A20)+(B3.4.18); (A20)+(B3.4.19); (A20)+(B4.1.1), (A20)+(B4.1.2); (A20)+(B4.2.1), (A20)+(B4.2.2); (A20)+(B4.3.1), (A20)+(B4.3.2), (A20)+(B4.3.3), (A20)+(B4.3.4), (A20)+(B4.3.5), (A20)+(B4.3.6); (A20)+(B4.4.1), (A20)+(B4.4.2), (A20)+(B4.4.3), (A20)+(B4.4.4);

(A21)+(B1.1.1), (A21)+(B1.1.2.); (A21)+(B1.2.1), (A21)+(B1.2.2.), (A21)+(B1.2.3); (A21)+(B1.3.1), (A21)+(B1.3.2.), (A21)+(B1.3.3), (A21)+(B1.3.4), (A21)+(B1.3.5), (A21)+(B1.3.6), (A21)+(B1.3.7), (A21)+(B1.3.8); (A21)+(B1.4.1), (A21)+(B1.4.2), (A21)+(B1.4.3), (A21)+(B1.4.4), (A21)+(B1.4.5); (A21)+(B1.5.1), (A21)+(B1.5.2), (A21)+(B1.5.3), (A21)+(B1.5.4); (A21)+(B1.6.1), (A21)+(B1.6.2), (A21)+(B1.6.3), (A21)+(B1.6.4), (A21)+(B1.6.5), (A21)+(B1.6.6), (A21)+(B1.6.7), (A21)+(B1.6.8), (A21)+(B1.6.9), (A21)+(B1.6.10), (A21)+(B1.6.11), (A21)+(B1.6.12), (A21)+(B1.6.13), (A21)+(B1.6.14), (A21)+(B1.6.15), (A21)+(B1.6.16), (A21)+(B1.6.17), (A21)+(B1.6.18); (A21)+(B1.6.19); (A21)+(B2.1.1), (A21)+(B2.1.2), (A21)+(B2.1.3), (A21)+(B2.1.4), (A21)+(B2.1.6), (A21)+(B2.1.7), (A21)+(B2.1.8), (A21)+(B2.1.9), (A21)+(B2.1.10), (A21)+(B2.1.11), (A21)+(B2.1.12), (A21)+(B2.1.13), (A21)+(B2.1.13); (A21)+(B2.2.1), (A21)+(B2.2.2), (A21)+(B2.2.3), (A21)+(B2.2.3−RS), (A21)+(B2.2.4), (A21)+(B2.2.4−RS) (A21)+(B2.2.5), (A21)+(B2.2.6), (A21)+(B2.2.7), (A21)+(B2.2.8), (A21)+(B2.30.1), (A21)+(B2.3.2); (A21)+(B2.4.1), (A21)+(B2.4.2.), (A21)+(B2.4.3); (A21)+(B2.5.1), (A21)+(B2.5.2); (A21)+(B2.6.1), (A21)+(B2.6.2), (A21)+(B2.6.3), (A21)+(B2.6.4), (A21)+(B2.6.5), (A21)+(B2.6.6), (A21)+(B2.6.7), (A21)+(B2.6.8), (A21)+(B2.6.9), (A21)+(B2.6.10), (A21)+(B2.6.1), (A21)+(B2.6.12), (A21)+(B2.6.13), (A21)+(B2.6.14), (A21)+(B2.6.15); (A21)+(B3.1.1), (A21)+(B3.1.2), (A21)+(B3.1.3), (A21)+(B3.1.4), (A21)+(B3.1.5), (A21)+(B3.1.6), (A21)+(B3.1.7), (A21)+(B3.1.8), (A21)+(B3.1.9), (A21)+(B3.1.10), (A21)+(63.1.11); (A21)+(B3.2.1), (A21)+(B3.2.2), (A21)+(B3.2.3); (A21)+(B3.3.1), (A21)+(B3.3.2), (A21)+(B3.3.2−RS), (A21)+(B3.3.3); (A21)+(B3.4.1), (A21)+(B3.4.2), (A21)+(B3.4.3), (A21)+(B3.4.4), (A21)+(B3.4.5), (A21)+(B3.4.6), (A21)+(B3.4.7), (A21)+(B3.4.8), (A21)+(B3.4.9), (A21)+(B3.4.10), (A21)+(B3.4.11), (A21)+(B3.4.12), (A21)+(B3.4.13), (A21)+(B3.4.14), (A21)+(B3.4.15), (A21)+(B3.4.16), (A21)+(B3.4.17), (A21)+(B3.4.18); (A21)+(B3.4.19); (A21)+(B4.1.1), (A21)+(B4.1.2); (A21)+(B4.2.1), (A21)+(B4.2.2); (A21)+(B4.3.1), (A21)+(B4.3.2), (A21)+(B4.3.3), (A21)+(B4.3.4), (A21)+(B4.3.5), (A2!)+(B4.3.6); (A21)+(B4.4.1), (A21)+(B4.4.2), (A21)+(B4.4.3), (A21)+(B4.40.4);

(A22)+(B1.1.1), (A22)+(B1.1.2.); (A22)+(B1.2.1), (A22)+(B1.2.2.), (A22)+(B1.2.3); (A22)+(B1.3.1), (A22)+(B1.3.2.), (A22)+(B1.3.3), (A22)+(B1.3.4), (A22)+(B1.3.5), (A22)+(B1.3.6), (A22)+(B1.3.7), (A22)+(B1.3.8); (A22)+(B1.4.1), (A22)+(B1.4.2), (A22)+(B1.4.3), (A22)+(B1.4.4), (A22)+(B1.4.5); (A22)+(B1.5.1), (A22)+(B1.5.2), (A22)+(B1.5.3), (A22)+(B1.5.4); (A22)+(B1.6.1), (A22)+(B1.6.2), (A22)+(B1.6.3), (A22)+(B1.6.4), (A22)+(B1.6.5), (A22)+(B1.6.6), (A22)+(B1.6-0.7), (A22)+(B1.6.8), (A22)+(B1.6.9), (A22)+(B1.6.10), (A22)+(B1.6.11), (A22)+(B1.6.12), (A22)+(B1.6.13), (A22)+(B1.6.14), (A22)+(B1.6.15), (A22)+(B1.6.16), (A22)+(B1.6.17), (A22)+(B1.6.18); (A22)+(B1.6.19); (A22)+(B2.1.1), (A22)+(B2.1.2), (A22)+(B2.1.3), (A22)+(B2.1.4), (A22)+(B2.1.6), (A22)+(B2.1.7), (A22)+(B2.1.8), (A22)+(B2.1.9), (A22)+(B2.1.10), (A22)+(B2.1.11), (A22)+(B2.1.12), (A22)+(B2.1.13), (A22)+(B2.1.13); (A22)+(B2.2.1), (A22)+(B2.2.2), (A22)+(B2.2.3), (A22)+(B2.2.3−RS), (A22)+(B2.2.4), (A22)+(B2.2.4−RS) (A22)+(B2.2.5), (A22)+(B2.2.6), (A22)+(B2.2.7), (A22)+(B2.2.8), (A22)+(B2.3.1), (A22)+(B2.3.2); (A22)+(B2.4.1), (A22)+(B2.4.2.), (A22)+(B2.4.3); (A22)+(B2.5.1), (A22)+(B2.5.2); (A22)+(B2.6.1), (A22)+(B2.6.2), (A22)+(B2.6.3), (A22)+(B2.6.4), (A22)+(B2.6.5), (A22)+(B2.6.6), (A22)+(B2.6.7), (A22)+(B2.6.8), (A22)+(B2.6.9), (A22)+(B2.6.10), (A22)+(B2.6.11), (A22)+(B2.6.12), (A22)+(B2.6.13), (A22)+(B2.6.14), (A22)+(B2.6.15); (A22)+(B3.1.1), (A22)+(B3.1.2), (A22)+(B3.1.3), (A22)+(B3.1.4), (A22)+(B3.1.5), (A22)+(B3.1.6), (A22)+(B3.1.7), (A22)+(B3.1.8), (A22)+(B3.1.9), (A22)+(B3.1.10), (A22)+(B3.1.11); (A22)+(B3.2.1), (A22)+(B3.2.2), (A22)+(B3.2.3); (A22)+(B3.3.1), (A22)+(B3.3.2), (A22)+(B3.3.2−RS), (A22)+(B3.3.3); (A22)+(B3.4.1), (A22)+(B3.4.2), (A22)+(B3.4.3), (A22)+(B3.4.4), (A22)+(B3.4.5), (A22)+(B3.4.6), (A22)+(B3.4.7), (A22)+(B3.4.8), (A22)+(B3.4.9), (A22)+(B3.4.10), (A22)+(B3.4.11), (A22)+(B3.4.12), (A22)+(B3.4.13), (A22)+(B3.4.14), (A22)+(B3.4.15), (A22)+(B3.4.16), (A22)+(B3.4.17), (A22)+(B3.4.18); (A22)+(B3.4.19); (A22)+(B4.1.1), (A22)+(B4.1.2); (A22)+(B4.2.1), (A22)+(B4.2.2); (A22)+(B4.3.1), (A22)+(B4.3.2), (A22)+(B4.3.3), (A22)+(B4.3.4), (A22)+(B4.3.5), (A22)+(B4.3.6); (A22)+(B4.4.1), (A22)+(B4.4.2), (A22)+(B4.4.3), (A22)+(B4.4.4);

(A23)+(B1.1.1), (A23)+(B1.1.2.); (A23)+(B1.2.1), (A23)+(B1.2.2.), (A23)+(B1.2.3); (A23)+(B1.3.1), (A23)+(B1.3.2.), (A23)+(B1.3.3), (A23)+(B1.3.4), (A23)+(B1.3.5), (A23)+(B1.3.6), (A23)+(B1.3.7), (A23)+(B1.3.8); (A23)+(B1.4.1), (A23)+(B1.4.2), (A23)+(B1.4.3), (A23)+(B1.4.4), (A23)+(B1.4.5); (A23)+(B1.5.1), (A23)+(B1.5.2), (A23)+(B1.5.3), (A23)+(B1.5.4); (A23)+(B1.6.1), (A23)+(B1.6.2), (A23)+(B1.6.3), (A23)+(B1.6.4), (A23)+(B1.6.5), (A23)+(B1.6.6), (A23)+(B1.6.7), (A23)+(B1.6.8), (A23)+(B1.6.9), (A23)+(B1.6.10), (A23)+(B1.6.11), (A23)+(B1.6.12), (A23)+(B1.6.13), (A23)+(B1.6.14), (A23)+(B1.6.15), (A23)+(B1.6.16), (A23)+(B1.6.17), (A23)+(B1.6.18); (A23)+(B1.6.19); (A23)+(B2.1.1), (A23)+(B2.1.2), (A23)+(B2.1.3), (A23)+(B2.1.4), (A23)+(B2.1.6), (A23)+(B2.1.7), (A23)+(B2.1.8), (A23)+(B2.1.9), (A23)+(B2.1.10), (A23)+(B2.1.11), (A23)+(B2.1.12), (A23)+(B2.1.13), (A23)+(B2.1.13); (A23)+(B2.2.1), (A23)+(B2.2.2), (A23)+(B2.2.3), (A23)+(B2.2.3−RS), (A23)+(B2.2.4), (A23)+(B2.2.4−RS) (A23)+(B2.2.5), (A23)+(B2.2.6), (A23)+(B2.2.7), (A23)+(B2.2.8), (A23)+(B2.3.1), (A23)+(B2.3.2); (A23)+(B2.4.1), (A23)+(B2.4.2.), (A23)+(B2.4.3); (A23)+(B2.5.1), (A23)+(B2.5.2); (A23)+(B2.6.1), (A23)+(B2.6.2), (A23)+(B2.6.3), (A23)+(B2.6.4), (A23)+(B2.6.5), (A23)+(B2.6.6), (A23)+(B2.6.7), (A23)+(B2.6.8), (A23)+(B2.6.9), (A23)+(B2.6.10), (A23)+(B2.6.11), (A23)+(B2.6.12), (A23)+(B2.6.13), (A23)+(B2.6.14), (A23)+(B2.6.15); (A23)+(B3.1.1), (A23)+(B3.1.2), (A23)+(B3.1.3), (A23)+(B3.1.4), (A23)+(B3.1.5), (A23)+(B3.1.6), (A23)+(B3.1.7), (A23)+(B3.1.8), (A23)+(B3.1.9), (A23)+(B3.1.10), (A23)+(B3.1.11); (A23)+(B3.2.1), (A23)+(B3.2.2), (A23)+(B3.2.3); (A23)+(B3.3.1), (A23)+(B3.3.2), (A23)+(B3.3.2−RS), (A23)+(B3.3.3); (A23)+(B3.4.1), (A23)+(B3.4.2), (A23)+(B3.4.3), (A23)+(B3.4.4), (A23)+(B3.4.5), (A23)+(B3.4.6), (A23)+(B3.4.7), (A23)+(B3.4.8), (A23)+(B3.4.9), (A23)+(B3.4.10), (A23)+(B3.4.11), (A23)+(B3.4.12), (A23)+(B3.4.13), (A23)+(B3.4.14), (A23)+(B3.4.15), (A23)+(B3.4.16), (A23)+(B3.4.17), (A23)+(B3.4.18); (A23)+(B3.4.19); (A23)+(B4.1.1), (A23)+(B4.1.2); (A23)+(B4.2.1), (A23)+(B4.2.2); (A23)+(B4.3.1), ,(A23)+(B4.3.2), (A23)+(B4.3.3), (A23)+(B4.3.4), (A23)+(B4.3.5), (A23)+(B4.3.6); (A23)+(B4.4.1), (A23)+(B4.4.2), (A23)+(B4.4.3), (A23)+(B4.4.4);

(A24)+(B1.1.1), (A24)+(B1.1.2.); (A24)+(B1.2.1), (A24)+(B1.2.2.), (A24)+(B1.2.3); (A24)+(B1.3.1), (A24)+(B1.3.2.), (A24)+(B1.3.3), (A24)+(B1.3.4), (A24)+(B1.3.5), (A24)+(B1.3.6), (A24)+(B1.3.7), (A24)+(B1.3.8); (A24)+(B1.4.1), (A24)+(B1.4.2), (A24)+(B1.4.3), (A24)+(B1.4.4), (A24)+(B1.4.5); (A24)+(B1.5.1), (A24)+(B1.5.2), (A24)+(B1.5.3), (A24)+(B1.5.4); (A24)+(B1.6.1), (A24)+(B1.6.2), (A24)+(B1.6.3), (A24)+(B1.6.4), (A24)+(B1.6.5), (A24)+(B1.6.6), (A24)+(B1.6.7), (A24)+(B1.6.8), (A24)+(B1.6.9), (A24)+(B1.6.10), (A24)+(B1.6.11), (A24)+(B1.6.12), (A24)+(B1.6.13), (A24)+(B1.6.14), (A24)+(B1.6.15), (A24)+(B1.6.16), (A24)+(B1.6.17), (A24)+(B1.6.18); (A24)+(B1.6.19); (A24)+(B2.1.1), (A24)+(B2.1.2), (A24)+(B2.1.3), (A24)+(B2.1.4), (A24)+(B2.1.6), (A24)+(B2.1.7), (A24)+(B2.1.8), (A24)+(B2.1.9), (A24)+(B2.1.10), (A24)+(B2.1.11), (A24)+(B2.1.12), (A24)+(B2.1.13), (A24)+(B2.1.13); (A24)+(B2.2.1), (A24)+(B2.2.2), (A24)+(B2.2.3), (A24)+(B2.2.3−RS), (A24)+(B2.2.4), (A24)+(B2.2.4−RS) (A24)+(B2.2.5), (A24)+(B2.2.6), (A24)+(B2.2.7), (A24)+(B2.2.8), (A24)+(B2.3.1), (A24)+(B2.3.2); (A24)+(B2.4.1), (A24)+(B2.4.2.), (A24)+(B2.4.3); (A24)+(B2.5.1), (A24)+(B2.5.2); (A24)+(B2.6.1), (A24)+(B2.6.2), (A24)+(B2.6.3), (A24)+(B2.6.4), (A24)+(B2.6.5), (A24)+(B2.6.6), (A24)+(B2.6.7), (A24)+(B2.6.8), (A24)+(B2.6.9), (A24)+(B2.6.10), (A24)+(B2.6.11), (A24)+(B2.6.12), (A24)+(B2.6.13), (A24)+(B2.6.14), (A24)+(B2.6.15); (A24)+(B3.1.1), (A24)+(B3.1.2), (A24)+(B3.1.3), (A24)+(B3.1.4), (A24)+(B3.1.5), (A24)+(B3.1.6), (A24)+(B3.1.7), (A24)+(B3.1.8), (A24)+(B3.1.9), (A24)+(B3.1.10), (A24)+(B3.1.11); (A24)+(B3.2.1), (A24)+(B3.2.2), (A24)+(B3.2.3); (A24)+(B3.3.1), (A24)+(B3.3.2), (A24)+(B3.3.2−RS), (A24)+(B3.3.3); (A24)+(B3.4.1), (A24)+(B3.4.2), (A24)+(B3.4.3), (A24)+(B3.4.4), (A24)+(B3.4.5), (A24)+(B3.4.6), (A24)+(B3.4.7), (A24)+(B3.4.8), (A24)+(B3.4.9), (A24)+(B3.4.10), (A24)+(B3.4.11), (A24)+(B3.4.12), (A24)+(B3.4.13), (A24)+(B3.4.14), (A24)+(B3.4.15), (A24)+(B3.4.16), (A24)+(B3.4.17), (A24)+(B3.4.18); (A24)+(B3.4.19); (A24)+(B4.1.1), (A24)+(B4.1.2); (A24)+(B4.2.1), (A24)+(B4.2.2); (A24)+(B4.3.1), (A24)+(B4.3.2), (A24)+(B4.3.3), (A24)+(B4.3.4), (A24)+(B4.3.5), (A24)+(B4.3.6); (A24)+(B4.4.1), (A24)+(B4.4.2), (A24)+(B4.4.3), (A24)+(B4.4.4);

(A25)+(B1.1.1), (A25)+(B1.1.2.); (A25)+(B1.2.1), (A25)+(B1.2.2.), (A25)+(B1.2.3); (A25)+(B1.3.1), (A25)+(B1.3.2.), (A25)+(B1.3.3), (A25)+(B1.3.4), (A25)+(B1.3.5), (A25)+(B1.3.6), (A25)+(B1.3.7), (A25)+(B1.3.8); (A25)+(B1.4.1), (A25)+(B1.4.2), (A25)+(B1.4.3), (A25)+(B1.4.4), (A25)+(B1.4.5); (A25)+(B1.5.1), (A25)+(B1.5.2), (A25)+(B1.5.3), (A25)+(B1.5.4); (A25)+(B1.6.1), (A25)+(B1.6.2), (A25)+(B1.6.3), (A25)+(B1.6.4), (A25)+(B1.6.5), (A25)+(B1.6.6), (A25)+(B1.6.7), (A25)+(B1.6.8), (A25)+(B1.6.9), (A25)+(B1.6.10), (A25)+(B1.6.11), (A25)+(B1.6.12), (A25)+(B1.6.13), (A25)+(B1.6.14), (A25)+(B1.6.15), (A25)+(B1.6.16), (A25)+(B1.6.17), (A25)+(B1.6.18); (A25)+(B1.6.19); (A25)+(B2.1.1), (A25)+(B2.1.2), (A25)+(B2.1.3), (A25)+(B2.1.4), (A25)+(B2.1.6), (A25)+(B2.1.7), (A25)+(B2.1.8), (A25)+(B2.1.9), (A25)+(B2.1.10), (A25)+(B2.1.11), (A25)+(B2.1.12), (A25)+(B2.1.13), (A25)+(B2.1.13); (A25)+(B2.2.1), (A25)+(B2.2.2), (A25)+(B2.2.3), (A25)+(B2.2.3−RS), (A25)+(B2.2.4), (A25)+(B2.2.4−RS) (A25)+(B2.2.5), (A25)+(B2.2.6), (A25)+(B2.2.7), (A25)+(B2.2.8), (A25)+(B2.3.1), (A25)+(B2.3.2); (A25)+(B2.4.1), (A25)+(B2.4.2.), (A25)+(B2.4.3); (A25)+(B2.5.1), (A25)+(B2.5.2); (A25)+(B2.6.1), (A25)+(B2.6.2), (A25)+(B2.6.3), (A25)+(B2.6.4), (A25)+(B2.6.5), (A25)+(B2.6.6), (A25)+(B2.6.7), (A25)+(B2.6.8), (A25)+(B2.6.9), (A25)+(B2.6.10), (A25)+(B2.6.11), (A25)+(B2.6.12), (A25)+(B2.6.13), (A25)+(B2.6.14), (A25)+(B2.6.15); (A25)+(B3.1.1), (A25)+(B3.1.2), (A25)+(B3.1.3), (A25)+(B3.1.4), (A25)+(B3.1.5), (A25)+(B3.1.6), (A25)+(B3.1.7), (A25)+(B3.1.8), (A25)+(B3.1.9), (A25)+(B3.1.10), (A25)+(B3.1.11); (A25)+(B3.2.1), (A25)+(B3.2.2), (A25)+(B3.2.3); (A25)+(B3.3.1), (A25)+(B3.3.2), (A25)+(B3.3.2−RS), (A25)+(B3.3.3); (A25)+(B3.4.1), (A25)+(B3.4.2), (A25)+(B3.4.3), (A25)+(B3.4.4), (A25)+(B3.4.5), (A25)+(B3.4.6), (A25)+(B3.4.7), (A25)+(B3.4.8), (A25)+(B3.4.9), (A25)+(B3.4.10), (A25)+(B3.4.11), (A25)+(B3.4.12), (A25)+(B3.4.13), (A25)+(B3.4.14), (A25)+(B3.4.15); (A25)+(B3.4.16), (A25)+(B3.4.17), (A25)+(B3.4.18); (A25)+(B3.4.19); (A25)+(B4.1.1), (A25)+(B4.1.2); (A25)+(B4.2.1), (A25)+(B4.2.2); (A25)+(B4.3.1), (A25)+(B4.3.2), (A25)+(B4.3.3), (A25)+(B4.3.4), (A25)+(B4.3.5), (A25)+(B4.3.6); (A25)+(B4.4.1), (A25)+(B4.4.2), (A25)+(B4.4.3), (A25)+(B4.4.4);

(A26)+(B1.1.1), (A26)+(B1.1.2.); (A26)+(B1.2.1), (A26)+(B1.2.2.), (A26)+(B1.2.3); (A26)+(B1.3.1), (A26)+(B1.3.2.), (A26)+(B1.3.3), (A26)+(B1.3.4), (A26)+(B1.3.5), (A26)+(B1.3.6), (A26)+(B1.3.7), (A26)+(B1.3.8); (A26)+(B1.4.1), (A26)+(B1.4.2), (A26)+(B1.4.3), (A26)+(B1.4.4), (A26)+(B1.4.5); (A26)+(B1.5.1), (A26)+(B1.5.2), (A26)+(B1.5.3), (A26)+(B1.5.4); (A26)+(B1.6.1), (A26)+(B1.6.2), (A26)+(B1.6.3), (A26)+(B1.6.4), (A26)+(B1.6.5), (A26)+(B1.6.6), (A26)+(B1.6.7), (A26)+(B1.6.8), (A26)+(B1.6.9), (A26)+(B1.6.10), (A26)+(B1.6.11), (A26)+(B1.6.12), (A26)+(B1.6.13), (A26)+(B1.6.14), (A26)+(B1.6.15), (A26)+(B1.6.16), (A26)+(B1.6.17), (A26)+(B1.6.18); (A26)+(B1.6.19); (A26)+(B2.1.1), (A26)+(B2.1.2), (A26)+(B2.1.3), (A26)+(B2.1.4), (A26)+(B2.1.6), (A26)+(B2.1.7), (A26)+(B2.1.8), (A26)+(B2.1.9), (A26)+(B2.1.10), (A26)+(B2.1.11), (A26)+(B2.1.12), (A26)+(B2.1.13), (A26)+(B2.1.13); (A26)+(B2.2.1), (A26)+(B2.2.2), (A26)+(B2.2.3), (A26)+(B2.2.3−RS), (A26)+(B2.2.4), (A26)+(B2.2.4−RS) (A26)+(B2.2.5), (A26)+(B2.2.6), (A26)+(B2.2.7), (A26)+(B2.2.8), (A26)+(B2.3.1), (A26)+(B2.3.2); (A26)+(B2.4.1), (A26)+(B2.4.2.), (A26)+(B2.4.3); (A26)+(B2.5.1), (A26)+(B2.5.2); (A26)+(B2.6.1), (A26)+(B2.6.2), (A26)+(B2.6.3), (A26)+(B2.6.4), (A26)+(B2.6.5), (A26)+(B2.6.6), (A26)+(B2.6.7), (A26)+(B2.6.8), (A26)+(B2.6.9), (A26)+(B2.6.10), (A26)+(B2.6.11), (A26)+(B2.6.12), (A26)+(B2.6.13), (A26)+(B2.6.14), (A26)+(B2.6.15); (A26)+(B3.1.1), (A26)+(B3.1.2), (A26)+(B3.1.3), (A26)+(B3.1.4), (A26)+(B3.1.5), (A26)+(B3.1.6), (A26)+(B3.1.7), (A26)+(B3.1.8), (A26)+(B3.1.9), (A26)+(B3.1.10), (A26)+(B3.1.11); (A26)+(B3.2.1), (A26)+(B3.2.2), (A26)+(B3.2.3); (A26)+(B3.3.1), (A26)+(B3.3.2), (A26)+(B3.3.2−RS), (A26)+(B3.3.3); (A26)+(B3.4.1), (A26)+(B3.4.2), (A26)+(B3.4.3), (A26)+(B3.4.4), (A26)+(B3.4.5), (A26)+(B3.4.6), (A26)+(B3.4.7), (A26)+(B3.4.8), (A26)+(B3.4.9), (A26)+(B3.4.10), (A26)+(B3.4.11), (A26)+(B3.4.12), (A26)+(B3.4.13), (A26)+(B3.4.14), (A26)+(B3.4.15), (A26)+(B3.4.16), (A26)+(B3.4.17), (A26)+(B3.4.18); (A26)+(B3.4.19); (A26)+(B4.1.1), (A26)+(B4.1.2); (A26)+(B4.2.1), (A26)+(B4.2.2); (A26)+(B4.3.1), (A26)+(B4.3.2), (A26)+(B4.3.3), (A26)+(B4.3.4), (A26)+(B4.3.5), (A26)+(B4.3.6); (A26)+(B4.4.1), (A26)+(B4.4.2), (A26)+(B4.4.3), (A26)+(B4.4.4);

(A27)+(B1.1.1), (A27)+(B1.1.2.); (A27)+(B1.2.1), (A27)+(B1.2.2.), (A27)+(B1.2.3); (A27)+(B1.3.1), (A27)+(B1.3.2.), (A27)+(B1.3.3), (A27)+(B1.3.4), (A27)+(B1.3.5), (A27)+(B1.3.6), (A27)+(B1.3.7), (A27)+(B1.3.8); (A27)+(B1.4.1), (A27)+(B1.4.2), (A27)+(B1.4.3), (A27)+(B1.4.4), (A27)+(B1.4.5); (A27)+(B1.5.1), (A27)+(B1.5.2), (A27)+(B1.5.3), (A27)+(B1.5.4); (A27)+(B1.6.1), (A27)+(B1.6.2), (A27)+(B1.6.3), (A27)+(B1.6.4), (A27)+(B1.6.5), (A27)+(B1.6.6), (A27)+(B1.6.7), (A27)+(B1.6.8), (A27)+(B1.6.9), (A27)+(B1.6.10), (A27)+(B1.6.11), (A27)+(B1.6.12), (A27)+(B1.6.13), (A27)+(B1.6.14), (A27)+(B1.6.15), (A27)+(B1.6.16), (A27)+(B1.6.17), (A27)+(B1.6.18); (A27)+(B1.6.19); (A27)+(B2.1.1), (A27)+(B2.1.2), (A27)+(B2.1.3), (A27)+(B2.1.4), (A27)+(B2.1.6), (A27)+(B2.1.7), (A27)+(B2.1.8), (A27)+(B2.1.9), (A27)+(B2.1.10), (A27)+(B2.1.11), (A27)+(B2.1.12), (A27)+(B2.1.13), (A27)+(B2.1.13); (A27)+(B2.2.1), (A27)+(B2.2.2), (A27)+(B2.2.3), (A27)+(B2.2.3−RS), (A27)+(B2.2.4), (A27)+(B2.2.4−RS) (A27)+(B2.2.5), (A27)+(B2.2.6), (A27)+(B2.2.7), (A27)+(B2.2.8), (A27)+(B2.3.1), (A27)+(B2.3.2); (A27)+(B2.4.1), (A27)+(B2.4.2.), (A27)+(B2.4.3); (A27)+(B2.5.1), (A27)+(B2.5.2); (A27)+(B2.6.1), (A27)+(B2.6.2), (A27)+(B2.6.3), (A27)+(B2.6.4), (A27)+(B2.6.5), (A27)+(B2.6.6), (A27)+(B2.6.7), (A27)+(B2.6.8), (A27)+(B2.6.9), (A27)+(B2.6.10), (A27)+(B2.6.11), (A27)+(B2.6.12), (A27)+(B2.6.13), (A27)+(B2.6.14), (A27)+(B2.6.15); (A27)+(B3.1.1), (A27)+(B3.1.2), (A27)+(B3.1.3), (A27)+(B3.1.4), (A27)+(B3.1.5), (A27)+(B3.1.6), (A27)+(B3.1.7), (A27)+(B3.1.8), (A27)+(B3.1.9), (A27)+(B3.1.10), (A27)+(B3.1.11); (A27)+(B3.2.1), (A27)+(B3.2.2), (A27)+(B3.2.3); (A27)+(B3.3.1), (A27)+(B3.3.2), (A27)+(B3.3.2−RS), (A27)+(B3.3.3); (A27)+(B3.4.1), (A27)+(B3.4.2), (A27)+(B3.4.3), (A27)+(B3.4.4), (A27)+(B3.4.5), (A27)+(B3.4.6), (A27)+(B3.4.7), (A27)+(B3.4.8), (A27)+(B3.4.9), (A27)+(B3.4.10), (A27)+(B3.4.11), (A27)+(B3.4.12), (A27)+(B3.4.13), (A27)+(B3.4.14), (A27)+(B3.4.15), (A27)+(B3.4.16), (A27)+(B3.4.17), (A27)+(B3.4.18); (A27)+(B3.4.19); (A27)+(B4.1.1), (A27)+(B4.1.2); (A27)+(B4.2.1), (A27)+(B4.2.2); (A27)+(B4.3.1), (A27)+(B4.3.2), (A27)+(B4.3.3), (A27)+(B4.3.4), (A27)+(B4.3.5), (A27)+(B4.3.6); (A27)+(B4.4.1), (A27)+(B4.4.2), (A27)+(B4.4.3), (A27)+(B4.4.4);

(A28)+(B1.1.1), (A28)+(B1.1.2.); (A28)+(B1.2.1), (A28)+(B1.2.2.), (A28)+(B1.2.3); (A28)+(B1.3.1), (A28)+(B1.3.2.), (A28)+(B1.3.3), (A28)+(B1.3.4), (A28)+(B1.3.5), (A28)+(B1.3.6), (A28)+(B1.3.7), (A28)+(B1.3.8); (A28)+(B1.4.1), (A28)+(B1.4.2), (A28)+(B1.4.3), (A28)+(B1.4.4), (A28)+(B1.4.5); (A28)+(B1.5.1), (A28)+(B1.5.2), (A28)+(B1.5.3), (A28)+(B1.5.4); (A28)+(B1.6.1), (A28)+(B1.6.2), (A28)+(B1.6.3), (A28)+(B1.6.4), (A28)+(B1.6.5), (A28)+(B1.6.6), (A28)+(B1.6.7), (A28)+(B1.6.8), (A28)+(B1.6.9), (A28)+(B1.6.10), (A28)+(B1.6.11), (A28)+(B1.6.12), (A28)+(B1.6.13), (A28)+(B1.6.14), (A28)+(B1.6.15), (A28)+(B1.6.16), (A28)+(B1.6.17), (A28)+(B1.6.18); (A28)+(B1.6.19); (A28)+(B2.1.1), (A28)+(B2.1.2), (A28)+(B2.1.3), (A28)+(B2.1.4), (A28)+(B2.1.6), (A28)+(B2.1.7), (A28)+(B2.1.8), (A28)+(B2.1.9), (A28)+(B2.1.10), (A28)+(B2.1.11), (A28)+(B2.1.12), (A28)+(B2.1.13), (A28)+(B2.1.13); (A28)+(B2.2.1), (A28)+(B2.2.2), (A28)+(B2.2.3), (A28)+(B2.2.3−RS), (A28)+(B2.2.4), (A28)+(B2.2.4−RS) (A28)+(B2.2.5), (A28)+(B2.2.6), (A28)+(B2.2.7), (A28)+(B2.2.8),(A28)+(B2.3.1), (A28)+(B2.3.2); (A28)+(B2.4.1), (A28)+(B2.4.2.), (A28)+(B2.4.3); (A28)+(B2.5.1), (A28)+(B2.5.2); (A28)+(B2.6.1), (A28)+(B2.6.2), (A28)+(B2.6.3), (A28)+(B2.6.4), (A28)+(B2.6.5), (A28)+(B2.6.6), (A28)+(B2.6.7), (A28)+(B2.6.8), (A28)+(B2.6.9), (A28)+(B2.6.10), (A28)+(B2.6.11), (A28)+(B2.6.12), (A28)+(B2.6.13), (A28)+(B2.6.14), (A28)+(B2.6.15); (A28)+(B3.1.1), (A28)+(B3.1.2), (A28)+(B3.1.3), (A28)+(B3.1.4), (A28)+(B3.1.5), (A28)+(B3.1.6), (A28)+(B3.1.7), (A28)+(B3.1.8), (A28)+(B3.1.9), (A28)+(B3.1.10), (A28)+(B3.1.11); (A28)+(B3.2.1), (A28)+(B3.2.2), (A28)+(B3.2.3); (A28)+(B3.3.1), (A28)+(B3.3.2), (A28)+(B3.3.2−RS), (A28)+(B3.3.3); (A28)+(B3.4.1), (A28)+(B3.4.2), (A28)+(B3.4.3), (A28)+(B3.4.4), (A28)+(B3.4.5), (A28)+(B3.4.6), (A28)+(B3.4.7), (A28)+(B3.4.8), (A28)+(B3.4.9), (A28)+(B3.4.10), (A28)+(B3.4.11), (A28)+(B3.4.12), (A28)+(B3.4.13), (A28)+(B3.4.14), (A28)+(B3.4.15), (A28)+(B3.4.16), (A28)+(B3.4.17), (A28)+(B3.4.18); (A28)+(B3.4.19); (A28)+(B4.1.1), (A28)+(B4.1.2); (A28)+(B4.2.1), (A28)+(B4.2.2); (A28)+(B4.3.1), (A28)+(B4.3.2), (A28)+(B4.3.3), (A28)+(B4.3.4), (A28)+(B4.3,.5), (A28)+(B4.3.6); (A28)+(B4.4.1), (A28)+(B4.4.2), (A28)+(B4.4.3), (A28)+(B4.4.4);

(A29)+(B1.1.1), (A29)+(B1.1.2.); (A29)+(B1.2.1), (A29)+(B1.2.2.), (A29)+(B1.2.3); (A29)+(B1.3.1), (A29)+(B1.3.2.), (A29)+(B1.3.3), (A29)+(B1.3.4), (A29)+(B1.3.5), (A29)+(B1.3.6), (A29)+(B1.3.7), (A29)+(B1.3.8); (A29)+(B1.4.1), (A29)+(B1.4.2), (A29)+(B1.4.3), (A29)+(B1.4.4), (A29)+(B1.4.5); (A29)+(B1.5.1), (A29)+(B1.5.2), (A29)+(B1.5.3), (A29)+(B1.5.4); (A29)+(B1.6.1), (A29)+(B1.6.2), (A29)+(B1.6.3), (A29)+(B1.6.4), (A29)+(B1.6.5), (A29)+(B1.6.6), (A29)+(B1.6.7), (A29)+(B1.6.8), (A29)+(B1.6.9), (A29)+(B1.6.10), (A29)+(B1.6.11), (A29)+(B1.6.12), (A29)+(B1.6.13), (A29)+(B1.6.14), (A29)+(B1.6.15), (A29)+(B1.6.16), (A29)+(B1.6.17), (A29)+(B1.6.18); (A29)+(B1.6.19); (A29)+(B2.1.1), (A29)+(B2.1.2), (A29)+(B2.1.3), (A29)+(B2.1.4), (A29)+(B2.1.6), (A29)+(B2.1.7), (A29)+(B2.1.8), (A29)+(B2.1.9), (A29)+(B2.1.10), (A29)+(B2.1.11), (A29)+(B2.1.12), (A29)+(B2.1.13), (A29)+(B2.1.13); (A29)+(B2.2.1), (A29)+(B2.2.2), (A29)+(B2.2.3), (A29)+(B2.2.3−RS), (A29)+(B2.2.4), (A29)+(B2.2.4−RS) (A29)+(B2.2.5), (A29)+(B2.2.6), (A29)+(B2.2.7), (A29)+(B2.2.8), (A29)+(B2.3.1), (A29)+(B2.3.2); (A29)+(B2.4.1), (A29)+(B2.4.2.), (A29)+(B2.4.3); (A29)+(B2.5.1), (A29)+(B2.5.2); (A29)+(B2.6.1), (A29)+(B2.6.2), (A29)+(B2.6.3), (A29)+(B2.6.4), (A29)+(B2.6.5), (A29)+(B2.6.6), (A29)+(B2.6.7), (A29)+(B2.6.8), (A29)+(B2.6.9), (A29)+(B2.6.10), (A29)+(B2.6.11), (A29)+(B2.6.12), (A29)+(B2.6.13), (A29)+(B2.6.14), (A29)+(B2.6.15); (A29)+(B3.1.1), (A29)+(B3.1.2), (A29)+(B3.1.3), (A29)+(B3.1.4), (A29)+(B3.1.5), (A29)+(B3.1.6), (A29)+(B3.1.7), (A29)+(B3.1.8), (A29)+(B3.1.9), (A29)+(B3.1.10), (A29)+(B3.1.11); (A29)+(B3.2.1), (A29)+(B3.2.2), (A29)+(B3.2.3); (A29)+(B3.3.1), (A29)+(B3.3.2), (A29)+(B3.3.2−RS), (A29)+(B3.3.3); (A29)+(B3.4.1), (A29)+(B3.4.2), (A29)+(B3.4.3), (A29)+(B3.4.4), (A29)+(B3.4.5), (A29)+(B3.4.6), (A29)+(B3.4.7), (A29)+(B3.4.8), (A29)+(B3.4.9), (A29)+(B3.4.10), (A29)+(B3.4.11), (A29)+(B3.4.12), (A29)+(B3.4.13), (A29)+(B3.4.14), (A29)+(B3.4.15), (A29)+(B3.4.16), (A29)+(B3.4.17), (A29)+(B3.4.18); (A29)+(B3.4.19); (A29)+(B4.1.1), (A29)+(B4.1.2); (A29)+(B4.2.1), (A29)+(B4.2.2); (A29)+(B4.3.1), (A29)+(B4.3.2), (A29)+(B4.3.3), (A29)+(B4.3.4), (A29)+(B4.3.5), (A29)+(B4.3.6); (A29)+(B4.4.1), (A29)+(B4.4.2), (A29)+(B4.4.3), (A29)+(B4.4.4);

(A30)+(B1.1.1), (A30)+(B1.1.2.); (A30)+(B1.2.1), (A30)+(B1.2.2.), (A30)+(B1.2.3); (A30)+(B1.3.1), (A30)+(B1.3.2.), (A30)+(B1.3.3), (A30)+(B1.3.4), (A30)+(B1.3.5), (A30)+(B1.3.6), (A30)+(B1.3.7), (A30)+(B1.3.8); (A30)+(B1.4.1), (A30)+(B1.4.2), (A30)+(B1.4.3), (A30)+(B1.4.4), (A30)+(B1.4.5); (A30)+(B1.5.1), (A30)+(B1.5.2), (A30)+(B1.5.3), (A30)+(B1.5.4); (A30)+(B1.6.1), (A30)+(B1.6.2), (A30)+(B1.6.3), (A30)+(B1.6.4), (A30)+(B1.6.5), (A30)+(B1.6.6), (A30)+(B1.6.7), (A30)+(B1.6.8), (A30)+(B1.6.9), (A30)+(B1.6.10), (A30)+(B1.6.11), (A30)+(B1.6.12), (A30)+(B1.6.13), (A30)+(B1.6.14), (A30)+(B1.6.15), (A30)+(B1.6.16), (A30)+(B1.6.17), (A30)+(B1.6.18); (A30)+(B1.6.19); (A30)+(B2.1.1), (A30)+(B2.1.2), (A30)+(B2.1.3), (A30)+(B2.1.4), (A30)+(B2.1.6), (A30)+(B2.1.7), (A30)+(B2.1.8), (A30)+(B2.1.9), (A30)+(B2.1.10), (A30)+(B2.1.11), (A30)+(B2.1.12), (A30)+(B2.1.13), (A30)+(B2.1.13); (A30)+(B2.2.1), (A30)+(B2.2.2), (A30)+(B2.2.3), (A30)+(B2.2.3−RS), (A30)+(B2.2.4), (A30)+(B2.2.4−RS) (A30)+(B2.2.5), (A30)+(B2.2.6), (A30)+(B2.2.7), (A30)+(B2.2.8), (A30)+(B2.3.1), (A30)+(B2.3.2); (A30)+(B2.4.1), (A30)+(B2.4.2.), (A30)+(B2.4.3); (A30)+(B2.5.1), (A30)+(B2.5.2); (A30)+(B2.6.1), (A30)+(B2.6.2), (A30)+(B2.6.3), (A30)+(B2.6.4), (A30)+(B2.6.5), (A30)+(B2.6.6), (A30)+(B2.6.7), (A30)+(B2.6.8), (A30)+(B2.6.9), (A30)+(B2.6.10), (A30)+(B2.6.11), (A30)+(B2.6.12), (A30)+(B2.6.13), (A30)+(B2.6.14), (A30)+(B2.6.15); (A30)+(B3.1.1), (A30)+(B3.1.2), (A30)+(B3.1.3), (A30)+(B3.1.4), (A30)+(B3.1.5), (A30)+(B3.1.6), (A30)+(B3.1.7), (A30)+(B3.1.8), (A30)+(B3.1.9), (A30)+(B3.1.10), (A30)+(B3.1.11); (A30)+(B3.2.1), (A30)+(B3.2.2), (A30)+(B3.2.3); (A30)+(B3.3.1), (A30)+(B3.3.2), (A30)+(B3.3.2−RS), (A30)+(B3.3.3); (A30)+(B3.4.1), (A30)+(B3.4.2), (A30)+(B3.4.3), (A30)+(B3.4.4), (A30)+(B3.4.5), (A30)+(B3.4.6), (A30)+(B3.4.7), (A30)+(B3.4.8), (A30)+(B3.4.9), (A30)+(B3.4.10), (A30)+(B3.4.11), (A30)+(B3.4.12), (A30)+(B3.4.13), (A30)+(B3.4.14), (A30)+(B3.4.15), (A30)+(B3.4.16), (A30)+(B3.4.17), (A30)+(B3.4.18); (A30)+(B3.4.19); (A30)+(B4.1.1), (A30)+(B4.1.2); (A30)+(B4.2.1), (A30)+(B4.2.2); (A30)+(B4.3.1), (A30)+(B4.3.2), (A30)+(B4.3.3), (A30)+(B4.3.4), (A30)+(B4.3.5), (A30)+(B4.3.6); (A30)+(B4.4.1), (A30)+(B4.4.2), (A30)+(B4.4.3), (A30)+(B4.4.4);

(A31)+(B1.1.1), (A31)+(B1.1.2.); (A31)+(B1.2.1), (A31)+(B1.2.2.), (A31)+(B1.2.3); (A31)+(B1.3.1), (A31)+(B1.3.2.), (A31)+(B1.3.3), (A31)+(B1.3.4), (A31)+(B1.3.5), (A31)+(B1.3.6), (A31)+(B1.3.7), (A31)+(B1.3.8); (A31)+(B1.4.1), (A31)+(B1.4.2), (A31)+(B1.4.3), (A31)+(B1.4.4), (A31)+(B1.4.5); (A31)+(B1.5.1), (A31)+(B1.5.2), (A31)+(B1.5.3), (A31)+(B1.5.4); (A31)+(B1.6.1), (A31)+(B1.6.2), (A31)+(B1.6.3), (A31)+(B1.6.4), (A31)+(B1.6.5), (A31)+(B1.6.6), (A31)+(B1.6.7), (A31)+(B1.6.8), (A31)+(B1.6.9), (A31)+(B1.6.10), (A31)+(B1.6.11), (A31)+(B1.6.12), (A31)+(B1.6.13), (A31)+(B1.6.14), (A31)+(B1.6.15), (A31)+(B1.6.16), (A31)+(B1.6.17), (A31)+(B1.6.18); (A31)+(B1.6.19); (A31)+(B2.1.1), (A31)+(B2.1.2), (A31)+(B2.1.3), (A31)+(B2.1.4), (A31)+(B2.1.6), (A31)+(B2.1.7), (A31)+(B2.1.8), (A31)+(B2.1.9), (A31)+(B2.1.10), (A31)+(B2.1.11), (A31)+(B2.1.12), (A31)+(B2.1.13), (A31)+(B2.1.13); (A31)+(B2.2.1), (A31)+(B2.2.2), (A31)+(B2.2.3), (A31)+(B2.2.3−RS), (A31)+(B2.2.4), (A31)+(B2.2.4−RS) (A31)+(B2.2.5), (A31)+(B2.2.6), (A31)+(B2.2.7), (A31)+(B2.2.8), (A31)+(B2.3.1), (A31)+(B2.3.2); (A31)+(B2.4.1), (A31)+(B2.4.2.), (A31)+(B2.4.3); (A31)+(B2.5.1), (A31)+(B2.5.2); (A31)+(B2.6.1), (A31)+(B2.6.2), (A31)+(B2.6.3), (A31)+(B2.6.4), (A31)+(B2.6.5), (A31)+(B2.6.6), (A31)+(B2.6.7), (A31)+(B2.6.8), (A31)+(B2.6.9), (A31)+(B2.6.10), (A31)+(B2.6.11), (A31)+(B2.6.12), (A31)+(B2.6.13), (A31)+(B2.6.14), (A31)+(B2.6.15); (A31)+(B3.1.1), (A31)+(B3.1.2), (A31)+(B3.1.3), (A31)+(B3.1.4), (A31)+(B3.1.5), (A31)+(B3.1.6), (A31)+(B3.1.7), (A31)+(B3.1.8), (A31)+(B3.1.9), (A31)+(B3.1.10), (A31)+(B3.1.11); (A31)+(B3.2.1), (A31)+(B3.2.2), (A31)+(B3.2.3); (A31)+(B3.3.1), (A31)+(B3.3.2), (A31)+(B3.3.2−RS), (A31)+(B3.3.3); (A31)+(B3.4.1), (A31)+(B3.4.2), (A31)+(B3.4.3), (A31)+(B3.4.4), (A31)+(B3.4.5), (A31)+(B3.4.6), (A31)+(B3.4.7), (A31)+(B3.4.8), (A31)+(B3.4.9), (A31)+(B3.4.10), (A31)+(B3.4.11), (A31)+(B3.4.12), (A31)+(B3.4.13), (A31)+(B3.4.14), (A31)+(B3.4.15), (A31)+(B3.4.16), (A31)+(B3.4.17), (A31)+(B3.4.18); (A31)+(B3.4.19); (A31)+(B4.1.1), (A31)+(B4.1.2); (A31)+(B4.2.1), (A31)+(B4.2.2); (A31)+(B4.3.1), (A31)+(B4.3.2), (A31)+(B4.3.3), (A31)+(B4.3.4), (A31)+(B4.3.5), (A31)+(B4.3.6); (A31)+(B4.4.1), (A31)+(B4.4.2), (A31)+(B4.4.3), (A31)+(B4.4.4);

(A32)+(B1.1.1), (A32)+(B1.1.2.); (A32)+(B1.2.1), (A32)+(B1.2.2.), (A32)+(B1.2.3); (A32)+(B1.3.1), (A32)+(B1.3.2.), (A32)+(B1.3.3), (A32)+(B1.3.4), (A32)+(B1.3.5), (A32)+(B1.3.6), (A32)+(B1.3.7), (A32)+(B1.3.8); (A32)+(B1.4.1), (A32)+(B1.4.2), (A32)+(B1.4.3), (A32)+(B1.4.4), (A32)+(B1.4.5); (A32)+(B1.5.1), (A32)+(B1.5.2), (A32)+(B1.5.3), (A32)+(B1.5.4); (A32)+(B1.6.1), (A32)+(B1.6.2), (A32)+(B1.6.3), (A32)+(B1.6.4), (A32)+(B1.6.5), (A32)+(B1.6.6), (A32)+(B1.6.7), (A32)+(B1.6.8), (A32)+(B1.6.9), (A32)+(B1.6.10), (A32)+(B1.6.11), (A32)+(B1.6.12), (A32)+(B1.6.13), (A32)+(B1.6.14), (A32)+(B1.6.15), (A32)+(B1.6.16), (A32)+(B1.6.17), (A32)+(B1.6.18); (A32)+(B1.6.19); (A32)+(B2.1.1), (A32)+(B2.1.2), (A32)+(B2.1.3), (A32)+(B2.1.4), (A32)+(B2.1.6), (A32)+(B2.1.7), (A32)+(B2.1.8), (A32)+(B2.1.9), (A32)+(B2.1.10), (A32)+(B2.1.11), (A32)+(B2.1.12), (A32)+(B2.1.13), (A32)+(B2.1.13); (A32)+(B2.2.1), (A32)+(B2.2.2), (A32)+(B2.2.3), (A32)+(B2.2.3−RS), (A32)+(B2.2.4), (A32)+(B2.2.4−RS) (A32)+(B2.2.5), (A32)+(B2.2.6), (A32)+(B2.2.7), (A32)+(B2.2.8), (A32)+(B2.3.1), (A32)+(B2.3.2); (A32)+(B2.4.1), (A32)+(B2.4.2.), (A32)+(B2.4.3); (A32)+(B2.5.1), (A32)+(B2.5.2); (A32)+(B2.6.1), (A32)+(B2.6.2), (A32)+(B2.6.3), (A32)+(B2.6.4), (A32)+(B2.6.5), (A32)+(B2.6.6), (A32)+(B2.6.7), (A32)+(B2.6.8), (A32)+(B2.6.9), (A32)+(B2.6.10), (A32)+(B2.6.11), (A32)+(B2.6.12), (A32)+(B2.6.13), (A32)+(B2.6.14), (A32)+(B2.6.15); (A32)+(B3.1.1), (A32)+(B3.1.2), (A32)+(B3.1.3), (A32)+(B3.1.4), (A32)+(B3.1.5), (A32)+(B3.1.6), (A32)+(B3.1.7), (A32)+(B3.1.8), (A32)+(B3.1.9), (A32)+(B3.1.10), (A32)+(B3.1.11); (A32)+(B3.2.1), (A32)+(B3.2.2), (A32)+(B3.2.3); (A32)+(B3.3.1), (A32)+(B3.3.2), (A32)+(B3.3.2−RS), (A32)+(B3.3.3); (A32)+(B3.4.1), (A32)+(B3.4.2), (A32)+(B3.4.3), (A32)+(B3.4.4), (A32)+(B3.4.5), (A32)+(B3.4.6), (A32)+(B3.4.7), (A32)+(B3.4.8), (A32)+(B3.4.9), (A32)+(B3.4.10), (A32)+(B3.4.11), (A32)+(B3.4.12), (A32)+(B3.4.13), (A32)+(B3.4.14), (A32)+(B3.4.15); (A32)+(B3.4.16), (A32)+(B3.4.17), (A32)+(B3.4.18); (A32)+(B3.4.19); (A32)+(B4.1.1), (A32)+(B4.1.2); (A32)+(B4.2.1), (A32)+(B4.2.2); (A32)+(B4.3.1), (A32)+(B4.3.2), (A32)+(B4.3.3), (A32)+(B4.3.4), (A32)+(B4.3.5), (A32)+(B4.3.6); (A32)+(B4.4.1), (A32)+(B4.4.2), (A32)+(B4.4.3), (A32)+(B4.4.4);

(A33)+(B1.1.1), (A33)+(B1.1.2.); (A33)+(B1.2.1), (A33)+(B1.2.2.), (A33)+(B1.2.3); (A33)+(B1.3.1), (A33)+(B1.3.2.), (A33)+(B1.3.3), (A33)+(B1.3.4), (A33)+(B1.3.5), (A33)+(B1.3.6), (A33)+(B1.3.7), (A33)+(B1.3.8); (A33)+(B1.4.1), (A33)+(B1.4.2), (A33)+(B1.4.3), (A33)+(B1.4.4), (A33)+(B1.4.5); (A33)+(B1.5.1), (A33)+(B1.5.2), (A33)+(B1.5.3), (A33)+(B1.5.4); (A33)+(B1.6.1), (A33)+(B1.6.2), (A33)+(B1.6.3), (A33)+(B1.6.4), (A33)+(B1.6.5), (A33)+(B1.6.6), (A33)+(B1.6.7), (A33)+(B1.6.8), (A33)+(B1.6.9), (A33)+(B1.6.10), (A33)+(B1.6.11), (A33)+(B1.6.12), (A33)+(B1.6.13), (A33)+(B1.6.14), (A33)+(B1.6.15), (A33)+(B16.16), (A33)+(B1.6.17), (A33)+(B1.6.18); (A33)+(B1.6.19); (A33)+(B2.1.1), (A33)+(B2.1.2), (A33)+(B2.1.3), (A33)+(B2.1.4), (A33)+(B2.1.6), (A33)+(B2.1.7), (A33)+(B2.1.8), (A33)+(B2.1.9), (A33)+(B2.1.10), (A33)+(B2.1.11), (A33)+(B2.1.12), (A33)+(B2.1.13), (A33)+(B2.1.13); (A33)+(B2.2.1), (A33)+(B2.2.2), (A33)+(B2.2.3), (A33)+(B2.2.3−RS), (A33)+(B2.2.4), (A33)+(B2.2.4−RS) (A33)+(B2.2.5), (A33)+(B2.2.6), (A33)+(B2.2.7), (A33)+(B2.2.8), (A33)+(B2.3.1), (A33)+(B2.3.2); (A33)+(B2.4.1), (A33)+(B2.4.2.), (A33)+(B2.4.3); (A33)+(B2.5.1), (A33)+(B2.5.2); (A33)+(B2.6.1), (A33)+(B2.6.2), (A33)+(B2.6.3), (A33)+(B2.6.4), (A33)+(B2.6.5), (A33)+(B2.6.6), (A33)+(B2.6.7), (A33)+(B2.6.8), (A33)+(B2.6.9), (A33)+(B2.6.10), (A33)+(B2.6.11), (A33)+(B2.6.12), (A33)+(B2.6.13), (A33)+(B2.6.14)+(B2.6.15), (A33)+(B2.6.15); (A33)+(B3.1.1), (A33)+(B3.1.2), (A33)+(B3.1.3), (A33)+(B3.1.4), (A33)+(B3.1.5), (A33)+(B3.1.6), (A33)+(B3.1.7), (A33)+(B3.10.8), (A33)+(B3.1.9), (A33)+(B3.1.10), (A33)+(B3.1.11); (A33)+(B3.2.1), (A33)+(B3.2.2), (A33)+(B3.2.3); (A33)+(B3.3.1), (A33)+(B3.3.2), (A33)+(B3.3.2−RS), (A33)+(B3.3.3); (A33)+(B3.4.1), (A33)+(B3.4.2), (A33)+(B3.4.3), (A33)+(B3.4.4), (A33)+(B3.4.5), (A33)+(B3.4.6), (A33)+(B3.4.7), (A33)+(B3.4.8), (A33)+(B3.4.9), (A33)+(B3.4.10), (A33)+(B3.4.11), (A33)+(B3.4.12), (A33)+(B3.4.13), (A33)+(B3.4.14), (A33)+(B3.4.15), (A33)+(B3.4.16), (A33)+(B3.4.17), (A33)+(B3.4.18); (A33)+(B3.4.19); (A33)+(B4.1.1), (A33)+(B4.1.2); (A33)+(B4.2.1), (A33)+(B4.2.2); (A33)+(B4.3.1), (A33)+(B4.3.2), (A33)+(B4.3.3), (A33)+(B4.3.4), (A33)+(B4.3.5), (A33)+(B4.3.6); (A33)+(B4.4.1), (A33)+(B4.4.2), (A33)+(B4.4.3), (A33)+(B4.4-4);

(A34)+(B1.1.1), (A34)+(B1.1.2.); (A34)+(B1.2.1), (A34)+(B1.2.2.), (A34)+(B1.2.3); (A34)+(B1.3.1), (A34)+(B1.3.2.), (A34)+(B1.3.3), (A34)+(B1.3.4), (A34)+(B1.3.5), (A34)+(B1.3.6), (A34)+(B1.3.7), (A34)+(B1.3.8); (A34)+(B1.4.1), (A34)+(B1.4.2), (A34)+(B1.4.3), (A34)+(B1.4.4), (A34)+(B1.4.5); (A34)+(B1.5.1), (A34)+(B1.5.2), (A34)+(B1.5.3), (A34)+(B1.5.4); (A34)+(B1.6.1), (A34)+(B1.6.2), (A34)+(B1.6.3), (A34)+(B1.6.4), (A34)+(B1.6.5), (A34)+(B1.6.6), (A34)+(B1.6.7), (A34)+(B1.6.8), (A34)+(B1.6.9), (A34)+(B1.6.10), (A34)+(B1.6.11), (A34)+(B1.6.12), (A34)+(B1.6.13), (A34)+(B1.6.14), (A34)+(B1.6.15), (A34)+(B1.6.16), (A34)+(B1.6.17), (A34)+(B1.6.18); (A34)+(B1.6.19); (A34)+(B2.1.1), (A34)+(B2.1.2), (A34)+(B2.1.3), (A34)+(B2.1.4), (A34)+(B2.1.6), (A34)+(B2.1.7), (A34)+(B2.1.8), (A34)+(B2.1.9), (A34)+(B2.1.10), (A34)+(B2.1.11), (A34)+(B2.1.12), (A34)+(B2.1.13), (A34)+(B2.1.13); (A34)+(B2.2.1), (A34)+(B2.2.2), (A34)+(B2.2.3), (A34)+(B2.2.3−RS), (A34)+(B2.2.4), (A34)+(B2.2.4−RS) (A34)+(B2.2.5), (A34)+(B2.2.6), (A34)+(B2.2.7), (A34)+(B2.2.8), (A34)+(B2.3.1), (A34)+(B2.3.2); (A34)+(B2.4.1), (A34)+(B2.4.2.), (A34)+(B2.4.3); (A34)+(B2.5.1), (A34)+(B2.5.2); (A34)+(B2.6.1), (A34)+(B2.6.2), (A34)+(B2.6.3), (A34)+(B2.6.4), (A34)+(B2.6.5), (A34)+(B2.6.6), (A34)+(B2.6.7), (A34)+(B2.6.8), (A34)+(B2.6.9), (A34)+(B2.6.10), (A34)+(B2.6.11), (A34)+(B2.6.12), (A34)+(B2.6.13), (A34)+(B2.6.14), (A34)+(B2.6.15); (A34)+(B3.1.1), (A34)+(B3.1.2), (A34)+(B3.1.3), (A34)+(B3.1.4), (A34)+(B3.1.5), (A34)+(B3.1.6), (A34)+(B3.1.7), (A34)+(B3.1.8), (A34)+(B3.1.9), (A34)+(B3.1.10), (A34)+(B3.1.11); (A34)+(B3.2.1), (A34)+(B3.2.2), (A34)+(B3.2.3); (A34)+(B3.3.1), (A34)+(B3.3.2), (A34)+(B3.3.2−RS), (A34)+(B3.3.3); (A34)+(B3.4.1), (A34)+(B3.4.2), (A34)+(B3.4.3), (A34)+(B3.4.4), (A34)+(B3.4.5), (A34)+(B3.4.6), (A34)+(B3.4.7), (A34)+(B3.4.8), (A34)+(B3.4.9), (A34)+(B3.4.10), (A34)+(B3.4.11), (A34)+(B3.4.12), (A34)+(B3.4.13), (A34)+(B3.4.14), (A34)+(B3.4.15), (A34)+(B3.4.16), (A34)+(B3.4.17), (A34)+(B3.4.18); (A34)+(B3.4.19); (A34)+(B4.1.1), (A34)+(B4.1.2); (A34)+(B4.2.1), (A34)+(B4.2.2); (A34)+(B4.3.1), (A34)+(B4.3.2), (A34)+(B4.3.3), (A34)+(B4.3.4), (A34)+(B4.3.5), (A34)+(B4.3.6); (A34)+(B4.4.1), (A34)+(B4.4.2), (A34)+(B4.4.3), (A34)+(B4.4.4);

(A35)+(B1.1.1), (A35)+(B1.1.2.); (A35)+(B1.2.1), (A35)+(B1.2.2.), (A35)+(B1.2.3); (A35)+(B1.3.1), (A35)+(B1.3.2.), (A35)+(B1.3.3), (A35)+(B1.3.4), (A35)+(B1.3.5), (A35)+(B1.3.6), (A35)+(B1.3.7), (A35)+(B1.3.8); (A35)+(B1.4.1), (A35)+(B1.4.2), (A35)+(B1.4.3), (A35)+(B1.4.4), (A35)+(B1.4.5); (A35)+(B1.5.1), (A35)+(B1.5.2), (A35)+(B1.5.3), (A35)+(B1.5.4); (A35)+(B1.6.1), (A35)+(B1.6.2), (A35)+(B1.6.3), (A35)+(B1.6.4), (A35)+(B1.6.5), (A35)+(B1.6.6), (A35)+(B1.6.7), (A35)+(B1.6.8), (A35)+(B1.6.9), (A35)+(B1.6.10), (A35)+(B1.6.11), (A35)+(B1.6.12), (A35)+(B1.6.13), (A35)+(B1.6.14), (A35)+(B1.6.15), (A35)+(B1.6.16), (A35)+(B1.6.17), (A35)+(B1.6.18); (A35)+(B1.6.19); (A35)+(B2.1.1), (A35)+(B2.1.2), (A35)+(B2.1.3), (A35)+(B2.1.4), (A35)+(B2.1.6), (A35)+(B2.1.7), (A35)+(B2.1.8), (A35)+(B2.1.9), (A35)+(B2.1.10), (A35)+(B2.1.11), (A35)+(B2.1.12), (A35)+(B2.1.13), (A35)+(B2.1.13); (A35)+(B2.2.1), (A35)+(B2.2.2), (A35)+(B2.2.3), (A35)+(B2.2.3−RS), (A35)+(B2.2.4), (A35)+(B2.2.4−RS) (A35)+(B2.2.5), (A35)+(B2.2.6), (A35)+(B2.2.7), (A35)+(B2.2.8), (A35)+(B2.3.1), (A35)+(B2.3.2); (A35)+(B2.4.1), (A35)+(B2.4.2.), (A35)+(B2.4.3); (A35)+(B2.5.1), (A35)+(B2.5.2); (A35)+(B2.6.1), (A35)+(B2.6.2), (A35)+(B2.6.3), (A35)+(B2.6.4), (A35)+(B2.6.5), (A35)+(B2.6.6), (A35)+(B2.6.7), (A35)+(B2.6.8), (A35)+(B2.6.9), (A35)+(B2.6.10), (A35)+(B2.6.11), (A35)+(B2.6.12), (A35)+(B2.6.13), (A35)+(B2.6.14), (A35)+(B2.6.15); (A35)+(B3.1.1), (A35)+(B3.1.2), (A35)+(B3.1.3), (A35)+(B3.1.4), (A35)+(B3.1.5), (A35)+(B3.1.6), (A35)+(B3.1.7), (A35)+(B3.1.8), (A35)+(B3.1.9), (A35)+(B3.1.10), (A35)+(B3.1.11); (A35)+(B3.2.1), (A35)+(B3.2.2), (A35)+(B3.2.3); (A35)+(B3.3.1), (A35)+(B3.3.2), (A35)+(B3.3.2−RS), (A35)+(B3.3.3); (A35)+(B3.4.1), (A35)+(B3.4.2), (A35)+(B3.4.3), (A35)+(B3.4.4), (A35)+(B3.4.5), (A35)+(B3.4.6), (A35)+(B3.4.7), (A35)+(B3.4.8), (A35)+(B3.4.9), (A35)+(B3.4.10), (A35)+(B3.4.11), (A35)+(B3.4.12), (A35)+(B3.4.13), (A35)+(B3.4.14), (A35)+(B3.4.15), (A35)+(B3.4.16), (A35)+(B3.4.17), (A35)+(B3.4.18); (A35)+(B3.4.19); (A35)+(B4.1.1), (A35)+(B4.1.2); (A35)+(B4.2.1), (A35)+(B4.2.2); (A35)+(B4.3.1), (A35)+(B4.3.2), (A35)+(B4.3.3), (A35)+(B4.3.4), (A35)+(B4.3.5), (A35)+(B4.3.6); (A35)+(B4.4.1), (A35)+(B4.4.2), (A35)+(B4.4.3), (A35)+(B4.44).

(A36)+(B1.1.1), (A36)+(B1.1.2.); (A36)+(B1.2.1), (A36)+(B1.2.2.), (A36)+(B1.2.3); (A36)+(B1.3.1), (A36)+(B1.3.2.), (A36)+(B1.3.3), (A36)+(B1.3.4), (A36)+(B1.3.5), (A36)+(B1.3.6), (A36)+(B1.3.7), (A36)+(B1.3.8); (A36)+(B1.4.1), (A36)+(B1.4.2), (A36)+(B1.4.3), (A36)+(B1.4.4), (A36)+(B1.4.5); (A36)+(B1.5.1), (A36)+(B1.5.2), (A36)+(B1.5.3), (A36)+(B1.5.4); (A36)+(B1.6.1), (A36)+(B1.6.2), (A36)+(B1.6.3), (A36)+(B1.6.4), (A36)+(B1.6.5), (A36)+(B1.6.6), (A36)+(B1.6.7), (A36)+(B1.6.8), (A36)+(B1.6.9), (A36)+(B1.6.10), (A36)+(B1.6.11), (A36)+(B1.6.12), (A36)+(B1.6.13), (A36)+(B1.6.14), (A36)+(B1.6.15), (A36)+(B1.6.16), (A36)+(B1.6.17), (A36)+(B1.6.18); (A36)+(B1.6.19); (A36)+(B2.1.1), (A36)+(B2.1.2), (A36)+(B2.1.3), (A36)+(B2.1.4), (A36)+(B2.1.6), (A36)+(B2.1.7), (A36)+(B2.1.8), (A36)+(B2.1.9), (A36)+(B2.1.10), (A36)+(B2.1.11), (A36)+(B2.1.12), (A36)+(B2.1.13), (A36)+(B2.1.13); (A36)+(B2.2.1), (A36)+(B2.2.2), (A36)+(B2.2.3), (A36)+(B2.2.3−RS), (A36)+(B2.2.4), (A36)+(B2.2.4−RS) (A36)+(B2.2.5), (A36)+(B2.2.6), (A36)+(B2.2.7), (A36)+(B2.2.8), (A36)+(B2.3.1), (A36)+(B2.3.2); (A36)+(B2.4.1), (A36)+(B2.4.2.), (A36)+(B2.4.3); (A36)+(B2.5.1), (A36)+(B2.5.2); (A36)+(B2.6.1), (A36)+(B2.6.2), (A36)+(B2.6.3), (A36)+(B2.6.4), (A36)+(B2.6.5), (A36)+(B2.6.6), (A36)+(B2.6.7), (A36)+(B2.6.8), (A36)+(B2.6.9), (A36)+(B2.6.10), (A36)+(B2.6.11), (A36)+(B2.6.12), (A36)+(B2.6.13), (A36)+(B2.6.14), (A36)+(B2.6.15); (A36)+(B3.1.1), (A36)+(B3.1.2), (A36)+(B3.1.3), (A36)+(B3.1.4), (A36)+(B3.1.5), (A36)+(B3.1.6), (A36)+(B3.1.7), (A36)+(B3.1:.8), (A3⁶)+(B3.1.9), (A36)+(B3.1.10), (A36)+(B3.1.11); (A36)+(B3.2.1), (A36)+(B3.2.2), (A36)+(B3.2.3); (A36)+(B3.3.1), (A36)+(B3.3.2), (A36)+(B3.3.2−RS), (A36)+(B3.3.3); (A36)+(B3.4.1), (A36)+(B3.4.2), (A36)+(B3.4.3), (A36)+(B3.4.4), (A36)+(B3.4.5), (A36)+(B3.4.6), (A36)+(B3.4.7), (A36)+(B3.4.8), (A36)+(B3.4.9), (A36)+(B3.4.10), (A36)+(B3.4.11), (A36)+(B3.4.12), (A36)+(B3.4.13), (A36)+(B3.4.14), (A36)+(B3.4.15), (A36)+(B3.4.16), (A36)+(B3.4.17), (A36)+(B3.4.18); (A36)+(B3.4.19); (A36)+(B4.1.1), (A36)+(B4.1.2); (A36)+(B4.2.1), (A36)+(B4.2.2); (A36)+(B4.3.1), (A36)+(B4.3.2), (A36)+(B4.3.3), (A36)+(B4.3.4), (A36)+(B4.3.5), (A36)+(B4.3.6); (A36)+(B4.4.1), (A36)+(B4.4.2), (A36)+(B4.4.3), (A36)+(B4.4.4);

(A37)+(B1.1.1), (A37)+(B1.1.2.); (A37)+(B1.2.1), (A37)+(B1.2.2.), (A37)+(B1.2.3); (A37)+(B1.3.1), (A37)+(B1.3.2.), (A37)+(B1.3.3), (A37)+(B1.3.4), (A37)+(B1.3.5), (A37)+(B1.3.6), (A37)+(B1.3.7), (A37)+(B1.3.8); (A37)+(B1.4.1), (A37)+(B1.4.2), (A37)+(B1.4.3), (A37)+(B1.4.4), (A37)+(B1.4.5); (A37)+(B1.5.1), (A37)+(B1.5.2), (A37)+(B1.5.3), (A37)+(B1.5.4); (A37)+(B1.6.1), (A37)+(B1.6.2), (A37)+(B1.6.3), (A37)+(B1.6.4), (A37)+(B1.6.5), (A37)+(B1.6.6), (A37)+(B1.6.7), (A37)+(B1.6.8), (A37)+(B1.6.9), (A37)+(B1.6.10), (A37)+(B1.6.11), (A37)+(B1.6.12), (A37)+(B1.6.13), (A37)+(B1.6.14), (A37)+(B1.6.15), (A37)+(B1.6.16), (A37)+(B1.6.17), (A37)+(B1.6.18); (A37)+(B1.6.19); (A37)+(B2.1.1), (A37)+(B2.1.2), (A37)+(B2.1.3), (A37)+(B2.1.4), (A37)+(B2.1.6), (A37)+(B2.1.7), (A37)+(B2.1.8), (A37)+(B2.1.9), (A37)+(B2.1.10), (A37)+(B2.1.11), (A37)+(B2.1.12), (A37)+(B2.1.13), (A37)+(B2.1.13); (A37)+(B2.2.1), (A37)+(B2.2.2), (A37)+(B2.2.3), (A37)+(B2.2.3−RS), (A37)+(B2.2.4), (A37)+(B2.2.4−RS) (A37)+(B2.2.5), (A37)+(B2.2.6), (A37)+(B2.2.7), (A37)+(B2.2.8), (A37)+(B2.3.1), (A37)+(B2.3.2); (A37)+(B2.4.1), (A37)+(B2.4.2.), (A37)+(B2.4.3); (A37)+(B2.5.1), (A37)+(B2.5.2); (A37)+(B2.6.1), (A37)+(B2.6.2), (A37)+(B2.6.3), (A37)+(B2.6.4), (A37)+(B2.6.5), (A37)+(B2.6.6), (A37)+(B2.6.7), (A37)+(B2.6.8), (A37)+(B2.6.9), (A37)+(B2.6.10), (A37)+(B2.6.11), (A37)+(B2.6.12), (A37)+(B2.6.13), (A37)+(B2.6.14), (A37)+(B2.6.15); (A37)+(B3.1.1), (A37)+(B3.1.2), (A37)+(B3.1.3), (A37)+(B3.1.4), (A37)+(B3.1.5), (A37)+(B3.1.6), (A37)+(B3.1.7), (A37)+(B3.1.8), (A37)+(B3.1.9), (A37)+(B3.1.10), (A37)+(B3.1.11); (A37)+(B3.2.1), (A37)+(B3.2.2), (A37)+(B3.2.3); (A37)+(B3.3.1), (A37)+(B3.3.2), (A37)+(B3.3.2−RS), (A37)+(B3.3.3); (A37)+(B3.4.1), (A37)+(B3.4.2), (A37)+(B3.4.3), (A37)+(B3.4.4), (A37)+(B3.4.5), (A37)+(B3.4.6), (A37)+(B3.4.7), (A37)+(B3.4.8), (A37)+(B3.4.9), (A37)+(B3.4.10), (A37)+(B3.4.11), (A37)+(B3.4.12), (A37)+(B3.4.13), (A37)+(B3.4.14), (A37)+(B3.4.15), (A37)+(B3.4.16), (A37)+(B3.4.17), (A37)+(B3.4.18); (A37)+(B3.4.19); (A37)+(B4.1.1), (A37)+(B4.1.2); (A37)+(B4.2.1), (A37)+(B4.2.2); (A37)+(B4.3.1), (A37)+(B4.3.2), (A37)+(B4.3.3), (A37)+(B4.3.4), (A37)+(B4.3.5), (A37)+(B4.3.6); (A37)+(B4.4.1), (A37)+(B4.4.2), (A37)+(B4.4.3), (A37)+(B4.4.4);

(A38)+(B1.1.1), (A38)+(B1.1.2.); (A38)+(B1.2.1), (A38)+(B1.2.2.), (A38)+(B1.2.3); (A38)+(B1.3.1), (A38)+(B1.3.2.), (A38)+(B1.3.3), (A38)+(B1.3.4), (A38)+(B1.3.5), (A38)+(B1.3.6), (A38)+(B1.3.7), (A38)+(B1.3.8); (A38)+(B1.4.1), (A38)+(B1.4.2), (A38)+(B1.4.3), (A38)+(B1.4.4), (A38)+(B1.4.5); (A38)+(B1.5.1), (A38)+(B1.5.2), (A38)+(B1.5.3), (A38)+(B1.5.4); (A38)+(B1.6.1), (A38)+(B1.6.2), (A38)+(B1.6.3), (A38)+(B1.6.4), (A38)+(B1.6.5), (A38)+(B1.6.6), (A38)+(B1.6.7), (A38)+(B1.6.8), (A38)+(B1.6.9), (A38)+(B1.6.10), (A38)+(B1.6.11), (A38)+(B1.6.12), (A38)+(B1.6.13), (A38)+(B1.6.14), (A38)+(B1.6.15), (A38)+(B1.6.16), (A38)+(B1.6.17), (A38)+(B1.6.18); (A38)+(B1.6.19); (A38)+(B2.1.1), (A38)+(B2.1.2), (A38)+(B2.1.3), (A38)+(B2.1.4), (A38)+(B2.1.6), (A38)+(B2.1.7), (A38)+(B2.1.8), (A38)+(B2.1.9), (A38)+(B2.1.10), (A38)+(B2.1.11), (A38)+(B2.1.12), (A38)+(B2.1.13), (A38)+(B2.1.13); (A38)+(B2.2.1), (A38)+(B2.2.2), (A38)+(B2.2.3), (A38)+(B2.2.3−RS), (A38)+(B2.2.4), (A38)+(B2.2.4−RS) (A38)+(B2.2.5), (A38)+(B2.2.6), (A38)+(B2.2.7), (A38)+(B2.2.8), (A38)+(B2.3.1), (A38)+(B2.3.2); (A38)+(B2.4.1), (A38)+(B2.4.2.), (A38)+(B2.4.3); (A38)+(B2.5.1), (A38)+(B2.5.2); (A38)+(B2.6.1), (A38)+(B2.6.2), (A38)+(B2.6.3), (A38)+(B2.6.4), (A38)+(B2.6.5), (A38)+(B2.6.6), (A38)+(B2.6.7), (A38)+(B2.6.8), (A38)+(B2.6.9), (A38)+(B2.6.10), (A38)+(B2.6.11), (A38)+(B2.6.12), (A38)+(B2.6.13), (A38)+(B2.6.14), (A38)+(B2.6.15); (A38)+(B3.1.1), (A38)+(B3.1.2), (A38)+(B3.1.3), (A38)+(B3.1.4), (A38)+(B3.1.5), (A38)+(B3.1.6), (A38)+(B3.1.7), (A38)+(B3.1.8), (A38)+(B3.1.9), (A38)+(B3.1.10), (A38)+(B3.1.11); (A38)+(B3.2.1), (A38)+(B3.2.2), (A38)+(B3.2.3); (A38)+(B3.3.1), (A38)+(B3.3.2), (A38)+(B3.3.2−RS), (A38)+(B3.3.3); (A38)+(B3.4.1), (A38)+(B3.4.2), (A38)+(B3.4.3), (A38)+(B3.4.4), (A38)+(B3.4.5), (A38)+(B3.4.6), (A38)+(B3.4.7), (A38)+(B3.4.8), (A38)+(B3.4.9), (A38)+(B3.4.10), (A38)+(B3.4.11), (A38)+(B3.4.12), (A38)+(B3.4.13), (A38)+(B3.4.14), (A38)+(B3.4.15), (A38)+(B3.4.16), (A38)+(B3.4.17), (A38)+(B3.4.18); (A38)+(B3.4.19); (A38)+(B4.1.1), (A38)+(B4.1.2); (A38)+(B4.2.1), (A38)+(B4.2.2); (A38)+(B4.3.1), (A38)+(B4.3.2), (A38)+(B4.3.3), (A38)+(B4.3.4), (A38)+(B4.3.5), (A38)+(B4.3.6); (A38)+(B4.4.1), (A38)+(B4.4.2), (A38)+(B4.4.3), (A38)+(B4.⁴L4);

(A39)+(B1.1.1), (A39)+(B1.1.2.); (A39)+(B1.2.1), (A39)+(B1.2.2.), (A39)+(B1.2.3); (A39)+(B1.3.1), (A39)+(B1.3.2.), (A39)+(B1.3.3), (A39)+(B1.3.4), (A39)+(B1.3.5), (A39)+(B1.3.6), (A39)+(B1.3.7), (A39)+(B1.3.8); (A39)+(B1.4.1), (A39)+(B1.4.2), (A39)+(B1.4.3), (A39)+(B1.4.4), (A39)+(B1.4.5); (A39)+(B1.5.1), (A39)+(B1.5.2), (A39)+(B1.5.3), (A39)+(B1.5.4); (A39)+(B1.6.1), (A39)+(B1.6.2), (A39)+(B1.6.3), (A39)+(B1.6.4), (A39)+(B1.6.5), (A39)+(B1.6.6), (A39)+(B1.6.7), (A39)+(B1.6.8), (A39)+(B1.6.9), (A39)+(B1.6.10), (A39)+(B1.6.11), (A39)+(B1.6.12), (A39)+(B1.6.13), (A39)+(B1.6.14), (A39)+(B1.6.15), (A39)+(B1.6.16), (A39)+(B1.6.17), (A39)+(B1.6.18); (A39)+(B1.6.19); (A39)+(B2.1.1), (A39)+(B2.1.2), (A39)+(B2.1.3), (A39)+(B2.1.4), (A39)+(B2.1.6), (A39)+(B2.1.7), (A39)+(B2.1.8), (A39)+(B2.1.9), (A39)+(B2.1.10), (A39)+(B2.1.11), (A39)+(B2.1.12), (A39)+(B2.1.13), (A39)+(B2.1.13); (A39)+(B2.2.1), (A39)+(B2.2.2), (A39)+(B2.2.3), (A39)+(B2.2.3−RS), (A39)+(B2.2.4), (A39)+(B2.2.4−RS) (A39)+(B2.2.5), (A39)+(B2.2.6), (A39)+(B2.2.7), (A39)+(B2.2.8), (A39)+(B2.3.1), (A39)+(B2.3.2); (A39)+(B2.4.1), (A39)+(B2.4.2.), (A39)+(B2.4.3); (A39)+(B2.5.1), (A39)+(B2.5.2); (A39)+(B2.6.1), (A39)+(B2.6.2), (A39)+(B2.6.3), (A39)+(B2.6.4), (A39)+(B2.6.5), (A39)+(B2.6.6), (A39)+(B2.6.7), (A39)+(B2.6.8), (A39)+(B2.6-0.9), (A39)+(B2.6.10), (A39)+(B2.6.11), (A39)+(B2.6.12), (A39)+(B2.6.13), (A39)+(B2.6.14), (A39)+(B2.6.15); (A39)+(B3.1.1), (A39)+(B3.1.2), (A39)+(B3.1.3), (A39)+(B3.1.4), (A39)+(B3.1.5), (A39)+(B3.1.6), (A39)+(B3.1.7), (A39)+(B3.1.8), (A39)+(B3.1.9), (A39)+(B3.11.10), (A39)+(B3.1.11); (A39)+(B3.2.1), (A39)+(B3.2.2), (A39)+(B3.2.3); (A39)+(B3.3.1), (A39)+(B3.3.2), (A39)+(B3.3.2−RS), (A39)+(B3.3.3); (A39)+(B3.4.1), (A39)+(B3.4.2), (A39)+(B3.4.3), (A39)+(B3.4.4), (A39)+(B3.4.5), (A39)+(B3.4.6), (A39)+(B3.4.7), (A39)+(B3.4.8), (A39)+(B3.4.9), (A39)+(B3.4.10), (A39)+(B3.4.11), (A39)+(B3.4.12), (A39)+(B3.4.13), (A39)+(B3.4.14), (A39)+(B3.4.15), (A39)+(B3.4.16), (A39)+(B3.4.17), (A39)+(B3.4.18); (A39)+(B3.4.19); (A39)+(B4.1.1), (A39)+(B4.1.2); (A39)+(B4.2.1), (A39)+(B4.2.2); (A39)+(B4.3.1), (A39)+(B4.3.2), (A39)+(B4.3.3), (A39)+(B4.3.4), (A39)+(B4.3.5), (A39)+(B4.3.6); (A39)+(B4.4.1), (A39)+(B4.4.2), (A39)+(B4.4.3), (A39)+(B4.4.4);

(A40)+(B1.1.1), (A40)+(B1.1.2.); (A40)+(B1.2.1), (A40)+(B1.2.2.), (A40)+(B1.2.3); (A40)+(B1.3.1), (A40)+(B1.3.2.), (A40)+(B1.3.3), (A40)+(B1.3.4), (A40)+(B1.3.5), (A40)+(B1.3.6), (A40)+(B1.3.7), (A40)+(B1.3.8); (A40)+(B1.4.1), (A40)+(B1.4.2), (A40)+(B1.4.3), (A40)+(B1.4.4), (A40)+(B1.4.5); (A40)+(B1.5.1), (A40)+(B1.5.2), (A40)+(B1.5.3), (A40)+(B1.5.4); (A40)+(B1.6.1), (A40)+(B1.6.2), (A40)+(B1.6.3), (A40)+(B1.6.4), (A40)+(B1.6.5), (A40)+(B1.6.6), (A40)+(B1.6.7), (A40)+(B1.6.8), (A40)+(B1.6.9), (A40)+(B1.6.10), (A40)+(B1.6.11), (A40)+(B1.6.12), (A40)+(B1.6.13), (A40)+(B1.6.14), (A40)+(B1.6.15), (A40)+(B1.6.16), (A40)+(B1.6.17), (A40)+(B1.6.18); (A40)+(B1.6.19); (A40)+(B2.1.1), (A40)+(B2.1.2), (A40)+(B2.1.3), (A40)+(B2.1.4), (A40)+(B2.1.6), (A40)+(B2.1.7), (A40)+(B2.1.8), (A40)+(B2.1.9), (A40)+(B2.1.10), (A40)+(B2.1.11), (A40)+(B2.1.12), (A40)+(B2.1.13), (A40)+(B2.1.13); (A40)+(B2.2.1), (A40)+(B2.2.2), (A40)+(B2.2.3), (A40)+(B2.2.3−RS), (A40)+(B2.2.4), (A40)+(B2.2.4−RS) (A40)+(B2.2.5), (A40)+(B2.2.6), (A40)+(B2.2.7), (A40)+(B2.2.8), (A40)+(B2.3.1), (A40)+(B2.3.2); (A40)+(B2.4.1), (A40)+(B2.4.2.), (A40)+(B2.4.3); (A40)+(B2.5.1), (A40)+(B2.5.2); (A40)+(B2.6.1), (A40)+(B2.6.2), (A40)+(B2.6.3), (A40)+(B2.6.4), (A40)+(B2.6.5), (A40)+(B2.6.6), (A40)+(B2.6.7), (A40)+(B2.6.8), (A40)+(B2.6.9), (A40)+(B2.6.10), (A40)+(B2.6.11), (A40)+(B2.6.12), (A40)+(B2.6.13), (A40)+(B2.6.14), (A40)+(B2.6.15); (A40)+(B3.1.1), (A40)+(B3.1.2), (A40)+(B3.1.3), (A40)+(B3.1.4), (A40)+(B3.1.5), (A40)+(B3.1.6), (A40)+(B3.1.7), (A40)+(B3.1.8), (A40)+(B3.1.9), (A40)+(B3.1.10), (A40)+(B3.1.11); (A40)+(B3.2.1), (A40)+(B3.2.2), (A40)+(B3.2.3); (A40)+(B3.3.1), (A40)+(B3.3.2), (A40)+(B3.3.2−RS), (A40)+(B3.3.3); (A40)+(B3.4.1), (A40)+(B3.4.2), (A40)+(B3.4.3), (A40)+(B3.4.4), (A40)+(B3.4.5), (A40)+(B3.4.6), (A40)+(B3.4.7), (A40)+(B3.4.8), (A40)+(B3.4.9), (A40)+(B3.4.10), (A40)+(B3.4.11), (A40)+(B3.4.12), (A40)+(B3.4.13), (A40)+(B3.4.14), (A40)+(B3.4.15), (A40)+(B3.4.16), (A40)+(B3.4.17), (A40)+(B3.4.18); (A40)+(B3.4.19); (A40)+(B4.1.1), (A40)+(B4.1.2); (A40)+(B4.2.1), (A40)+(B4.2.2); (A40)+(B4.3.1), (A40)+(B4.3.2), (A40)+(B4.3.3), (A40)+(B4.3.4), (A40)+(B4.3.5), (A40)+(B4.3.6); (A40)+(B4.4.1), (A40)+(B4.4.2), (A40)+(B4.4.3), (A40)+(B4.4.4);

(A41)+(B1.1.1), (A41)+(B1.1.2.); (A41)+(B1.2.1), (A41)+(B1.2.2.), (A41)+(B1.2.3); (A41)+(B1.3.1), (A41)+(B1.3.2.), (A41)+(B1.3.3), (A41)+(B1.3.4), (A41)+(B1.3.5), (A41)+(B1.3.6), (A41)+(B1.3.7), (A41)+(B1.3.8); (A41)+(B1.4.1), (A41)+(B1.4.2), (A41)+(B1.4.3), (A41)+(B1.4.4), (A41)+(B1.4.5); (A41)+(B1.5.1), (A41)+(B1.5.2), (A41)+(B1.5.3), (A41)+(B1.5.4); (A41)+(B1.6.1), (A41)+(B1.6.2), (A41)+(B1.6.3), (A41)+(B1.6.4), (A41)+(B1.6.5), (A41)+(B1.6.6), (A41)+(B1.6.7), (A41)+(B1.6.8), (A41)+(B1.6.9), (A41)+(B1.6.10), (A41)+(B1.6.11), (A41)+(B1.6.12), (A41)+(B1.6.13), (A41)+(B1.6.14), (A41)+(B1.6.15), (A41)+(B1.6.16), (A41)+(B1.6.17), (A41)+(B1.6.18); (A41)+(B1.6.19); (A41)+(B2.1.1), (A41)+(B2.1.2), (A41)+(B2.1.3), (A41)+(B2.1.4), (A41)+(B2.1.6), (A41)+(B2.1.7), (A41)+(B2.1.8), (A41)+(B2.1.9), (A41)+(B2.1.10), (A41)+(B2.1.11), (A41)+(B2.1.12), (A41)+(B2.1.13), (A41)+(B2.1.13); (A41)+(B2.2.1), (A41)+(B2.2.2), (A41)+(B2.2.3), (A41)+(B2.2.3−RS), (A41)+(B2.2.4), (A41)+(B2.2.4−RS) (A41)+(B2.2.5), (A41)+(B2.2.6), (A41)+(B2.2.7), (A41)+(B2.2.8), (A41)+(B2.3.1), (A41)+(B2.3.2); (A41)+(B2.4.1), (A41)+(B2.4.2.), (A41)+(B2.4.3); (A41)+(B2.5.1), (A41)+(B2.5.2); (A41)+(B2.6.1), (A41)+(B2.6.2), (A41)+(B2.6.3), (A41)+(B2.6.4), (A41)+(B2.6.5), (A41)+(B2.6.6), (A41)+(B2.6.7), (A41)+(B2.6.8), (A41)+(B2.6.9), (A41)+(B2.6.10), (A41)+(B2.6.11), (A41)+(B2.6.12), (A41)+(B2.6.13), (A41)+(B2.6.14), (A41)+(B2.6.15); (A41)+(B3.1.1), (A41)+(B3.1.2), (A41)+(B3.1.3), (A41)+(B3.1.4), (A41)+(B3.1.5), (A41)+(B3.1.6), (A41)+(B3.1.7), (A41)+(B3.1.8), (A41)+(B3.1.9), (A41)+(B3.1.10), (A41)+(B3.1.11); (A41)+(B3.2.1), (A41)+(B3.2.2), (A41)+(B3.2.3); (A41)+(B3.3.1), (A41)+(B3.3.2), (A41)+(B3.3.2−RS), (A41)+(B3.3.3); (A41)+(B3.4.1), (A41)+(B3.4.2), (A41)+(B3.4.3), (A41)+(B3.4.4), (A41)+(B3.4.5), (A41)+(B3.4.6), (A41)+(B3.4.7), (A41)+(B3.4.8), (A41)+(B3.4.9), (A41)+(B3.4.10), (A41)+(B3.4.11), (A41)+(B3.4.12), (A41)+(B3.4.13), (A41)+(B3.4.14), (A41)+(B3.4.15), (A41)+(B3.4.16), (A41)+(B3.4.17), (A41)+(B3.4.18); (A41)+(B3.4.19); (A41)+(B4.1.1), (A41)+(B4.1.2); (A41)+(B4.2.1), (A41)+(B4.2.2); (A41)+(B4.3.1), (A41)+(B4.3.2), (A41)+(B4.3.3), (A41)+(B4.3.4), (A41)+(B4.3.5), (A41)+(B4.3.6); (A41)+(B4.4.1), (A41)+(B4.4.2), (A41)+(B4.4.3), (A41)+(B4.4.4);

(A42)+(B1.1.1), (A42)+(B1.1.2.); (A42)+(B1.2.1), (A42)+(B1.2.2.), (A42)+(B1.2.3); (A42)+(B1.3.1), (A42)+(B1.3.2.), (A42)+(B1.3.3), (A42)+(B1.3.4), (A42)+(B1.3.5), (A42)+(B1.3.6), (A42)+(B1.3.7), (A42)+(B1.3.8); (A42)+(B1.4.1), (A42)+(B1.4.2), (A42)+(B1.4.3), (A42)+(B1.4.4), (A42)+(B1.4.5); (A42)+(B1.5.1), (A42)+(B1.5.2), (A42)+(B1.5.3), (A42)+(B1.5.4); (A42)+(B1.6.1), (A42)+(B1.6.2), (A42)+(B1.6.3), (A42)+(B1.6.4), (A42)+(B1.6.5), (A42)+(B1.6.6), (A42)+(B1.6.7), (A42)+(B1.6.8), (A42)+(B1.6.9), (A42)+(B1.6.10), (A42)+(B1.6.11), (A42)+(B1.6.12), (A42)+(B1.6.13), (A42)+(B1.6.14), (A42)+(B1.6.15), (A42)+(B1.6.16); (A42)+(B1.6.17), (A42)+(B1.6.18); (A42)+(B1.6.19); (A42)+(B2.1.1), (A42)+(B2.1.2), (A42)+(B2.1.3), (A42)+(B2.1.4), (A42)+(B2.1.6), (A42)+(B2.1.7), (A42)+(B2.1.8), (A42)+(B2.1.9), (A42)+(B2.1.10), (A42)+(B2.1.11), (A42)+(B2.1.12), (A42)+(B2.1.13), (A42)+(B2.1.13); (A42)+(B2.2.1), (A42)+(B2.2.2), (A42)+(B2.2.3), (A42)+(B2.2.3−RS), (A42)+(B2.2.4), (A42)+(B2.2.4−RS) (A42)+(B2.2.5), (A42)+(B2.2.6), (A42)+(B2.2.7), (A42)+(B2.2.8), (A42)+(B2.3.1), (A42)+(B2.3.2); (A42)+(B2.4.1), (A42)+(B2.4.2.), (A42)+(B2.4.3); (A42)+(B2.5.1), (A42)+(B2.5.2); (A42)+(B2.6.1), (A42)+(B2.6.2), (A42)+(B2.6.3), (A42)+(B2.6.4), (A42)+(B2.6.5), (A42)+(B2.6.6), (A42)+(B2.6.7), (A42)+(B2.6.8), (A42)+(B2.6.9), (A42)+(B2.6.10), (A42)+(B2.6.11), (A42)+(B2.6.12), (A42)+(B2.6.13), (A42)+(B2.6.14), (A42)+(B2.6.15); (A42)+(B3.1.1), (A42)+(B3.1.2), (A42)+(B3.1.3), (A42)+(B3.1.4), (A42)+(B3.1.5), (A42)+(B3.1.6), (A42)+(B3.1.7), (A42)+(B3.1.8), (A42)+(B3.1.9), (A42)+(B3.1.10), (A42)+(B3.1.11); (A42)+(B3.2.1), (A42)+(B3.2.2), (A42)+(B3.2.3); (A42)+(B3.3.1), (A42)+(B3.3.2), (A42)+(B3.3.2−RS), (A42)+(B3.3.3); (A42)+(B3.4.1), (A42)+(B3.4.2), (A42)+(B3.4.3), (A42)+(B3.4.4), (A42)+(B3.4.5), (A42)+(B3.4.6), (A42)+(B3.4.7), (A42)+(B3.4.8), (A42)+(B3.4.9), (A42)+(B3.4.10), (A42)+(B3.4.11), (A42)+(B3.4.12), (A42)+(B3.4.13), (A42)+(B3.4.14), (A42)+(B3.4.15), (A42)+(B3.4.16), (A42)+(B3.4.17), (A42)+(B3.4.18); (A42)+(B3.4.19); (A42)+(B4.1.1), (A42)+(B4.1.2); (A42)+(B4.2.1), (A42)+(B4.2.2); (A42)+(B4.3.1), (A42)+(B4.3.2), (A42)+(B4.3.3), (A42)+(B4.3.4), (A42)+(B4.3.5), (A42)+(B4.3.6); (A42)+(B4.4.1), (A42)+(B4.4.2), (A42)+(B4.4.3), (A42)+(B4.4.4);

(A43)+(B1.1.1), (A43)+(B1.1.2.); (A43)+(B1.2.1), (A43)+(B1.2.2.), (A43)+(B1.2.3); (A43)+(B1.3.1), (A43)+(B1.3.2.), (A43)+(B1.3.3), (A43)+(B1.3.4), (A43)+(B1.3.5), (A43)+(B1.3.6), (A43)+(B1.3.7), (A43)+(B1.3.8); (A43)+(B1.4.1), (A43)+(B1.4.2), (A43)+(B1.4.3), (A43)+(B1.4.4), (A43)+(B1.4.5); (A43)+(B1.5.1), (A43)+(B1.5.2), (A43)+(B1.5.3), (A43)+(B1.5.4); (A43)+(B1.6.1), (A43)+(B1.6.2), (A43)+(B1.6.3), (A43)+(B1.6.4), (A43)+(B1.6.5), (A43)+(B1.6.6), (A43)+(B1.6.7), (A43)+(B1.6.8), (A43)+(B1.6.9), (A43)+(B1.6.10), (A43)+(B1.6.11), (A43)+(B1.6.12), (A43)+(B1.6.13), (A43)+(B1.6.14), (A43)+(B1.6.15), (A43)+(B1.6.16), (A43)+(B1.6.17), (A43)+(B1.6.18); (A43)+(B1.6.19); (A43)+(B2.1.1), (A43)+(B2.1.2), (A43)+(B2.1.3), (A43)+(B2.1.4), (A43)+(B2.1.6), (A43)+(B2.1.7), (A43)+(B2.1.8), (A43)+(B2.1.9), (A43)+(B2.1.10), (A43)+(B2.1.11), (A43)+(B2.1.12), (A43)+(B2.1.13), (A43)+(B2.1.13); (A43)+(B2.2.1), (A43)+(B2.2.2), (A43)+(B2.2.3), (A43)+(B2.2.3−RS), (A43)+(B2.2.4), (A43)+(B2.2.4−RS) (A43)+(B2.2.5), (A43)+(B2.2.6), (A43)+(B2.2.7), (A43)+(B2.2.8), (A43)+(B2.3.1), (A43)+(B2.3.2); (A43)+(B2.4.1), (A43)+(B2.4.2.), (A43)+(B2.4.3); (A43)+(B2.5.1), (A43)+(B2.5.2); (A43)+(B2.6.1), (A43)+(B2.6.2), (A43)+(B2.6.3), (A43)+(B2.6.4), (A43)+(B2.6.5), (A43)+(B2.6.6), (A43)+(B2.6.7), (A43)+(B2.6.8), (A43)+(B2.6.9), (A43)+(B2.6.10), (A43)+(B2.6.11), (A43)+(B2.6.12), (A43)+(B2.6.13), (A43)+(B2.6.14), (A43)+(B2.6.15); (A43)+(B3.1.1), (A43)+(B3.1.2), (A43)+(B3.1.3), (A43)+(B3.1.4), (A43)+(B3.1.5), (A43)+(B3.1.6), (A43)+(B3.1.7), (A43)+(B3.1.8), (A43)+(B3.1.9), (A43)+(B3.1.10), (A43)+(B3.1.11); (A43)+(B3.2.1), (A43)+(B3.2.2), (A43)+(B3.2.3); (A43)+(B3.3.1), (A43)+(B3.3.2), (A43)+(B3.3.2−RS), (A43)+(B3.3.3); (A43)+(B3.4.1), (A43)+(B3.4.2), (A43)+(B3.4.3), (A43)+(B3.4.4), (A43)+(B3.4.5), (A43)+(B3.4.6), (A43)+(B3.4.7), (A43)+(B3.4.8), (A43)+(B3.4.9), (A43)+(B3.410), (A43)+(B3.4.11), (A43)+(B3.4.12), (A43)+(B3.4.13), (A43)+(B3.4.14), (A43)+(B3.4.15), (A43)+(B3.4.16), (A43)+(B3.4.17), (A43)+(B3.4.18); (A43)+(B3.4.19); (A43)+(B4.1.1), (A43)+(B4.1.2); (A43)+(B4.2.1), (A43)+(B4.2.2); (A43)+(B4.3.1), (A43)+(B4.3.2), (A43)+(B4.3.3), (A43)+(B4.3.4), (A43)+(B4.3.5), (A43)+(B4.3.6); (A43)+(B4.4.1), (A43)+(B4.4.2), (A43)+(B4.4.3), (A43)+(B4.4.4);

(A44)+(B1.1.1), (A44)+(B1.1.2.); (A44)+(B1.2.1), (A44)+(B1.2.2.), (A44)+(B1.2.3); (A44)+(B1.3.1), (A44)+(B1.3.2.), (A44)+(B1.3.3), (A44)+(B1.3.4), (A44)+(B1.3.5), (A44)+(B1.3.6), (A44)+(B1.3.7), (A44)+(B1.3.8); (A44)+(B1.4.1), (A44)+(B1.4.2), (A44)+(B1.4.3), (A44)+(B1.4.4), (A44)+(B1.4.5); (A44)+(B1.5.1), (A44)+(B1.5.2), (A44)+(B1.5.3), (A44)+(B1.5.4); (A44)+(B1.6.1), (A44)+(B1.6.2), (A44)+(B1.6.3), (A44)+(B1.6.4), (A44)+(B1.6.5), (A44)+(B1.6.6), (A44)+(B1.6.7), (A44)+(B1.6.8), (A44)+(B1.6.9), (A44)+(B1.6.10), (A44)+(B1.6.11), (A44)+(B1.6.12), (A44)+(B1.6.13), (A44)+(B1.6.14), (A44)+(B1.6.15), (A44)+(B1.6.16), (A44)+(B1.6.17), (A44)+(B1.6.18); (A44)+(B1.6.19); (A44)+(B2.1.1), (A44)+(B2.1.2), (A44)+(B2.1.3), (A44)+(B2.1.4), (A44)+(B2.1.6), (A44)+(B2.1.7), (A44)+(B2.1.8), (A44)+(B2.1.9), (A44)+(B2.1.10), (A44)+(B2.1.11), (A44)+(B2.1.12), (A44)+(B2.1.13), (A44)+(B2.1.13); (A44)+(B2.2.1), (A44)+(B2.2.2), (A44)+(B2.2.3), (A44)+(B2.2.3−RS), (A44)+(B2.2.4), (A44)+(B2.2.4−RS) (A44)+(B2.2.5), (A44)+(B2.2.6), (A44)+(B2.2.7), (A44)+(B2.2.8), (A44)+(B2.3.1), (A44)+(B2.3.2); (A44)+(B2.4.1), (A44)+(B2.4.2.), (A44)+(B2.4.3); (A44)+(B2.5.1), (A44)+(B2.5.2); (A44)+(B2.6.1), (A44)+(B2.6.2), (A44)+(B2.6.3), (A44)+(B2.6.4), (A44)+(B2.6.5), (A44)+(B2.6.6), (A44)+(B2.6.7), (A44)+(B2.6.8), (A44)+(B2.6.9), (A44)+(B2.6.10), (A44)+(B2.6.11), (A44)+(B2.6.12), (A44)+(B2.6.13), (A44)+(B2.6.14),y (A44)+(B2.6.15); (A44)+(B3.1.1), (A44)+(B3.1.2), (A44)+(B3.1.3), (A44)+(B3.1.4), (A44)+(B3.1.5), (A44)+(B3.1.6), (A44)+(B3.1.7), (A44)+(B3.1.8), (A44)+(B3.1.9), (A44)+(B3.1.10), (A44)+(B3.1.11); (A44)+(B3.2.1), (A44)+(B3.2.2), (A44)+(B3.2.3); (A44)+(B3.3.1), (A44)+(B3.3.2), (A44)+(B3.3.2−RS), (A44)+(B3.3.3); (A44)+(B3.4.1), (A44)+(B3.4.2), (A44)+(B3.4.3), (A44)+(B3.4.4), (A44)+(B3.4.5), (A44)+(B3.4.6), (A44)+(B3.4.7), (A44)+(B3.4.8), (A44)+(B3.4.9), (A44)+(B3.4.10), (A44)+(B3.4.11), (A44)+(B3.4.12), (A44)+(B3.4.13), (A44)+(B3.4.14), (A44)+(B3.4.15), (A44)+(B3.4.16), (A44)+(B3.4.17), (A44)+(B3.4.18); (A44)+(B3.4.19), (A44)+(B4.1.1), (A44)+(B4.1.2); (A44)+(B4.2.1), (A44)+(B4.2.2); (A44)+(B4.3.1), (A44)+(B4.3.2), (A44)+(B4.3.3), (A44)+(B4.3.4), (A44)+(B4.3.5), (A44)+(B4.3.6); (A44)+(B4.4.1), (A44)+(B4.4.2), (A44)+(B4.4.3), (A44)+(B4.4.4);

(A45)+(B1.1.1), (A45)+(B1.1.2.); (A45)+(B1.2.1), (A45)+(B1.2.2.), (A45)+(B1.2.3); (A45)+(B1.3.1), (A45)+(B1.3.2.), (A45)+(B1.3.3), (A45)+(B1.3.4), (A45)+(B1.3.5), (A45)+(B1.3.6), (A45)+(B1.3.7), (A45)+(B1.3.8); (A45)+(B1.4.1), (A45)+(B1.4.2), (A45)+(B1.4.3), (A45)+(B1.4.4), (A45)+(B1.4.5); (A45)+(B1.5.1), (A45)+(B1.5.2), (A45)+(B1.5.3), (A45)+(B1.5.4); (A45)+(B1.6.1), (A45)+(B1.6.2), (A45)+(B1.6.3), (A45)+(B1.6.4), (A45)+(B1.6.5), (A45)+(B1.6.6), (A45)+(B1.6-0.7), (A45)+(B1.6.8), (A45)+(B1.6.9), (A45)+(B1.6.10), (A45)+(B1.6.11), (A45)+(B1.6.12), (A45)+(B1.6.13), (A45)+(B1.6.14), (A45)+(B1.6.15), (A45)+(B1.6.16), (A45)+(B1.6.17), (A45)+(B1.6.18); (A45)+(B1.6.19); (A45)+(B2.1.1), (A45)+(B2.1.2), (A45)+(B2.1.3), (A45)+(B2.1.4), (A45)+(B2.1.6), (A45)+(B2.1.7), (A45)+(B2.1.8), (A45)+(B2.1.9), (A45)+1.10), (A45)+(B2.1.11), (A45)+(B2.1.12), (A45)+(B2.1.13), (A45)+(B2.1.13); (A45)+(B2.2.1), (A45)+(B2.2.2), (A45)+(B2.2.3), (A45)+(B2.2.3−RS), (A45)+(B2.2.4), (A45)+(B2.2.4−RS) (A45)+(B2.2.5), (A45)+(B2.2.6), (A45)+(B2.2.7), (A45)+(B2.2.8), (A45)+(B2.3.1), (A45)+(B2.3.2); (A45)+(B2.4.1), (A45)+(B2.4.2.), (A45)+(B2.4.3); (A45)+(B2.5.1), (A45)+(B2.5.2); (A45)+(B2.6.1), (A45)+(B2.6.2), (A45)+(B2.6.3), (A45)+(82.6.4), (A45)+(B2.6.5), (A45)+(B2.6.6), (A45)+(B2.6.7), (A45)+(B2.6.8), (A45)+(B2.6.9), (A45)+(B2.6.10), (A45)+(B2.6.11), (A45)+(B2.6.12), (A45)+(B2.6.13), (A45)+(B2.6.14), (A45)+(B2.6.15); (A45)+(B3.1.1), (A45)+(B3.1.2), (A45)+(B3.1.3), (A45)+(B3.1.4), (A45)+(B3.1.5), (A45)+(B3.1.6), (A45)+(B3.1.7), (A45)+(B3.1.8), (A45)+(B3.1.9), (A45)+(B3.1.10), (A45)+(B3.1.11); (A45)+(B3.2.1), (A45)+(B3.2.2), (A45)+(B3.2.3); (A45)+(B3.3.1), (A45)+(B3.3.2), (A45)+(B3.3.2−RS), (A45)+(B3.3.3); (A45)+(B3.4.1), (A45)+(B3.4.2), (A45)+(B3.4.3), (A45)+(B3.4.4), (A45)+(B3.4.5), (A45)+(B3.4.6), (A45)+(B3.4.7),(A45)+(B3.4.8),(A45)+(B3.4.9),(A45)+(B3.4.10),(A45)+(B3.4.11), (A45)+(B3.4.12), (A45)+(B3.4.13), (A45)+(B3.4.14), (A45)+(B3.4.15), (A45)+(B3.4.16), (A45)+(B3.4.17), (A45)+(B3.4.18); (A45)+(B3.4.19); (A45)+(B4.1.1), (A45)+(B4.1.2); (A45)+(B4.2.1), (A45)+(B4.2-0.2); (A45)+(B4.3.1), (A45)+(B4.3.2), (A45)+(B4.3.3), (A45)+(B4.3.4), (A45)+(B4.3.5), (A45)+(B4.3.6); (A45)+(B4.4.1), (A45)+(B4.4.2), (A45)+(B4.4.3), (A45)+(B4.4.4);

(A46)+(B1.1.1), (A46)+(B1.1.2.); (A46)+(B1.2.1), (A46)+(B1.2.2.), (A46)+(B1.2.3); (A46)+(B1.3.1), (A46)+(B1.3.2.), (A46)+(B1.3.3), (A46)+(B1.3.4), (A46)+(B1.3.5), (A46)+(B1.3.6), (A46)+(B1.3.7), (A46)+(B1.3.8); (A46)+(B1.4.1), (A46)+(B1.4.2), (A46)+(B1.4.3), (A46)+(B1.4.4), (A46)+(B1.4.5); (A46)+(B1.5.1), (A46)+(B1.5.2), (A46)+(B1.5.3), (A46)+(B1.5.4); (A46)+(B1.6.1), (A46)+(B1.6.2), (A46)+(B1.6.3), (A46)+(B1.6.4), (A46)+(B1.6.5), (A46)+(B1.6.6), (A46)+(B1.6.7), (A46)+(B1.6.8), (A46)+(B1.6.9), (A46)+(B1.6.10), (A46)+(B1.6.11), (A46)+(B1.6.12), (A46)+(B1.6.13), (A46)+(B1.6.14), (A46)+(B1.6.15), (A46)+(B1.6.16), (A46)+(B1.6.17), (A46)+(B1.6.18); (A46)+(B1.6.19); (A46)+(B2.1.1), (A46)+(B2.1.2), (A46)+(B2.1.3), (A46)+(B2.1.4), (A46)+(B2.1.6), (A46)+(B2.1.7), (A46)+(B2.1.8), (A46)+(B2.1.9), (A46)+(B2.1.10), (A46)+(B2.1.11), (A46)+(B2.1.12), (A46)+(B2.1.13), (A46)+(B2.1.13); (A46)+(B2.2.1), (A46)+(B2.2.2), (A46)+(B2.2.3), (A46)+(B2.2.3−RS), (A46)+(B2.2.4), (A46)+(B2.2.4−RS) (A46)+(B2.2.5), (A46)+(B2.2.6), (A46)+(B2.2.7), (A46)+(B2.2.8), (A46)+(B2.3.1), (A46)+(B2.3.2); (A46)+(B2.4.1), (A46)+(B2.4.2.), (A46)+(B2.4.3); (A46)+(B2.5.1), (A46)+(B2.5.2); (A46)+(B2.6.1), (A46)+(B2.6.2), (A46)+(B2.6.3), (A46)+(B2.6.4), (A46)+(B2.6.5), (A46)+(B2.6.6), (A46)+(B2.6.7), (A46)+(B2.6.8), (A46)+(B2.6.9), (A46)+(B2.6.10), (A46)+(B2.6.11), (A46)+(B2.6.12), (A46)+(B2.6.13), (A46)+(B2.6.14), (A46)+(B2.6.15); (A46)+(B3.1.1), (A46)+(B3.1.2), (A46)+(B3.1.3), (A46)+(B3.1.4), (A46)+(B3.1.5), (A46)+(B3.1.6), (A46)+(B3.1.7), (A46)+(B3.1.8), (A46)+(B3.1.9), (A46)+(B3.1.10), (A46)+(B3.1.11); (A46)+(B3.2.1), (A46)+(B3.2.2), (A46)+(B3.2.3); (A46)+(B3.3.1), (A46)+(B3.3.2), (A46)+(B3.3.2−RS), (A46)+(B3.3.3); (A46)+(B3.4.1), (A46)+(B3.4.2), (A46)+(B3.4.3), (A46)+(B3.4.4), (A46)+(B3.4.5), (A46)+(B3.4.6), (A46)+(B3.4.7), (A46)+(B3.4.8), (A46)+(B3.4.9), (A46)+(B3.4.10), (A46)+(B3.4.11), (A46)+(B3.4.12), (A46)+(B3.4.13), (A46)+(B3.4.14), (A46)+(B3.4.15), (A46)+(B3.4.16), (A46)+(B3.4.17), (A46)+(B3.4.18); (A46)+(B3.4.19); (A46)+(B4.1.1), (A46)+(B4.1.2); (A46)+(B4.2.1), (A46)+(B4.2.2); (A46)+(B4.3.1), (A46)+(B4.3.2), (A46)+(B4.3.3), (A46)+(B4.3.4), (A46)+(B4.3.5), (A46)+(B4.3.6); (A46)+(B4.4.1), (A46)+(B4.4.2), (A46)+(B4.4.3), (A46)+(B4.4.4);

(A47)+(B1.1.1), (A47)+(B1.1.2.); (A47)+(B1.2.1), (A47)+(B1.2.2.), (A47)+(B1.2.3); (A47)+(B1.3.1), (A47)+(B1.3.2.), (A47)+(B1.3.3), (A47)+(B1.3.4), (A47)+(B1.3.5), (A47)+(B1.3.6), (A47)+(B1.3.7), (A47)+(B1.3.8); (A47)+(B1.4.1), (A47)+(B1.4.2), (A47)+(B1.4.3), (A47)+(B1.4.4), (A47)+(B1.4.5); (A47)+(B1.5.1), (A47)+(B1.5.2), (A47)+(B1.5.3), (A47)+(B1.5.4); (A47)+(B1.6.1), (A47)+(B1.6.2), (A47)+(B1.6.3), (A47)+(B1.6.4), (A47)+(B1.6.5), (A47)+(B1.6.6), (A47)+(B1.6.7), (A47)+(B1.6.8), (A47)+(B1.6.9), (A47)+(B1.6.10), (A47)+(B1.6.11), (A47)+(B1.6.12), (A47)+(B1.6.13), (A47)+(B1.6.14), (A47)+(B1.6.15), (A47)+(B1.6.16), (A47)+(B1.6.17), (A47)+(B1.6.18); (A47)+(B1.6.19); (A47)+(B2.1.1), (A47)+(B2.1.2), (A47)+(B2.1.3), (A47)+(B2.1.4), (A47)+(B2.1.6), (A47)+(B2.1.7), (A47)+(B2.1.8), (A47)+(B2.1.9), (A47)+(B2.1.10), (A47)+(B2.1.11), (A47)+(B2.1.12), (A47)+(B2.1.13), (A47)+(B2.1.13); (A47)+(B2.2.1), (A47)+(B2.2.2), (A47)+(B2.2.3), (A47)+(B2.2.3−RS), (A47)+(B2.2.4), (A47)+(B2.2.4−RS) (A47)+(B2.2.5), (A47)+(B2.2.6), (A47)+(B2.2.7), (A47)+(B2.2.8), (A47)+(B2.3.1), (A47)+(B2.3.2); (A47)+(B2.4.1), (A47)+(B2.4.2.), (A47)+(B2.4.3); (A47)+(B2.5.1), (A47)+(B2.5.2); (A47)+(B2.6.1), (A47)+(B2.6.2), (A47)+(B2.6.3), (A47)+(B2.6.4), (A47)+(B2.6.5), (A47)+(B2.6.6), (A47)+(B2.6.7), (A47)+(B2.6.8), (A47)+(B2.6.9), (A47)+(B2.6.10), (A47)+(B2.6.1), (A47)+(B2.6.12), (A47)+(B2.6.13), (A47)+(B2.6.14), (A47)+(B2.6.15); (A47)+(B3.1.1), (A47)+(B3.1.2), (A47)+(B3.1.3), (A47)+(B3.61.4), (A47)+(B3.61.5), (A47)+(B3.6.6), (A47)+(B3.1.7), (A47)+(B3.61.8), (A47)+(B3.21.9), (A47)+(B3.1.10), (A47)+(B3.1.11); (A47)+(B3.2.1), (A47)+(B3.2.2), (A47)+(B3.2.3); (A47)+(B3.3.1), (A47)+(B3.3.2), (A47)+(B3.3.2−RS), (A47)+(B3.3.3); (A47)+(B3.4.1), (A47)+(B3.4.2), (A47)+(B3.4.3), (A47)+(B3.4.4), (A47)+(B3.4.5), (A47)+(B3.4.6), (A47)+(B3.4.7), (A47)+(B3.4.8), (A47)+(B3.4.9), (A47)+(B3.4.10), (A47)+(B3.4.11), (A47)+(B3.4.12), (A47)+(B3.4.13), (A47)+(B3.4.14), (A47)+(B3.4.15), (A47)+(B3.4.16), (A47)+(B3.4.17), (A47)+(B3.4.18); (A47)+(B3.4.19); (A47)+(B4.1.1), (A47)+(B4.1.2); (A47)+(B4.2.1), (A47)+(B4.2.2); (A47)+(B4.3.1), (A47)+(B4.3.2), (A47)+(B4.3.3), (A47)+(B4.3.4), (A47)+(B4.3.5), (A47)+(B4.3.6); (A47)+(B4.4.1), (A47)+(B4.4.2), (A47)+(B4.4.3), (A47)+(B4.4.4);

(A48)+(B1.1.1), (A48)+(B1.1.2.); (A48)+(B1.2.1), (A48)+(B1.2.2.), (A48)+(B1.2.3); (A48)+(B1.3.1), (A48)+(B1.3.2.), (A48)+(B1.3.3), (A48)+(B1.3.4), (A48)+(B1.3.5), (A48)+(B1.3.6), (A48)+(B1.3.7), (A48)+(B1.3.8); (A48)+(B1.4.1), (A48)+(B1.4.2), (A48)+(B1.4.3), (A48)+(B1.4.4), (A48)+(B1.4.5); (A48)+(B1.5.1), (A48)+(B1.5.2), (A48)+(B1.5.3), (A48)+(B1.5.4); (A48)+(B1.6.1), (A48)+(B1.6.2), (A48)+(B1.6.3), (A48)+(B1.6.4), (A48)+(B1.6.5), (A48)+(B1.6.6), (A48)+(B1.6.7), (A48)+(B1.6.8), (A48)+(B1.6.9), (A48)+(B1.6.10), (A48)+(B1.6.11), (A48)+(B1.6.12), (A48)+(B1.6.13), (A48)+(B1.6.14), (A48)+(B1.6.15), (A48)+(B1.6.16), (A48)+(B1.6.17), (A48)+(B1.6.18); (A48)+(B1.6.19); (A48)+(B2.1.1), (A48)+(B2.1.2), (A48)+(B2.1.3), (A48)+(B2.1.4), (A48)+(B2.1.6), (A48)+(B2.1.7), (A48)+(B2.1.8), (A48)+(B2.1.9), (A48)+(B2.1.10), (A48)+(B2.1.11), (A48)+(B2.1.12), (A48)+(B2.1.13), (A48)+(B2.1.13); (A48)+(B2.2.1), (A48)+(B2.2.2), (A48)+(B2.2.3), (A48)+(B2.2.3−RS), (A48)+(B2.2.4), (A48)+(B2.2.4−RS) (A48)+(B2.2.5), (A48)+(B2.2.6), (A48)+(B2.2.7), (A48)+(B2.2.8), (A48)+(B2.3.1), (A48)+(B2.3.2); (A48)+(B2.4.1), (A48)+(B2.4.2.), (A48)+(B2.4.3); (A48)+(B2.5.1), (A48)+(B2.5.2); (A48)+(B2.6.1), (A48)+(B2.6.2), (A48)+(B2.6.3), (A48)+(B2.6.4), (A48)+(B2.6.5), (A48)+(B2.6.6), (A48)+(B2.6.7), (A48)+(B2.6.8), (A48)+(B2.6.9), (A48)+(B2.6.10), (A48)+(B2.6.11), (A48)+(B2.6.12), (A48)+(B2.6.13), (A48)+(B2.6.14), (A48)+(B2.6.15); (A48)+(B3.1.1), (A48)+(B3.1.2), (A48)+(B3.1.3), (A48)+(B3.1.4), (A48)+(B3.1.5), (A48)+(B3.1.6), (A48)+(B3.1.7), (A48)+(B3.1.8), (A48)+(B3.1.9), (A48)+(B3.1.10), (A48)+(B3.1.11); (A48)+(B3.2.1), (A48)+(B3.2.2), (A48)+(B3.2.3); (A48)+(B3.3.1), (A48)+(B3.3.2), (A48)+(63.3.2−RS), (A48)+(B3.3.3); (A48)+(B3.4.1), (A48)+(B3.4.2), (A48)+(B3.4.3), (A48)+(B3.4.4), (A48)+(B3.4.5), (A48)+(B3.4.6), (A48)+(B3.4.7), (A48)+(B3.4.8), (A48)+(B3.4.9), (A48)+(B3.4.10), (A48)+(B3.4.11), (A48)+(B3.4.12), (A48)+(B3.4.13), (A48)+(B3.4.14), (A48)+(B3.4.15),p (A48)+(B3.4.16), (A48)+(B3.4.17), (A48)+(B3.4.18); (A48)+(B3.4.19),; (A48)+(B4.1.1), (A48)+(B4.1.2); (A48)+(B4.2.1), (A48)+(B4.2.2); (A48)+(B4.3.1), (A48)+(B4.3.2), (A48)+(B4.3.3), (A48)+(B4.3.4), (A48)+(B4.3.5), (A48)+(B4.3.6); (A48)+(B4.4.1), (A48)+(B4.4.2), (A48)+(B4.4.3), (A48)+(B4.4.4);

(A49)+(B1.1.1), (A49)+(B1.1.2.); (A49)+(B1.2.1), (A49)+(B1.2.2.), (A49)+(B1.2.3); (A49)+(B1.3.1), (A49)+(B1.3.2.), (A49)+(B1.3.3), (A49)+(B1.3.4), (A49)+(B1.3.5), (A49)+(B1.3.6), (A49)+(B1.3.7), (A49)+(B1.3.8); (A49)+(B1.4.1), (A49)+(B1.4.2), (A49)+(B1.4.3), (A49)+(B1.4.4), (A49)+(B1.4.5); (A49)+(B1.5.1), (A49)+(B1.5.2), (A49)+(B1.5.3), (A49)+(B1.5.4); (A49)+(B1.6.1), (A49)+(B1.6.2), (A49)+(B1.6.3), (A49)+(B1.6.4), (A49)+(B1.6.5), (A49)+(B1.6.6), (A49)+(B1.6.7), (A49)+(B1.6.8), (A49)+(B1.6.9), (A49)+(B1.6.10), (A49)+(B1.6.11), (A49)+(B1.6.12), (A49)+(B1.6.13), (A49)+(B1.6.14), (A49)+(B1.6.15), (A49)+(B1.6.16), (A49)+(B1.6.17), (A49)+(B1.6.18); (A49)+(B1.6.19); (A49)+(B2.1.1), (A49)+(B2.1.2), (A49)+(B2.1.3), (A49)+(B2.1.4), (A49)+(B2.1.6), (A49)+(B2.1.7), (A49)+(B2.1.8), (A49)+(B2.1.9), (A49)+(B2.1.10), (A49)+(B2.1.11), (A49)+(B2.1.12), (A49)+(B2.1.13), (A49)+(B2.1.13); (A49)+(B2.2.1), (A49)+(B2.2.2), (A49)+(B2.2.3), (A49)+(B2.2.3−RS), (A49)+(B2.2.4), (A49)+(B2.2.4−RS) (A49)+(B2.2.5), (A49)+(B2.2.6), (A49)+(B2.2.7), (A49)+(B2.2.8), (A49)+(B2.3.1), (A49)+(B2.3.2); (A49)+(B2.4.1), (A49)+(B2.4.2.), (A49)+(B2.4.3); (A49)+(B2.5.1), (A49)+(B2.5.2); (A49)+(B2.6.1), (A49)+(B2.6.2), (A49)+(B2.6.3), (A49)+(B2.6.4), (A49)+(B2.6.5), (A49)+(B2.6.6), (A49)+(B2.6.7), (A49)+(B2.6.8), (A49)+(B2.6.9), (A49)+(B2.6.10), (A49)+(B2.6.11), (A49)+(B2.6.12), (A49)+(B2.6.13), (A49)+(B2.6.14), (A49)+(B2.6.15); (A49)+(B3.1.1), (A49)+(B3.1.2), (A49)+(B3.1.3), (A49)+(B3.1.4), (A49)+(B3.1.5), (A49)+(B3.1.6), (A49)+(B3.1.7), (A49)+(B3.1.8), (A49)+(B3.1.9), (A49)+(B3.1.10), (A49)+(B3.1.11); (A49)+(B3.2.1), (A49)+(B3.2.2), (A49)+(B3.2.3); (A49)+(B3.3.1), (A49)+(B3.3.2), (A49)+(B3.3.2−RS), (A49)+(B3.3.3); (A49)+(B3.4.1), (A49)+(B3.4.2), (A49)+(B3.4.3), (A49)+(B3.4.4), (A49)+(B3.4.5), (A49)+(B3.4.6), (A49)+(B3.4.7), (A49)+(B3.4.8), (A49)+(B3.4.9), (A49)+(B3.4.10), (A49)+(B3.4.11), (A49)+(B3.4.12), (A49)+(B3.4.13), (A49)+(B3.4.14), (A49)+(B3.4.15), (A49)+(B3.4.16), (A49)+(B3.4.17), (A49)+(B3.4.18); (A49)+(B3.4.19); (A49)+(B4.1.1), (A49)+(B4.1.2); (A49)+(B4.2.1), (A49)+(B4.2.2); (A49)+(B4.3.1), (A49)+(B4.3.2), (A49)+(B4.3.3), (A49)+(B4.3.4), (A49)+(B4.3.5), (A49)+(B4.3.6); (A49)+(B4.4.1), (A49)+(B4.4.2), (A49)+(B4.4.3), (A49)+(B4.4.4);

(A50)+(B1.1.1), (A50)+(B1.1.2.); (A50)+(B1.2.1), (A50)+(B1.2.2.), (A50)+(B1.2.3); (A50)+(B1.3.1), (A50)+(B1.3.2.), (A50)+(B1.3.3), (A50)+(B1.3.4), (A50)+(B1.3.5), (A50)+(B1.3.6), (A50)+(B1.3.7), (A50)+(B1.3.8); (A50)+(B1.4.1), (A50)+(B1.4.2), (A50)+(B1.4.3), (A50)+(B1.4.4), (A50)+(B1.4.5); (A50)+(B1.5.1), (A50)+(B1.5.2), (A50)+(B1.5.3), (A50)+(B1.5.4); (A50)+(B1.6.1), (A50)+(B1.6.2), (A50)+(B1.6.3), (A50)+(B1.6.4), (A50)+(B1.6.5), (A50)+(B1.6.6), (A50)+(B1.6.7), (A50)+(B1.6.8), (A50)+(B1.6.9), (A50)+(B1.6.10), (A50)+(B1.6.11), (A50)+(B1.6.12), (A50)+(B1.6.13), (A50)+(B1.6.14), (A50)+(B1.6.15), (A50)+(B1.6.16), (A50)+(B1.6.17), (A50)+(B1.6.18); (A50)+(B1.6.19); (A50)+(B2.1.1), (A50)+(B2.1.2), (A50)+(B2.1.3), (A50)+(B2.1.4), (A50)+(B2.1.6), (A50)+(B2.1.7), (A50)+(B2.1.8), (A50)+(B2.1.9), (A50)+(B2.1.10), (A50)+(B2.1.11), (A50)+(B2.1.12), (A50)+(B2.1.13), (A50)+(B2.1.13); (A50)+(B2.2.1), (A50)+(B2.2.2), (A50)+(B2.2.3), (A50)+(B2.2.3−RS), (A50)+(B2.2.4), (A50)+(B2.2.4−RS) (A50)+(B2.2.5), (A50)+(B2.2.6), (A50)+(B2.2.7), (A50)+(B2.2.8), (A50)+(B2.3.1), (A50)+(B2.3.2); (A50)+(B2.4.1), (A50)+(B2.4.2.), (A50)+(B2.4.3); (A50)+(B2.5.1), (A50)+(B2.5.2); (A50)+(B2.6.1), (A50)+(B2.6.2), (A50)+(B2.6.3), (A50)+(B2.6.4), (A50)+(B2.6.5), (A50)+(B2.6.6), (A50)+(B2.6.7), (A50)+(B2.6.8), (A50)+(B2.6.9), (A50)+(B2.6.10), (A50)+(B2.6.11), (A50)+(B2.6.12), (A50)+(B2.6.13), (A50)+(B2.6.14), (A50)+(B2.6.15); (A50)+(B3.1.1), (A50)+(B3.1.2), (A50)+(B3.1.3), (A50)+(B3.1.4), (A50)+(B3.1.5), (A50)+(B3.1.6), (A50)+(B3.1.7), (A50)+(B3.1.8), (A50)+(B3.1.9), (A50)+(B3.1.10), (A50)+(B3.1.11); (A50)+(B3.2.1), (A50)+(B3.2.2), (A50)+(B3.2.3); (A50)+(B3.3.1), (A50)+(B3.3.2), (A50)+(B3.3.2−RS), (A50)+(B3.3.3); (A50)+(B3.4.1), (A50)+(B3.4.2), (A50)+(B3.4.3), (A50)+(B3.4.4), (A50)+(B3.4.5), (A50)+(B3.4.6), (A50)+(B3.4.7), (A50)+(B3.4.8), (A50)+(B3.4.9), (A50)+(B3.4.10), (A50)+(B3.4.11), (A50)+(B3.4.12), (A50)+(B3.4.13), (A50)+(B3.4.14), (A50)+(B3.4.15), (A50)+(B3.4.16), (A50)+(B3.4.17), (A50)+(B3.4.18); (A50)+(B3.4.19); (A50)+(B4.1.1), (A50)+(B4.1.2); (A50)+(B4.2.1), (A50)+(B4.2.2); (A50)+(B4.3.1), (A50)+(B4.3.2), (A50)+(B4.3.3), (A50)+(B4.3.4), (A50)+(B4.3.5), (A50)+(B4.3.6); (A50)+(B4.4.1), (A50)+(B4.4.2), (A50)+(B4.4.3), (A50)+(B4.4.4);

(A51)+(B1.1.1), (A51)+(B1.1.2.); (A51)+(B1.2.1), (A51)+(B1.2.2.), (A51)+(B1.2.3); (A51)+(B1.3.1), (A51)+(B1.3.2.), (A51)+(B1.3.3), (A51)+(B1.3.4), (A51)+(B1.3.5), (A51)+(B1.3.6), (A51)+(B1.3.7), (A51)+(B1.3.8); (A51)+(B1.4.1), (A51)+(B1.4.2), (A51)+(B1.4.3), (A51)+(B1.4.4), (A51)+(B1.4.5); (A51)+(B1.5.1), (A51)+(B1.5.2), (A51)+(B1.5.3), (A51)+(B1.5.4); (A51)+(B1.6.1), (A51)+(B1.6.2), (A51)+(B1.6.3), (A51)+(B1.6.4), (A51)+(B1.6.5), (A51)+(B1.6.6), (A51)+(B1.6.7), (A51)+(B1.6.8), (A51)+(B1.6.9), (A51)+(B1.6.10), (A51)+(B1.6.11), (A51)+(B1.6.12), (A51)+(B1.6.13), (A51)+(B1.6.14), (A51)+(B1.6.15), (A51)+(B1.6.16), (A51)+(B1.6.17), (A51)+(B1.6.18); (A51)+(B1.6.19); (A51)+(B2.1.1), (A51)+(B2.1.2), (A51)+(B2.1.3), (A51)+(B2.1.4), (A51)+(B2.1.6), (A51)+(B2.1.7), (A51)+(B2.1.8), (A51)+(B2.1.9), (A51)+(B2.1.10), (A51)+(B2.1.11), (A51)+(B2.1.12), (A51)+(B2.1.13), (A51)+(B2.1.13); (A51)+(B2.2.1), (A51)+(B2.2.2), (A51)+(B2.2.3), (A51)+(B2.2.3−RS), (A51)+(B2.2.4), (A51)+(B2.2.4−RS) (A51)+(B2.2.5), (A51)+(B2.2.6), (A51)+(B2.2.7), (A51)+(B2.2.8), (A51)+(B2.3.1), (A51)+(B2.3.2); (A51)+(B2.4.1), (A51)+(B2.4.2.), (A51)+(B2.4.3); (A51)+(B2.5.1), (A51)+(B2.5.2); (A51)+(B2.6.1), (A51)+(B2.6.2), (A51)+(B2.6.3), (A51)+(B2.6.4), (A51)+(B2.6.5), (A51)+(B2.6.6), (A51)+(B2.6.7), (A51)+(B2.6.8), (A51)+(B2.6.9), (A51)+(B2.6.10), (A51)+(B2.6.11), (A51)+(B2.6.12), (A51)+(B2.6.13), (A51)+(B2.6.14), (A51)+(B2.6.15); (A51)+(B3.1.1), (A51)+(B3.1.2), (A51)+(B3.1.3), (A51)+(B3.1.4), (A51)+(B3.1.5), (A51)+(B3.1.6), (A51)+(B3.1.7), (A51)+(B3.1-0.8), (A5S)+(B3.1.9), (A51)+(B3.1.10), (A51)+(B3.1.11); (A51)+(B3.2.1), (A1)+(B3.2.2), (A1)+(B3.2.3);

(A52)+(B3.3.1), (A52)+(B3.3.2), (A52)+(B3.3.2−RS), (A52)+(B3.3.3); (A52)+(B3.4.1), (A52)+(B3.4.2), (A52)+(B3.4.3), (A52)+(B3.4.4), (A52)+(B3.4.5), (A52)+(B3.4.6), (A52)+(B3.4.7), (A52)+(B3.4.8), (A52)+(B3.4.9), (A52)+(B3.4.10), (A52)+(B3.4.11), (A52)+(B3.4.12), (A52)+(B3.4.13), (A52)+(B3.4.14), (A52)+(B3.4.15), (A52)+(B3.4.16), (A52)+(B3.4.17), (A52)+(B3.4.18); (A52)+(B3.4.19); (A52)+(B4.1.1), (A52)+(B4.1.2); (A52)+(B4.2.1), (A52)+(B4.21.2); (A52)+(B4.3.1), (A52)+(B4.3.2), (A52)+(B4.3.3), (A52)+(B4.3.4), (A52)+(B4.3:S5), (A52)+(B4.3.6); (A52)+(B4.4.1), (A52)+(B4.4.2), (A52)+(B4.4.3), (A52)+(B4.4.4);

(A52)+(B1.1.1), (A52)+(B1.1.2.); (A52)+(B1.2.1), (A52)+(B1.2.2.), (A52)+(B1.2.3); (A52)+(B1.3.1), (A52)+(B1.3.2.), (A52)+(B1.3.3), (A52)+(B1.3.4), (A52)+(B1.3.5), (A52)+(B1.3.6), (A52)+(B1.3.7), (A52)+(B1.3.8); (A52)+(B1.4.1), (A52)+(B1.4.2), (A52)+(B1.4.3), (A52)+(B1.4.4), (A52)+(B1.4.5); (A52)+(B1.5.1), (A52)+(B1.5.2), (A52)+(B1.5.3), (A52)+(B1.5.4); (A52)+(B1.6.1), (A52)+(B1.6.2), (A52)+(B1.6.3), (A52)+(B1.6.4), (A52)+(B1.6.5), (A52)+(B1.6.6), (A52)+(B1.6.7), (A52)+(B1.6.8), (A52)+(B1.6.9), (A52)+(B1.6.10), (A52)+(B1.6.11), (A52)+(B1.6.12), (A52)+(B1.6.13), (A52)+(B1.6.14), (A52)+(B1.6.15), (A52)+(B1.6.16), (A52)+(B1.6.17), (A52)+(B1.6.18); (A52)+(B1.6.19); (A52)+(B2.1.1), (A52)+(B2.1.2), (A52)+(B2.1.3), (A52)+(B2.1.4), (A52)+(B2.1.6), (A52)+(B2.1.7), (A52)+(B2.1.8), (A52)+(B2.1.9), (A52)+(B2.1.10), (A52)+(B2.1.11), (A52)+(B2.1.12), (A52)+(B2.1.13), (A52)+(B2.1.13); (A52)+(B2.2.1), (A52)+(B2.2.2), (A52)+(B2.2.3), (A52)+(B2.2.3−RS), (A52)+(B2.2.4), (A52)+(B2.2.4−RS) (A52)+(B2.2.5), (A52)+(B2.2.6), (A52)+(B2.2.7), (A52)+(B2.2.8), (A52)+(B2.3.1), (A52)+(B2.3.2); (A52)+(B2.4.1), (A52)+(B2.4.2.), (A52)+(B2.4.3); (A52)+(B2.5.1), (A52)+(B2.5.2); (A52)+(B2.6.1), (A52)+(B2.6.2), (A52)+(B2.6.3), (A52)+(B2.6.4), (A52)+(B2.6.5), (A52)+(B2.6.6), (A52)+(B2.6.7), (A52)+(B2.6.8), (A52)+(B2.6.9), (A52)+(B2.6.10), (A52)+(B2.6.11), (A52)+(B2.6.12), (A52)+(B2.6.13), (A52)+(B2.6.14), (A52)+(B2.6.15); (A52)+(B3.1.1), (A52)+(B3.1.2), (A52)+(B31.3), (A52)+(B3.1.4), (A52)+(B3.1.5), (A52)+(B3.1.6), (A52)+(B3.1.7), (A52)+(B3.10.8), (A52)+(B3.1.9), (A52)+(B3.1.10), (A52)+(B3.1.11); (A52)+(B3.2.1), (A52)+(B3.2.2), (A52)+(B3.2.3); (A52)+(B3.3.1), (A52)+(B3.3.2), (A52)+(B3.3.2−RS), (A52)+(B3.3.3); (A52)+(B3.4.1), (A52)+(B3.4.2), (A52)+(B3.4.3), (A52)+(B3.4.4), (A52)+(B3.4.5), (A52)+(B3.4.6), (A52)+(B3.4.7), (A52)+(B3.4.8), (A52)+(B3.4.9), (A52)+(B3.4.10), (A52)+(B3.4.19), (A52)+(B3.4.12), (A52)+(B3.4.13), (A52)+(B3.4.14), (A52)+(B3.4.15), (A52)+(B3.4.16), (A52)+(B3.4.17), (A52)+(B3.4.18); (A52)+(B3.4.19); (A52)+(B4.1.1), (A52)+(B4.1.2); (A52)+(B4.2.1), (A52)+(B4.2.2); (A52)+(B4.3.1), (A52)+(B4.3.2), (A52)+(B4.3.3), (A52)+(B4.3.4), (A52)+(B4.3.5), (A52)+(B4.3.6); (A52)+(B4.4.1), (A52)+(B4.4.2), (A52)+(B4.4.3), (A52)+(B4.45.4);

(A53)+(B1.1.1), (A53)+(B11.1.2.); (A53)+(B11.2.1), (A53)+(B1.2.2.), (A53)+(B1.2.3); (A53)+(B1.3.1), (A53)+(B1.3.2.), (A53)+(B1.3.3), (A53)+(B1.3.4), (A53)+(B1.3.5), (A53)+(B1.3.6), (A53)+(B1.3.7), (A53)+(B1.3.8); (A53)+(B1.4.1), (A53)+(B1.4.2), (A53)+(B1.4.3), (A53)+(B1.4.4), (A53)+(B1.4.5); (A53)+(B1.5.1), (A53)+(B1.5.2), (A53)+(B1.5.3), (A53)+(B1.5.4); (A53)+(B1.6.1), (A53)+(B1.6.2), (A53)+(B1.6.3), (A53)+(B1.6.4), (A53)+(B1.6.5), (A53)+(B1.6.6), (A53)+(B1.6.7), (A53)+(B1.6.8), (A53)+(B1.6.9), (A53)+(B1.6.10), (A53)+(B1.6.11), (A53)+(B1.6.12), (A53)+(B1.6.13), (A53)+(B1.6.14), (A53)+(B1.6.15), (A53)+(B1.6.16), (A53)+(B1.6.17), (A53)+(B1.6.18); (A53)+(B1.6.19); (A53)+(B2.1.1), (A53)+(B2.1.2), (A53)+(B2.1.3), (A53)+(B2.1.4), (A53)+(B2.1.6), (A53)+(B2.1.7), (A53)+(B2.1.8), (A53)+(B2.1.9), (A53)+(B2.1.10), (A53)+(B2.1.11), (A53)+(B2.1.12), (A53)+(B2.1.13), (A53)+(B2.1.13); (A53)+(B2.2.1), (A53)+(B2.2.2), (A53)+(B2.2.3), (A53)+(B2.2.3−RS), (A53)+(B2.2.4), (A53)+(B2.2.4−RS) (A53)+(B2.2.5), (A53)+(B2.2.6), (A53)+(B2.2.7), (A53)+(B2.2.8), (A53)+(B2.3.1), (A53)+(B2.3.2); (A53)+(B2.4.1), (A53)+(B2.4.2.), (A53)+(B2.4.3); (A53)+(B2.5.1), (A53)+(B2.5.2); (A53)+(B2.6.1), (A53)+(B2.6.2), (A53)+(B2.6.3), (A53)+(B2.6.4), (A53)+(B2.6.5), (A53)+(B2.6.6), (A53)+(B2.6.7), (A53)+(B2.6.8), (A53)+(B2.6.9), (A53)+(B2.6.10), (A53)+(B2.6.11), (A53)+(B2.6.12), (A53)+(B2.6.13), (A53)+(B2.6.14), (A53)+(B2.6.15); (A53)+(B3.1.1), (A53)+(B3.1.2), (A53)+(B3.1.3), (A53)+(B3.1.4), (A53)+(B3.1.5), (A53)+(B3.1.6), (A53)+(B3.1.7), (A53)+(B3.1.8), (A53)+(B3.1.9), (A53)+(B3.1.10), (A53)+(B3.1.11); (A53)+(B3.2.1), (A53)+(B3.2.2), (A53)+(B3.2.3); (A53)+(B3.3.1), (A53)+(B3.3.2), (A53)+(B3.3.2−RS), (A53)+(B3.3.3); (A53)+(B3.4.1), (A53)+(B3.4.2), (A53)+(B3.4.3), (A53)+(B3.4.4), (A53)+(B3.4.5), (A53)+(B3.4.6), (A53)+(B3.4.7), (A53)+(B3.4.8), (A53)+(B3.4.9), (A53)+(B3.4.10), (A53)+(B3.4.11), (A53)+(B3.4.12), (A53)+(B3.4.13), (A53)+(B3.4.14), (A53)+(B3.4.15), (A53)+(B3.4.16), (A53)+(B3.4.17), (A53)+(B3.4.18); (A53)+(B3.4.19); (A53)+(B4.1.1), (A53)+(B4.1.2); (A53)+(B4.2.1), (A53)+(B4.2.2); (A53)+(B4.3.1), (A53)+(B4.3.2), (A53)+(B4.3.3), (A53)+(B4.3.4), (A53)+(B4.3.5), (A53)+(B4.3.6); (A53)+(B4.4.1), (A53)+(B4.4.2), (A53)+(B4.4.3), (A53)+(B4.4.4);

(A54)+(B1.1.1), (A54)+(B1.1.2.); (A54)+(B1.2.1), (A54)+(B1.2.2.), (A54)+(B1.2.3); (A54)+(B1.3.1), (A54)+(B1.3.2.), (A54)+(B1.3.3), (A54)+(B1.3.4), (A54)+(B1.3.5), (A54)+(B1.3.6), (A54)+(B1.3.7), (A54)+(B1.3.8); (A54)+(B1.4.1), (A54)+(B1.4.2), (A54)+(B1.4.3), (A54)+(B1.4.4), (A54)+(B1.4.5); (A54)+(B11.5.1), (A54)+(B1.5.2), (A54)+(B1.5.3), (A54)+(B1.5.4); (A54)+(B1.6.1), (A54)+(B1.6.2), (A54)+(B1.6.3), (A54)+(B1.6.4), (A54)+(B1.6.5), (A54)+(B1.6.6), (A54)+(B1.6.7), (A54)+(B1.6.8), (A54)+(B1.6.9), (A54)+(B1.6.10), (A54)+(B1.6.11), (A54)+(B11.6.12), (A54)+(B1.6.13), (A54)+(B1.6.14), (A54)+(B1.6.15), (A54)+(B1.6.16), (A54)+(B1.6.17), (A54)+(B1.6.18); (A54)+(B1.6.19); (A54)+(B2.1.1), (A54)+(B2.1.2), (A54)+(B2.1.3), (A54)+(B2.1.4), (A54)+(B2.1.6), (A54)+(B2.1.7), (A54)+(B2.1.8), (A54)+(B2.1.9), (A54)+(B2.1.10), (A54)+(B2.1.11), (A54)+(B2.1.12), (A54)+(B2.1.13), (A54)+(B2.1.13); (A54)+(B2.2.1), (A54)+(B2.2.2), (A54)+(B2.2.3), (A54)+(B2.2.3−RS), (A54)+(B2.2.4), (A54)+(B2.2.4−RS) (A54)+(B2.2.5), (A54)+(B2.2.6), (A54)+(B2.2.7), (A54)+(B2.2.8), (A54)+(B2.3.1), (A54)+(B2.3.2); (A54)+(B2.4.1), (A54)+(B2.4.2.), (A54)+(B2.4.3); (A54)+(B2.5.1), (A54)+(B2.5.2); (A54)+(B2.6.1), (A54)+(B2.6.2), (A54)+(B2.6.3), (A54)+(B2.6.4), (A54)+(B2.6.5), (A54)+(B2.6.6), (A54)+(B2.6.7), (A54)+(B2.6.8), (A54)+(B2.6.9), (A54)+(B2.6.10), (A54)+(B2.6.11), (A54)+(B2.6.12), (A54)+(B2.6.13), (A54)+(B2.6.14), (A54)+(B2.6.15); (A54)+(B3.1.1), (A54)+(B3.1.2), (A54)+(B3.1.3), (A54)+(B3.1.4), (A54)+(B3.1.5), (A54)+(B3.1.6), (A54)+(B3.1.7), (A54)+(B3.1.8), (A54)+(B3.1.9), (A54)+(B3.1.10), (A54)+(B3.1.11); (A54)+(B3.2.1), (A54)+(B3.2.2), (A54)+(B3.2.3); (A54)+(B3.3.1), (A54)+(B3.3.2), (A54)+(B3.3.2−RS), (A54)+(B3.3.3); (A54)+(B3.4.1), (A54)+(B3.4.2), (A54)+(B3.4.3), (A54)+(B3.4.4), (A54)+(B3.4.5), (A54)+(B3.4.6), (A54)+(B3.4.7), (A54)+(B3.4.8), (A54)+(B3.4.9), (A54)+(B3.4.10), (A64)+(B3.4.11), (A54)+(B3.4.12), (A54)+(B3.4.13), (A54)+(B3.4.14), (A54)+(B3.4.15), (A54)+(B3.4.16), (A54)+(B3.4.17), (A54)+(B3.4.18); (A54)+(B3.4.19); (A54)+(B4.1.1), (A54)+(B4.1.2); (A54)+(B4.2.1), (A54)+(B4.2.2); (A54)+(B4.3.1), (A54)+(B4.3.2), (A54)+(B4.3.3), (A54)+(B4.3.4), (A54)+(B4.3.5), (A54)+(84.3.6); (A54)+(B4.4.1), (A54)+(B4.4.2), (A54)+(B4.4.3), (A54)+(B4.4.4);

(A55)+(B1.1.1), (A55)+(B1.1.2.); (A55)+(B1.2.1), (A55)+(B1.2.2.), (A55)+(B1.2.3); (A55)+(B1.3.1), (A55)+(B1.3.2.), (A55)+(B1.3.3), (A55)+(B1.3.4), (A55)+(B1.3.5), (A55)+(B1.3.6), (A55)+(B1.3.7), (A55)+(B11.3.8); (A55)+(B1.4.1), (A5S )+(B1.4.2), (A55)+(B1.4.3), (A55)+(B1.4.4), (A55)+(B1.4.5); (A55)+(B1.5.1), (A55)+(B1.5.2), (A55)+(B1.5.3), (A55)+(B1.5.4); (A55)+(B1.6.1), (A55)+(B1.6.2), (A55)+(B1.6.3), (A55)+(B1.6.4), (A55)+(B1.6.5), (A55)+(B1.6.6), (A55)+(B1.6.7), (A55)+(B1.6.8), (A55)+(B1.6.9), (A55)+(B1.6.10), (A55)+(B1.6.11), (A55)+(B1.6.12), (A55)+(B1.6.13), (A55)+(B1.6.14), (A55)+(B1.6.15), (A55)+(B1.6.16), (A55)+(B1.6.17), (A55)+(B1.6.18); (A55)+(B1.6.19); (A55)+(B2.1.1), (A55)+(B2.1.2), (A55)+(B2.1.3), (A55)+(B2.1.4), (A55)+(B2.1.6), (A55)+(B2.1.7), (A55)+(B2.1.8), (A55)+(B2.1.9), (A55)+(B2.1.10), (A55)+(B2.1.11), (A55)+(B2.1.12), (A55)+(B2.1.13), (A55)+(B2.1.13); (A55)+(B2.2.1), (A55)+(B2.2.2), (A55)+(B2.2.3), (A55)+(B2.2.3−RS), (A55)+(B2.2.4), (A55)+(B2.2.4−RS) (A55)+(B2.2.5), (A55)+(B2.2.6), (A55)+(B2.2.7), (A55)+(B2.2.8), (A55)+(B2.31), (A55)+(B2.3.2); (A55)+(B2.4.1), (A55)+(B2.4.2.), (A55)+(B2.4.3); (A55)+(B2.5.1), (A55)+(B2.5.2); (A55)+(B2.6.1), (A55)+(B2.6.2), (A55)+(B2.6.3), (A55)+(B2.6.4), (A55)+(B2.6.5), (A55)+(B2.6.6), (A55)+(B2.6.7), (A55)+(B2.6.8), (A55)+(B2.6.9), (A55)+(B2.6.10), (A55)+(B2.6.11), (A55)+(B2.6.12), (A55)+(B2.6.13), (A55)+(B2.6.14), (A55)+(B2.6.15); (A55)+(B3.1.1), (A55)+(B3.1.2), (A55)+(B3.1.3), (A55)+(B3.1.4), (A55)+(B3.1.5), (A55)+(B3.1.6), (A55)+(B3.1.7), (A55)+(B3.1.8), (A55)+(B3.1.9), (A55)+(B3.1.10), (A55)+(B3.1.11); (A55)+(B3.2.1), (A55)+(B3.2.2), (A55)+(B3.2.3); (A55)+(B3.3.1), (A55)+(B3.3.2), (A55)+(B3.3.2−RS), (A55)+(B3.3.3); (A55)+(B3.4.1), (A55)+(B3.4.2), (A55)+(B3.4.3), (A55)+(B3.4.4), (A55)+(B3.5), (A55)+(B3.4.6), (A55)+(B3.4.7), (A55)+(B3.4.8), (A55)+(B3.4.9), (A55)+(B3.40), (A55)+(B3.4.11), (A55)+(B3.4.12), (A55)+(B3.4.13), (A55)+(B3.4.14), (A55)+(B3.4.15); (A55)+(B3.4.16), (A55)+(B3.4.17), (A55)+(B3.4.18); (A55)+(B3.4.19); (A55)+(B4.1.1), (A55)+(B4.1.2); (A55)+(B4.2.1), (A55)+(B4.2.2); (A56)+(B4.3.1), (A55)+(B4.3.2), (A55)+(B4.3.3), (A55)+(B4.3.4), (A55)+(B4.3.5), (A55)+(B4.3.6); (A55)+(B4.4.1), (A55)+(B4.4.2), (A55)+(B4.4.3), (A55)+(B4.4.4);

(A56)+(B1.1.1), (A56)+(B1.1.2.); (A56)+(B1.2.1), (A56)+(B1.2.2.), (A56)+(B1.2.3); (A56)+(B1.3.1), (A56)+(B1.3.2.), (A56)+(B1.3.3), (A56)+(B1.3.4), (A56)+(B1.3.5), (A56)+(B1.3.6), (A56)+(B1.3.7), (A56)+(B1.3.8); (A56)+(B1.4.1), (A56)+(B1.4.2), (A56)+(B1.4.3), (A56)+(B1.4.4), (A56)+(B1.4.5); (A56)+(B1.5.1), (A56)+(B1.5.2), (A56)+(B1.5.3), (A56)+(B1.5.4); (A56)+(B1.6.1), (A56)+(B1.6.2), (A56)+(B1.6.3), (A56)+(B1.6.4), (A56)+(B1.6.5), (A56)+(B1.6.6), (A56)+(B1.6.7), (A56)+(B1.6.8), (A56)+(B1.6.9), (A56)+(B1.6.10), (A56)+(B1.6.11), (A56)+(B1.6.12), (A56)+(B1.6.13), (A56)+(B1.6.14), (A56)+(B1.6.15), (A56)+(B1.6.16), (A56)+(B1.6.17), (A56)+(B1.6.18); (A56)+(B1.6.19); (A56)+(B2.1.1), (A56)+(B2.1.2), (A56)+(B2.1.3), (A56)+(B2.1.4), (A56)+(B2.1.6), (A56)+(B2.1.7), (A56)+(B2.1.8), (A56)+(B2.1.9), (A56)+(B2.1.10), (A56)+(B2.1.11), (A56)+(B2.1.12), (A56)+(B2.1.13), (A56)+(B2.1.13); (A56)+(B2.2.1), (A56)+(B2.2.2), (A56)+(B2.2.3), (A56)+(B2.2.3−RS), (A56)+(B2.2.4), (A56)+(B2.2.4−RS) (A56)+(B2.2.5), (A56)+(B2.2.6), (A56)+(B2.2.7), (A56)+(B2.2.8), (A56)+(B2.3.1), (A56)+(B2.3.2); (A56)+(B2.4.1), (A56)+(B2.4.2.), (A56)+(B2.4.3); (A56)+(B2.5.1), (A56)+(B2.5.2); (A56)+(B2.6.1), (A56)+(B2.6.2), (A56)+(B2.6.3), (A56)+(B2.6.4), (A56)+(B2.6.5), (A56)+(B2.6.6), (A56)+(B2.6.7), (A56)+(B2.6.8), (A56)+(B2.6.9), (A56)+(B2.6.10), (A56)+(B2.6.11), (A56)+(B2.6.12), (A56)+(B2.6.13), (A56)+(B2.6.14), (A56)+(B2.6.15); (A56)+(B3.1.1), (A56)+(B3.1.2), (A56)+(B3.1.3), (A56)+(B3.1.4), (A56)+(B3.1.5), (A56)+(B3.1.6), (A56)+(B3.1.7), (A56)+(B3.1.8), (A56)+(B3.1.9), (A56)+(B3.1.10), (A56)+(B3.1.11); (A56)+(B3.2.1), (A56)+(B3.2.2), (A56)+(B3.2.3); (A56)+(B3.3.1), (A56)+(B3.3.2), (A56)+(B3.3.2−RS), (A56)+(B3.3.3); (A56)+(B3.4.1), (A56)+(B3.4.2), (A56)+(B3.4.3), (A56)+(B3.4.4), (A56)+(B3.4.5), (A56)+(B3.4.6), (A56)+(B3.4.7), (A56)+(B3.4.8), (A56)+(B3.4.9), (A56)+(B3.4.10), (A56)+(B3.4.11), (A56)+(B3.4.12), (A56)+(B3.4.13), (A56)+(B3.4.14), (A56)+(B3.4.15), (A56)+(B3.4.16), (A56)+(B3.4.17), (A56)+(B3.4.18); (A56)+(B3.4.19); (A56)+(B4.1.1), (A56)+(B4.1.2); (A56)+(B4.2.1), (A56)+(B4.2.2); (A56)+(B4.3.1), (A56)+(B4.3.2), (A56)+(B4.3.3), (A56)+(B4.3.4), (A56)+(B4.3.5), (A56)+(B4.3.6); (A56)+(B4.4.1), (A56)+(B4.4.2), (A56)+(B4.4.3), (A56)+(B4.4.4);

(A57)+(B1.1.1), (A57)+(B1.1.2.); (A57)+(B1.2.1), (A57)+(B1.2.2.), (A57)+(B1.2.3); (A57)+(B1.3.1), (A57)+(B1.3.2.), (A57)+(B1.3.3), (A57)+(B1.3.4), (A57)+(B1.3.5), (A57)+(B1.3.6), (A57)+(B1.3.7), (A57)+(B1.3.8); (A57)+(B1.4.1), (A57)+(B1.4.2), (A57)+(B1.4.3), (A57)+(B1.4.4), (A57)+(B1.4.5); (A57)+(B1.5.1), (A57)+(B1.5.2), (A57)+(B1.5.3), (A57)+(B1.5.4); (A57)+(B1.6.1), (A57)+(B1.6.2), (A57)+(B1.6.3), (A57)+(B1.6.4), (A57)+(B1.6.5), (A57)+(B1.6.6), (A57)+(B1.6.7), (A57)+(B1.6.8), (A57)+(B1.6.9), (A57)+(B1.6.10), (A57)+(B1.6.11), (A57)+(B1.6.12), (A57)+(B1.6.13), (A57)+(B1.6.14), (A57)+(B1.6.15), (A57)+(B1.6.16), (A57)+(B1.6.17), (A57)+(B1.6.18); (A57)+(B1.6.19); (A57)+(B2.1.1), (A57)+(B2.1.2), (A57)+(B2.1.3), (A57)+(B2.1.4), (A57)+(B2.1.6), (A57)+(B2.1.7), (A57)+(B2.1.8), (A57)+(B2.1.9), (A57)+(B2.1.10), (A57)+(B2.1.11), (A57)+(B2.1.12), (A57)+(B2.1.13), (A57)+(82.1.13); (A57)+(B2.2.1), (A57)+(B2.2.2), (A57)+(B2.2.3), (A57)+(B2.2.3−RS), (A57)+(B2.2.4), (A57)+(B2.2.4−RS) (A57)+(B2.2.5), (A57)+(B2.2.6), (A57)+(B2.2.7), (A57)+(B2.2.8), (A57)+(B2.3.1), (A57)+(B2.3.2); (A57)+(B2.4.1), (A57)+(B2.4.2.), (A57)+(B2.4.3); (A57)+(B2.5.1), (A57)+(B2.5.2); (A57)+(B2.6.1), (A57)+(B2.6.2), (A57)+(B2.6.3), (A57)+(B2.6.4), (A57)+(B2.6.5), (A57)+(B2.6.6), (A57)+(B2.6.7), (A57)+(B2.6.8), (A57)+(B2.6.9), (A57)+(B2.6.10), (A57)+(B2.6.11), (A57)+(B2.6.12), (A57)+(B2.6.13), (A57)+(B2.6.14), (A57)+(B2.6.15); (A57)+(B3.1.1), (A57)+(B3.1.2), (A57)+(B3.1.3), (A57)+(B3.1.4), (A57)+(B3.1.5), (A57)+(B3.1.6), (A57)+(B3.1.7), (A57)+(B3.1.8), (A57)+(B3.1.9), (A57)+(B3.1.10), (A57)+(B3.1.11); (A57)+(B3.2.1), (A57)+(B3.2.2), (A57)+(B3.2.3); (A57)+(B3.3.1), (A57)+(B3.3.2), (A57)+(B3.3.2−RS), (A57)+(B3.3.3); (A57)+(B3.4.1), (A57)+(B3.4.2), (A57)+(B3.4.3), (A57)+(B3.4.4), (A57)+(B3.4.5), (A57)+(B3.4.6), (A57)+(B3.4.7), (A57)+(B3.4.8), (A57)+(B3.4.9), (A57)+(B3.4.10), (A57)+(B3.4.11), (A57)+(B3.4.12), (A57)+(B3.4.13), (A57)+(B3.4.14), (A57)+(B3.4.15), (A57)+(B3.4.16), (A57)+(B3.4.17), (A57)+(B3.4.18); (A57)+(B3.4.19); (A57)+(B4.1.1), (A57)+(B4.1.2); (A57)+(B4.2.1), (A57)+(B4.2.2); (A57)+(B4.3.1), (A57)+(B4.3.2), (A57)+(B4.3.3), (A57)+(B4.3.4), (A57)+(B4.3.5), (A57)+(B4.3.6); (A57)+(B4.4.1), (A57)+(B4.4.2), (A57)+(B4.4.3), (A57)+(B4.4.4);

(A58)+(B1.1.1), (A58)+(B1.1.2.); (A58)+(B1.2.1), (A58)+(B1.2.2.), (A58)+(B1.2.3); (A58)+(B1.3.1), (A58)+(B1.3.2.), (A58)+(B1.3.3), (A58)+(B1.3.4), (A58)+(B1.3.5), (A58)+(B1.3.6), (A58)+(B1.3.7), (A58)+(B1.3.8); (A58)+(B1.4.1), (A58)+(B1.4.2), (A58)+(B1.4.3), (A58)+(B1.4.4), (A58)+(B1.4.5); (A58)+(B1.5.1), (A58)+(B1.5.2), (A58)+(B1.5.3), (A58)+(B1.5.4); (A58)+(B1.6.1), (A58)+(B1.6.2), (A58)+(B1.6.3), (A58)+(B1.6.4), (A58)+(B1.6.5), (A58)+(B1.6.6), (A58)+(B1.60.7), (A58)+(B1.6.8), (A58)+(B1.6.9), (A58)+(B1.6.10), (A58)+(B1.6.11), (A58)+(B1.6.12), (A58)+(B1.6.13), (A58)+(B1.6.14), (A58)+(B1.6.15), (A58)+(B1.6.16), (A58)+(B1.6.17), (A58)+(B1.6.18); (A58)+(B1.6.19); (A58)+(B2.1.1), (A58)+(B2.1.2), (A58)+(B2.1.3), (A58)+(B2.1.4), (A58)+(B2.1.6), (A58)+(B2.1.7), (A58)+(B2.1.8), (A58)+(B2.1.9), (A58)+(B2.1.10), (A58)+(B2.1.11), (A58)+(B2.1.12), (A58)+(B2.1.13), (A58)+(B2.1.13); (A58)+(B2.2.1), (A58)+(B2.2.2), (A58)+(B2.2.3), (A58)+(B2.2.3−RS), (A58)+(B2.2.4), (A58)+(B2.2.4−RS) (A58)+(B2.2.5), (A58)+(B2.2.6), (A58)+(B2.2.7), (A58)+(B2.2.8), (A58)+(B2.3.1), (A58)+(B2.3.2); (A58)+(B2.4.1), (A58)+(B2.4.2.), (A58)+(B2.4.3); (A58)+(B2.5.1), (A58)+(B2.5.2); (A58)+(B2.6.1), (A58)+(B2.6.2), (A58)+(B2.6.3), (A58)+(B2.6.4), (A58)+(B2.6.5), (A58)+(B2.6.6), (A58)+(B2.6.7), (A58)+(B2.6.8), (A58)+(B2.6.9), (A58)+(B2.6.10), (A58)+(B2.6.11), (A58)+(B2.6.12), (A58)+(B2.6.13), (A58)+(B2.6.14), (A58)+(B2.6.15); (A58)+(B3.1.1), (A58)+(B3.1.2), (A58)+(B3.1.3), (A58)+(B3.1.4), (A58)+(B3.1.5), (A58)+(B3.1.6), (A58)+(B3.1.7), (A58)+(B3.1.8), (A58)+(B3.1.9), (A58)+(B3.1.10), (A58)+(B3.1.11); (A58)+(B3.2.1), (A58)+(B3.2.2), (A58)+(B3.2.3); (A58)+(B3.3.1), (A58)+(B3.3.2), (A58)+(B3.3.2−RS), (A58)+(B3.3.3); (A58)+(B3.4.1), (A58)+(B3.4.2), (A58)+(B3.4.3), (A58)+(B3.4.4), (A58)+(B3.4.5), (A58)+(B3.4.6), (A58)+(B3.4.7), (A58)+(B3.4.8), (A58)+(B3.4.9), (A58)+(B3.4.10), (A58)+(B3.4.11), (A58)+(B3.4.12), (A58)+(B3.4.13), (A58)+(B3.4.14), (A58)+(B3.4.15), (A58)+(B3.4.16), (A58)+(B3.4.17), (A58)+(B3.4.18); (A58)+(B3.4.19); (A58)+(B4.1.1), (A58)+(B4.1.2); (A58)+(B4.2.1), (A58)+(B4.2.2); (A58)+(B4.3.1), (A58)+(B4.3.2), (A58)+(B4.3.3), (A58)+(B4.3.4), (A58)+(B4.3.5), (A58)+(B4.3.6); (A58)+(B4.4.1), (A58)+(B4.4.2), (A58)+(B4.4.3), (A58)+(B4.4.4);

(A59)+(B1.1.1), (A59)+(B1.1.2.); (A59)+(B1.2.1), (A59)+(B1.2.2.), (A59)+(B1.2.3); (A59)+(B1.3.1), (A59)+(B1.3.2.), (A59)+(B1.3.3), (A59)+(B1.3.4), (A59)+(B1.3.5), (A59)+(B1.3.6), (A59)+(B1.3.7), (A59)+(B1.3.8); (A59)+(B1.4.1), (A59)+(B1.4.2), (A59)+(B1.4.3), (A59)+(B1.4.4), (A59)+(B1.4.5); (A59)+(B1.5.1), (A59)+(B1.5.2), (A59)+(B1.5.3), (A59)+(B1.5.4); (A59)+(B1.6.1), (A59)+(B1.6.2), (A59)+(B1.6.3), (A59)+(B1.6.4), (A59)+(B1.6.5), (A59)+(B1.6.6), (A59)+(B1.6-0.7), (A59)+(B1.6.8), (A59)+(B1.6.9), (A59)+(B1.6.10), (A59)+(B1.6.11), (A59)+(B1.6.12), (A59)+(B1.6.13), (A59)+(B1.6.14), (A59)+(B1.6.15), (A59)+(B1.6.16), (A59)+(B1.6.17), (A59)+(B1.6.18); (A59)+(B1.6.19); (A59)+(B2.1.1), (A59)+(B2.1.2), (A59)+(B2.1.3), (A59)+(B2.1.4), (A59)+(B2.1.6), (A59)+(B2.1.7), (A59)+(B2.1.8), (A59)+(B2.1.9), (A59)+(B2.1.10), (A59)+(B2.1.11), (A59)+(B2.1.12), (A59)+(B2.1.13), (A59)+(B2.1.13); (A59)+(B2.2.1), (A59)+(B2.2.2), (A59)+(B2.2.3), (A59)+(B2.2.3−RS), (A59)+(B2.2.4), (A59)+(B2.2.4−RS) (A59)+(82.2.5), (A59)+(B2.2.6), (A59)+(B2.2.7), (A59)+(B2.2.8), (A59)+(B2.3.1), (A59)+(B2.3.2); (A59)+(B2.4.1), (A59)+(B2.4.2.), (A59)+(B2.4.3); (A59)+(B2.5.1), (A59)+(B2.5.2); (A59)+(B2.6.1), (A59)+(B2.6.2), (A59)+(B2.6.3), (A59)+(B2.6.4), (A59)+(B2.6.5), (A59)+(B2.6.6), (A59)+(B2.6.7), (A59)+(B2.6.8), (A59)+(B2.6.9), (A59)+(B2.6.10), (A59)+(B2.6.11), (A59)+(B2.6.12), (A59)+(B2.6.13), (A59)+(B2.6.14), (A59)+(B2.6.15); (A59)+(B3.1.1), (A59)+(B3.1.2), (A59)+(B3.1.3), (A59)+(B3.1.4), (A59)+(B3.1.5), (A59)+(B3.1.6), (A59)+(B3.1.7), (A59)+(B3.1.8), (A59)+(B3.1.9), (A59)+(B3.1.10), (A59)+(B3.1.11); (A59)+(B3.2.1), (A59)+(B3.2.2), (A59)+(B3.2.3); (A59)+(B3.3.1), (A59)+(B3.3.2), (A59)+(B3.3.2−RS), (A59)+(B3.3.3); (A59)+(B3.4.1), (A59)+(B3.4.2), (A59)+(B3.4.3), (A59)+(B3.4.4), (A59)+(B3.4.5), (A59)+(B3.4.6), (A59)+(B3.4.7), (A59)+(B3.4.8), (A59)+(B3.4.9), (A59)+(B3.4.10), (A59)+(B3.4.11), (A59)+(B3.4.12), (A59)+(B3.4.13), (A59)+(B3.4.14), (A59)+(B3.4.15), (A59)+(B3.4.16), (A59)+(B3.4.17), (A59)+(B3.4.18); (A59)+(B3.4.19); (A59)+(B4.1.1), (A59)+(B4.1.2); (A59)+(B4.2.1), (A59)+(B4.2.2); (A59)+(B4.3.1), (A59)+(B4.3.2), (A59)+(B4.3.3), (A59)+(B4.3.4), (A59)+(B4.3.5), (A59)+(B4.3.6); (A59)+(B4.4.1), (A59)+(B4.4.2), (A59)+(B4.4.3), (A59)+(B4.4.4);

(A60)+(B1.1.1), (A60)+(B1.1.2.); (A60)+(B1.2.1), (A60)+(B1.2.2.), (A60)+(B1.2.3); (A60)+(B1.3.1), (A60)+(B1.3.2.), (A60)+(B1.3.3), (A60)+(B1.3.4), (A60)+(B1.3.5), (A60)+(B1.3.6), (A60)+(B1.3.7), (A60)+(B1.3.8); (A60)+(B1.4.1), (A6d)+(B1.4.2), (A60)+(B1.4.3), (A60)+(B1.4.4), (A60)+(B1.4.5); (A60)+(B1.5.1), (A60)+(B1.5.2), (A60)+(B1.5.3), (A60)+(B1.5.4); (A60)+(B1.6.1), (A60)+(B1.6.2), (A60)+(B1.6.3), (A60)+(B1.6.4), (A60)+(B1.6.5), (A60)+(B1.6.6), (A60)+(B1.6.7), (A60)+(B1.6.8), (A60)+(B1.6.9), (A60)+(B1.6.10), (A60)+(B1.6.11), (A60)+(B1.6.12),. (A60)+(B1.6.13), (A60)+(B1.6.14), (A60)+(B1.6.15), (A60)+(B1.6.16), (A60)+(B1.6.17), (A60)+(B1.6.18); (A60)+(B1.6.19); (A60)+(B2.1.1), (A60)+(B2.1.2), (A60)+(B2.1.3), (A60)+(B2.1.4), (A60)+(B2.1.6), (A60)+(B2.1.7), (A60)+(B2.1.8), (A60)+(B2.1.9), (A60)+(B2.1.10), (A60)+(B2.1.11), (A60)+(B2.1.12), (A60)+(B2.1.13), (A60)+(B2.1.13); (A60)+(B2.2.1), (A60)+(B2.2.2), (A60)+(B2.2.3), (A60)+(B2.2.3−RS), (A60)+(B2.2.4), (A60)+(B2.2.4−RS) (A60)+(B2.2.5), (A60)+(B2.2.6), (A60)+(B2.2.7), (A60)+(B2.2.8), (A60)+(B2.3.1), (A60)+(B2.3.2); (A60)+(B2.4.1), (A60)+(B2.4.2.), (A60)+(B2.4.3); (A60)+(B2.5.1), (A60)+(B2.5.2); (A60)+(B2.6.1), (A60)+(B2.6.2), (A60)+(B2.6.3), (A60)+(B2.6.4), (A60)+(B2.6.5), (A60)+(B2.6.6), (A60)+(B2.6.7), (A60)+(B2.6.8), (A60)+(B2.6.9), (A60)+(B2.6.10), (A60)+(B2.6.11), (A60)+(B2.6.12), (A60)+(B2.6.13), (A60)+(B2.6.14), (A60)+(B2.6.15); (A60)+(B3.1.1), (A60)+(B3.1.2), (A60)+(B3.1.3), (A60)+(B3.1.4), (A60)+(B3.1.5), (A60)+(B3.1.6), (A60)+(B3.1.7), (A60)+(B3.1.8), (A60)+(B3.1.9), (A60)+(B3.1.10), (A60)+(B3.1.11); (A60)+(B3.2.1), (A60)+(B3.2.2), (A60)+(B3.2.3); (A60)+(B3.3.1), (A60)+(B3.3.2), (A60)+(B3.3.2−RS), (A60)+(B3.3.3); (A60)+(B3.4.1), (A60)+(B3.4.2), (A60)+(B3.4.3), (A60)+(B3.4.4), (A60)+(B3.4.5), (A60)+(B3.4.6), (A60)+(B3.4.7), (A60)+(B3.4.8), (A60)+(B3.4.9), (A60)+(B3.4.10), (A60)+(B3.4.11), (A60)+(B3.4.12), (A60)+(B3.4.13), (A60)+(B3.4.14), (A60)+(B3.4.15), (A60)+(B3.4.16), (A60)+(B3.4.17), (A60)+(B3.4.18); (A60)+(B3.4.19); (A60)+(B4.1.1), (A60)+(B4.1.2); (A60)+(B4.2.1), (A60)+(B4.2.2); (A60)+(B4.3.1), (A60)+(B4.3.2), (A60)+(B4.3.3), (A60)+(B4.3.4), (A60)+(B4.3.5), (A60)+(B4.3.6); (A60)+(B4.4.1), (A60)+(B4.4.2), (A60)+(B4.4.3), (A60)+(B4.4.4).

The abovementioned ranges of application rates and ratios are in each case preferred.

In individual cases, it may be expedient to combine one of the compounds (A) with a plurality of compounds (B) from the classes (B1), (B2), (B3) and/or (B4). Furthermore, the combinations according to the invention may be employed together with other active compounds, for example from the group of the safeners, fungicides, insecticides and plant growth regulators, or from the group of the additives and formulation auxiliaries which are customary in crop protection.

Preference is given to herbicide combinations according to the invention comprising such an amount of safeners (C) that they act as antidotes, to reduce the phytotoxic side effects of the herbicides used in economically important crops such as cereals (wheat, barley, rye, corn, rice, millet), sugar beet, sugar cane, oilseed rape, cotton and soybean. The herbicide combinations are preferably employed in cereals. Suitable safeners for the abovementioned herbicidal active compounds (A) and (B) are, for example, the following groups of compounds:

| | |
|---|---|
| a) | Compounds of the dichlorophenylpyrazoline-3-carboxylic acid type, preferably |
| | compounds such as ethyl 1-(2,4-dichlorophenyl)- |
| | 5-(ethoxycarbonyl)-5-methyl-2-pyrazoline-3-carboxylate (S1-1) (“mefenpyr- |
| | diethyl”, PM, pp. 781-782), and related compounds, as described in |
| | WO 91/07874, |
| b) | Derivatives of dichlorophenylpyrazole carboxylic acid, preferably compounds |
| | such as ethyl 1-(2,4-dichlorophenyl)-5-methylpyrazole-3-carboxylate (S1-2), |
| | ethyl 1-(2,4-dichlorophenyl)-5-isopropylpyrazole-3-carboxylate (S1-3), ethyl |
| | 1-(2,4-dichlorophenyl)-5-(1,1-dimethylethyl)pyrazole-3-carboxylate (S1-4), |
| | ethyl 1-(2,4-dichlorophenyl)-5-phenylpyrazole-3-carboxylate (S1-5) and |
| | related compounds as described in EP-A-333 131 and EP-A-269 806. |
| c) | Compounds of the triazolecarboxylic acid type, preferably compounds such as |
| | fenchlorazole(ethyl ester), i.e. ethyl 1-(2,4-dichlorophenyl)-5-trichloro- |
| | methyl-(1H)-1,2,4-triazole-3-carboxylate (S1-6) and related compounds as |
| | described in EP-A-174 562 and EP-A-346 620; |
| d) | Compounds of the 5-benzyl- or 5-phenyl-2-isoxazoline-3-carboxylic acid type, |
| | or the 5,5-diphenyl-2-isoxazoline-3-carboxylic acid type, preferably |
| | compounds such as ethyl 5-(2,4-dichlorobenzyl)-2-isoxazoline-3-carboxylate |
| | (S1-7) or ethyl 5-phenyl-2-isoxazoline-3-carboxylate (S1-8) and related |
| | compounds, as described in WO 91/08202, or the ethyl 5,5-diphenyl-2- |
| | isoxazolinecarboxylate (S1-9) (“isoxadifen-ethyl”) or its n-propyl ester (S1-10) |
| | or the ethyl 5-(4-fluorophenyl)-5-phenyl-2-isoxazoline-3-carboxylate (S1-11), |
| | as described in the German patent application (WO-A-95/07897). |
| e) | Compounds of the 8-quinolineoxyacetic acid type (S2), preferably |
| | 1-methylhex-1-yl (5-chloro-8-quinolineoxy) acetate (common name |
| | “cloquintocet-mexyl” (S2-1) (see PM, pp. 263-264) |
| | 1,3-dimethylbut-1-yl (5-chloro-8-quinolineoxy)acetate (S2-2), |
| | 4-allyloxybutyl (5-chloro-8-quinolineoxy)acetate (S2-3), |
| | 1-allyloxyprop-2-yl (5-chloro-8-quinolineoxy)acetate (S2-4), |
| | ethyl (5-chloro-8-quinolineoxy)acetate (S2-5), |
| | methyl (5-chloro-8-quinolineoxy)acetate (S2-6), |
| | allyl (5-chloro-8-quinolineoxy)acetate (S2-7), |
| | 2-(2-propylideneiminoxy)-1-ethyl (5-chloro-8-quinolineoxy)acetate (S2-8), |
| | 2-oxoprop-1-yl (5-chloro-8-quinolineoxy)acetate (S2-9) |
| | and related compounds, as described in EP-A-86 750, EP-A-94 349 and |
| | EP-A-191 736 or EP-A-0 492 366. |
| f) | Compounds of the (5-chloro-8-quinolineoxy)malonic acid type, preferably |
| | compounds such as diethyl (5-chloro-8-quinolineoxy)malonate, diallyl |
| | (5-chloro-8-quinolineoxy)malonate, methyl ethyl |
| | (5-chloro-8-quinolineoxy)malonate and related compounds, as described in |
| | EP-A-0 582 198. |
| g) | Active compounds of the phenoxyacetic or -propionic acid derivative type or |
| | the aromatic carboxylic acid type, such as, for example, |
| | 2,4-dichlorophenoxyacetic acid (esters) (2,4-D), |
| | 4-chloro-2-methylphenoxypropionic esters (mecoprop), MCPA or 3,6-dichloro- |
| | 2-methoxybenzoic acid (esters) (dicamba). |
| h) | Active compounds of the pyrimidine type, which are used as soil-acting |
| | safeners in rice, such as, for example, “fenclorim” (PM pp. 512-511) (= 4,6- |
| | dichloro-2-phenylpyrimidine), which is known as safener against pretilachlor |
| | damage in sown rice, |
| i) | Active compounds of the dichloroacetamide type, which are frequently used |
| | as pre-emergent safeners (soil-acting safeners), such as, for example, |
| | “dichlormid” (PM, pp. 363-364) (= N,N-diallyl-2,2-dichloroacetamide), |
| | “R-29148” (= 3-dichloroacetyl-2,2,5-trimethyl-1,3-oxazolidine from Stauffer), |
| | “benoxacor” (PM, pp. 102-103) (= 4-dichloroacetyl-3,4-dihydro-3-methyl-2H- |
| | 1,4-benzoxazine), |
| | “PPG-1292” (= N-allyl-N-[(1,3-dioxolan-2-yl)methyl]dichloroacetamide from |
| | PPG Industries), |
| | “DK-24” (= N-allyl-N-[(allylaminocarbonyl)methyl]dichloroacetamide from |
| | Sagro-Chem), |
| | “AD-67” or “MON 4660” (= 3-dichloroacetyl-1-oxa-3-aza-spiro[4,5]decane from |
| | Nitrokemia or Monsanto), |
| | “diclonon” or “BAS145138” or “LAB145138” (= 3-dichloroacetyl-2,5,5- |
| | trimethyl-1,3-diazabicyclo[4.3.0]nonane from BASF) and |
| | “furilazol” or “MON 13900” (see PM, 637-638) (= (RS)-3-dichloroacetyl-5-(2- |
| | furyl)-2,2-dimethyloxazolidine) |
| j) | Active compounds of the dichloroacetone derivative type, such as, for |
| | example, |
| | “MG 191” (CAS-Reg. No. 96420-72-3) (= 2-dichloromethyl-2-methyl-1,3- |
| | dioxolane from Nitrokemia), which is known as safener for corn, |
| k) | Active compounds of the oxyimino compound type, which are known as seed |
| | dressings, such as, for example, |
| | “oxabetrinil” (PM, pp. 902-903) (= (Z)-1,3-dioxolan-2-ylmethoxy- |
| | imino(phenyl)acetonitrile), which is known as seed dressing safener for millet |
| | against metolachlor damage, and |
| | “fluxofenim” (PM, pp. 613-614) (= 1-(4-chlorophenyl)-2,2,2-trifluoro-1- |
| | ethanone O-(1,3-dioxolan-2-ylmethyl) oxime), which is known as seed |
| | dressing safener for millet against metolachlor damage, and |
| | “cyometrinil” or “-CGA-43089” (PM, p. 1304) (= (Z)-cyanomethoxyimino- |
| | (phenyl)acetonitrile), which is known as seed dressing safener for millet |
| | against metolachlor damage, |
| l) | Active compounds of the thiazolecarboxylic ester type, which are known as |
| | seed dressings, such as, for example, |
| | “flurazol” (PM, pp. 590-591) (= benzyl 2-chloro-4-trifluoromethyl-1,3-thiazole- |
| | 5-carboxylate), which is known as seed dressing safener for millet against |
| | alachlor and metolachlor damage, |
| m) | Active compounds of the naphthalenedicarboxylic acid derivative type, which |
| | are known as seed dressings, such as, for example, |
| | “naphthalic anhydride” (PM, p. 1342) (= 1,8-naphthalenedicarboxylic |
| | anhydride), which is known as seed dressing safener for corn against |
| | thiocarbamate herbicide damage, |
| n) | Active compounds of the chromanacetic acid derivative type, such as, for |
| | example, |
| | “CL 304415” (CAS-Reg. No. 31541-57-8) (= 2-(4-carboxychroman-4-yl)acetic |
| | acid from American Cyanamid), which is known as safener for corn against |
| | imidazolinone damage, |
| o) | Active compounds which, in addition to a herbidical action against harmful |
| | plants, also have safener action in crop plants such as rice, such as, for |
| | example, |
| | “dimepiperate” or “MY-93” (PM, pp. 404-405) (= S-1-methyl-1-phenylethyl |
| | piperidine-1-thiocarboxylate), which is known as safener for rice against |
| | damage by the herbicide molinate, |
| | “daimuron” or “SK 23” (PM, p. 330) (= 1-(1-methyl-1-phenylethyl)-3-p- |
| | tolylurea), which is known as safener for rice against damage by the herbicide |
| | imazosulfuron, |
| | “cumyluron” = “JC-940” (= 3-(2-chlorophenylmethyl)-1-(1-methyl- |
| | 1-phenylethyl)urea, see JP-A-60087254), which is known as safener for rice |
| | against damage by some herbicides, |
| | “methoxyphenon” or “NK 049” (= 3,3′-dimethyl-4-methoxybenzophenone), |
| | which is known as safener for rice against damage by some herbicides, |
| | “CSB” (= 1-bromo-4-(chloromethylsulfonyl)benzene) (CAS-Reg. No. 54091- |
| | 06-4 from Kumiai), which is known as safener against damage by some |
| | herbicides in rice, |
| p) | N-Acylsulfonamides of the formula (S3) and salts thereof, |

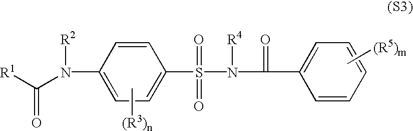

as described in WO-A-97/45016,

q) Acylsulfamoylbenzoamides of the formula (S4), if appropriate also in salt form,

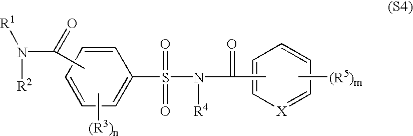

as described in the International Application No. PCT/EP98/06097, and

r) Compounds of the formula (S5),

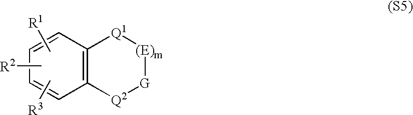

as described in WO-A 98/13 361,

including the stereoisomers and the salts used in agriculture.

Among the safeners mentioned, (S1-1) and (S1-9) and (S2-1), in particular (S1-1) and (S1-9), are of particular interest.

Some of the safeners have already been mentioned above as herbicides and consequently show, in addition to the herbicidal action against harmful plants, also protective action in connection with crop plants.

Preference is also given to herbicide combinations (A)+(B)+(C) in which (C) are safeners which are usually employed in commercial products with herbicides (B).

The combinations according to the invention (=herbicidal compositions) have an outstanding herbicidal activity against a broad spectrum of economically important monocotyledonous and dicotyledonous harmful plants. The active ingredients also act efficiently on perennial weeds which produce shoots from rhizomes, rootstocks or other perennial organs and which are difficult to control.

Specifically, examples may be mentioned of some representatives of the monocotyledonous and dicotyledonous weed flora which can be controlled by the compounds according to the invention, without the enumeration being a restriction to certain species.

Examples of weed species on which the herbicidal compositions act efficiently are, from amongst the monocotyledonous weed species, Avena spp., Alopecurus spp., Brachiaria spp., Digitaria spp., Lolium spp., Echinochloa spp., Panicum spp., Phalaris spp., Poa spp., Setaria spp. and Cyperus species from the annual group, and, amongst the perennial species, Agropyron, Cynodon, Imperata and Sorghum and also perennial Cyperus species.

In the case of the dicotyledonous weed species, the spectrum of action extends to species such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp., Viola spp., and Xanthium spp., amongst the annuals, and Convolvulus, Cirsium, Rumex and Artemisia in the case of the perennial weeds.

If the compounds according to the invention are applied to the soil surface before germination, then the weed seedlings are either prevented completely from emerging, or the weeds grow until they have reached the cotyledon stage but then their growth stops, and, eventually, after three to four weeks have elapsed, they die completely.

If the compositions are applied post-emergence to the green parts of the plants, growth likewise stops drastically a very short time after the treatment and the weed plants remain at the growth stage of the point of time of application, or they die completely after a certain time, so that in this manner competition by the weeds, which is harmful to the crop plants, is eliminated at a very early point in time and in a sustained manner.

The herbicidal compositions according to the invention are distinguished by a rapidly commencing and long-lasting herbicidal action. As a rule, the rainfastness of the active ingredients in the combinations according to the invention is advantageous. A particular advantage is that the dosages of the compounds (A) and (B), which are used in the combinations and are effective, can be adjusted to such a low quantity that their soil action is optimally low. This does not only allow them to be employed in sensitive crops in the first place, but groundwater contaminations are virtually avoided. The active-ingredient combination according to the invention allows the application rate of the active ingredients required to be reduced considerably.

When herbicides of the type (A)+(B) are used jointly, superadditive (=synergistic) effects are observed. This means that the effect in the combinations exceeds the expected total of the effects of the individual herbicides employed. The synergistic effects allow the application rate to be reduced, a broader spectrum of broad-leaved weeds and grass weeds to be controlled, the herbicidal action to take place more rapidly, the duration of action to be longer, the harmful plants to be controlled better while using only one, or few, applications, and the application period which is possible to be extended. In some cases, use of the compositions also reduces the amount of harmful constituents, such as nitrogen or oleic acid, and their entry into the ground.

The abovementioned properties and advantages are necessary for weed control in practice to keep agricultural crops free from undesired competing plants and thus to guarantee and/or increase the yields from the qualitative and quantitative point of view. These novel combinations markedly exceed the technical state of the art with a view to the properties described.

While the combinations according to the invention have an outstanding herbicidal activity against monocotyledonous and dicotyledonous weeds, the crop plants are damaged only to a minor extent, if at all.

Moreover, some of the compositions according to the invention have outstanding growth-regulatory properties on the crop plants. They engage in the plants' metabolism in a regulatory manner and can thus be employed for provoking directed effects on plant constituents and to facilitate harvesting such as for example by triggering desiccation and stunted growth. Moreover, they are also suitable for the general control and inhibition of undesired vegetative growth without simultaneously destroying the plants. An inhibition of vegetative growth is very important in a large number of monocotyledonous and dicotyledonous crops since lodging can thus be reduced, or prevented completely.

Owing to their herbicidal and plant-growth-regulatory properties, the compositions can be employed for controlling harmful plants in known plant crops or tolerant or genetically modified crop plants still to be developed. The transgenic plants are generally distinguished by particular, advantageous properties, such as resistances to plant diseases or causative agents of plant diseases such as particular insects or microorganisms such as fungi, bacteria or viruses in addition to resistances to the compositions according to the invention. Other particular properties relate, for example, to the harvested material with regard to quantity, quality, storability, composition and specific constituents. Thus, for example, transgenic plants are known whose starch content is increased or whose starch quality is altered, or those where the harvested material has a different fatty acid composition.

Conventional methods of generating novel plants which have modified properties in comparison to plants occurring to date consist, for example, in traditional breeding methods and the generation of mutants. Alternatively, novel plants with altered properties can be generated with the aid of recombinant methods (see, for example, EP-A-0221044, EP-A-0131624). For example, the following have been described in several cases:

the modification, by recombinant technology, of crop plants with the aim of modifying the starch synthesized in the plants (for example WO 92/11376, WO 92/14827, WO 91/19806),

transgenic crop plants which exhibit resistances to other herbicides, for example to sulfonylureas (EP-A-0257993, U.S. Pat. No. 5,013,659),

transgenic crop plants with the capability of producing Bacillus thuringiensis toxins (Bt toxins), which make the plants resistant to certain pests (EP-A-0142924, EP-A-0193259),

transgenic crop plants with a modified fatty acid composition (WO 91/13972).

A large number of techniques in molecular biology are known in principle with the aid of which novel transgenic plants with modified properties can be generated: see, for example, Sambrook et al., 1989, Molecular Cloning, A Laboratory Manual, 2nd Edition, Cold Spring Harbor Laboratory Press, Cold Spring Harbor, N.Y.; or Winnacker “Gene und Klone”, VCH Weinheim 2nd Edition 1996 or Christou, “Trends in Plant Science” 1(1996)423431).

To carry out such recombinant manipulations, nucleic acid molecules which allow mutagenesis or sequence changes by recombination of DNA sequences can be introduced into plasmids. For example, the abovementioned standard methods allow base exchanges to be carried out, subsequences to be removed, or natural or synthetic sequences to be added. To connect the DNA fragments to each other, adapters or linkers may be added to the fragments.

For example, the generation of plant cells with a reduced activity of a gene product can be achieved by expressing at least one corresponding antisense RNA, a sense RNA for achieving a cosuppression effect or by expressing at least one suitably constructed ribosome which specifically cleaves transcripts of the above-mentioned gene product.

To this end, it is possible to use, on the one hand, DNA molecules which encompass the entire coding sequence of a gene product inclusive of any flanking sequences which may be present, as well as DNA molecules which only encompass portions of the coding sequence, it being necessary for these portions to be long enough to have an antisense effect on the cells. The use of DNA sequences which have a high degree of homology to the coding sequences of a gene product, but are not completely identical to them, is also possible.

When expressing nucleic acid molecules in plants, the protein synthesized can be localized in any desired compartment of the plant cell. However, to achieve localization in a particular compartment, it is possible, for example, to link the coding region with DNA sequences which ensure localization in a particular compartment. Such sequences are known to those skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106).

The transgenic plant cells can be regenerated by known techniques to give rise to entire plants. In principle, the transgenic plants can be plants of any desired plant species, i.e. not only monocotyledonous, but also dicotyledonous, plants. Thus, transgenic plants can be obtained whose properties are altered by overexpression, suppression or inhibition of homologous (=natural) genes or gene sequences or the expression of heterologous (=foreign) genes or gene sequences.

The invention therefore also relates to a method of controlling undesired vegetation, preferably in plant crops, which comprises applying one or more compositions of type (A) together with one or more herbicides of type (B) to the harmful plants, parts of these plants, or the area under cultivation.

The invention also relates to the use of the herbicidal compositions of compounds (A)+(B) for controlling harmful plants, preferably in plant crops.

The active ingredient combinations according to the invention can exist not only as mixed formulations of the two components, if appropriate together with further active ingredients, additives and/or customary formulation auxiliaries, which are then applied in the customary manner as a dilution with water, but also as so-called tank mixes by jointly diluting the separately formulated, or partially separately formulated, components with water.

The compounds (A) and (B) or their combinations can be formulated in various ways, depending on the prevailing biological and/or chemical-physical parameters. The following are examples of general possibilities for formulations: wettable powders (WP), emulsifiable concentrates (EC), aqueous solutions (SL), emulsions (EW) such as oil-in-water and water-in-oil emulsions, sprayable solutions or emulsions, oil- or water-based dispersions, suspoemulsions, dusts (DP), seed-dressing materials, granules for soil application or for broadcasting, or water-dispersible granules (WG), ULV formulations, microcapsules or waxes.

The individual formulation types are known in principle and are described for example, in: Winnacker-Küchler, “Chemische Technologie”, Volume 7, C. Hauser Verlag Munich, 4th Edition, 1986; van Valkenburg, “Pesticide Formulations”, Marcel Dekker N.Y., 1973; K. Martens, “Spray Drying Handbook”, 3rd Ed. 1979, G. Goodwin Ltd. London.

The formulation auxiliaries required, such as-inert materials, surfactants, solvents and other additives are also known and are described, for example, in Watkins, “Handbook of Insecticide Dust Diluents and Carriers”, 2nd Ed., Darland Books, Caldwell N.J.; H. v. Olphen, “Introduction to Clay Colloid Chemistry”; 2nd Ed., J. Wiley & Sons, N.Y.; Marsden, “Solvents Guide”, 2nd Ed., Interscience, N.Y. 1950; McCutcheon's, “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schönfeldt, “Grenzflächenaktive Äthylenoxidaddukte” [Surface-active ethylene oxide adducts], Wiss. Verlagsgesellschaft, Stuttgart 1976, Winnacker-Küchler, “Chemische Technologie”, Volume 7, C. Hauser Verlag Munich, 4th Edition 1986.

Based on these formulations, combinations with other pesticidally active substances, such as other herbicides, fungicides or insecticides, and with safeners, fertilizers and/or growth regulators, may also be prepared, for example in the form of a readymix or a tank mix. Further suitable pesticidally active substances can be found in “the pesticide Mammal”, 12^{th} edition 2000, published by the British Crop Protection Council, and in the literature cited therein, unless they are already mentioned above as components (B) according to the invention.

Wettable powders (sprayable powders) are preparations which are uniformly dispersible in water and which, besides the active ingredient, also comprise ionic or nonionic surfactants (wetters, dispersants), for example polyoxethylated alkylphenols, polyethoxylated fatty alcohols or fatty amines, alkanesulfonates or alkylbenzenesulfonates, sodium lignosulfonate, sodium 2,2′-dinaphthylmethane-6,6′-disulfonate, sodium dibutylnaphthalenesulfonate or else sodium oleoylmethyltauride, in addition to a diluent or inert material.

Emulsifiable concentrates are prepared by dissolving the active ingredient in an organic solvent, for example butanol, cyclohexanone, dimethylformamide, xylene or else higher-boiling aromatics or hydrocarbons with addition of one or more ionic or nonionic surfactants (emulsifiers). Examples of emulsifiers which may be used are: calcium salts of alkylarylsulfonic acids, such as Ca dodecylbenzene sulfonate, or nonionic emulsifiers such as fatty acid polyglycol esters, alkylaryl polyglycol ethers, fatty alcohol polyglycol ethers, propylene oxide/ethylene oxide condensates, alkyl polyethers, sorbitan fatty acid esters, polyoxyethylene sorbitan fatty acid esters or polyoxethylene sorbitol esters.

Dusts are obtained by grinding the active ingredient with finely divided solid materials, for example talc, natural clays such as kaolin, bentonite and pyrophyllite, or diatomaceous earth.

Granules can be prepared either by spraying the active ingredient onto adsorptive, granulated inert material or by applying active ingredient concentrates to the surface of carriers such as sand, kaolinites or granulated inert material with the aid of binders, for example polyvinyl alcohol, sodium polyacrylate or else mineral oils. Suitable active ingredients may also be granulated in the manner conventionally used for the production of fertilizer granules, if desired in a mixture with fertilizers. In general, water-dispersible granules are prepared by processes such as spray drying, fluidized-bed granulation, disk granulation, mixing with high-speed mixers and extrusion without solid inert material.

In general, the agrochemical formulations comprise 0.1 to 99 percent by weight, in particular 2 to 95% by weight, of active ingredients of the types A and/or B, the following concentrations being customary, depending on the type of formulation: The active ingredient concentration in wettable powders is, for example, approximately 10 to 95% by weight, the remainder to 100% by weight being composed of customary formulation constituents. In the case of emulsifiable concentrates, the active ingredient concentration may amount to, for example, 5 to 80% by weight.

Formulations in the form of dusts comprise, in most cases, 5 to 20% by weight of active ingredient, sprayable solutions approximately 0.2 to 25% by weight of active ingredient.

In the case of granules such as dispersible granules, the active ingredient content depends partly on whether the active compound is present in liquid or solid form and on which granulation auxiliaries and fillers are being used. As a rule, the content amounts to between 10 and 90% by weight in the case of the water-dispersible granules.

In addition, the abovementioned active ingredient formulations may comprise, if appropriate, the conventional adhesives, wetters, dispersants, emulsifiers, preservatives, antifreeze agents, solvents, fillers, colorants, carriers, antifoams, evaporation inhibitors, pH regulators or viscosity regulators, thickeners, fertilizers and/or dyes.

For use, the formulations, which are present in commercially available form, are optionally diluted in the customary manner, for example using water in the case of wettable powders, emulsifiable concentrates, dispersions and water-dispersible granules. Preparations in the form of dusts, soil granules, granules for broadcasting and sprayable solutions are usually not diluted further with other inert substances prior to use.

The herbicidal compositions can be applied to the plants, parts of the plants, seeds of the plants or the area under cultivation (soil of the field), preferably to the green plants and parts of the plants and, if appropriate, additionally to the soil of the field. One possible use is the joint application of the active ingredients in the form of tank mixes, the concentrated formulations of the individual active ingredients, in optimal formulations, jointly being mixed with water in the tank and the resulting spray mixture being applied.

A joint herbicidal formulation of the combination according to the invention of the active ingredients (A) and (B) has the advantage of being easier to apply since the quantities of the components are already presented in the correct ratio to each other. Moreover, the adjuvants in the formulation can be matched optimally to each other, while a tank mix of different formulations may lead to undesired combinations of adjuvants.

| | |
|---|---|
| A. | General formulation examples |
| a) | A dust is obtained by mixing 10 parts by weight of an active ingredient/active |
| | ingredient mixture and 90 parts by weight of talc as inert material and |
| | comminuting the mixture in a hammer mill. |
| b) | A wettable powder which is readily dispersible in water is obtained by mixing |
| | 25 parts by weight of an active ingredient/active ingredient mixture, 64 parts |
| | by weight of kaolin-containing quartz as inert material, 10 parts by weight of |
| | potassium lignosulfonate and 1 part by weight of sodium |
| | oleoylmethyltaurinate as wetter and dispersant, and grinding the mixture in a |
| | pinned-disk mill. |
| c) | A dispersion concentrate which is readily dispersible in water is obtained by |
| | mixing 20 parts by weight of an active ingredient/active ingredient mixture |
| | with 6 parts by weight of alkylphenol polyglycol ether (® Triton X 207), 3 parts |
| | by weight of isotridecanol polyglycol ether (8 EO) and 71 parts by weight of |
| | paraffinic mineral oil (boiling range for example approx. 255 to 277EC), and |
| | grinding the mixture in a ball mill to a fineness of below 5 microns. |
| d) | An emulsifiable concentrate is obtained from 15 parts by weight of an active |
| | ingredient/active ingredient mixture, 75 parts by weight of cyclohexanone as |
| | solvent and 10 parts by weight of oxethylated nonylphenol as emulsifier. |
| e) | Water-dispersible granules are obtained by mixing |
| | 75 parts by weight of an active ingredient/active ingredient mixture, |
| | 10 parts by weight of calcium lignosulfonate, |
| | 5 parts by weight of sodium lauryl sulfate, |
| | 3 parts by weight of polyvinyl alcohol and |
| | 7 parts by weight of kaolin, |
| | grinding the mixture in a pinned-disk mill and granulating the powder in a |
| | fluidized bed by spraying on water as granulation liquid. |
| f) | Water-dispersible granules are also obtained by homogenizing and |
| | precomminuting, in a colloid mill, |
| | 25 parts by weight of an active ingredient/active ingredient mixture, |
| | 5 parts by weight of sodium 2,2′-dinaphthylmethane-6,6′-disulfonate, |
| | 2 parts by weight of sodium oleoylmethyltaurinate, |
| | 1 part by weight of polyvinyl alcohol, |
| | 17 parts by weight of calcium carbonate and |
| | 50 parts by weight of water, |
| | subsequently grinding the mixture in a bead mill and atomizing and drying the |
| | resulting suspension in a spray tower by means of a single-substance nozzle. |

### BIOLOGICAL EXAMPLES

1. Pre-Emergence Effect on Weeds

Seeds or rhizome pieces of monocotyledonous and dicotyledonous weed plants are placed in sandy loam soil in pots and covered with soil. The compositions, formulated in the form of concentrated aqueous solutions, wettable powders or emulsion concentrates, are then applied to the surface of the soil cover as aqueous solution, suspension or emulsion at an application rate of 600 to 800 l of water/ha (converted), in various dosages. After the treatment, the pots are placed in a greenhouse and kept under good growth conditions for the weeds. After the test plants have emerged, the damage to the plants or the negative effects on the emergence is scored visually after a test period of 3 to 4 weeks by comparison with untreated controls. As shown by the test results, the compositions according to the invention have good herbicidal pre-emergence activity against a broad spectrum of weed grasses and broad-leaved weeds.

Scoring and evaluation of the synergistic herbicidal effects:

The herbicidal efficacy of the active compounds or active compound mixtures was scored visually using the treated plots in comparison to untreated control plots. The damage and development of all above-ground parts of the plants were recorded. Scoring was carried out using a percentage scale (100% effect=all plants killed; 50% effect=50% of the plants and the green parts of the plants killed; 0% effect no noticeable effect=like control plot). The scores of in each case 4 plots were averaged.

When using the combinations according to the invention, herbicidal effects on a harmful plant species are frequently observed which exceed the formal sum of the activities of the herbicides contained in the combination when applied on their own. Alternatively, in some cases, it can be observed that a lower application rate is required for the herbicide combination in order to obtain, compared to the individual preparations, the same effect on a harmful plant species. Such activity increases or increases in effectiveness or reduced application rates are a strong indication of a synergistic effect.

If the observed activity values already exceed the formal sum of the values for the trials with the individual applications, they also exceed the expected value according to Colby which is calculated using the following formula and which is likewise considered to be an indication of synergism (cf. S. R. Colby; in Weeds 15 (1967) p. 20 to 22):

E=A+B−(A×B/100)

The figures denote: A, B=activity of the active compounds A or B in % at an application rate a or b g of a.s./ha; E=expected value in % of the active compound combination at an application rate of a+b g of a.s./ha (a.s.=active substance).

The observed test results show, at suitable low dosages, an effect of the combinations which exceeds the formal sum of the effects in the case of individual application or the expected values according to Colby.

2. Post-Emergence Effect on Weeds

Seeds or rhizome pieces of monocotyledonous and dicotyledonous weeds are placed in sandy loam soil in pots, covered with soil and grown in a greenhouse under good growth conditions (temperature, atmospheric humidity, water supply). Three weeks after sowing, the test plants are treated at the three-leaf stage with the compositions according to the invention. The compositions according to the invention, formulated as wettable powders or as emulsion concentrates, are sprayed, at various dosages, onto the green parts of the plant at an application rate of 600 to 800 l of water/ha (converted). After the test plants have been in the greenhouse for about 3 to 4 weeks under ideal growth conditions, the effect of the preparations is scored visually by comparison with untreated controls (cf. Section 1). The compositions according to the invention also have a good herbicidal post-emergence activity against a broad spectrum of economically important Weed grasses and broad-leaved weeds.

Frequently, activities of the combinations according to the invention are observed which exceed the formal sum of the activities when the herbicides are applied individually. The observed test results show, at suitable low dosages, an effect of the combinations which exceeds the formal sum of the effects in the case of individual application or the expected values according to Colby.

3. Herbicidal Effect and Crop Plant Compatibility (Field Trials)

Crop plants were grown outdoors on plots under natural outdoor conditions, and seeds or rhizome pieces of typical harmful plants were laid out or the natural weed growth was utilized. Treatment with the compositions according to the invention was carried out after the harmful plants had emerged and the crop plants were, generally, at the 2- to 4-leaf stage; in some cases (as stated), application of individual active compounds or active compound combinations was carried out pre-emergence (cf. Section 1) or post-emergence (cf. Section 2) or as a sequential treatment partly pre-emergence and/or post-emergence. After the application, for example 2, 4, 6 and 8 weeks after the application, the effect of the preparations was scored visually by comparison with untreated controls (cf. scoring in Section 1). In the field trial as well, the compositions according to the invention have synergistic herbicidal activity against a broad spectrum of economically important weed grasses and broad-leaved weeds. The comparison showed that the combinations according to the invention in most cases have a higher, in some cases a considerably higher, herbicidal activity than the sum of the activities of the individual herbicides, thus indicating synergism. Moreover, the effects in essential phases of the scoring period were above the expected values according to Colby, also indicating synergism. In contrast, the crop plants were, as a consequence of the treatments with the herbicidal compositions, damaged only to a small degree, if at all.

Abbreviations used in the tables below:

ai=a.s.=active substance (based on 100% active compound)

E^{a}=formal sum of the effects of the individual applications (cf. Section 1)

E^{c}=expected value according to Colby (cf. scoring in Section 1)

The numbers in the columns of the table under the designations of the harmful plants and the crop plants relate to the herbicidal effects or damage to the plants in percent.

TABLE 2
Field trial in winter wheat, post-emergence method

| | Dose | APESV | Winter wheat |
|---|---|---|---|
| Compound No, | [g ai/ha] | [effect in %] | [damage in %] |
| (A60) | 50 | 0 | 0 |
| (B3.1.5) + | 9 + 1.8 | 82 | 10 |
| (B3.1.4) | | | |
| (A60) + | 50 + (9 + 1.8) | 89 (E^{a} = 82 + 0) | 0 |
| (B3.1.5) + | | | |
| (B3.1.4) | | | |
| (A50) | 50 | 0 | 0 |
| (A50) + | 50 + (9 + 1.8) | 89 (E^{a} = 82 + 0) | 9 |
| (B3.1.5) + | | | |
| (B3.1.4) | | | |

Conditions: Field trial, application by the post-emergence method at the middle tillering stage, evaluation 21 days after the application
Abbreviations:
APESV = Apera spica-venti (common wind grass)
(A60) = Compound No. (A55) from Table 1, i.e. 2-amino-4-(1-fluoropropyl)-6-[1-(3,5-difluorophenyl)ethyl]-1,3,5-triazine
(A50) = Compound No. (A50) from Table 1, i.e. 2-amino-4-(1-fluoropropyl)-6-[1-(3-chloro-4-fluorophenyl)ethyl]-1,3,5-triazine
(B3.1.4) = iodosulfuron-methyl sodium salt
(B3.1.5) = mesosulfuron

TABLE 3
Field trial in corn, pre-emergence method

| | | | ECHCG | Corn |
|---|---|---|---|---|
| | Dose | CHEAL | [effect in | [damage |
| Compound no. | [g ai/ha] | [effect in %] | %] | in %] |
| (A11) | 75 | 0 | 0 | 0 |
| (B3.4.4) | 50 | 25 | 86 | 0 |
| (A11) + (B3.4.4) | 75 + 50 | 55 | 95 | 0 |
| | | (E^{a} = 25) | (E^{a} = 86) | |
| (A20) | 75 | 20 | 0 | 0 |
| (A20) + (B3.4.4) | 75 + 50 | 55 | 97 | 15 |
| | | (E^{a} = 45) | (E^{a} = 86) | |

Conditions: Field trial, application by the pre-emergence method, evaluation 36 days after the application
Abbreviations:
APESV = Apera spica-venti (windgrass)
(A11) = Compound No. (A11) from Table 1, i.e. 2-amino-4-(1-fluoroethyl)-6-[1-(3,4-difluorophenyl)ethyl]-1,3,5-triazine
(A20) = Compound No. (A20) from Table 1, i.e. 2-amino-4-(1-fluoropropyl)-6-[1-(3-methyl-4-fluorophenyl)ethyl]-1,3,5-triazine
(B3.4.4) = isoxaflutole

1. A herbicide combination comprising a synergistically effective amount of components (A) and (B), where
component (A) is one or more herbicidally active aminotriazine compounds of the formula (I) or salts thereof, 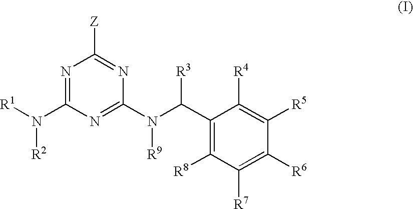
in which
Z is hydroxyl, halogen or
(C₁-C₁₀)alkyl, where the last-mentioned substituent is unsubstituted or substituted by one or more radicals selected from the group consisting of halogen, hydroxyl, amino, mercapto, cyano, nitro, thiocyanato, formyl, (C₁-C₄)alkoxy, mono(C₁-C₄)alkylamino, di(C₁-C₄)alkylamino, (C₁-C₄)haloalkoxy, (C₂-C₄)alkenyloxy, (C₂-C₄)haloalkenyloxy, (C₂-C₄)alkynyloxy, (C₂-C₄)haloalkynyloxy, (C₁-C₄)alkylthio, (C₁-C₄)alkylsulfinyl, (C₁-C₄)haloalkylsulfinyl, (C₁-C₄)alkylsulfonyl, (C₁-C₄)haloalkylsulfonyl, [(C₁-C₄)alkyl]carbonyl, [(C₁-C₄)haloalkyl]carbonyl, [(C₁-C₄)alkoxy]carbonyl, (C₃-C₉)cycloalkyl, (C₅-C₆)cycloalkenyl, phenyl and heterocyclyl, where each of the 4 last-mentioned radicals is unsubstituted or substituted, or
[(C₁-C₆)alkyl]carbonyl, [(C₁-C₆)alkoxy]carbonyl, (C₁-C₆)alkylsulfinyl or (C₁-C₄)alkylsulfonyl, where each of the 4 last-mentioned radicals is unsubstituted or substituted, or
(C₃-C₆)cycloalkyl, (C₅-C₆)cycloalkenyl, where each of the two last-mentioned cyclic radicals is unsubstituted or substituted,
R¹ and R² independently of one another are
H, formyl, aminocarbonyl, aminothiocarbonyl, (C₁-C₁₀)alkyl, (C₂-C₁₀)alkenyl, (C₂-C₁₀)alkynyl, (C₁-C₁₀)alkylsulfinyl, (C₁-C₁₀)alkylsulfonyl, (C₁-C₁₀)alkoxy, [(C₁-C₁₀)alkyl]carbonyl, [(C₁-C₁₀)alkyl]thiocarbonyl, [(C₁-C₁₀)alkoxy]carbonyl, [(C₁-C₁₀)alkoxy]thiocarbonyl, mono[(C₁-C₁₀)alkyl]aminocarbonyl, di[(C₁-C₁₀)alkyl]aminocarbonyl, mono[(C₁-C₁₀)alkyl]aminothiocarbonyl or di[(C₁-C₁₀)alkyl]aminothiocarbonyl, where each of the 14 last-mentioned radicals is unsubstituted or substituted,
or (C₃-C₆)cycloalkyl, (C₅-C₆)cycloalkenyl, (C₃-C₆)cycloalkoxy, (C₅-C₆)cycloalkenyloxy, phenyl, phenoxy, phenylamino, phenylsulfonyl, phenylcarbonyl, naphthylcarbonyl, phenylthiocarbonyl, naphthylthiocarbonyl, heterocyclyl, heterocyclyloxy, heterocyclylamino, heterocyclylcarbonyl, heterocyclylsulfonyl, where each of the 13 last-mentioned radicals is unsubstituted or substituted, or
one of the radicals R¹ and R² is as defined above and the other of the radicals
R¹ and R² is a group of the formula NR′R″, where R′ and R″ independently of one another are H or (C₁-C₆)alkyl,
or
R¹ and R² together are (C₁-C₁₀)alkylidene which is unsubstituted or substituted by one or more radicals selected from the group consisting of halogen, cyano, (C₁-C₄)alkoxy, (C₁-C₄)haloalkoxy, (C₁-C₄)-monoalkylamino, (C₁-C₄)-dialkylamino and (C₁-C₄)alkylthio,
or
NR¹R² together are a heterocyclyl radical which has 3 to 6 ring atoms, is attached at the nitrogen atom and, in addition to the nitrogen atom, optionally contains, as hetero ring atoms, 1 to 3 further hetero ring atoms selected from the group consisting of N, O and S, the heterocycle being unsubstituted or substituted,
R³ is halogen, CN, NO₂, SCN or a radical of the formula —X¹—A¹, where
X¹ is a direct bond or a divalent group of the formula —O—, —S(O)ₚ—, —S(O)ₚ—O—, —O—S(O)ₚ—, —CO—, —O—CO—, —CO—O—, —S—CO—, —CO—S—, —S—CS—, —CS—S—, —O—CO—O—, —NR^{O}—, —O—NR^{O}—, —NR^{O}—O—, —NR^{O}—CO—, —CO—NR^{O}—, —O—CO—NR^{O}— or —NR^{O}—CO—O—, where in each case p is the integer 0, 1 or 2 and Ro is hydrogen, (C₁-C₆)alkyl, (C₂-C₆)alkenyl, (C₂-C₆)alkynyl, phenyl, phenyl-(C₁-C₆)alkyl, (C₃-C₆)cycloalkyl or [(C₁-C₆)alkyl]carbonyl, and
A¹ is hydrogen, (C₁-C₁₀)alkyl, (C₂-C₁₀)alkenyl, (C₂-C₁₀)alkynyl, (C₃-C₆)cycloalkyl, (C₅-C₆)cycloalkenyl, phenyl or heterocyclyl having 3 to 9 ring atoms and 1 to 4 hetero ring atoms selected from the group consisting of N, O and S, where each of the 7 last-mentioned radicals is unsubstituted or substituted,
R⁴, R⁵, R⁶, R⁷ and R⁸ in each case independently of one another are halogen, nitro, cyano, thiocyanato or a radical of the formula —X²—A², where
X² is a direct bond or a divalent group of the formula —O—, —S(O)_{q}—, —S(O)_{q}—O— —O—S(O)_{q}—, S(O)_{q}NR^{r}—, —NR^{r}S(O)_{q}—, —CO—, —O—CO—, —CO—O—, —S—CO—, —CO—S—, —S—CS—, —CS—S—, —O—CO—O—, —NR^{r}—, —O—NR^{r}, —NR^{r}—O—, —NR^{r}—CO—, —CO—NR^{r}, —O—CO—NR^{r}— or —NR^{r}—CO—O— where in each case q is the integer 0, 1 or 2 and R^{r} is hydrogen, amino, substituted amino, (C₁-C₆)alkyl, (C₂-C₆)alkenyl, (C₂-C₆)alkynyl, phenyl, phenyl-(C₁-C₆)alkyl, phenylcarbonyl, (C₃-C₆)cycloalkyl, (C₅-C₆)cycloalkenyl, [(C₁-C₆)alkyl]carbonyl, (C₁-C₆)alkylsulfonyl or (C₁-C₆)alkylsulfinyl, phenylsulfonyl or phenylsulfinyl, where each of the 13 last-mentioned radicals is unsubstituted or substituted, and
A² is hydrogen, (C₁-C₁₀)alkyl, (C₂-C₁₀)alkenyl, (C₂-C₁₀)alkynyl, (C₃-C₆)cycloalkyl, (C₅-C₆)cycloalkenyl, phenyl or heterocyclyl, where each of the 7 last-mentioned radicals is unsubstituted or substituted,
or
two adjacent radicals from the group consisting of R⁴, R⁵, R⁶, R⁷ and R⁸ together with the phenyl ring carbon atoms to which they are attached form a fused ring having 4 to 6 ring atoms which is carbocyclic or contains 1 to 3 hetero ring atoms selected from the group consisting of N, O and S and which is unsubstituted or substituted by one or more radicals selected from the group consisting of halogen, (C₁-C₆)alkyl, (C₁-C₆)haloalkyl, (C₂-C₆)alkenyl, (C₂-C₆)alkynyl, (C₁-C₆)alkoxy, (C₁-C₆)haloalkoxy, [(C₁-C₆)alkyl]carbonyl, [(C₁-C₆)alkoxy]carbonyl, (C₁-C₆)alkylsulfonyl and (C₁-C₆)alkylsulfinyl, and
R⁹ is H or formyl, (C₁-C₁₀)alkyl, (C₂-C₁₀)alkenyl, (C₂-C₁₀)alkynyl, (C₁-C₁₀)alkylsulfinyl, (C₁-C₁₀)alkylsulfonyl, (C₁-C₁₀)alkoxy, [(C₁-C₁₀)alkyl]carbonyl, [(C₁-C₁₀)alkoxy]carbonyl, where each of the 8 last-mentioned radicals is unsubstituted or substituted,
or
(C₃-C₆)cycloalkyl, (C₅-C₆)cycloalkenyl, (C₃-C₆)cycloalkoxy, (C₅-C₆)cycloalkenyloxy, phenyl, phenoxy, phenylamino, phenylcarbonyl, phenylsulfonyl, heterocyclyl, heterocyclyloxy, heterocyclylamino, heterocyclylcarbonyl or heterocyclylsulfonyl, where each of the 14 last-mentioned radicals is unsubstituted or substituted, or a group of the formula NR^{a}R^{b},
where R^{a} and R^{b} independently of one another are H, formyl, (C₁-C₆)alkyl, (C₂-C₆)alkenyl, (C₂-C₆)alkynyl, (C₁-C₆)alkylsulfinyl, (C₁-C₆)alkylsulfonyl, (C₁-C₆)alkoxy, (C₁-C₆)alkylcarbonyl or [(C₁-C₆)alkoxy]carbonyl, where each of the 8 last-mentioned groups is unsubstituted or substituted, or
R^{a} and R^{b} together are straight-chain (C₂-C₅)alkylene which is unsubstituted or substituted by one or more radicals selected from the group consisting of (C₁-C₄)alkyl, (C₁-C₄)alkoxy, (C₁-C₄)alkoxy-(C₁-C₄)alkyl and oxo,
where
at least two radicals, preferably 2 to 3 radicals, from the group consisting of R⁴, R⁵, R⁶, R⁷and R⁸are different from hydrogen,
and
component (B) is one or more herbicides selected from the group of compounds consisting of
(B1) foliar- and/or soil-acting herbicides which are active against monocotyledonous harmful plants,
(B2) herbicides which are active against predominantly dicotyledonous harmful plants,
(B3) herbicides which are active against monocotyledonous and dicotyledonous harmful plants and
(B4) herbicides which are active against monocotyledonous and dicotyledonous harmful plants and which can be employed specifically in tolerant crops or on non-crop land.

2. The herbicide combination as claimed in claim 1, wherein in compounds of the formula (I) or salts thereof
Z is (C₁-C₆)alkyl, which is unsubstituted or substituted by one or more radicals selected from the group consisting of halogen, cyano, formyl, (C₁-C₄)alkoxy, mono(C₁-C₄)alkylamino, di(C₁-C₄)alkylamino, (C₁-C₄)haloalkoxy, (C₁-C₄)alkylsulfonyl, (C₁-C₄)haloalkylsulfonyl, [(C₁-C₄)alkyl]carbonyl, [(C₁-C₄)alkoxy]carbonyl, (C₃-C₆)cycloalkyl, (C₅-C₆)cycloalkenyl and phenyl, where each of the 3 last-mentioned radicals is unsubstituted or substituted by one or more radicals selected from the group consisting of halogen, cyano, (C₁-C₄)alkyl, (C₁-C₄)haloalkyl, (C₁-C₄)alkoxy, (C₁-C₄)haloalkoxy and (C₁-C₄)alkylthio, or (C₃-C₆)cycloalkyl which is unsubstituted or substituted by one or more radicals selected from the group consisting of halogen, cyano, (C₁-C₄)alkyl, (C₁-C₄)haloalkyl, (C₁-C₄)alkoxy, (C₁-C₄)haloalkoxy and (C₁-C₄)alkylthio,
R¹ is hydrogen or (C₁-C₄)alkyl and
R² is hydrogen, formyl, aminocarbonyl, aminothiocarbonyl, (C₁-C₄)alkyl, (C₁-C₄)alkylsulfonyl, [(C₁-C₄)alkyl]carbonyl, [(C₁-C₄)alkoxy]carbonyl, where each of the 4 last-mentioned radicals is unsubstituted or substituted by one or more radicals selected from the group consisting of halogen and (C₁-C₄)alkoxy, or
(C₃-C₆)cycloalkyl which is unsubstituted or substituted by one or more radicals selected from the group consisting of halogen, (C₁-C₄)alkyl and (C₁-C₄)haloalkyl, or
R¹ and R² together are (C₁-C₆)alkylidene which is unsubstituted or substituted by one or more radicals selected from the group consisting of halogen and cyano, and
R³ is halogen, CN, NO₂, SCN or a radical of the formula —X¹—A¹, where
X¹ is a direct bond or a divalent group of the formula —O—, —S(O)ₚ—, —S(O)ₚ—O—, —O—S(O)ₚ—, —CO—, —O—CO—, —CO—O—, —S—CO—, —CO—S—, —S—CS—, —CS—S—, —O—CO—O—, —NR^{O}—, —O—NR^{O}—, —NR^{O}—O—, —NR^{O}—CO—, —CO—NR^{O}—, —O—CO—NR^{O}— or —NR^{O}—CO—O—, where in each case p is the integer 0, 1 or 2 and R^{O} is hydrogen, (C₁-C₄)alkyl, (C₂-C₄)alkenyl, (C₂-C₄)alkynyl, phenyl, phenyl-(C₁-C₂)alkyl, (C₃-C₆)cycloalkyl or [(C₁-C₄)alkyl]carbonyl, and
A¹ is hydrogen, (C₁-C₆)alkyl, (C₂-C₆)alkenyl, (C₂-C₆)alkynyl, (C₃-C₆)cycloalkyl, phenyl or heterocyclyl having 3 to 9 ring atoms and 1 to 3 hetero ring atoms selected from the group consisting of N, O and S, where each of the 6 last-mentioned radicals is unsubstituted or substituted by one or more radicals selected from the group consisting of halogen, cyano, (C₁-C₄)alkyl, (C₃-C₆)cycloalkyl, (C₁-C₄)alkoxy, (C₁-C₄)haloalkoxy, (C₁-C₄)alkylthio and, in the case of cyclic radicals, also (C₁-C₄)haloalkyl and (C₁-C₄)alkoxy-(C₁-C₄)alkyl and, including substituents, has up to 16 carbon atoms,
each of the radicals R⁴, R⁵, R⁶, R⁷ and R⁸ independently of one another is halogen, nitro, cyano, thiocyanato or a radical of the formula —X²—A², where
X² is a direct bond or a divalent group of the formula —O—, —S(O)_{q}—, —S(O)_{q}—O—, —O—S(O)_{q}—, S(O)_{q}NR^{r}—, —NR^{r}—S(O)_{q}—, —CO—, —O—CO—, —CO—O—, —S—CO—, —CO—S—, —S—CS—, —CS—S—, —O—CO—O—, —NR^{r}—, O—NR^{r}, —NR^{r}—O—, —NR^{r}CO—, —CO—NR^{r}—, —O—CO—NR^{r}— or —NR^{r}—CO—O— where in each case q is the integer 0, 1 or 2 and R^{r} is in each case, independently of the others, hydrogen, amino, mono- or di-(C₁-C₄)alkylamino, mono- or di-(C₁-C₄)arylamino, N—(C₁-C₄)alkyl-N-arylamino, (C₁-C₄)alkyl, (C₂-C₄)alkenyl, (C₂-C₄)alkynyl, phenyl, phenyl(C₁-C₄)alkyl, phenyl-carbonyl, (C₃-C₆)cycloalkyl, (C₅-C₆)cycloalkenyl, [(C₁-C₄)alkyl]carbonyl, (C₁-C₄)alkylsulfonyl, (C₁-C₄)alkylsulfinyl, phenylsulfonyl or phenylsulfinyl, where each of the 18 last-mentioned radicals is unsubstituted or substituted by one or more radicals selected from the group consisting of halogen, cyano, (C₁-C₄)alkyl, (C₁-C₄)alkoxy, (C₁-C₄)haloalkoxy and, in the case of cyclic radicals, also (C₁-C₄)haloalkyl and (C₁-C₄)alkoxy-(C₁-C₄)alkyl, and
A² is hydrogen, (C₁-C₆)alkyl, (C₂-C₆)alkenyl, (C₂-C₆)alkynyl, (C₃-C₆)cycloalkyl, (C₅-C₆)cycloalkenyl, phenyl or heterocyclyl having 3 to 6 ring atoms and 1 to 3 hetero ring atoms selected from the group consisting N, O and S, where each of the 7 last-mentioned radicals is unsubstituted or substituted by one or more radicals selected from the group conssiting of halogen, cyano, hydroxyl, amino or else mercapto or aminocarbonyl, mono- and di-(C₁-C₄)alkylamino, mono- and di-phenylamino, N—(C₁-C₄)alkyl-N-phenylamino, mono- and di-[(C₁-C₄)alkanoyl]amino, mono- and di-[(C₁-C₄)alkylsulfonyl]amino, N—(C₁-C₄)alkyl-N-[(C₁-C₄)alkanoyl]amino, (C₁-C₄)alkyl-N-[(C₁-C₄)alkylsulfonyl]amino, N-phenyl-N-[(C₁-C₄)alkanoyl]amino, N-phenyl-N-[(C₁-C₄)alkylsulfonyl]amino, (C₁-C₄)alkoxy, (C₁-C₄)alkylthio, (C₁-C₄)alkylsulfonyl, (C₁-C₄)alkylsulfinyl, [(C₁-C₄)alkyl]-carbonyl, 3(C₁-C₄)alkoxy]carbonyl, [(C₁-C₄)alkyl]carbonyloxy, (C₃-C₆)cycloalkyl, (C₃-C₆)cycloalkoxy, (C₃-C₆)cycloalkylcarbonyl, (C₃-C₆)cycloalkylcarbonyloxy, phenyl, phenoxy, phenylthio, phenylcarbonyl, phenylcarbonyloxy, heterocyclyl, heterocyclyloxy, heterocyclylthio, heterocyclylcarbonyl, heterocyclylcarbonyloxy and, in the case of cyclic radicals, also (C₁-C₆)alkyl, where each of the 35 last-mentioned radicals is unsubstituted or substituted by one or more radicals selected from the group consisting of halogen, cyano, hydroxyl, amino, mono- and di-(C₁-C₄)alkylamino, mono- and di-phenylamino, N—(C₁-C₄)alkyl-N-phenylamino, (C₁-C₄)alkoxy, (C₁-C₄)alkylthio, (C₃-C₆)cycloalkyl, (C₃-C₆)cycloalkoxy, phenyl, phenoxy and phenylthio and, in the case of cyclic radicals, also (C₁-C₄)alkyl, (C₁-C₄)haloalkyl and (C₁-C₄)alkoxy-(C₁-C₄)alkyl, and A² including substituents has up to 16 carbon atoms, or
two adjacent radicals from the group consisting of R⁴, R⁵, R⁶, R⁷ and R⁸ together with the phenyl ring carbon atoms to which they are attached form a fused ring having 4 to 6 ring atoms which is carbocyclic or contains 1 to 3 hetero ring atoms selected from the group consisting of N, O and S and which is unsubstituted or substituted by one or more radicals selected from the group consisting of halogen, (C₁-C₄)alkyl, (C₂-C₄)alkenyl, (C₂-C₄)alkynyl, [(C₁-C₄)alkyl]carbonyl, (C₁-C₆)alkoxy, [(C₁-C₄)alkoxy]carbonyl, (C₁-C₄)alkylsulfonyl and (C₁-C₄)alkylsulfinyl,
where at least two radicals from the group consisting of R⁴, R⁵, R⁶, R⁷ and R⁸ are different from hydrogen, and
R⁹ is H or formyl, (C₁-C₆)alkyl, (C₂-C₆)alkenyl, (C₂-C₆)alkynyl, (C₁-C₆)alkylsulfinyl, (C₁-C₆)alkylsulfonyl, (C₁-C₆)alkoxy, [(C₁-C₆)alkyl]carbonyl, [(C₁-C₆)alkoxy]carbonyl, where each of the 8 last-mentioned radicals is unsubstituted or substituted by one or more radicals selected from the group consisting of halogen, (C₁-C₄)alkoxy, (C₁-C₄)haloalkoxy and (C₁-C₄)hydroxyalkoxy, or
a group of the formula NR^{a}R^{b}, where R^{a} and R^{b} independently of one another are H, or (C₁-C₄)alkyl.

3. The herbicide combination as claimed in claim 1, wherein in the compounds of the formula I or salts thereof
Z is (C₁-C₆)alkyl, which is unsubstituted or substituted by one or more radicals selected from the group consisting of halogen, (C₃-C₆)cycloalkyl and phenyl, where each of the 2 last-mentioned radicals is unsubstituted or substituted by one or more radicals selected from the group consisting of halogen, (C₁-C₄)alkyl, (C₁-C₄)haloalkyl, (C₁-C₄)alkoxy, (C₁-C₄)haloalkoxy and (C₁-C₄)alkylthio, or
(C₃-C₆)cycloalkyl which is unsubstituted or substituted by one or more radicals selected from the group consisting of halogen, (C₁-C₄)alkyl, (C₁-C₄)haloalkyl, (C₁-C₄)alkoxy, (C₁-C₄)haloalkoxy and (C₁-C₄)alkylthio,
R¹ is hydrogen or (C₁-C₄)alkyl, in particular H, and
R² is hydrogen, formyl, aminocarbonyl, aminothiocarbonyl, (C₁-C₄)alkyl, (C₁-C₄)alkylsulfonyl, [(C₁-C₄)alkyl]carbonyl, [(C₁-C₄)alkoxy]carbonyl, where each of the 4 last-mentioned radicals is unsubstituted or substituted by one or more radicals selected from the group consisting of halogen and (C₁-C₄)alkoxy, or
(C₃-C₆)cycloalkyl which is unsubstituted or substituted by one or more radicals selected from the group consisting of halogen, (C₁-C₄)alkyl and (C₁-C₄)haloalkyl, or
R¹ and R² together are (C₁-C₆)alkylidene which is unsubstituted or substituted by one or more radicals selected from the group consisting of halogen and cyano,
R³ is halogen, CN, NO₂, SCN or a radical of the formula —X¹—A¹, where
X¹ is a direct bond or a divalent group of the formula —O—, —S(O)ₚ—, —S(O)ₚ—O—, —O—S(O)ₚ—, —CO—, —O—CO—, —CO—O—, —S—CO—, —CO—S—, —S—CS—, —CS—S—, —O—CO—O—, —NR^{O}—, —O—NR^{O}—, —NR^{O}—O—, —NR^{O}—CO—, —CO—NR—, —O—CO—NR^{O}— or —NR^{O}—CO—O—, where in each case p is the integer 0, 1 or 2 and R^{O} is hydrogen, (C₁-C₄)alkyl, (C₂-C₄)alkenyl, (C₂-C₄)alkynyl, phenyl, phenyl-(C₁-C₂)alkyl, (C₃-C₆)cycloalkyl or [(C₁-C₄)alkyl]carbonyl, and
A¹ is hydrogen, (C₁-C₆)alkyl, (C₂-C₆)alkenyl, (C₂-C₆)alkynyl, (C₃-C₆)cycloalkyl, phenyl or heterocyclyl having 3 to 9 ring atoms and 1 to 3 hetero ring atoms selected from the group consisting of N, O and S, where each of the 6 last-mentioned radicals is unsubstituted or substituted by one or more radicals selected from the group consisting of halogen, cyano, (C₁-C₄)alkyl, (C₃-C₆)cycloalkyl, (C₁-C₄)alkoxy, (C₁-C₄)haloalkoxy, (C₁-C₄)alkylthio and, in the case of cyclic radicals, also (C₁-C₄)haloalkyl and (C₁-C₄)alkoxy-(C₁-C₄)alkyl and, including substituents, has up to 16 carbon atoms,
each of the radicals R⁴, R⁵, R⁶, R⁷ and R⁸ independently of one another is halogen, nitro, cyano, thiocyanato or a radical of the formula —X²—A², where
X² is a direct bond or a divalent group of the formula —O—, —S(O)_{q}—, —S(O)_{q}—O—, —O—S(O)_{q}—, —S(O)_{q}NR^{r}—, —NR^{r}—S(O)_{q}—, —CO—, —O—CO—, —CO—O—, —S—CO—, —CO—S—, —S—CS—, —CS—S—, —O—CO—O—, —NR^{r}—, —O—NR^{r}—, —NR^{r}—O—, —NR^{r}—CO, —CO—NR^{r}—, —O—CO—NR^{r}— or —NR^{r}—CO—O—, where in each case q is the integer 0, 1 or 2 and R^{r} is in each case, independently of the others, hydrogen, amino, mono- or di-(C₁-C₄)alkylamino, mono- or di-(C₁-C₄)arylamino, N—(C₁-C₄)alkyl-N-arylamino, (C₁-C₄)alkyl, (C₂-C₄)alkenyl, (C₂-C₄)alkynyl, phenyl, phenyl(C₁-C₄)alkyl, phenylcarbonyl, (C₃-C₆)cycloalkyl, (C₅-C₆)cycloalkenyl, [(C₁-C₄)alkyl]carbonyl, (C₁-C₄)alkylsulfonyl, (C₁-C₄)alkylsulfinyl, phenylsulfonyl or phenylsulfinyl, where each of the 18 last-mentioned radicals is unsubstituted or substituted by one or more radicals selected from the group consisting of halogen, cyano, (C₁-C₄)alkyl, (C₁-C₄)alkoxy, (C₁-C₄)haloalkoxy and, in the case of cyclic radicals, (C₁-C₄)haloalkyl and (C₁-C₄)alkoxy-(C₁-C₄)alkyl, and
A² is hydrogen, (C₁-C₆)alkyl, (C₂-C₆)alkenyl, (C₂-C₆)alkynyl, (C₃-C₆)cycloalkyl, (C₅-C₆)cycloalkenyl, phenyl or heterocyclyl having 3 to 6 ring atoms and 1 to 3 hetero ring atoms selected from the group consisting of N, O and S, where each of the 7 last-mentioned radicals is unsubstituted or substituted by one or more radicals selected from the group consisting of halogen, cyano, hydroxyl, amino or else mercapto or aminocarbonyl, mono- and di-(C₁-C₄)alkylamino, mono- and di-phenylamino, N—(C₁-C₄)alkyl-N-phenylamino, mono- and di-[(C₁-C₄)alkanoyl]amino, mono- and di-[(C₁-C₄)alkylsulfonyl]amino, N—(C₁-C₄)alkyl-N-[(C₁-C₄)alkanoyl]amino, (C₁-C₄)alkyl-N-[(C₁-C₄)alkylsulfonyl]amino, N-phenyl-N-[(C₁-C₄)alkanoyl]amino, N-phenyl-N-[(C₁-C₄)alkylsulfonyl]amino, (C₁-C₄)alkoxy, (C₁-C₄)alkylthio, (C₁-C₄)alkylsulfonyl, (C₁-C₄)alkylsulfinyl, [(C₁-C₄)alkyl]carbonyl, [(C₁-C₄)alkoxy]carbonyl, [(C₁-C₄)alkyl]carbonyloxy, (C₃-C₆)cycloalkyl, (C₃-C₆)cycloalkoxy, (C₃-C₆)cycloalkylcarbonyl, (C₃-C₆)cycloalkylcarbonyloxy, phenyl, phenoxy, phenylthio, phenylcarbonyl, phenylcarbonyloxy, heterocyclyl, heterocyclyloxy, heterocyclylthio, heterocyclylcarbonyl, heterocyclylcarbonyloxy and, in the case of cyclic radicals, also (C₁-C₆)alkyl,
where each of the 35 last-mentioned radicals is unsubstituted or substituted, preferably unsubstituted or substituted by one or more radicals selected from the group consisting of halogen, cyano, hydroxyl, amino, mono- and di-(C₁-C₄)alkylamino, mono- and di-phenylamino, N—(C₁-C₄)alkyl-N-phenylamino, (C₁-C₄)alkoxy, (C₁-C₄)alkylthio, (C₃-C₆)cycloalkyl, (C₃-C₆)cycloalkoxy, phenyl, phenoxy and phenylthio and, in the case of cyclic radicals, also (C₁-C₄)alkyl, (C₁-C₄)haloalkyl and (C₁-C₄)alkoxy-(C₁-C₄)alkyl, and A², including substituents, has up to 16 carbon atoms, or
two adjacent radicals from the group consisting of R⁴, R⁵, R⁶, R⁷ and R⁸ together with the phenyl ring carbon atoms to which they are attached form a fused ring having 4 to 6 ring atoms which is carbocyclic or contains 1 to 3 hetero ring atoms selected from the group consisting of N, O and S and which is unsubstituted or substituted by one or more radicals selected from the group consisting of halogen, (C₁-C₄)alkyl, (C₂-C₄)alkenyl, (C₂-C₄)alkynyl, [(C₁-C₄)alkyl]carbonyl, (C₁-C₆)alkoxy, [(C₁-C₄)alkoxy]carbonyl, (C₁-C₄)alkylsulfonyl and (C₁-C₄)alkylsulfinyl,
where at least two radicals from the group consisting of R⁴, R⁵, R⁶, R⁷ and R⁸ are different from hydrogen.

4. The herbicide combination as claimed in claim 1, wherein component (A) comprises compounds of the formula (Ia) and salts thereof, 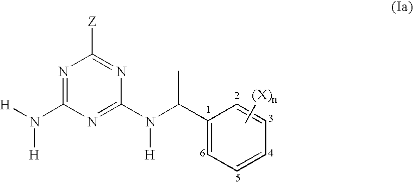
in which
Z is (C₁-C₄)alkyl or (C₁-C₄)haloalkyl,
(X)ₙ are n radicals X, each of which independently of one another is located in the 2-, 3-, 4- or 5-position on the phenyl ring and is halogen, methyl, ethyl, methoxy, ethoxy or CF₃, and
n is 2 or 3.

5. The herbicide combination as claimed in claim 1, where component (B) comprises one or more compounds selected from the group consisting of groups (B1) to (B4), where are

| | |
|---|---|
| (B1) | consists of foliar- and/or soil-acting herbicides which are act- |
| | ive against monocotyledonous harmful plants, selected from |
| (B1.1) | predominantly soil-acting ureas, selected from |
| (B1.1.1) | isoproturon and |
| (B1.1.2) | chlorotoluron, |
| (B1.2) | predominantly soil-acting compounds having various |
| | structures, selected from |
| (B1.2.1) | flufenacet, |
| (B1.2.2) | pendimethalin, |
| (B1.2.3) | prosulfocarb, |
| (B1.3) | predominantly foliar-acting 2-(4-heteroaryl- or 4- |
| | aryloxyphenoxy)propionic acids, selected from |
| (B1.3.1) | clodinafop-propargyl, |
| (B1.3.2) | diclofop-methyl, |
| (B1.3.3) | fenoxaprop-P-ethyl, |
| (B1.3.4) | quizalofop-P and its esters, |
| (B1.3.5) | fluazifop-P and its esters, |
| (B1.3.6) | haloxyfop and haloxyfop-P, |
| (B1.3.7) | propaquizafop, |
| (B1.3.8) | cyhalofop and its esters, |
| (B1.4) | predominantly foliar-acting cyclohexanedione oximes, |
| | selected from |
| (B1.4.1) | sethoxydim, |
| (B1.4.2) | cycloxydim, |
| (B1.4.3) | clethodim, |
| (B1.4.4) | profoxydim, |
| (B1.4.5) | tralkoxydim, |
| (B1.5) | predominantly soil-acting chloroacetamides, selected from |
| (B1.5.1) | dimethenamid, |
| (B1.5.2) | penthoxamid, |
| (B1.5.3) | butachlor, |
| (B1.5.4) | pretilachlor, |
| (B1.6) | foliar- and/or soil-acting compounds having various structures, |
| | selected from |
| (B1.6.1) | imazamethabenz-methyl, |
| (B1.6.2) | simazin, |
| (B1.6.3) | molinate, |
| (B1.6.4) | thiobencarb, |
| (B1.6.5) | oxaziclomefone, |
| (B1.6.6) | anilofos, |
| (B1.6.7) | cafenstrole, |
| (B1.6.8) | mefenacet, |
| (B1.6.9) | fentrazamid, |
| (B1.6.10) | thiazopyr, |
| (B1.6.11) | oxadiazon, |
| (B1.6.12) | esprocarb, |
| (B1.6.13) | pyributicarb, |
| (B1.6.14) | azimsulfuron, |
| (B1.6.15) | thenylchlor, |
| (B1.6.16) | pentoxazone, |
| (B1.6.17) | pyriminobac and its salts and esters, |
| (B1.6.18) | flucarbazone and its salts, |
| (B1.6.19) | procarbazone and its salts, |
| (B2) | herbicides which are active predominately against |
| | dicotyledonous harmful plants, selected from |
| (B2.1) | sulfonylureas, selected from |
| (B2.1.1) | tribenuron-methyl, |
| (B2.1.2) | thifensulfuron and its esters, |
| (B2.1.3) | prosulfuron, |
| (B2.1.4) | amidosulfuron, |
| (B2.1.5) | chlorimuron and its esters, |
| (B2.1.6) | halosulfuron and its esters, |
| (B2.1.7) | tritosulfuron, |
| (B2.1.8) | bensulfuron-methyl, |
| (B2.1.9) | ethoxysulfuron, |
| (B2.1.10) | cinosulfuron, |
| (B2.1.11) | pyrazosulfuron and its esters, |
| (B2.1.12) | imazosulfuron, |
| (B2.1.13) | cyclosulfamuron, |
| (B2.2) | growth regulators (of the auxin type), selected from |
| (B2.2.1) | MCPA, |
| (B2.2.2) | 2,4-D and their salts and esters |
| (B2.2.3) | dichlorprop-P and their esters and salts, |
| (B2.2.4) | mecoprop-P and their salts and esters, |
| (B2.2.5) | fluoroxypyr and their salts and esters |
| (B2.2.6) | dicamba and their salts and esters, |
| (B2.2.7) | clopyralid and their salts and esters, |
| (B2.2.8) | picloram and their salts and esters, |
| (B2.3) | hydroxylbenzonitriles, selected from |
| (B2.3.1) | bromoxynil and its salts and esters, |
| (B2.3.2) | loxynil and its salts and esters, |
| (B2.4) | diphenyl ethers, selected from |
| (B2.4.1) | fluoroglycofen-ethyl, |
| (B2.4.2) | aclonifen, |
| (B2.4.3) | acifluorfen and its salts, |
| (B2.5) | [1,2,4]triazolopyrimidinesulfonamides, selected from |
| (B2.5.1) | cloransulam (methyl ester), |
| (B2.5.2) | florasulam, |
| (B2.6) | compounds having various structures, selected from |
| (B2.6.1) | bentazone, |
| (B2.6.2) | bifenox, |
| (B2.6.3) | carfentrazone-ethyl, |
| (B2.6.4) | pyraflufen, |
| (B2.6.5) | pyridate, |
| (B2.6.6) | linuron, |
| (B2.6.7) | diflufenzopyr and its salts, |
| (B2.6.8) | cinidon-ethyl, |
| (B2.6.9) | metribuzin, |
| (B2.6.10) | picolinafen, |
| (B2.6.11) | clomazone, |
| (B2.6.12) | bromobutide, |
| (B2.6.13) | benfuresate, |
| (B2.6.14) | dithiopyr, |
| (B2.6.15) | triclopyr and its salts and esters, |
| (B3) | herbicides which are active against monocotyledonous and |
| | dicotyledonous harmful plants, selected from |
| (B3.1) | sulfonylureas, selected from |
| (B3.1.1) | metsulfuron-methyl, |
| (B3.1.2) | triasulfuron, |
| (B3.1.3) | chlorsulfuron, |
| (B3.1.4) | iodosulfuron-methyl and its salts, |
| (B3.1.5) | mesosulfuron, |
| (B3.1.6) | sulfosulfuron, |
| (B3.1.7) | flupyrsulfuron-methyl and its salts, |
| (B3.1.8) | nicosulfuron, |
| (B3.1.9) | rimsulfuron, |
| (B3.1.10) | primisulfuron-methyl, |
| (B3.1.11) | foramsulfuron, |
| (B3.2) | triazine derivatives, selected from |
| (B3.2.1) | cyanazine, |
| (B3.2.2) | atrazine, |
| (B3.2.3) | terbuthylazine, |
| (B3.2.4) | terbutryn, |
| (B3.3) | chloroacetamides, selected from |
| (B3.3.1) | acetochlor, |
| (B3.3.2) | S-metolachlor, |
| (B3.3.3) | alachlor, |
| (B3.4) | compounds having various structures, selected from |
| (B3.4.1) | diflufenican, |
| (B3.4.2) | flumetsulam, |
| (B3.4.3) | flurtamone, |
| (B3.4.4) | isoxaflutole, |
| (B3.4.5) | metosulam, |
| (B3.4.6) | paraquat (salts), |
| (B3.4.7) | benoxacor, |
| (B3.4.8) | sulcotrione, |
| (B3.4.9) | mesotrione, |
| (B3.4.10) | quinclorac, |
| (B3.4.11) | propanil, |
| (B3.4.12) | bispyribac (salts), |
| (B3.4.13) | pyribenzoxim, |
| (B3.4.14) | oxadiargyl, |
| (B3.4.15) | norflurazon, |
| (B3.4.16) | fluometuron, |
| (B3.4.17) | methylarsonic acid (salts), |
| (B3.4.18) | prometryn, |
| (B3.4.19) | trifluralin, |
| (B4) | herbicides which are active against monocotyledonous and |
| | dicotyledonous harmful plants and which can be employed |
| | specifically in tolerant crops or on non-crop land, selected |
| | from |
| (B4.1) | compounds of the glufosinate or phosphinothricin (= L- |
| | glufosinate) type and their salts and derivatives, selected from |
| (B4.1.1) | glufosinate (salts), |
| (B4.1.2) | bilanafos (salts), |
| (B4.2) | compounds of the phosphonomethylglycine type and their |
| | salts, selected from |
| (B4.2.1) | glyphosate (salts), |
| (B4.2.2) | sulfosate, |
| (B4.3) | imidazolinones, selected from |
| (B4.3.1) | imazapyr (salts), |
| (B4.3.2) | imazethapyr (salts), |
| (B4.3.3) | imazamethabenz (salts and esters), |
| (B4.3.4) | imazamox (salts and esters), |
| (B4.3.5) | imazaquin (salts and esters), |
| (B4.3.6) | imazapic (salts and esters), |
| (B4.4) | compounds having various structural types, selected from |
| (B4.4.1) | WC9717 or CGA276854, |
| (B4.4.2) | azafenidin, |
| (B4.4.3) | diuron and |
| (B4.4.4) | oxyfluorfen |

and, if appropriate, their agriculturally useful salts.

6. The herbicide combination as claimed in claim 1, which comprises one or more further components selected from the group consisting of crop protection agents of a different type, additives customary in crop protection and formulation auxiliaries.

7. A method for controlling harmful plants, which comprises applying the herbicides of the herbicide combination as defined in claim 1 together or separately, pre-emergence, post-emergence or pre- and post-emergence, to the plants, parts of plants, plant seeds or the area under cultivation.

8. The method as claimed in claim 7 for the selective control of harmful plants in crops of plants.

9. The method as claimed in claim 8 for the control of harmful plants in cereals, corn or rice.
